(19) United States
(12) Patent Application Publication
(10) Pub. No.: US 2025/0355546 A1
(43) Pub. Date: Nov. 20, 2025

(54) USER INTERFACES FOR MATHEMATICAL OPERATIONS AND GRAPHING

(71) Applicant: Apple Inc., Cupertino, CA (US)

(72) Inventors: Bryant A. JOW, Palo Alto, CA (US); Christopher D. SOLI, San Francisco, CA (US); Woosung KANG, San Jose, CA (US); Brandon M. WALKIN, San Francisco, CA (US); Dylan R. EDWARDS, San Jose, CA (US); Ryan S. DIXON, Redwood City, CA (US); Nicholas V. KING, San Jose, CA (US); Thomas DESELAERS, Zurich (CH); Martin BRESLER, Santa Clara, CA (US); Francisco ALVARO MUNOZ, Zurich (CH); Aditya GALADA, Santa Clara, CA (US); Kritarth JAIN, San Francisco, CA (US); Michael P. MCFADDEN, Mountain View, CA (US); Peder BLEKKEN, Lier (BE); Steffen RYLL, Holle (DE); Christian C. HILTON, Pacifica, CA (US); Julian K. MISSIG, Burlingame, CA (US); Marisa R. LU, San Francisco, CA (US); Guillaume R. ARDAUD, Tokyo (JP)

(21) Appl. No.: 19/173,726

(22) Filed: Apr. 8, 2025

Related U.S. Application Data
(60) Provisional application No. 63/636,683, filed on Apr. 19, 2024.
(60) Provisional application No. 63/646,950, filed on May 13, 2024.
(60) Provisional application No. 63/657,892, filed on Jun. 9, 2024.

(51) Int. Cl. G06F 3/0484; G06F 3/0482; G06F 3/0488; G06F 17/11

(52) U.S. Cl. CPC G06F 3/0484; G06F 3/0482; G06F 3/0488; G06F 17/11

(57) ABSTRACT

In some embodiments, an electronic device solves mathematical equations detected in text input into applications other than a calculator application. In some embodiments, an electronic device performs unit conversions in a calculator application. In some embodiments, an electronic device presents graphs of mathematical equations. In some embodiments, an electronic device edits graphs of mathematical equations.

### CROSS REFERENCE TO RELATED APPLICATIONS

This application claims the benefit of U.S. Provisional Application No. 63/636,683, filed Apr. 19, 2024, and U.S. Provisional Application No. 63/646,950, filed May 13, 2024, and U.S. Provisional No. 63/657,892, filed Jun. 9, 2024, the contents of which are herein incorporated by reference in their entireties for all purposes.

### FIELD OF THE DISCLOSURE

This disclosure relates generally to an electronic device presenting user interfaces for mathematical operations and graphing.

### BACKGROUND OF THE DISCLOSURE

User interaction with electronic devices has increased significantly in recent years. These devices can be devices such as computers, tablet computers, televisions, multimedia devices, or mobile devices. In some circumstances, users may wish to perform mathematical operations. The user may therefore desire efficient ways of performing mathematical operations.

### SUMMARY OF THE DISCLOSURE

Providing efficient ways of performing mathematical operations in response to detecting text including a mathematical equation in applications other than a calculator application enhances user interactions with the electronic device by reducing the time and inputs needed to perform mathematical operations and reducing user errors. Providing efficient ways of performing unit conversion within a calculator application enhances user interactions with the electronic device by reducing time and inputs needed to perform unit conversions with other mathematical operations and reduces user errors. Displaying a selectable option that, when selected, causes the electronic device to display a graph of a mathematical equation in response to detecting the mathematical equation enhances user interactions with the electronic device by reducing the inputs needed to graph mathematical equations. Displaying a menu of options for adding, removing, or modifying functions included in a graph enhances user interactions with the electronic device by reducing inputs and reducing user errors when interacting with graphs of mathematical functions.

The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIGS. 3A-3G is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6GG illustrate exemplary ways in which an electronic device displays solutions to mathematical equations in response to receiving an input including a mathematical equation in accordance with some embodiments of the disclosure.

FIG. 7 illustrates a flow diagram illustrating a method in which an electronic device displays solutions to mathematical equations in response to receiving an input including a mathematical equation in accordance with some embodiments of the disclosure.

FIGS. 8A-8W illustrate exemplary ways in which an electronic device performs unit conversions using a calculator application according to some embodiments.

FIGS. 9A-9B illustrate a flow diagram illustrating a method in which an electronic device performs unit conversions using a calculator application according to some embodiments.

FIGS. 10A-10YY illustrate exemplary ways in which an electronic device presents and/or edits graphs of mathematical equations according to some embodiments.

FIG. 11 illustrates a flow diagram illustrating a method in which an electronic device displays presents graphs of mathematical equations in accordance with some embodiments of the disclosure.

FIG. 12 illustrates a flow diagram illustrating a method in which an electronic device edits graphs of mathematical functions in accordance with some embodiments of the disclosure.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used, and structural changes are optionally made without departing from the scope of the disclosed embodiments.

Providing efficient ways of performing mathematical operations in response to detecting text including a mathematical equation in applications other than a calculator application enhances user interactions with the electronic device by reducing the time and inputs needed to perform mathematical operations and reducing user errors. Providing efficient ways of performing unit conversion within a calculator application enhances user interactions with the electronic device by reducing time and inputs needed to perform unit conversions with other mathematical operations and reduces user errors. Displaying a selectable option that, when selected, causes the electronic device to display a graph of a mathematical equation in response to detecting the mathematical equation enhances user interactions with the electronic device by reducing the inputs needed to graph mathematical equations. Displaying a menu of options for adding, removing, or modifying functions included in a graph enhances user interactions with the electronic device by reducing inputs and reducing user errors when interacting with graphs of mathematical functions.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### Exemplary Devices

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component (e.g., a display device such as a head-mounted device (HMD), a display, a projector, a touch-sensitive display, or other device or component that presents visual content to a user, for example, on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

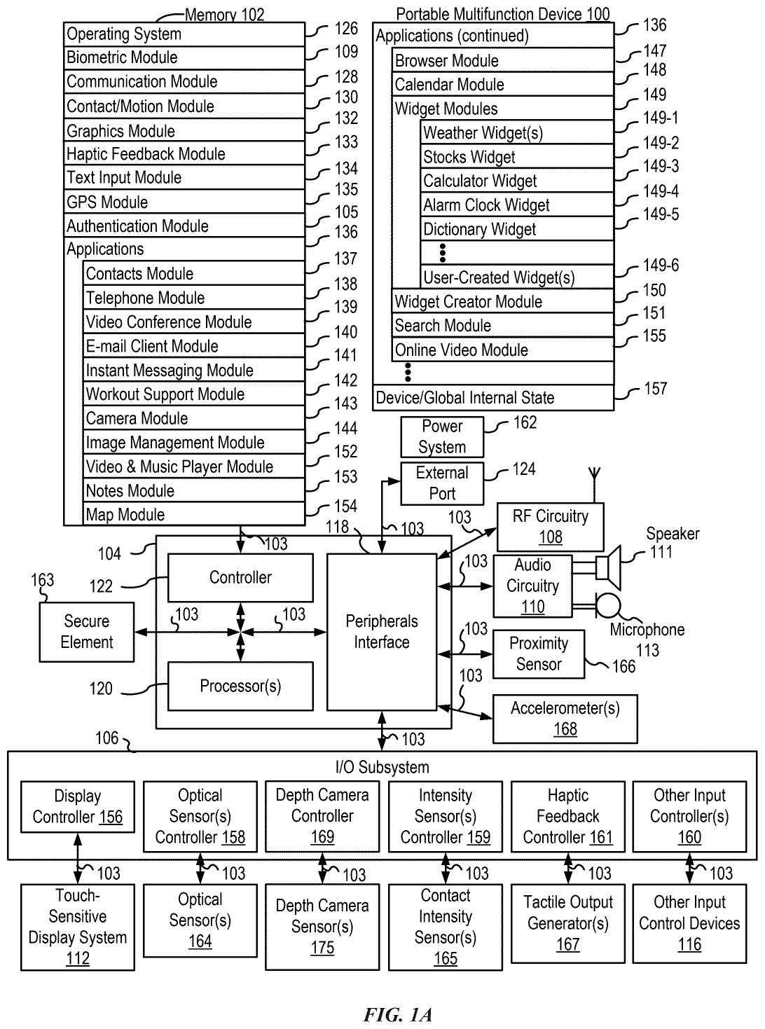

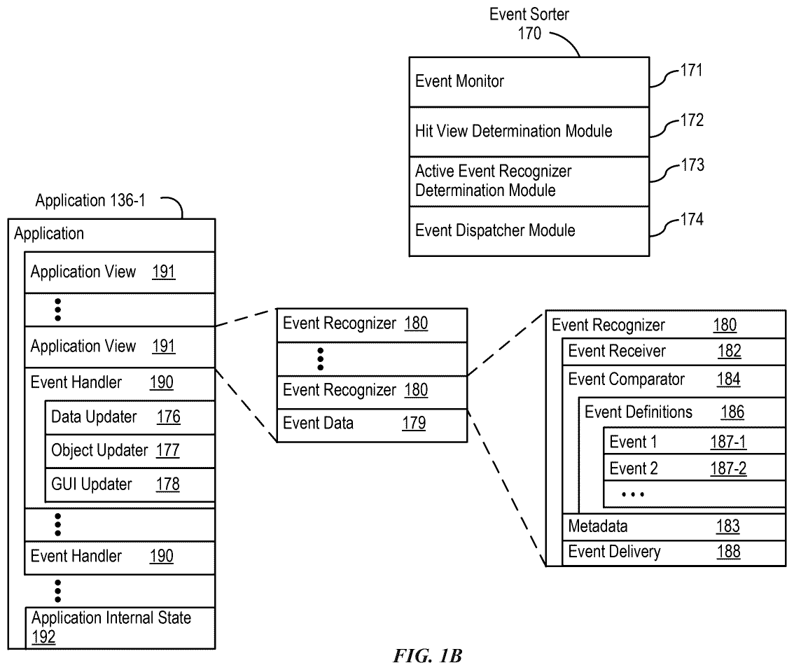

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as a “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

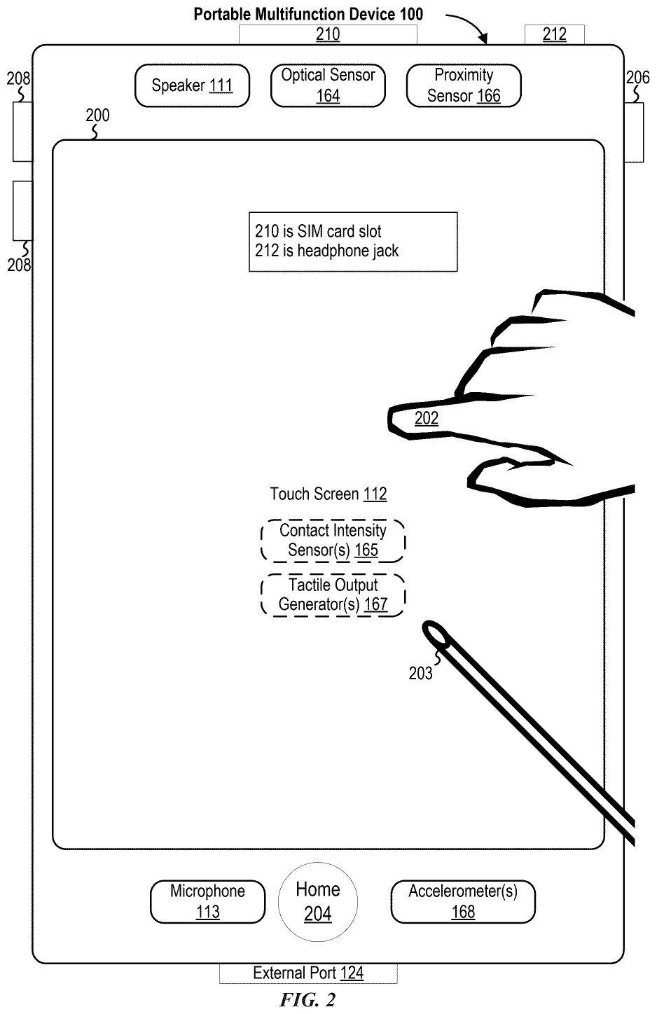

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/48,264, “Gestures For Touch Sensitive Input Devices,” filed Jan. 31, 2005; (5) U.S. patent application Ser. No. 11/38,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's car (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

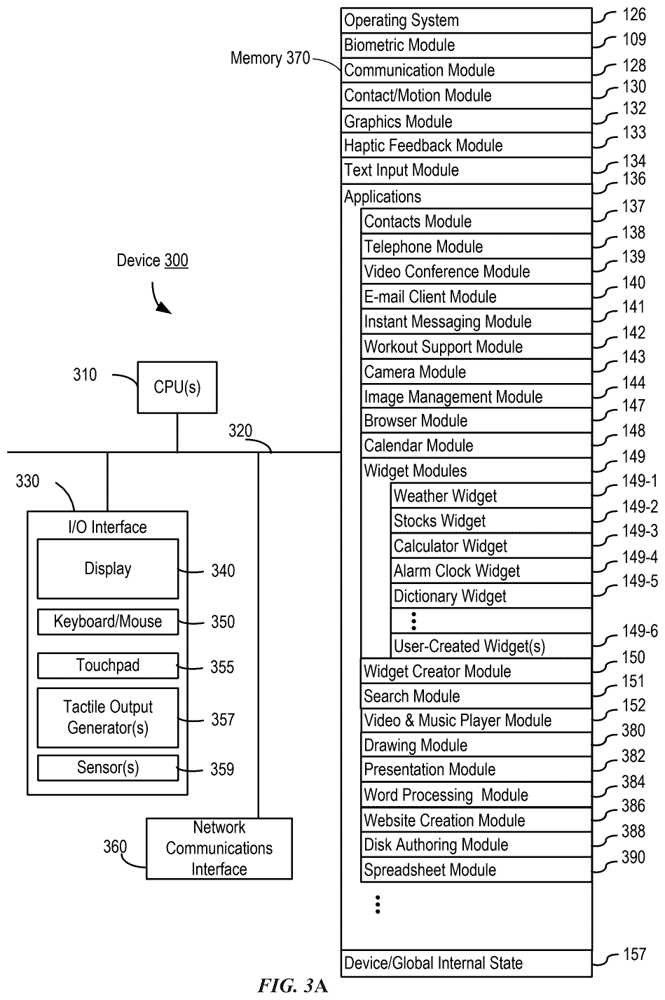

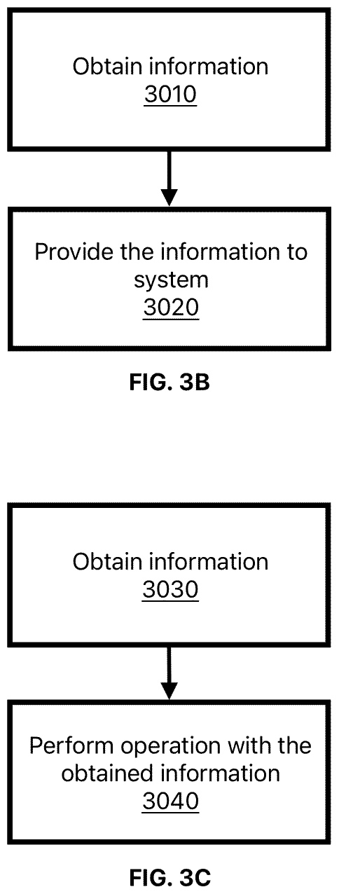

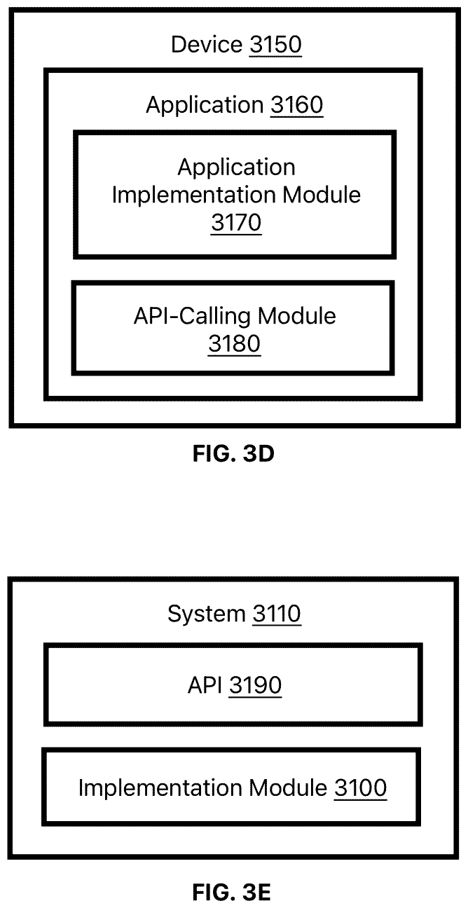

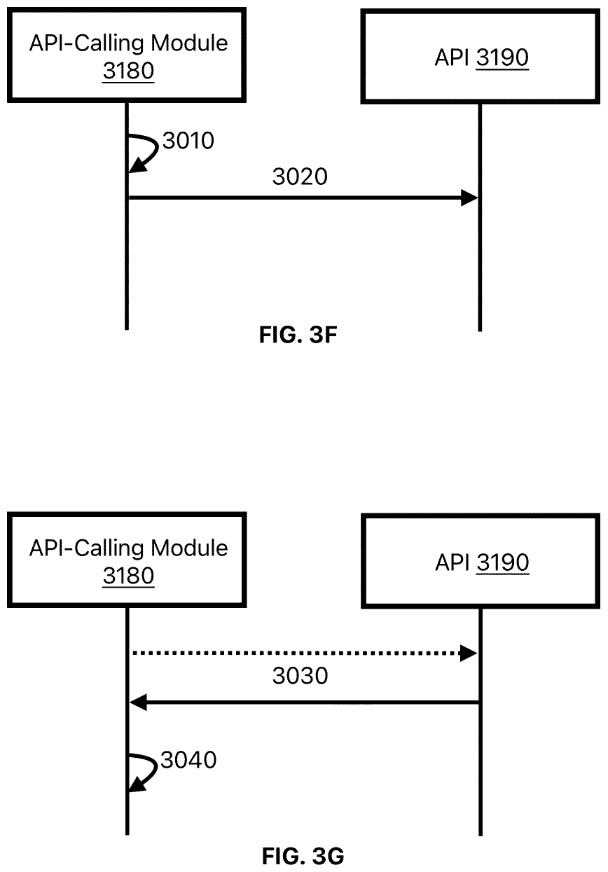

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,67, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (arc) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes onc or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call docs), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

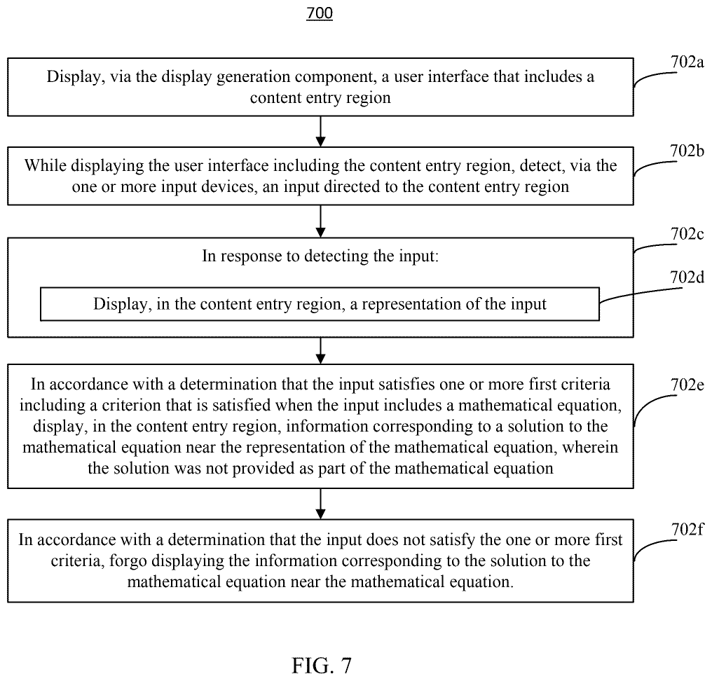

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

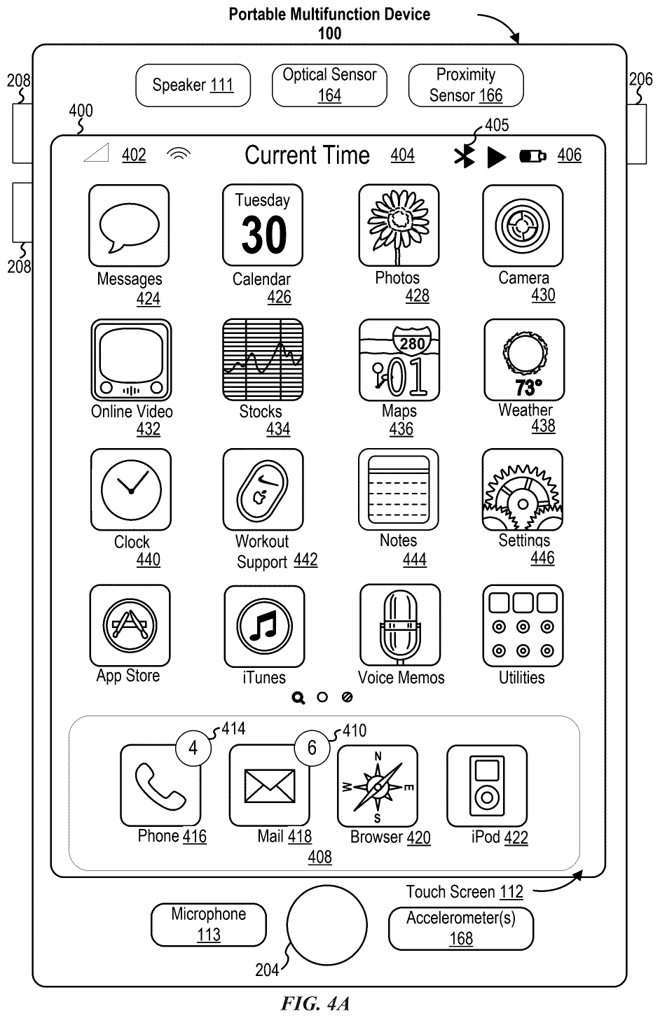

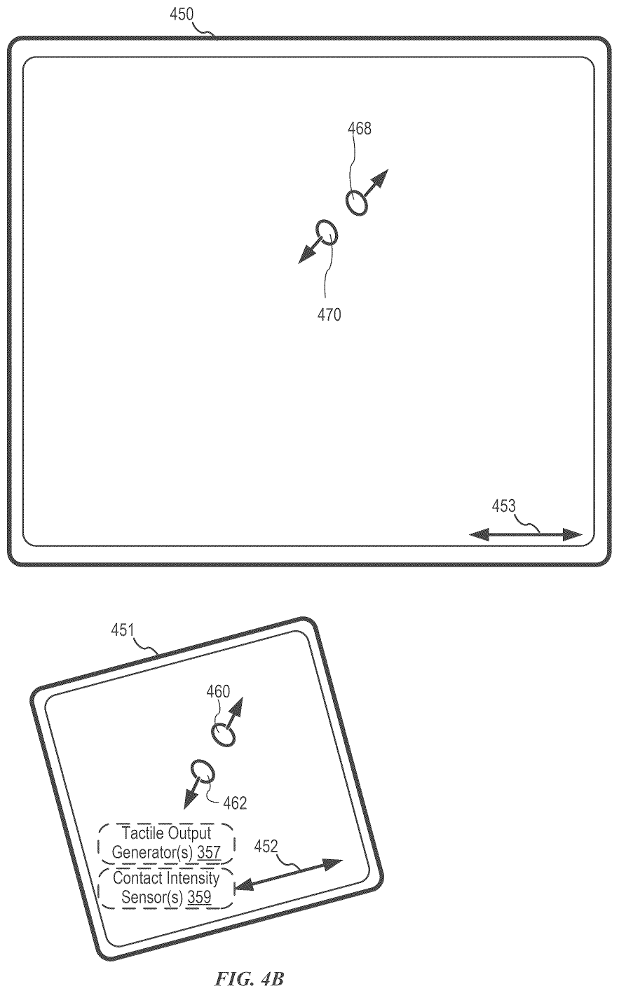

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

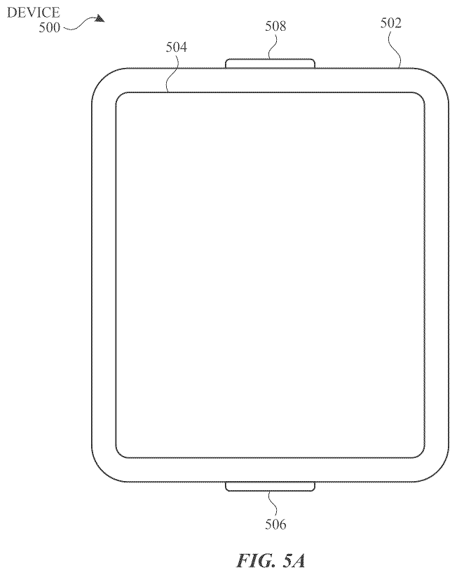

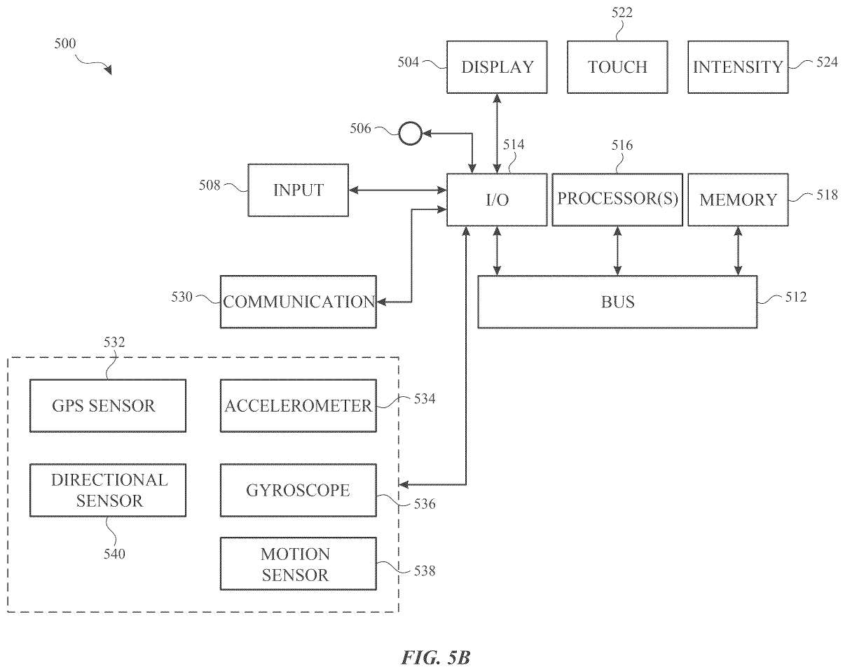

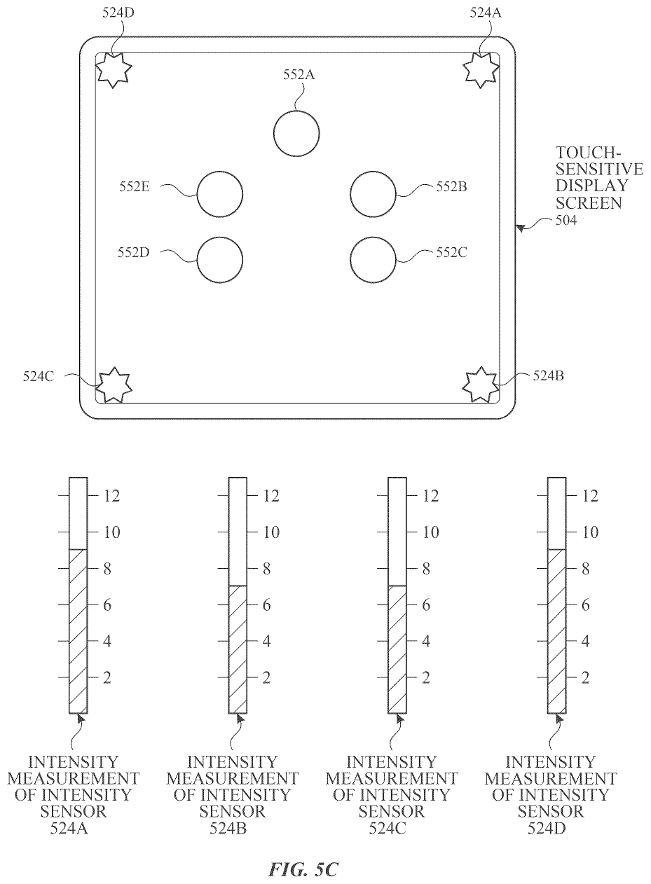

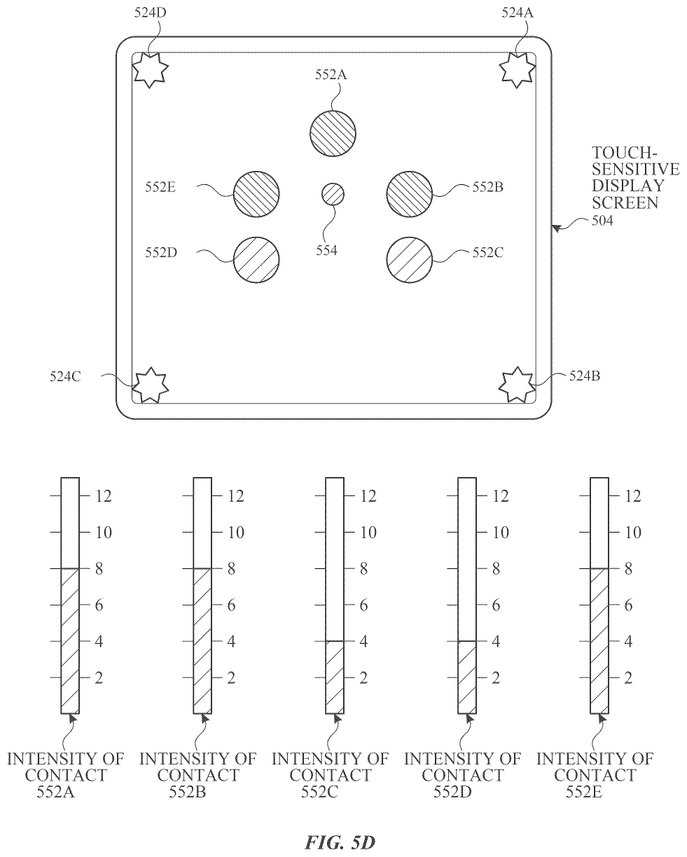

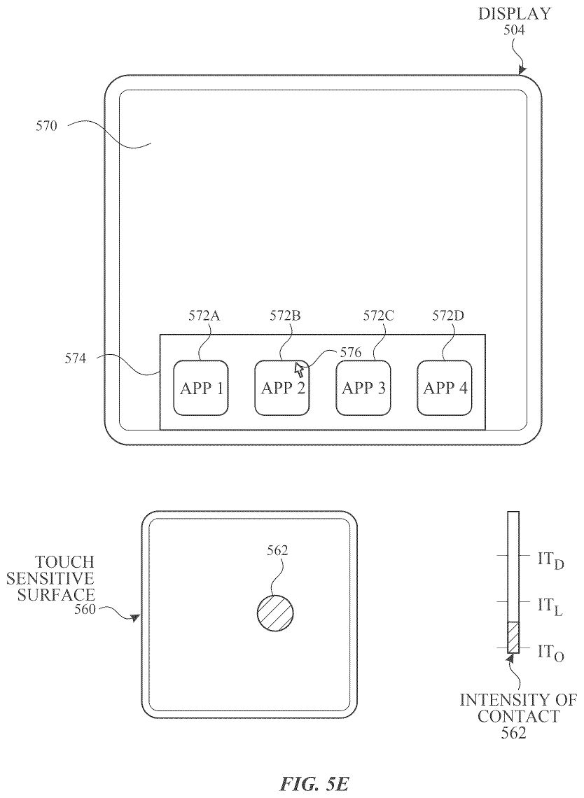

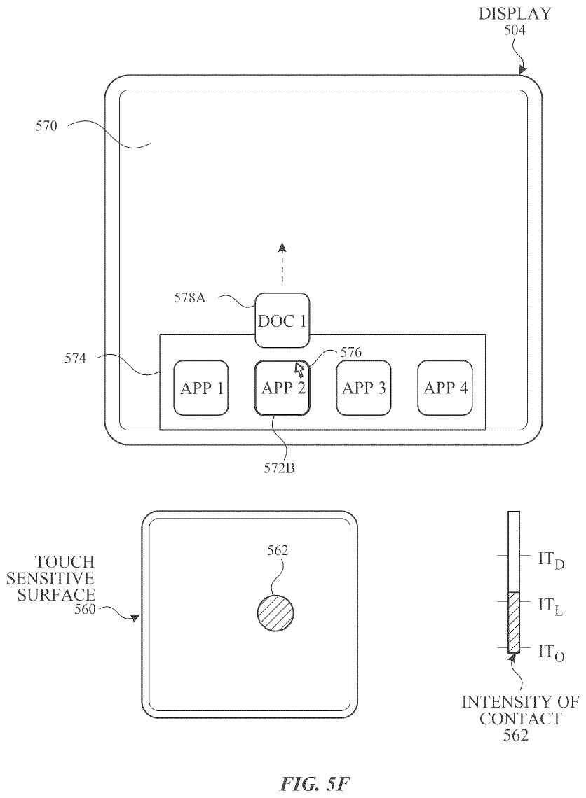

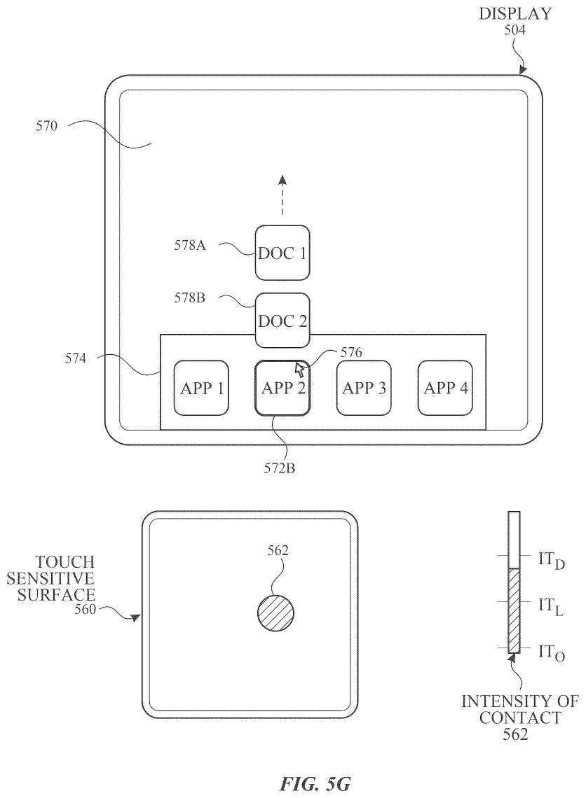

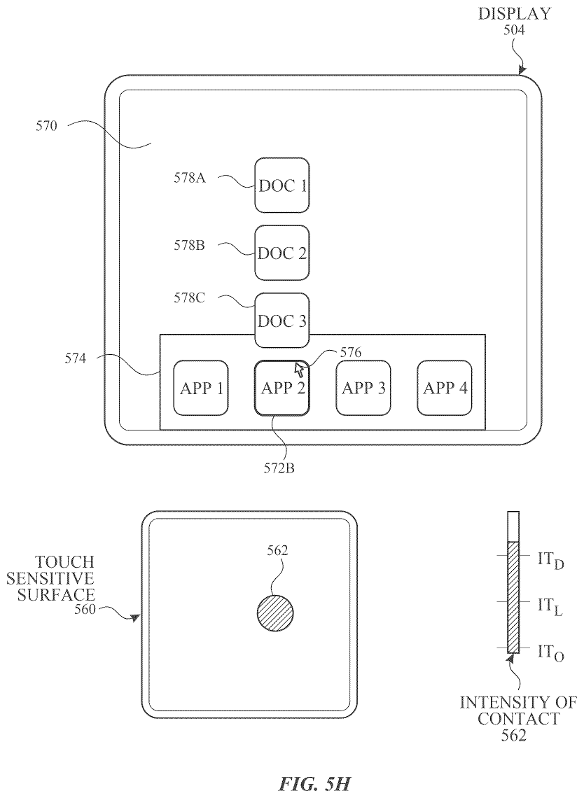

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 504 optionally execute any number of programs stored in memory 506 or storage, which optionally includes instructions to perform one or more of the methods and/or processes described herein (e.g., methods 700, 900, 1100, and/or 1200). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIGS. 5, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D})”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D})”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For case of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

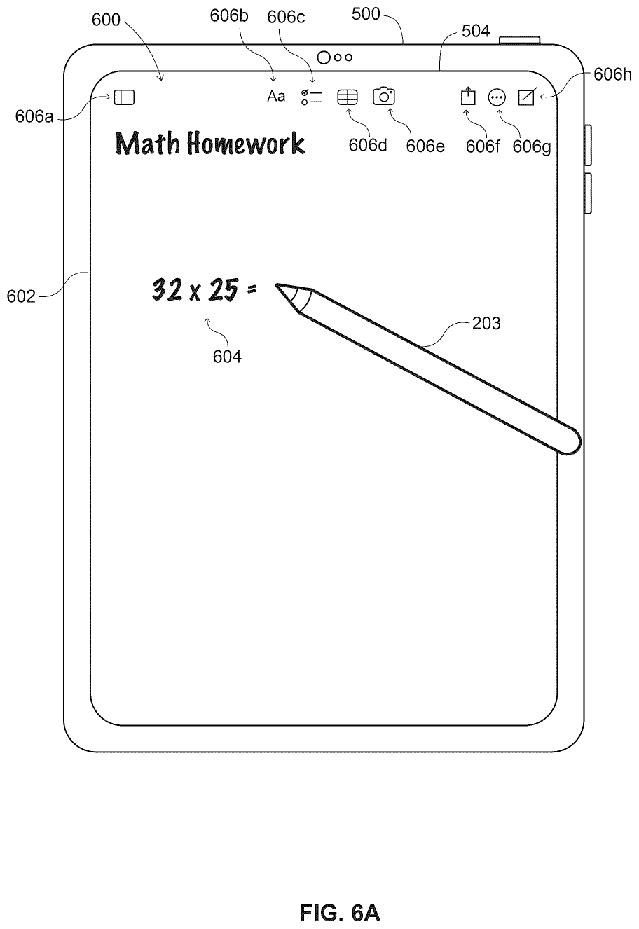

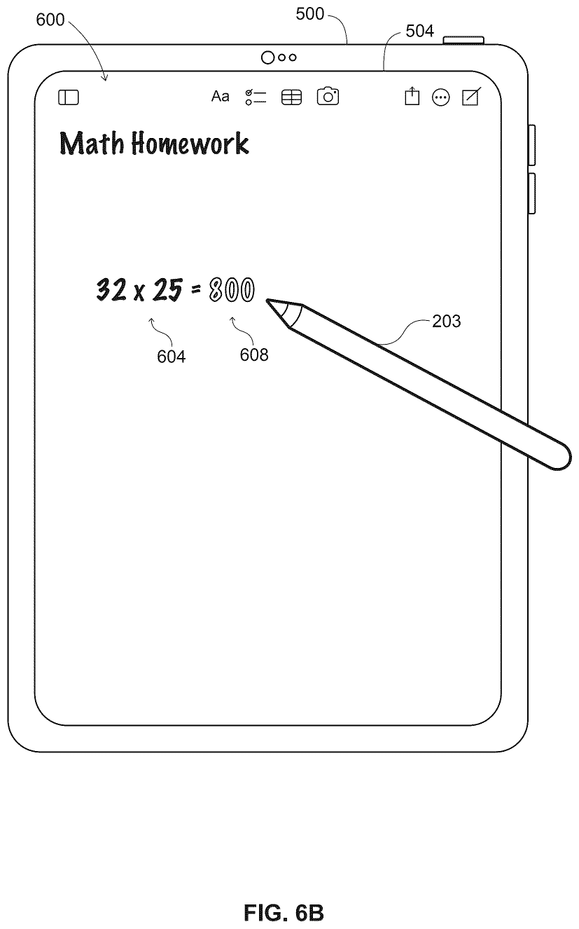

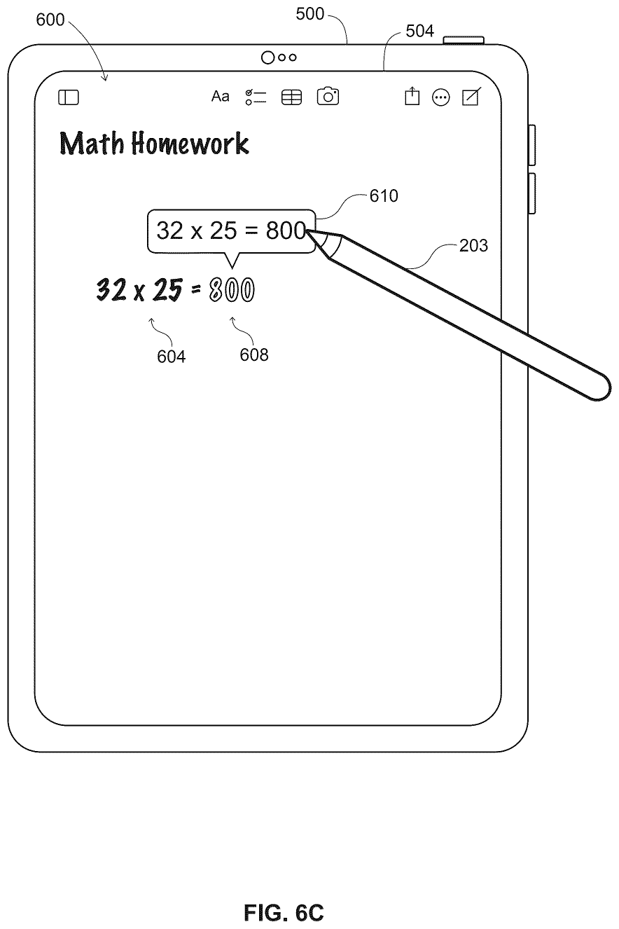

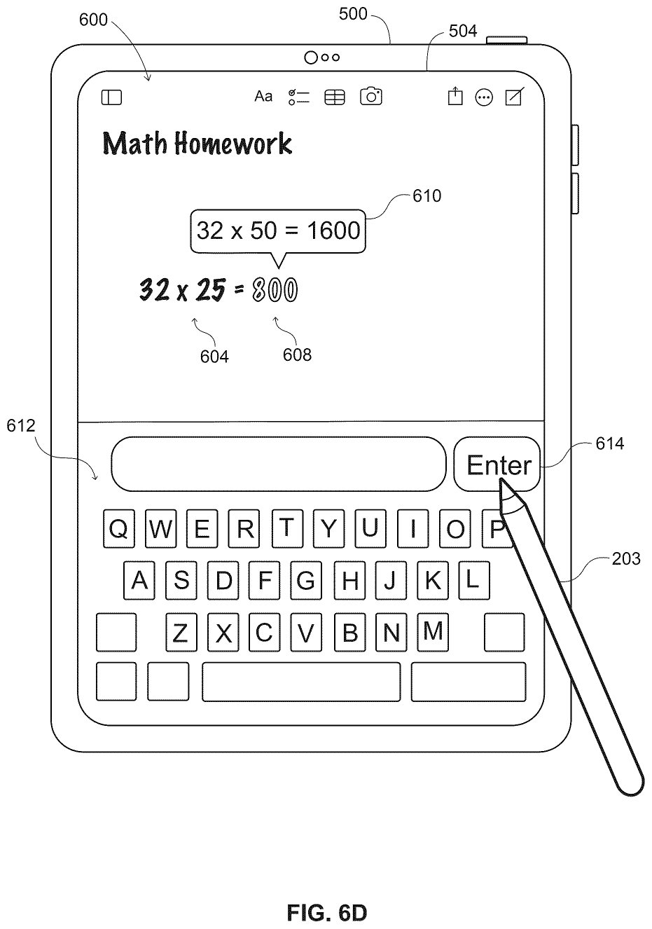

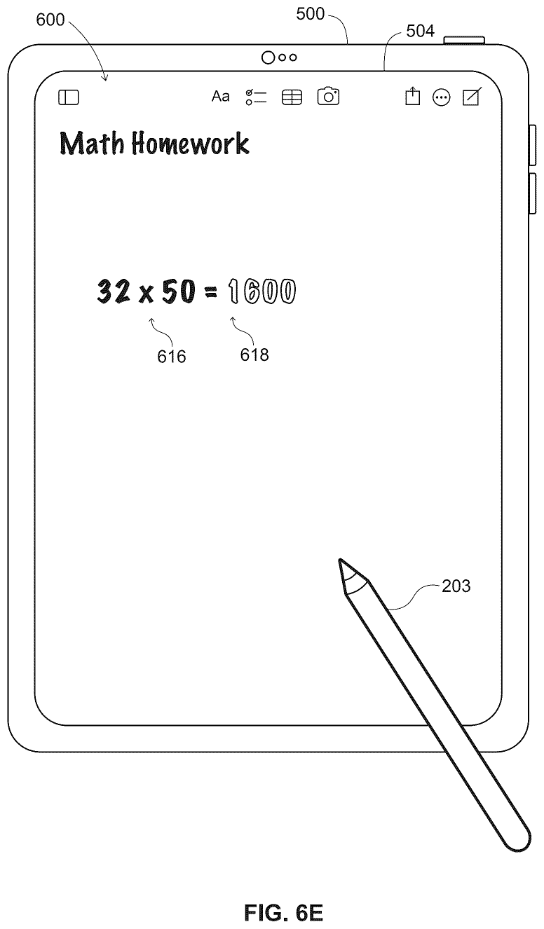

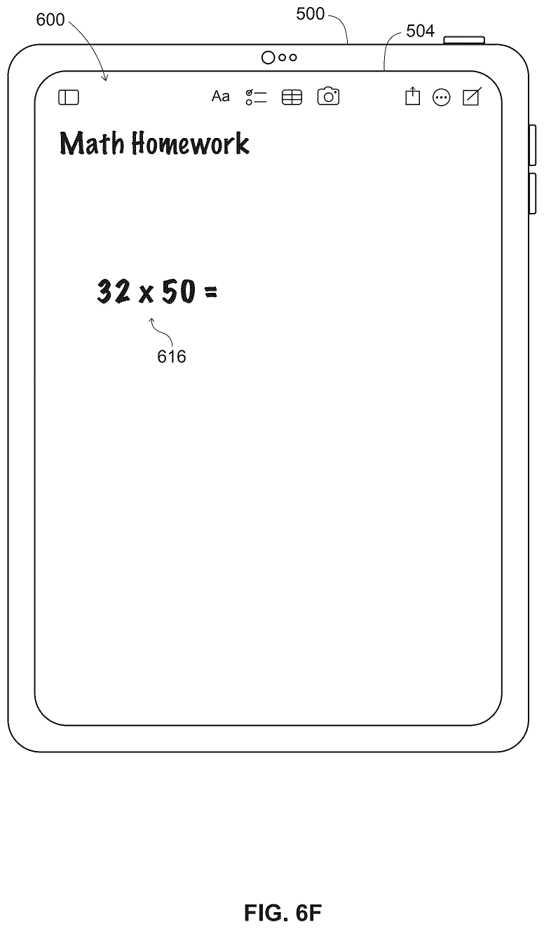

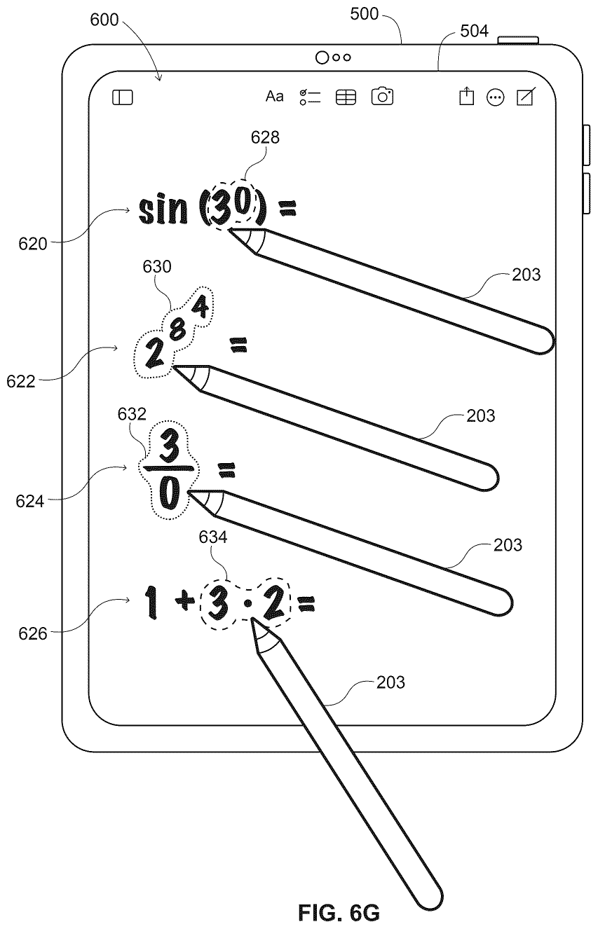

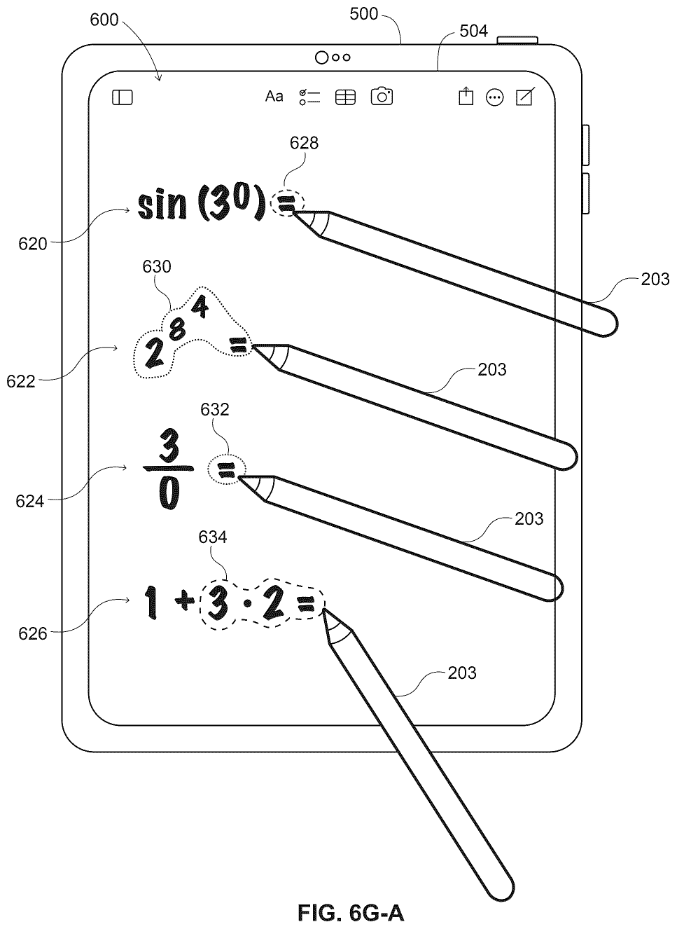

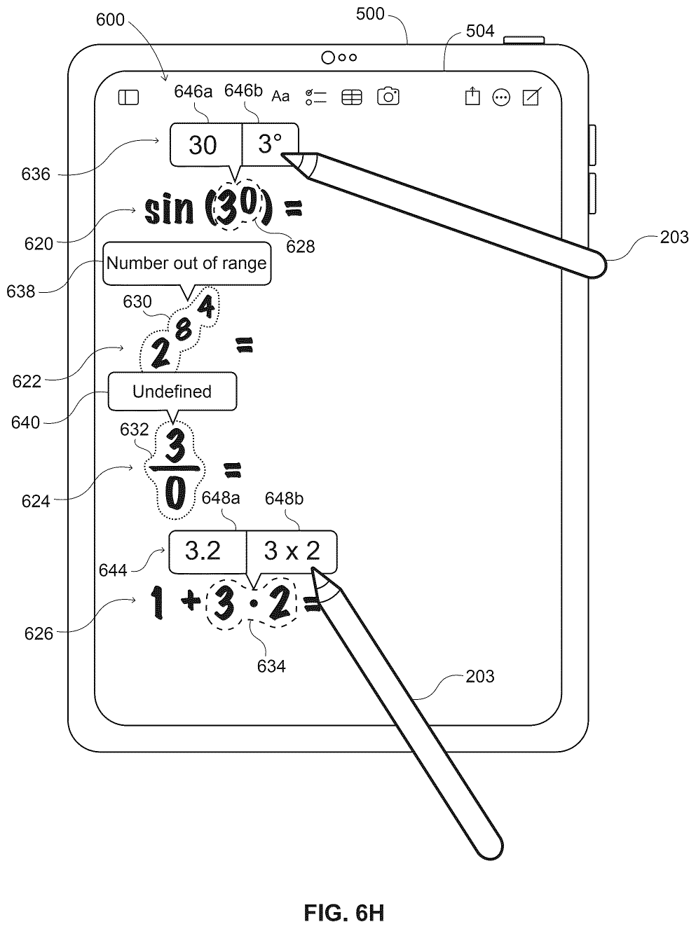

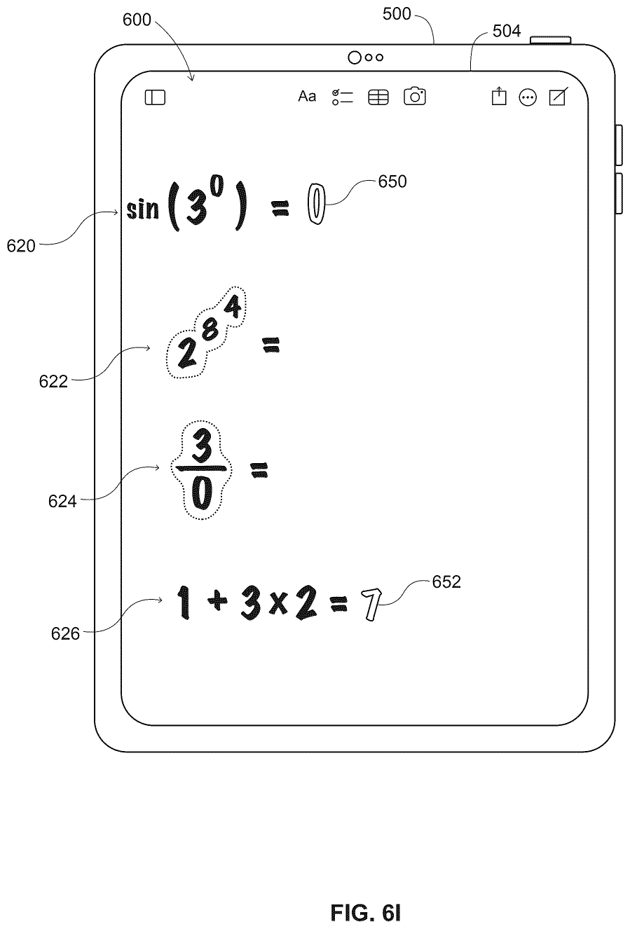

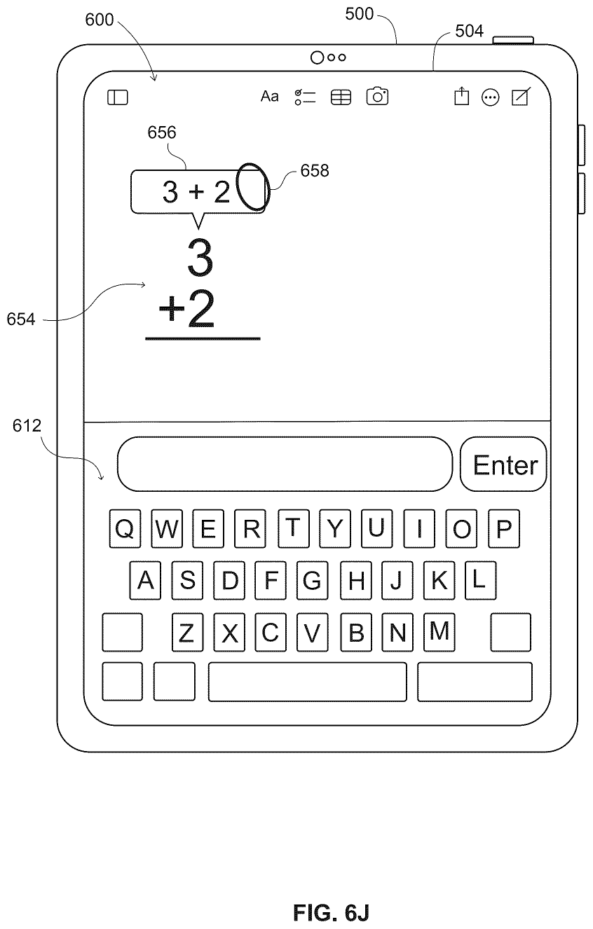

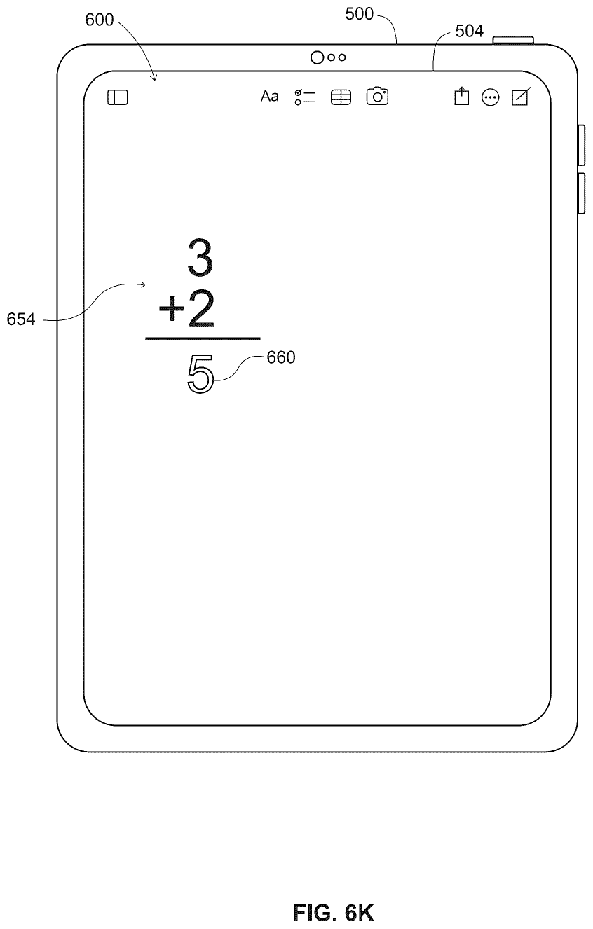

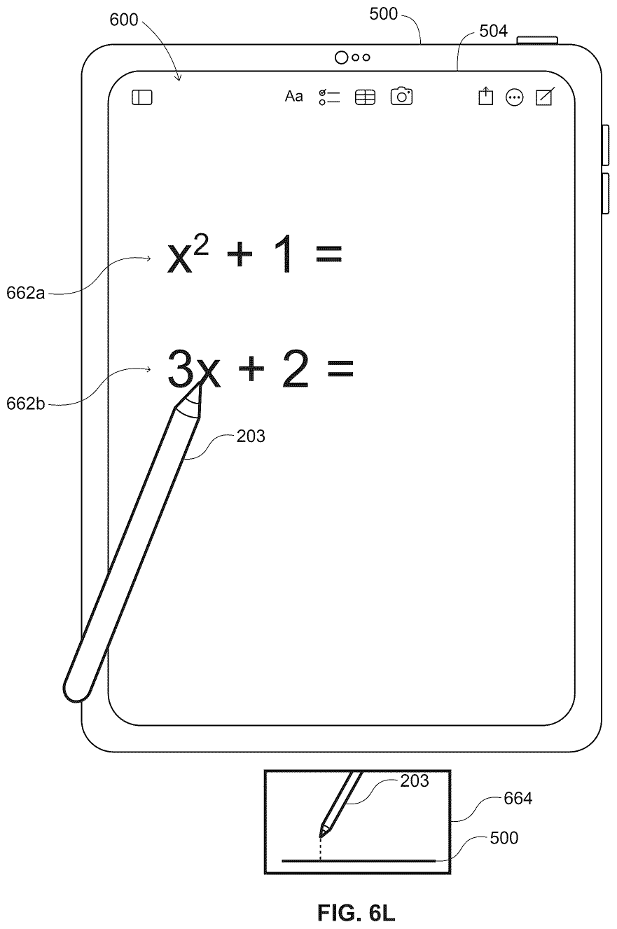

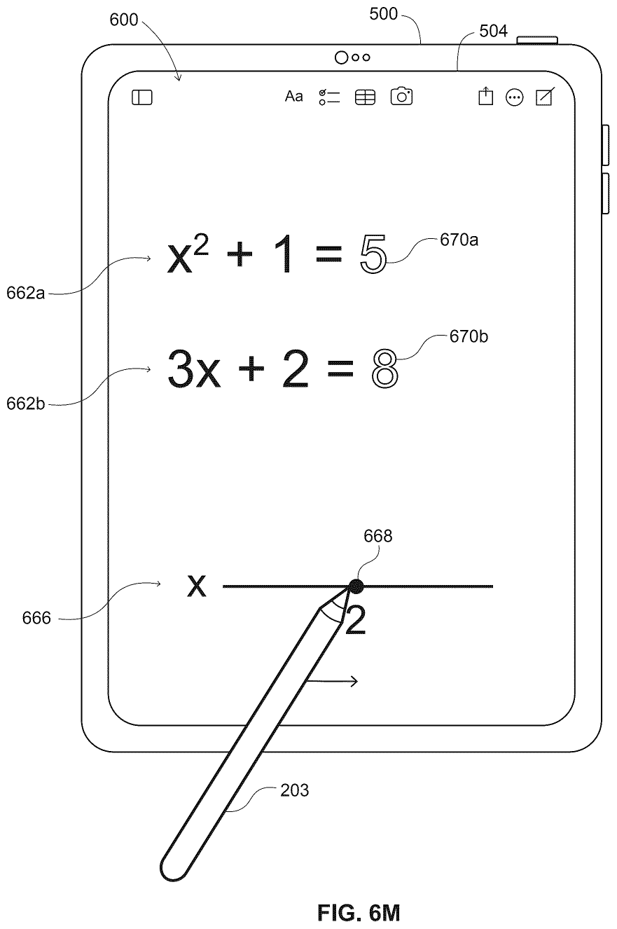

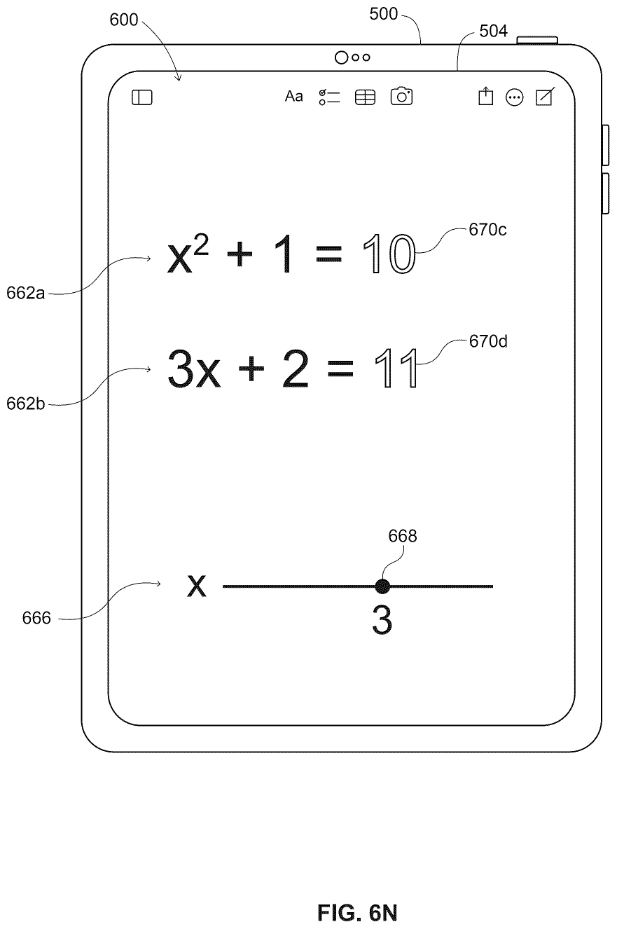

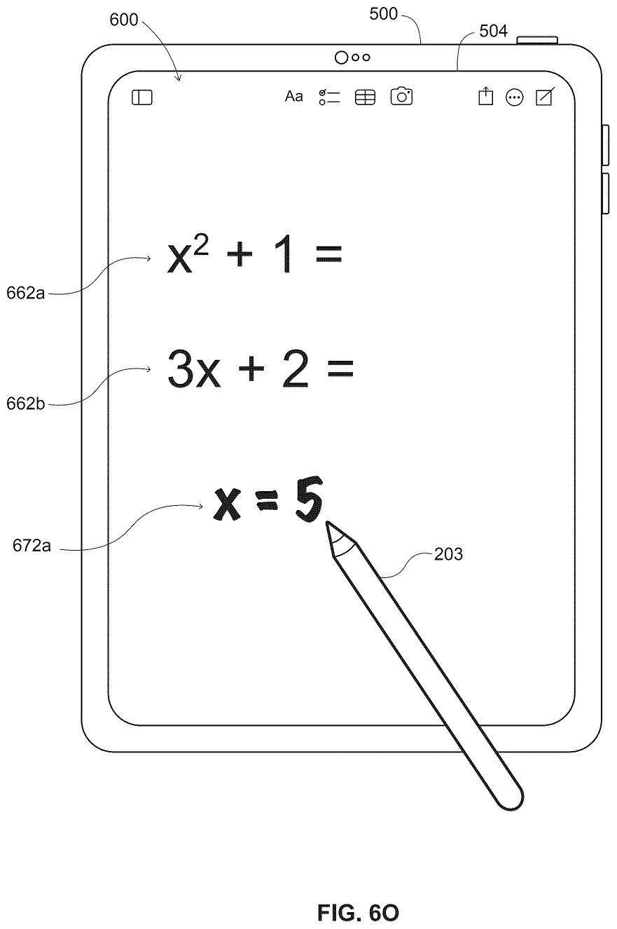

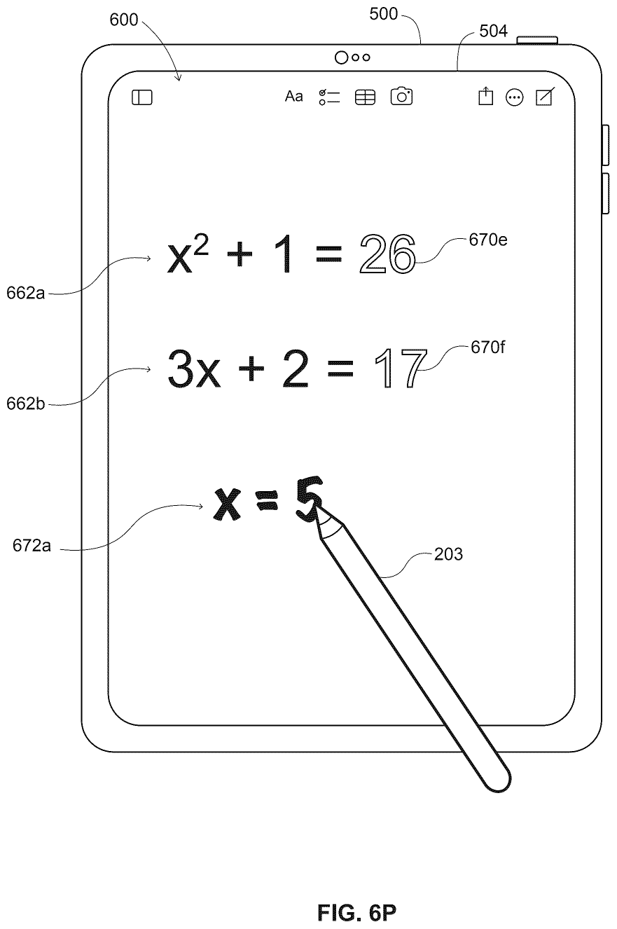

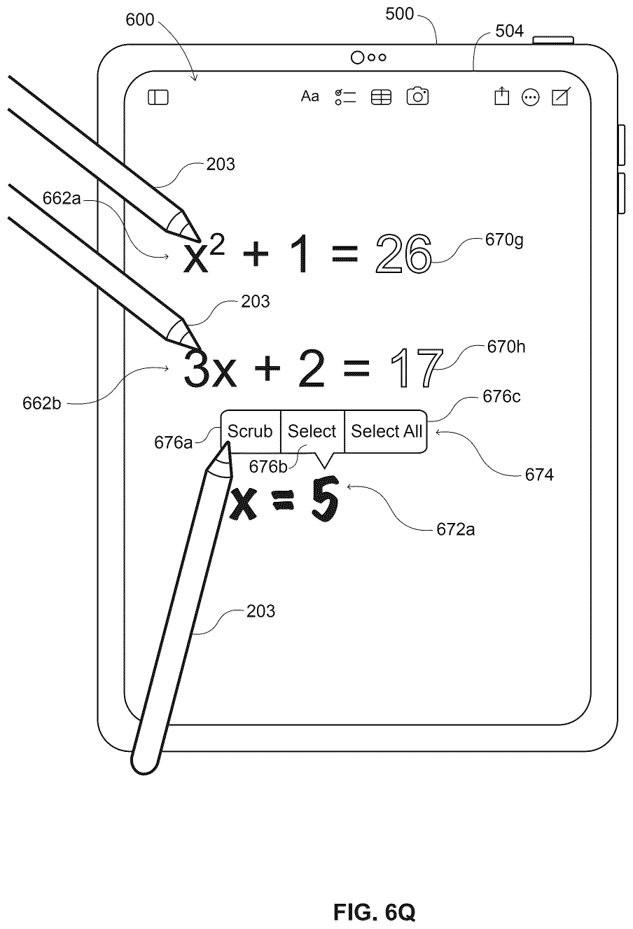

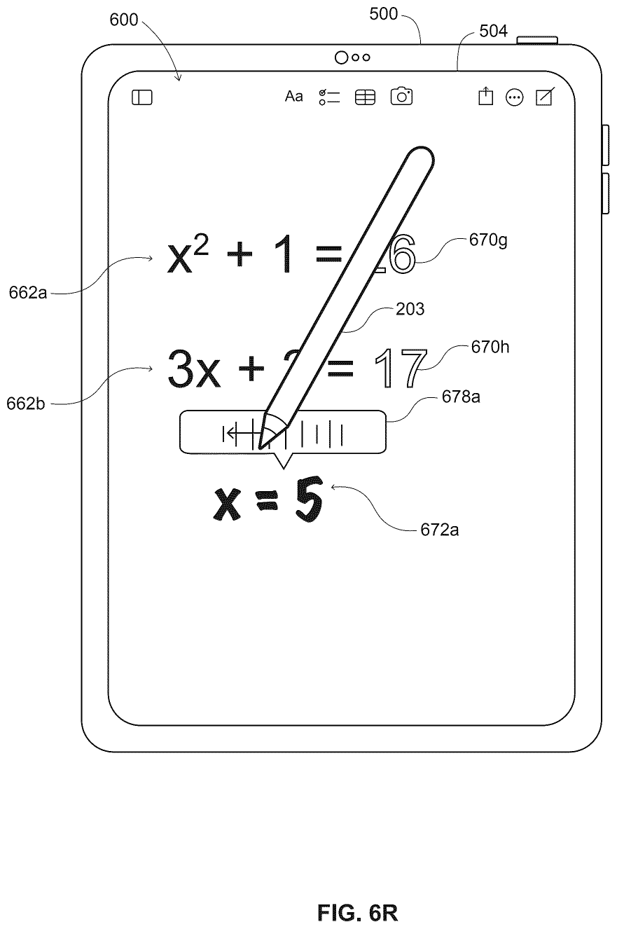

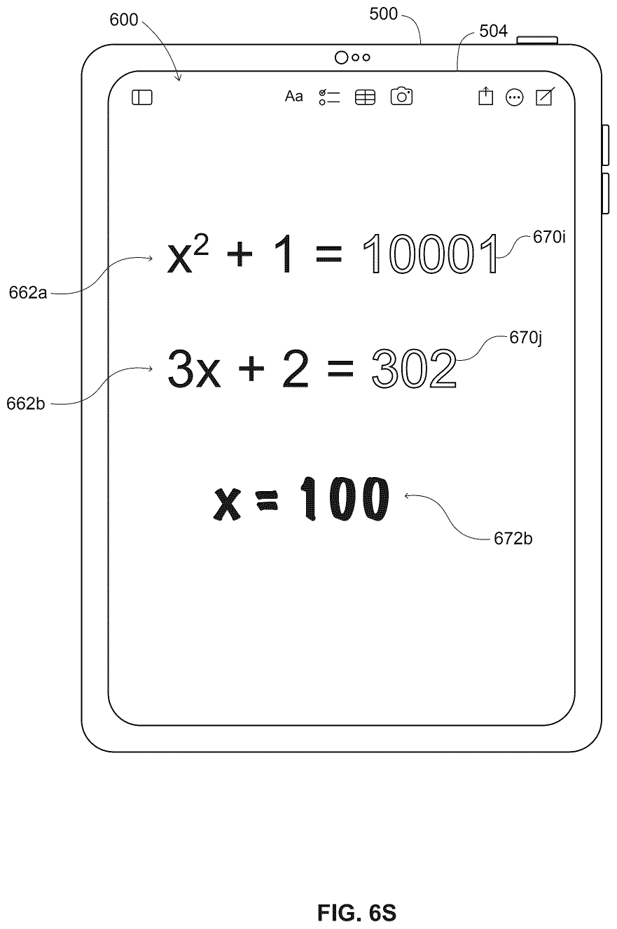

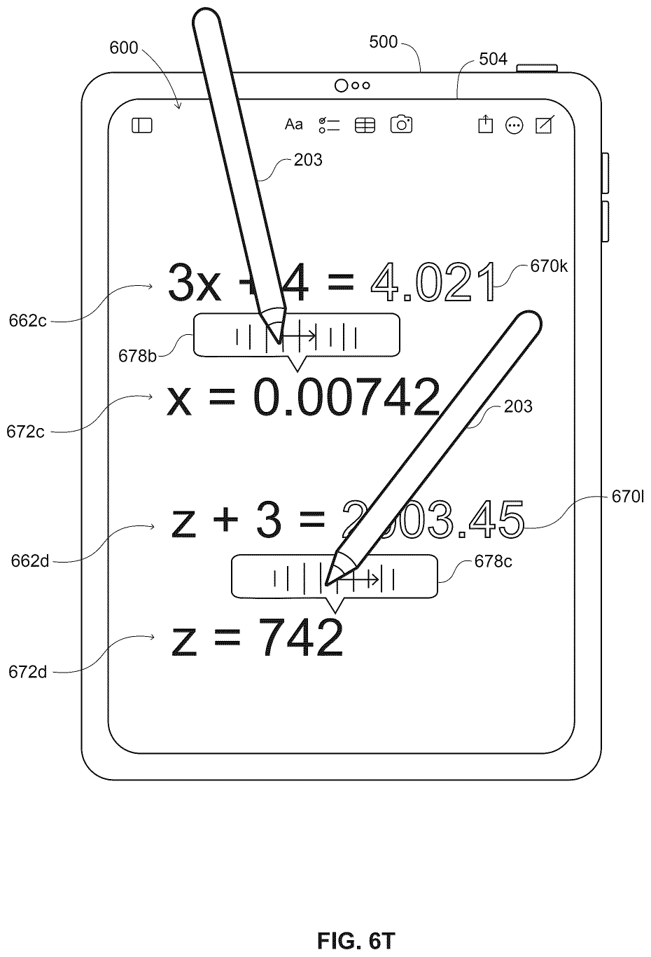

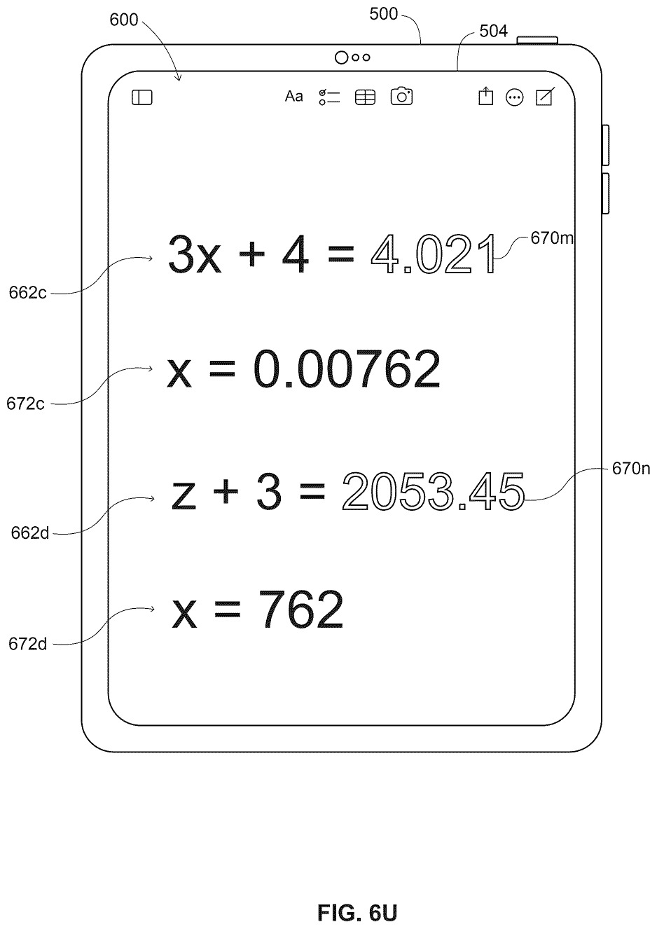

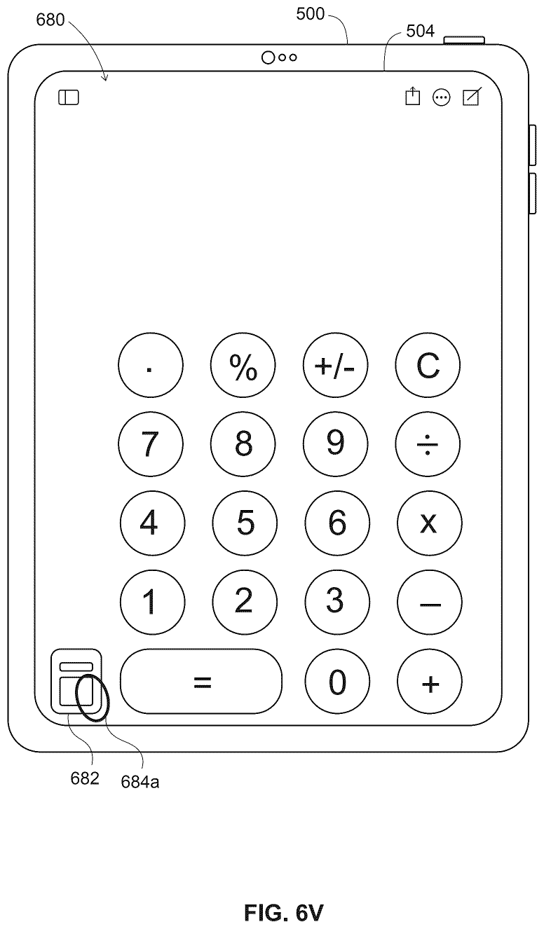

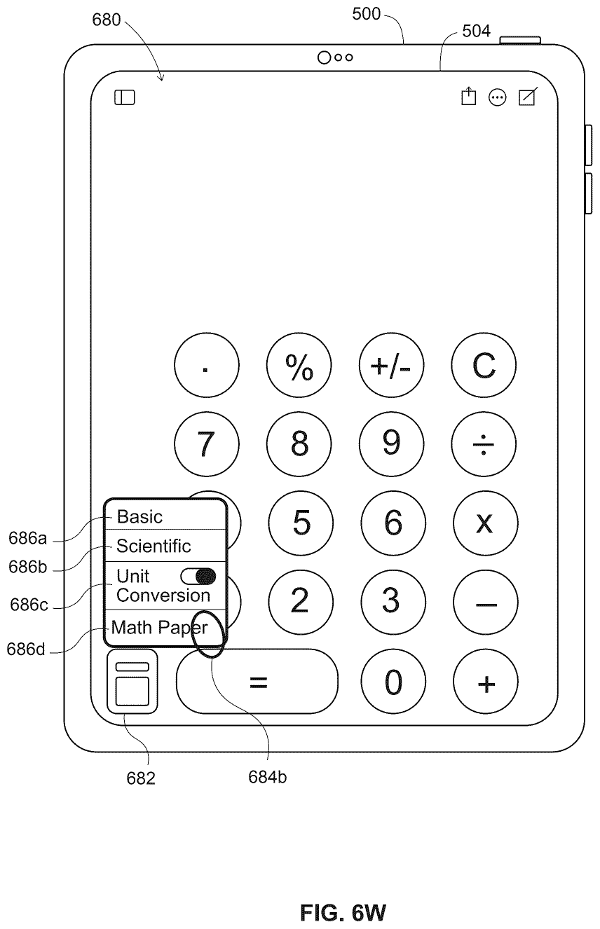

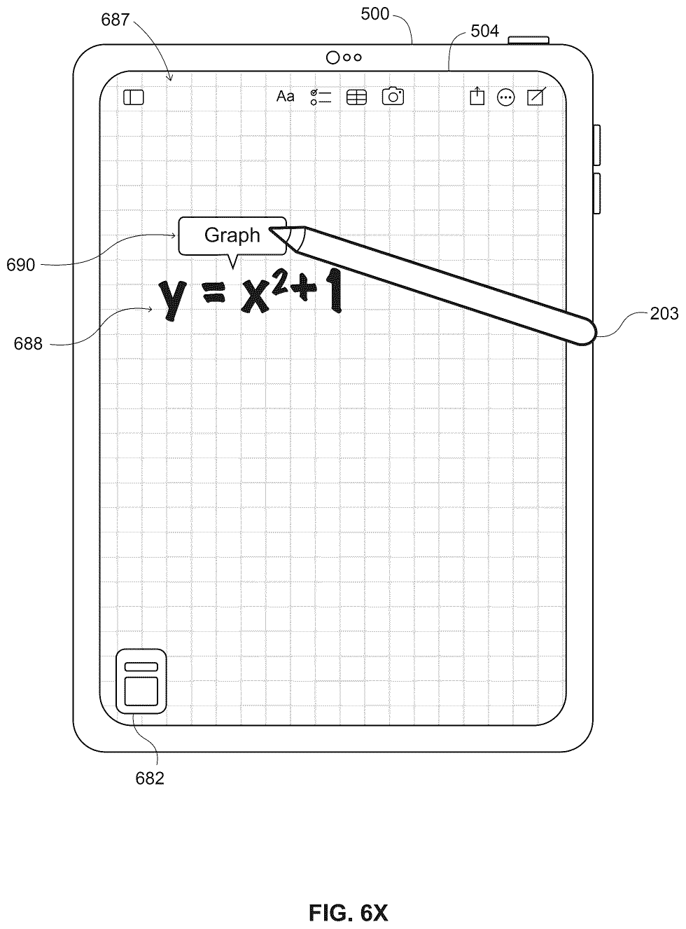

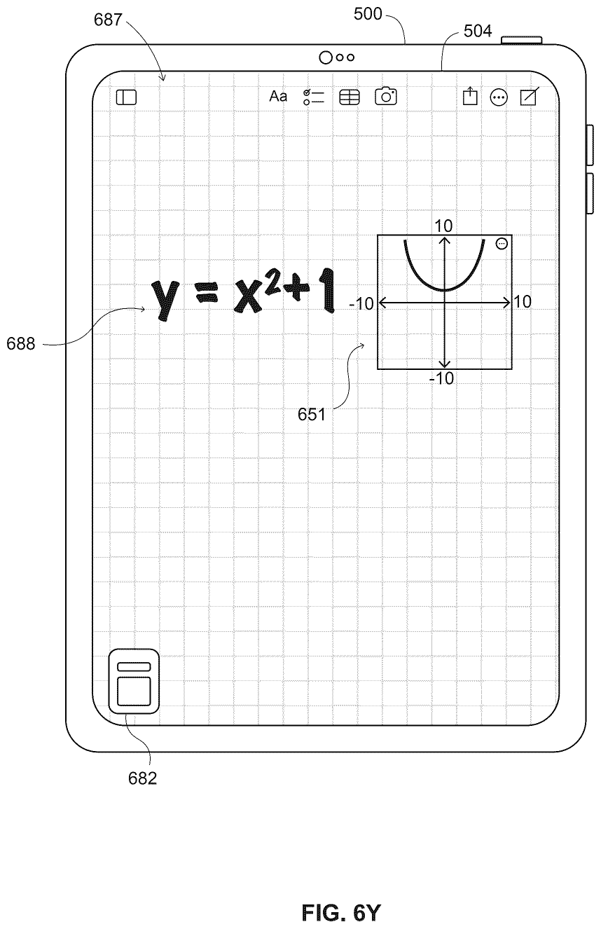

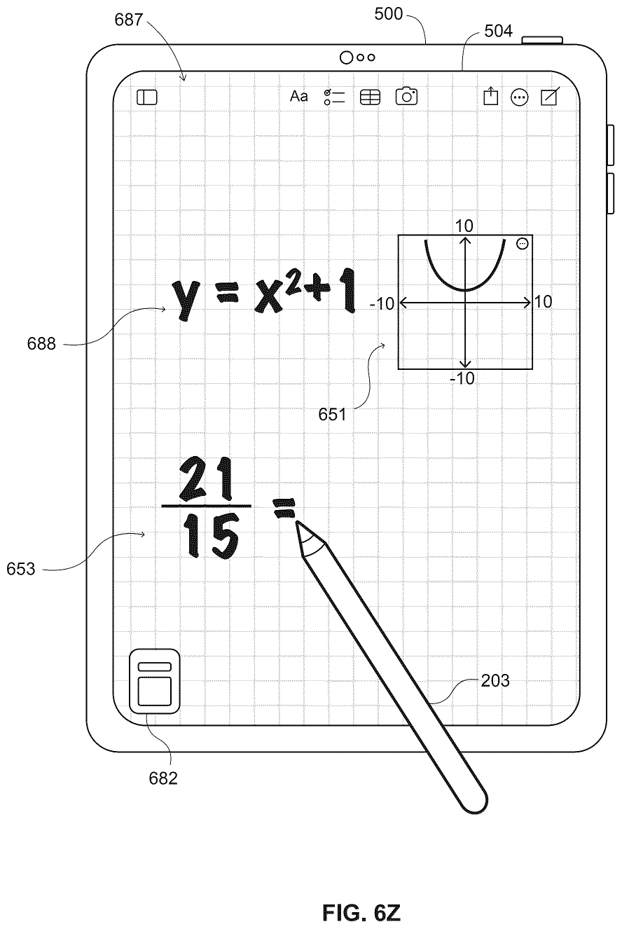

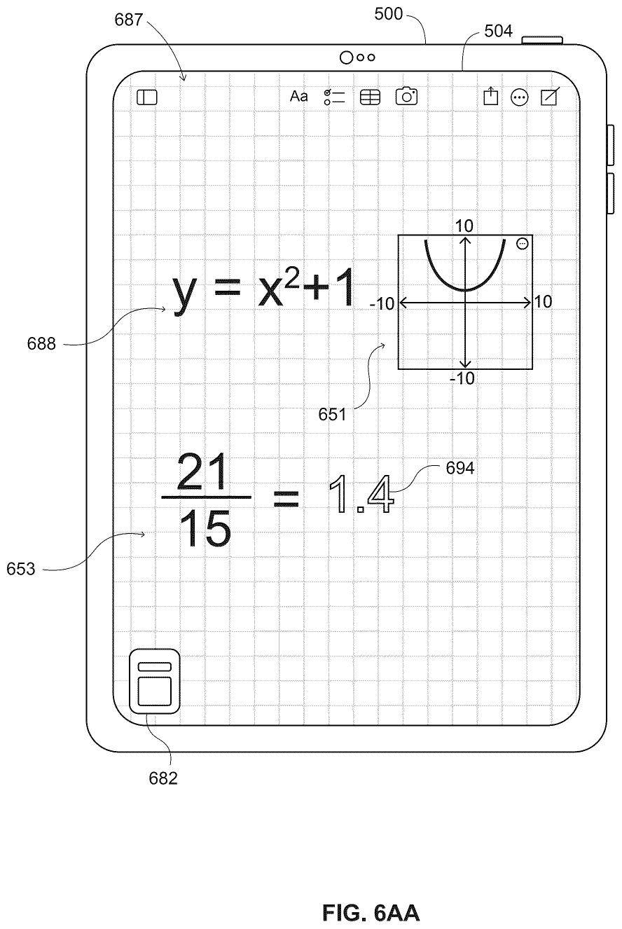

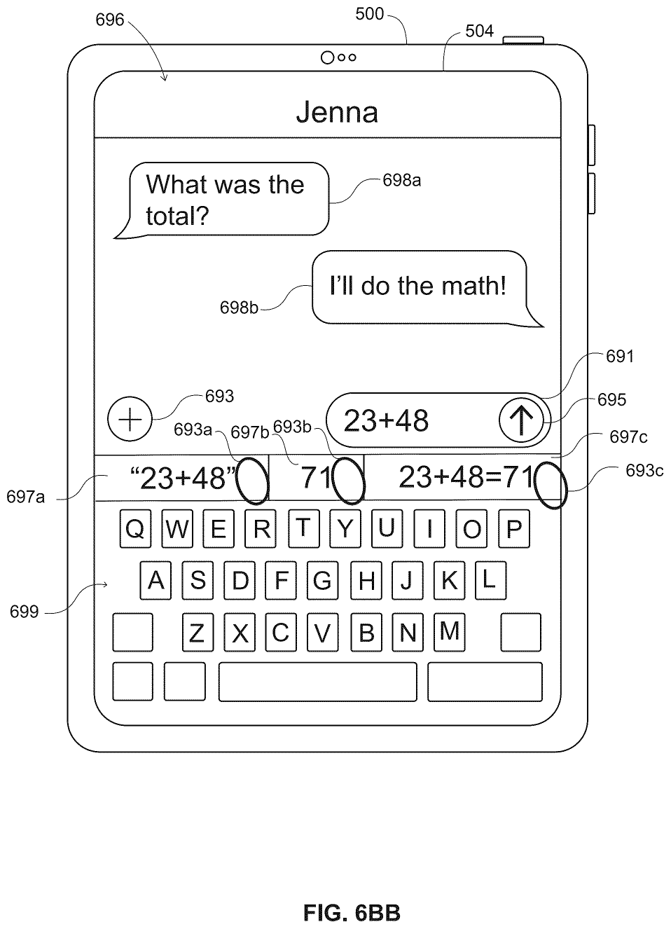

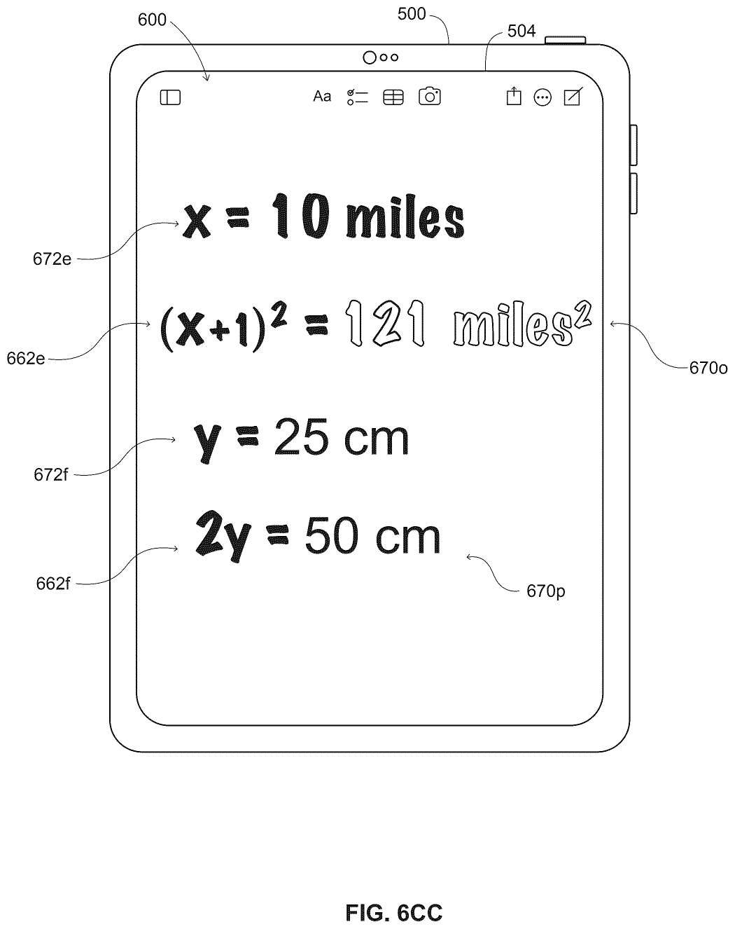

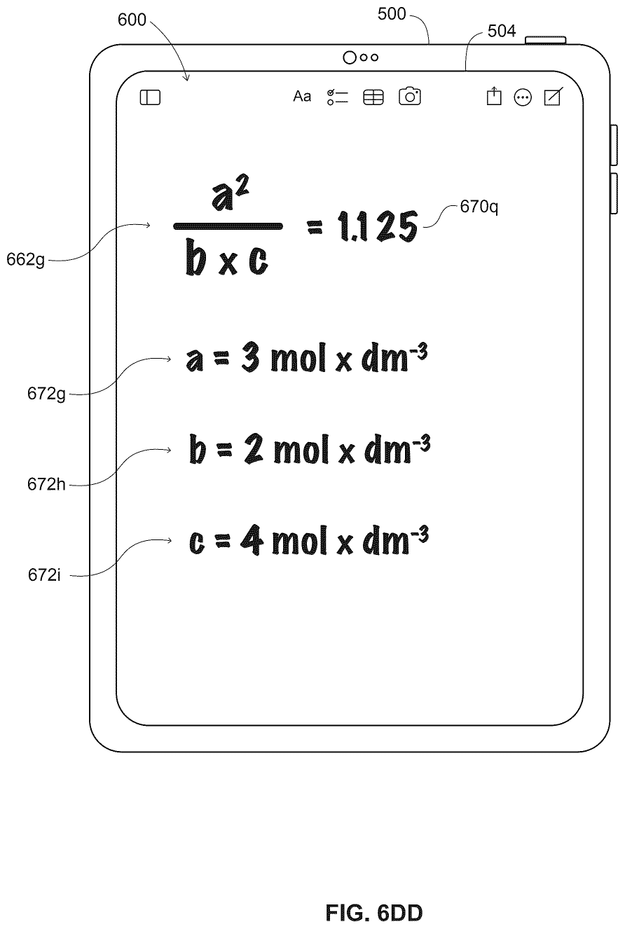

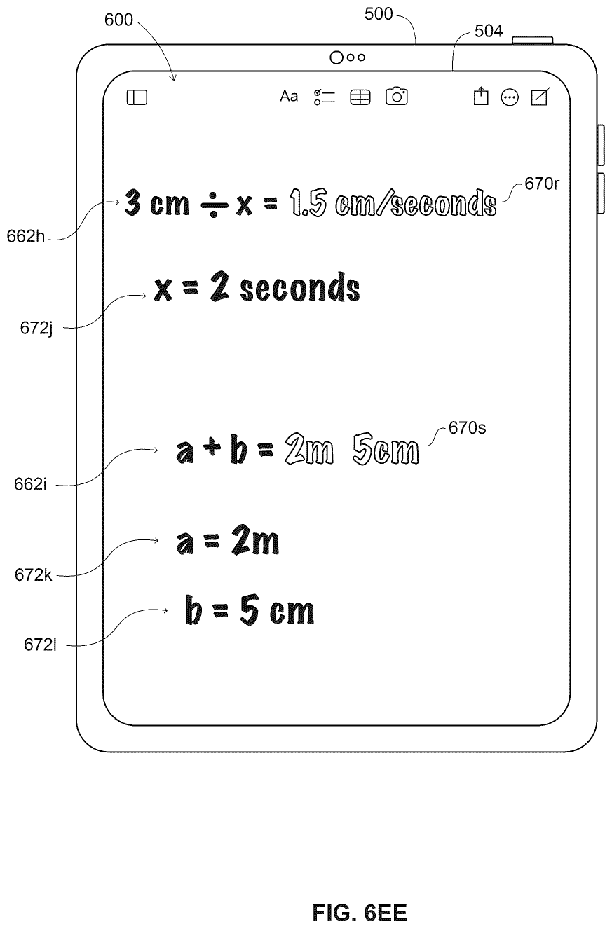

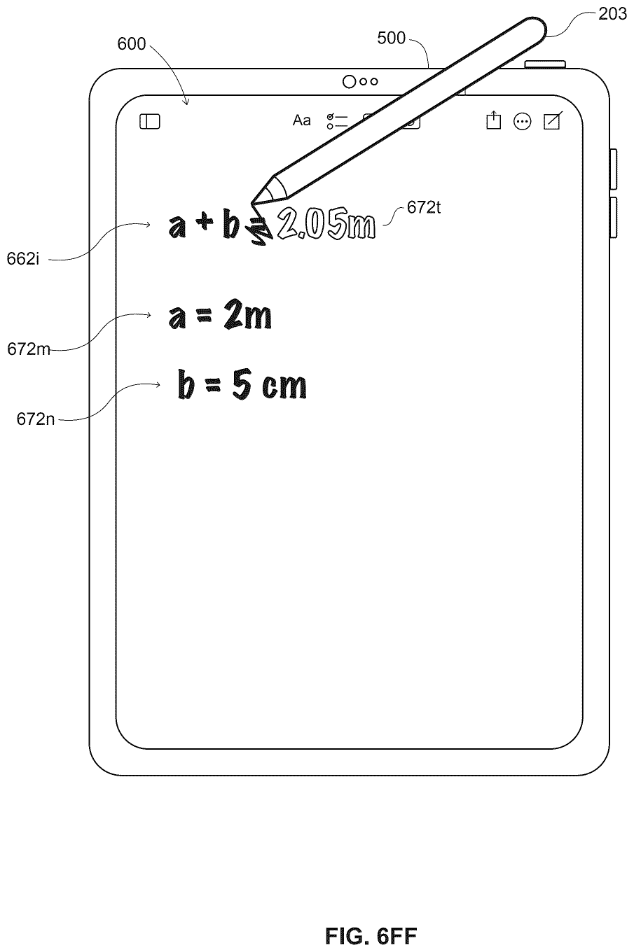

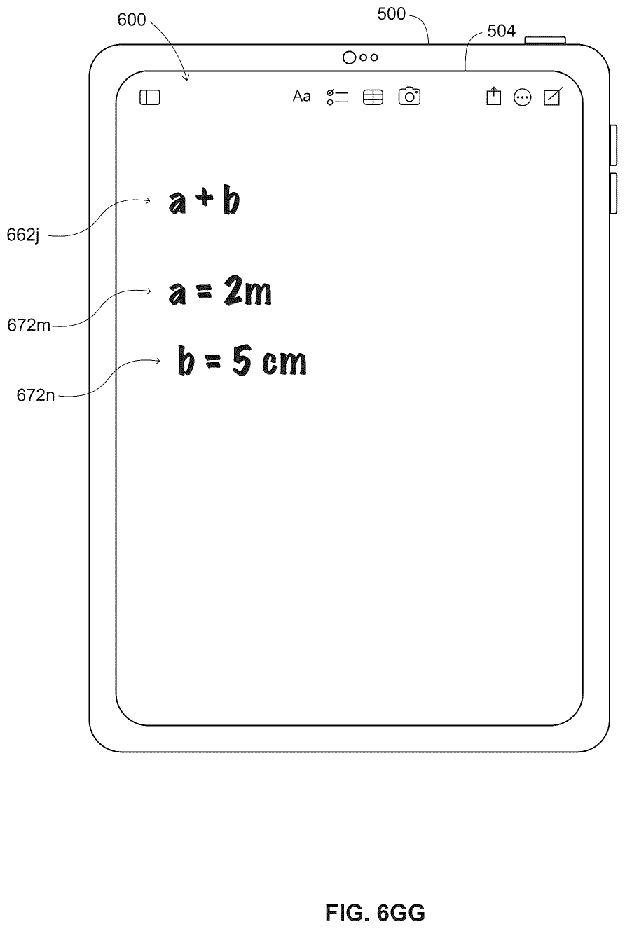

In some embodiments, one or more AI processes are able to be used to identify mathematical equations (e.g., by processing handwriting and/or typed text to identify characters and groups of characters that correspond to mathematical equations) and synthesize handwriting (e.g., using an AI process or a generative AI process), as described in greater detail in methods 700, 900, 1100, 1200, and in FIGS. 6A-6GG, 8A-8W, and 10A-10XX. As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Attention is now directed towards embodiments of user interfaces (“UI”) and associated processes that are implemented on an electronic device, such as device 100, device 300, or device 500.

Users interact with electronic devices in many different manners. In some embodiments, an electronic device is in communication with one or more input devices, a display generation component, and wireless circuitry. In some embodiments, the electronic device presents a user interface that includes one or more content entry regions, wherein a user can input handwritten (e.g., using a stylus) or font-based text (e.g., using a physical or soft keyboard). In some embodiments, the user inputs mathematical equations on the user interface. The embodiments described below provide ways in which an electronic device detects an input including a mathematical input and displays the solution to the mathematical equation. Detecting mathematical equations and solving the respective mathematical equation enhances interactions with the device by reducing the amount of time needed to display the solution and reduces erroneous inputs to the electronic device. It is understood that people use devices. When a person uses a device, that person is optionally referred to as a user of the device.

FIGS. 6A-6GG illustrate exemplary ways in which an electronic device displays solutions to mathematical equations in response to receiving an input including a mathematical equation. The embodiments in these figures are used to illustrate the processes described below, including the processes described with reference to FIG. 7. Although FIGS. 6A-6GG illustrate various examples of ways an electronic device is able to perform the processes described below with respect to FIG. 7, it should be understood that these examples are not meant to be limiting, and the electronic device is able to perform one or more processes described below with reference to FIG. 7 in ways not expressly described with reference to FIGS. 6A-6GG.

FIG. 6A illustrates an electronic device 500 with a display generation component 504 (e.g., a touchscreen). In some embodiments, the electronic device 500 is a mobile device, such as a smartphone, tablet, or wearable device. In FIG. 6A, the electronic device 500 displays user interface 600 corresponding to a notes application. User interface 600 includes a content entry region 602 in which a user is able to enter content, including text in one or more lines, drawings, and/or images. User interface 600 includes a plurality of selectable options 606a through 606h. Option 606a, when selected, causes the electronic device 500 to display a menu including a plurality of previously saved notes. Option 606b, when selected, causes the electronic device 500 to display a menu including one or more options to format and change the style of font-based text. Option 606c, when selected, causes the electronic device 500 to create a to-do list in the content entry region 602. Option 606d, when selected, causes the electronic device 500 to create a table in the content entry region 602. Option 606e, when selected, causes the electronic device 500 to display a menu including a plurality of selectable options to take a photo and/or video using a camera application or select a photo and/or video from a media library to be inserted in the content entry region 602. Option 606f, when selected, causes the electronic device 500 to transmit the contents of the content entry region 602 to a different application and/or to a different user account. Option 606g, when selected, causes the electronic device 500 to display a menu of additional settings. Option 606h, when selected, causes the electronic device 500 to display a new note including a second content entry region.

In FIG. 6A, the electronic device 500 receives an handwritten input in content entry region 602 and displays text 604. In some embodiments, the handwritten input is inputted using stylus 203 (e.g., a user writes using the stylus 203 as a writing instrument while the stylus 203 is in contact with the touch screen of electronic device 500). In some embodiments, text 604 includes a mathematical equation (also referred to herein as an “equation”). In FIG. 6A, the equation is “35×25”. The text 604 also includes an equals sign, indicating that the user is finished writing the mathematical equation so that the electronic device 500 is able to display the solution (e.g., and solve the equation). In some embodiments, the one or more criteria that needs to be satisfied for the electronic device 500 to display the solution is described in greater detail in method 700. For example, the electronic device detects that there is no longer an input (e.g., no longer detects handwriting) for a threshold amount of time, detects that the input includes an equals signs, or detects that the input includes a selection input (e.g., using stylus 203, or a contact such as a finger or an indirect contact such as a gaze) directed towards a selectable option to display the solution to the mathematical equation. In some embodiments, the electronic device 500 detects other inputs, such as typing or voice inputs, for entering text to content entry region 602.

In response to detecting the equals sign in FIG. 6A, the electronic device 500 displays solution 608 in the same direction as the text 604 (e.g., written left to right) in FIG. 6B. In FIG. 6B, the electronic device 500 displays the solution 608 with the same style characteristics as the text 604 (e.g., the electronic device 500 mimics the handwritten characteristics of text 604 and the solution 608 has the same handwritten characteristics of the text 604, as described in greater detail in method 700). Additionally, in FIG. 6B, the electronic device 500 displays the solution 608 with a different visual characteristic than the text 604, as described in greater detail in method 700) to distinguish between the user written input and the device generated solution. For example, in FIG. 6B, while the solution 608 and the text 604 are displayed with the same style characteristics, the solution 608 is displayed with a different color than the text 604. Additionally, in some embodiments, the solution to a mathematical equation is displayed at the same size (e.g., handwriting or font size) as the text including the mathematical equation. For example, in FIG. 6B, the size of solution 608 matches the size of text 604.

In FIG. 6B, the electronic device 500 receives a selection input via stylus 203, directed towards solution 608. In response to receiving the input via the stylus 203, the electronic device 500 displays a user interface element 610, shown in FIG. 6C. The user interface element 610 illustrates the input recognized by the electronic device 500 as font-based text, as described in greater detail in method 700. For example, in FIG. 6C, the electronic device 500 recognized the handwritten input 604 as “32×25” and as a result, the electronic device 500 displays “32×25” as font-based text in user interface element 610. The electronic device 500 also displays the solution (e.g., “800”) to the recognized equation (e.g., “32×25”) in the element 610.

While displaying the element 610, the electronic device 500 receives an input via the stylus 203 directed towards user interface element 610 in FIG. 6C. In some embodiments, while displaying element 610, the electronic device 500 is able to receive requests to change the mathematical input (e.g., a handwritten or font-based text input). In response to receiving the input via stylus 203 shown in FIG. 6C, the electronic device 500 displays keyboard 612, shown in FIG. 6D. While displaying keyboard 612, the electronic device 500 receives one or more inputs directed towards keyboard 612 to change the equation shown in element 610 from “32×25” to “32×50”. In response to receiving the one or more inputs directed towards keyboard 612 to change the equation, the electronic device 500 updates the solution shown in element 610 from “800” to “1600” in accordance with the updated equation, as shown in FIG. 6D.

In FIG. 6D, the electronic device 500 receives an input via the stylus 203, directed towards option 614. In response to receiving the input via the stylus 203, the electronic device 500 updates equation 604 to equation 616 and solution 608 to solution 610, shown in FIG. 6E. In some embodiments, even though the electronic device 500 receives the updated equation in FIG. 6C using font-based text, the electronic device 500 displays equation 616, in FIG. 6D, with the same style characteristics as equation 604 (e.g., handwritten text). Additionally, as described above and with reference to method 700, the solution 618 is also displayed with the same style characteristics as equation 604 and 616.

In some embodiments, if the electronic device does not detect a committing input while displaying the solution, then the electronic device ceases displaying the solution, as described in greater detail in method 700 and shown in FIGS. 6E and 6F. In FIG. 6E, the electronic device 500 receives an input via the stylus 203 directed to a different portion of the user interface 600 while displaying solution 618. In response to receiving the input, the electronic device 500 ceases displaying solution 618, shown in FIG. 6F, because the input via stylus 203 in FIG. 6E does not correspond to a request to commit the solution 618.

FIG. 6G illustrates text resulting from various handwritten inputs (e.g., text 620, 622, 624, and 626) that the electronic device 500 cannot solve. In response to detecting an error with a respective handwritten input, the electronic device 500 displays an indication (e.g., indication 628, 630, 632, and 634) indicating the location of the error, shown in FIG. 6G. Although FIG. 6G illustrates a plurality of handwritten inputs with respective indications, the electronic device 500 optionally displays respective indications as the electronic device 500 receives the respective handwritten input that includes an error. In FIG. 6G, indications 628 and 634 are a first type of indication corresponding to an ambiguous operation (e.g., the respective portions of equations corresponding to text 620 and 626 highlighted by indications 628 and 634 include ambiguities) and indications 630 and 632 are a second type of indication corresponding to an unsupported operation (e.g., the respective portions of equations corresponding to text 622 and 624 highlighted by indications 630 and 632 include unsupported operations). Ambiguous operations and unsupported operations are described in greater detail in method 700.

FIG. 6G-A illustrates different embodiments of indications 628 through 634. In some embodiments, the indications (e.g., indications 628 and 632) surround respective equal signs without surrounding other portions of the equations (e.g., text 620 and 624) with errors. In some embodiments, the indications (e.g., indications 630 and 634) surround the location of the error and the equal sign without surrounding other portions. In some embodiments, the indication indicating an error only surrounds the equal sign of the equation that includes the error without surrounding other portions.

While receiving the text 620, 622, 624, and 626 and displaying the indications 628, 630, 632, and 634, the electronic device 500 receives one or more inputs including stylus 203 directed towards selecting indications 628, 630, 632, and 634, shown in FIG. 6G. In some embodiments, the inputs are directed towards the portion of the equation including the error (e.g., the inputs selecting indication 628 and 632). In some embodiments, the inputs are directed towards the equal sign of the equation including the error (e.g., the inputs selecting the equal sign of text 622 and 626). Although FIG. 6G illustrates multiple inputs directed towards multiple indications and/or text using stylus 203, the electronic device 500 optionally receives the inputs directed towards one or more indications and/or equal signs independently. In response to receiving the one or more inputs in FIG. 6G, the electronic device 500 displays user interface elements 636, 638, 640, and 644, respectively, which include additional information about the errors indicated by indications 628, 630, 632, and 634, shown in FIG. 6H.

FIG. 6H illustrates the user interface elements 636, 638, 640, and 644. The electronic device 500 displays user interface elements 636 and 640 in response to receiving the inputs directed towards indications 628 and 632, indicating an ambiguity. In some embodiments, if the electronic device 500 detects an ambiguous operation and/or an ambiguous number, then the electronic device 500 displays options to resolve the ambiguity. For example, in FIG. 6H, the electronic device 500 displays options 646a and 646b in user interface element 636 corresponding to options to resolve the ambiguity highlighted by indication 628. The electronic device 500 displays options 648a and 648b in user interface element 640, corresponding to options to resolve the ambiguity highlighted by indication 634. User interface elements 638 and 640 include text illustrating the reason that the respective operations are unsupported. For example, the equation represented by text 622 is unsupported because the resulting solution is out of range, and the equation representation by input 624 is unsupported because dividing by zero results in an undefined number.

In FIG. 6H, the electronic device 500 receives an input via the stylus 203 directed towards 646b and an input via the stylus 203 directed towards option 648b, which are optionally inputs that occur independently from each other. In response to receiving the inputs, the electronic device 500 updates the respective equations with the option to resolve the respective ambiguities, shown in FIG. 6I.

FIG. 6I illustrates the updated equations represented by text 620 and 626 to include the options to resolve the respective ambiguities. As a result of resolving the ambiguities, the electronic device 500 solves and displays solutions 650 and 652 corresponding to the equations represented by text 620 and 626. As described above and with reference to method 700, the electronic device 500 displays the solutions 650 and 652 with the same style characteristics as inputs 620 and 626. The equations represented by text 622 and 624 do not include a solution because they still include operations that are unsupported.

FIG. 6J illustrates an embodiment of text 654 from a font-based text input of an equation written in a vertical direction up and down direction instead of a horizontal left to right direction, as shown in FIG. 6A. In some embodiments, vertical handwritten inputs and horizontal font-based text inputs are also possible. In some embodiments, vertical text (and horizontal text) including equations (e.g., text 654) is able to include multiple different mathematical operations (e.g., multiplication, addition, division, and/or subtraction). In some embodiments, if there are multiple operations (e.g., a first operation and a second operation) for vertical text, the electronic device 500 applies the first operation to the one or more numbers of the equation until there is a different operation (e.g., a second operation). For example, in FIG. 6J, the electronic device 500 applies addition to the numbers 2 and 3. In some embodiments, if there is no operation, the electronic device 500 defaults to addition.

As shown in FIG. 6J, the electronic device 500 receives one or more inputs directed towards keyboard 612, which causes the electronic device to display the font-based text 654 including the equation “3+2”. In some embodiments, the electronic device 500 does not display a solution to the equation after detecting an equals sign (or equals sign equivalent). In some embodiments, displaying the solution to the equation is independent from the direction that the equation is written and/or based on how the equation is written (e.g., font-based text and/or handwritten text). As described in method 700, in some embodiments, the electronic device 500 displays the solution to the equation in response to receiving an input directed towards a selectable option, that when selected, causes the electronic device 500 to display the solution. As shown in FIG. 6J, the electronic device 500 displays user interface element 656 including a visual indication (e.g., text) illustrating the detected equation. In FIG. 6J, the electronic device 500 receives a selection input including contact 658 (e.g., an input using a finger on the touch screen, a stylus on the touch screen, or an indirect input using a gaze) directed towards element 656. In response to receiving the input, the electronic device 500 displays solution 660, which is the solution to the equation indicated by input 654, shown in FIG. 6K.

In FIG. 6K, the electronic device 500 displays the solution 660 below the text 654 including equation “3+2”. As described in method 700, the location that the solution is displayed at is based on the direction that the text is written in. For example, in FIG. 6K, the equation of input 654 is written from top to bottom, so the solution 660 is displayed below the equation.

FIGS. 6L-6O illustrates an embodiment wherein the user changes a number representing a variable using the stylus 203. In FIG. 6L, the electronic device receives two inputs (separately of one another, or at the same time) and displays text 662a including a first equation and text 662b including a second equation. Both equations include the variable “x”. In FIG. 6L, the electronic device 500 receives a hover input using stylus 203 directed towards the variable “x” on the equation of input 662b. Representation 664 illustrates the hover input via the stylus 203 over the electronic device 500. In response to receiving the hover input in FIG. 6L, the electronic device 500 displays a representation 666 of the variable “x” including a slider and an indication 668 of a position on the slider, shown in FIG. 6M. In some embodiments, the electronic device 500 also displays representation 666 if the electronic device 500 had received a hover input over the variable “x” in the input 662a. In FIG. 6M, the indication 668 is on a location of the slider representing the number “2”. As a result, the electronic device 500 displays solutions 670a and 670b, which are the resulting solutions to the respective equations if the variable “x” equals 2.

In FIG. 6M, the electronic device 500 receives an input via the stylus 203 selecting and dragging indication 668 to the right. In response to receiving the input, the electronic device 500 updates the location of the indication 668, which corresponds to the number 3, and updates variable “x” to equal 3, as shown in FIG. 6N. Additionally, in FIG. 6N, the electronic device 500 updates the solutions 670c and 670d because the number corresponding to the variable changed from 2 to 3.

FIGS. 6O-6U illustrates an embodiment wherein the user changes a number representing a variable using the stylus 203. In FIG. 6O, the electronic device 500 receives a handwritten input via stylus 203. In response to receiving the input, the electronic device 500 displays handwritten text 672a. In some embodiments, the input 672a includes handwriting assigning a number to the variable “x”, which is also the variable used in text 662a and 662b. In response to receiving the input, the electronic device 500 displays solutions 670e and 670f corresponding to the solution of the respective equations of the respective text 622a and 622b, shown in FIG. 6P.

In FIG. 6P, the electronic device 500 receives a selection input via the stylus 203, directed towards the number that is representing the variable “x” (e.g., “5”). In response to receiving the selection input, the electronic device 500 displays selectable options 676a through 676c, shown in FIG. 6Q.

FIG. 6Q illustrates selectable options 676a through 676c. Option 676a, when selected, causes the electronic device 500 to display a scrub bar to change the numerical value associated with the variable. In some embodiments, option 676a, when selected, causes the electronic device 500 to select the representation of the number 5 for further edits and/or modifications. In some embodiments, option 676c, when selected, causes the electronic device 500 to select the text associated with the inputs presently displayed (e.g., the equations associated with input 662a, 662b, and 672a, and the solutions 670g and 670h) for further edits and/or modifications. In some embodiments, options 676b and 676c, when selected causes the electronic device 500 to highlight the respective text to indicate that the respective text is selected.

In FIG. 6Q, the electronic device 500 receives a selection input via the stylus 203 directed towards option 676a. In response to receiving the input, the electronic device 500 displays scrub bar 678a, shown in FIG. 6R. In FIG. 6Q, electronic device 500 also receives a selection input directed towards the “x” variable in text 622a and 622b including the stylus 203. Although FIG. 6Q illustrates multiple inputs including stylus 203 directed towards inputs 662a through 662c, the electronic device 500 optionally receives the inputs directed towards one or more text 622a through 622b and 672a independently. In some embodiments, the inputs directed towards the variable “x” in text 622a and 622b also results in the display of selectable options 676a through 676c. In some embodiments, the electronic device 500 is able to change the number associated with the variable x for equations corresponding to text 662a and 662b in a similar manner to how the electronic device 500 changes the numerical value of the variable “x” associated with text 672a, which is shown in FIG. 6R. For example, the electronic device is able to change x\hat{ }2 to x\hat{ }4 or x\hat{ }1, or any other number in accordance with methods to scrub through numbers described in method 700, and the electronic device 500 is able to change 3x to any number (e.g., 2x, 4x, 5x, 100x, or 175x) in accordance with methods to scrub through numbers described in method 700.

In FIG. 6R, the electronic device 500 displays a scrub bar 678a including a visual indication (e.g., lines) illustrating that a user is able to change the number. In FIG. 6R, the electronic device 500 receives a right to left drag input via the stylus 203. In response to receiving the dragging input, the electronic device 500 updates the numerical value associated with the variable “x”, shown in FIG. 6S. For example, the electronic device updates input 672a to input 672b, which results in the number changing from 5 to 100. In some embodiments, the rate of scrubbing (e.g., the rate that the number changes) is based on the amount of significant figures of the original constant (e.g., 5), as described in greater detail in method 700. In some embodiments, the longer (e.g., the greater the distance) the dragging input via the stylus 203, the larger the number will be. In some embodiments, if the electronic device 500 receives a right to left dragging input directed towards scrub bar 678a, then the numerical value of the constant decreases at the rate of change described in method 700 (e.g., by significant figures or by the value of the number).

In FIG. 6S, the value of the variable is 100. In response to receiving the input in FIG. 6R, the electronic device 500 also updates the solutions 670g through 670h to solutions 670i and 670j corresponding to the text 662a and 662b respectively. In some embodiments, updating the variable includes updating the variable with the visual characteristics of the originally inputted input 672b, as described in method 700. For example, the electronic device displays “100” with the same visual characteristics as “5” (e.g., the same handwriting characteristics).

FIG. 6T illustrates embodiments of changing a variable using a rate of change dependent on the value of the originally inputted number. For example, electronic device 500 displays inputs 672c and 672d which include variables (e.g., x and y) and their associated original inputted numbers (e.g., 0.00742 and 742 shown in FIG. 6T). In FIG. 6T, the electronic device 500 also displays inputs 662c and 662d corresponding to equations including the respective variables, and solutions 670k and 670i corresponding to the respective equations. In FIG. 6T, the electronic device 500 displays scrubbing bars 678b and 678c. Although the process to display the scrubbing bars is not described in detail in FIG. 6T, it is described in greater detail in FIG. 6R. In FIG. 6T, the electronic device 500 receives a left to right dragging input via the stylus 203 directed towards scrubbing bar 678b and 678c. Although FIG. 6T illustrates multiple inputs including stylus 203 directed towards scrubber bars 678b and 678c, the electronic device 500 optionally receives the inputs directed towards scrubber bars 678b and 678c, independently.

In response to receiving the dragging inputs directed towards scrubber bars 678b and 678c in FIG. 6T, the electronic device updates text 672c and 672d with updated numbers corresponding to the respective variables and subsequently updates the solutions to the equations of text 662c and 662d to solutions 670m and 670n, respectively, shown in FIG. 6U. In some embodiments, and as described in method 700, the rate of change of the number is based on the value of the constant. In some embodiments, if the electronic device receives a right to left dragging input directed towards the one or more scrubbing bars (e.g., scrubber bars 678b and 678c), then the electronic device would decrease the numbers based on the value of the constant.

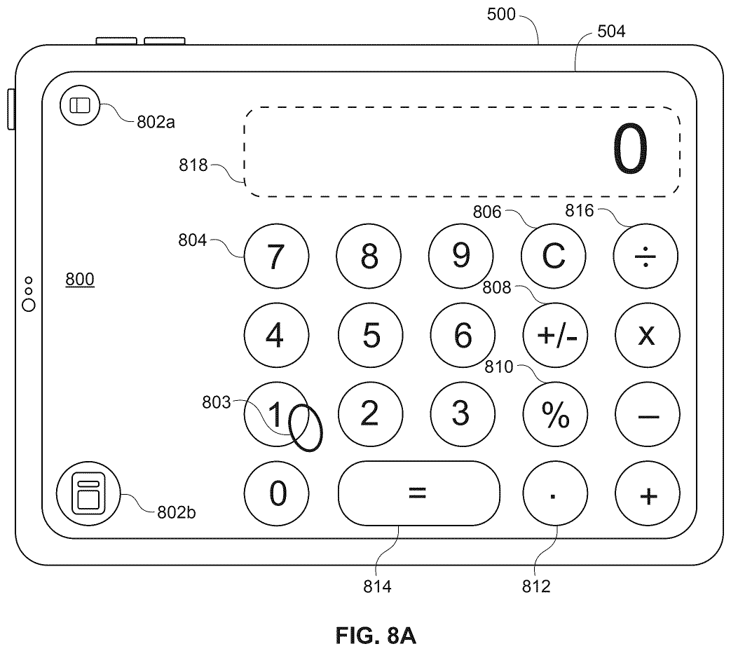

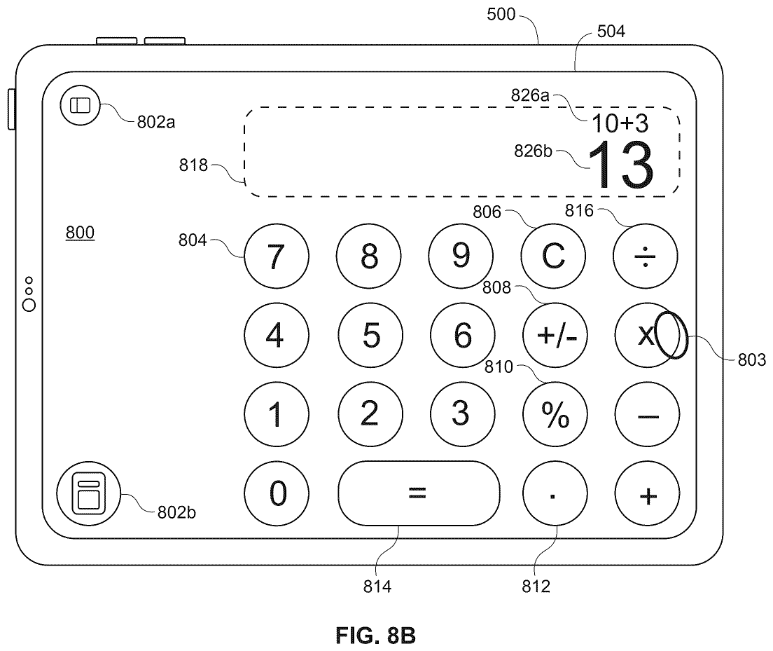

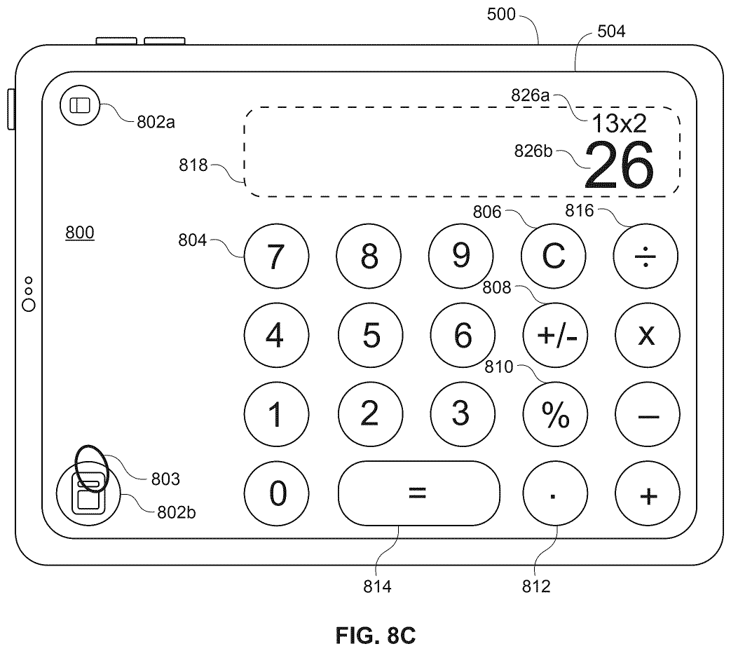

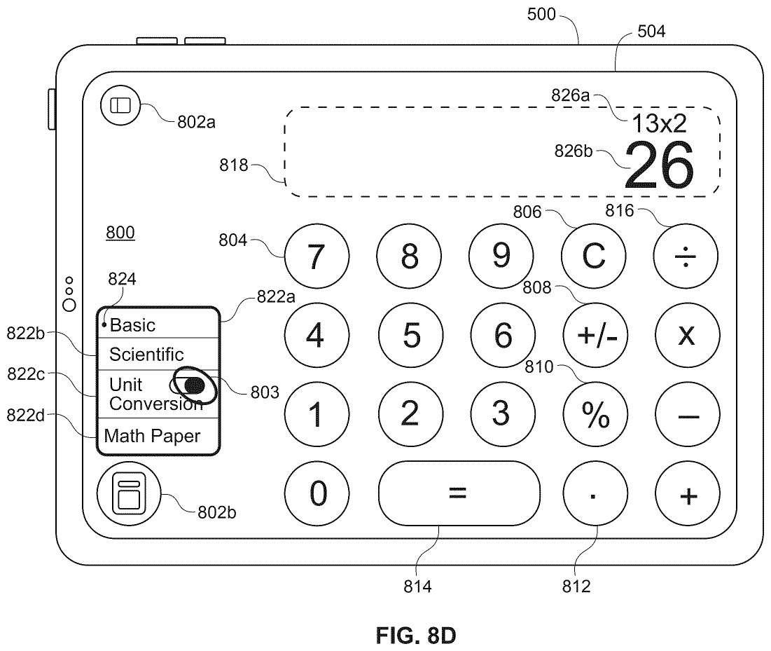

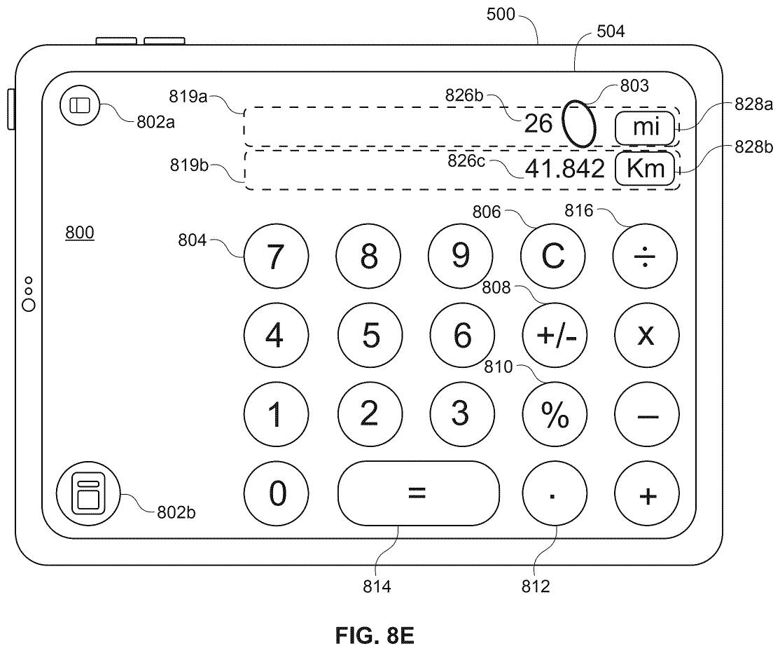

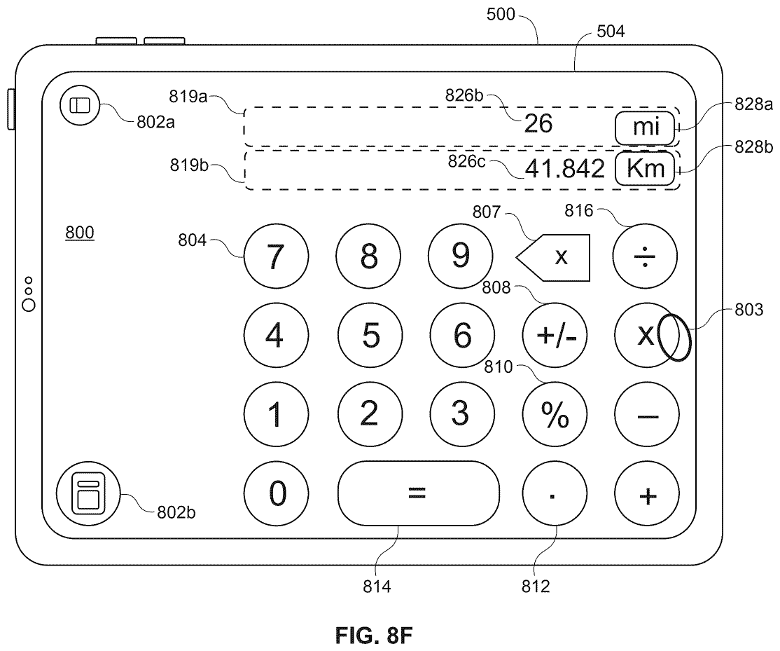

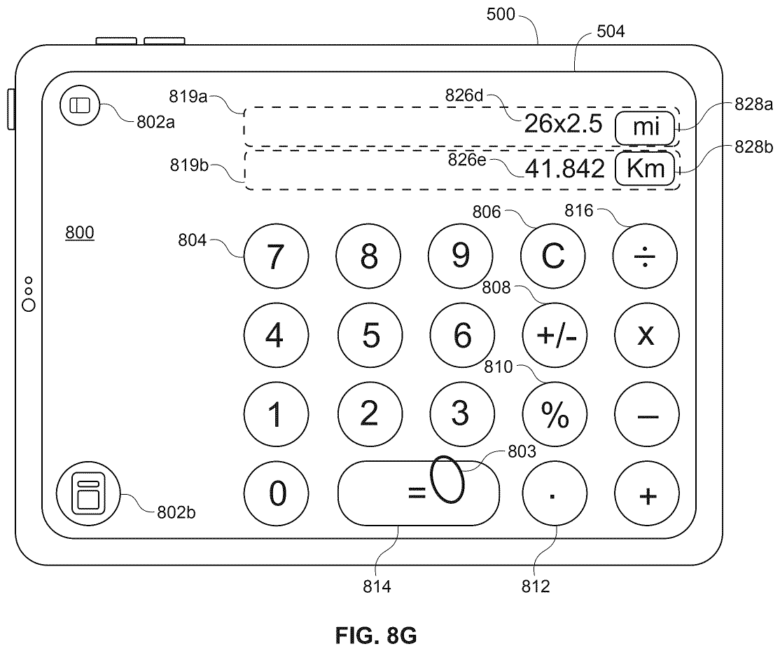

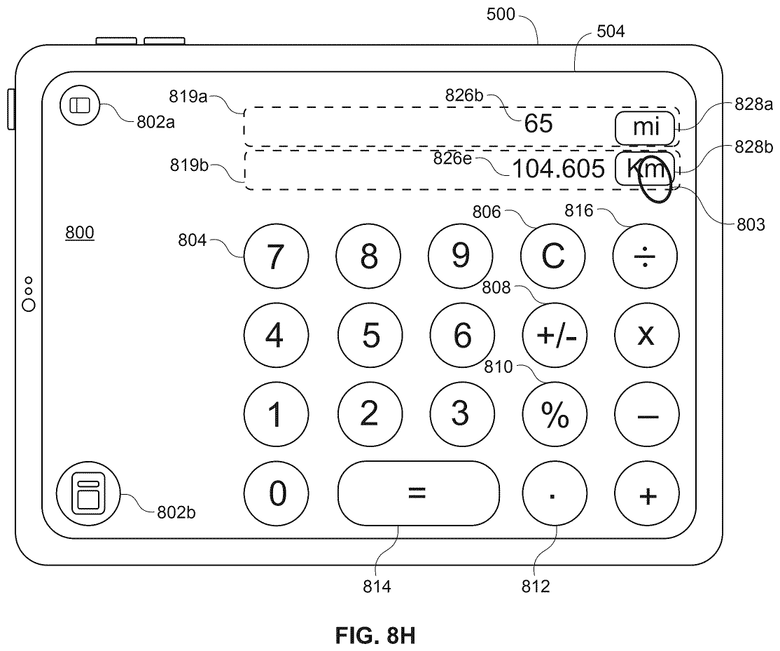

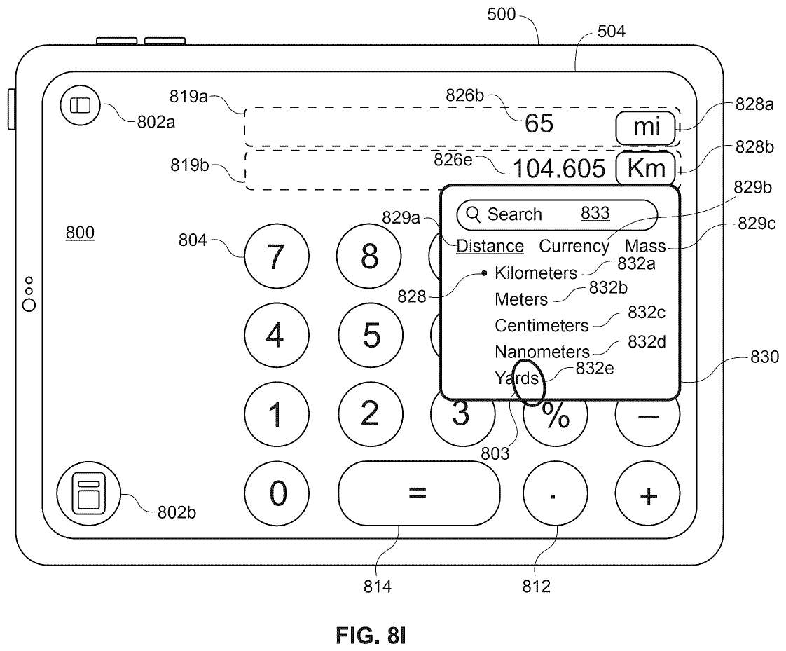

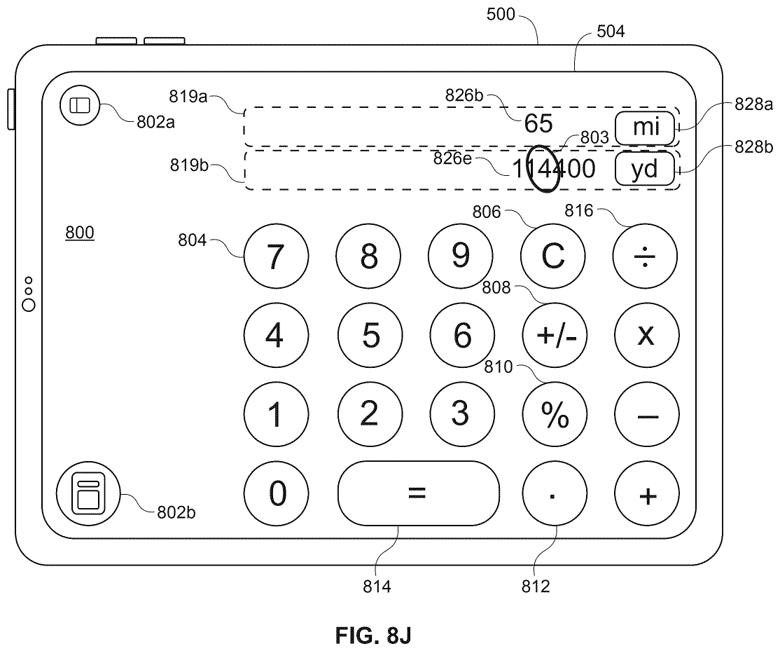

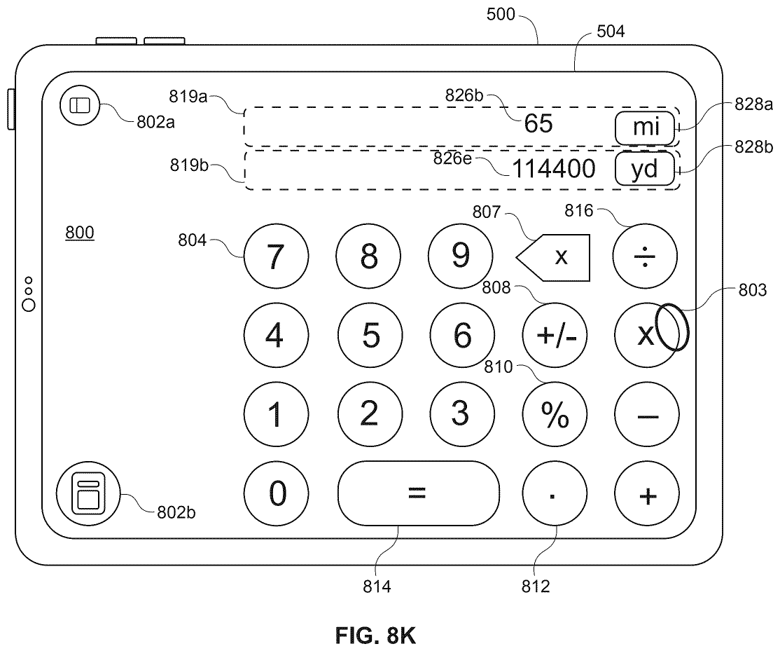

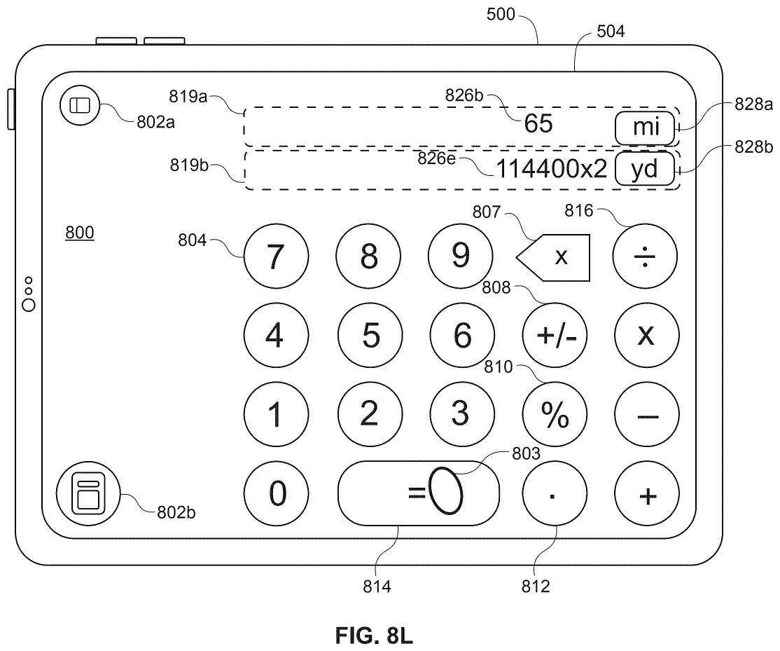

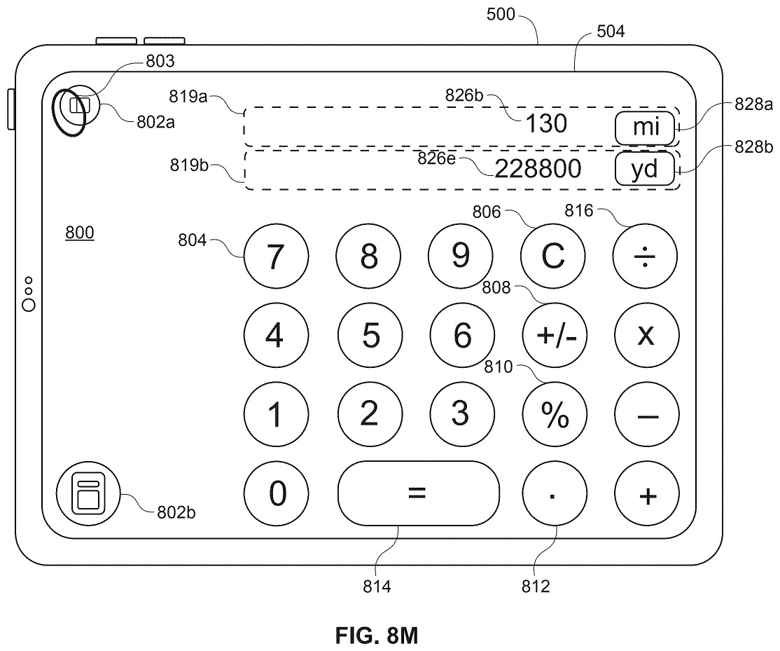

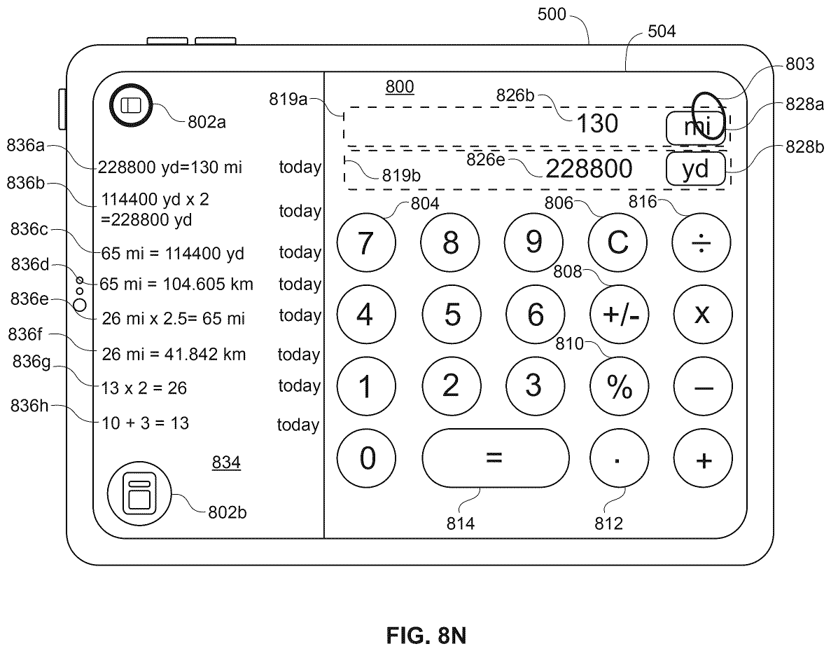

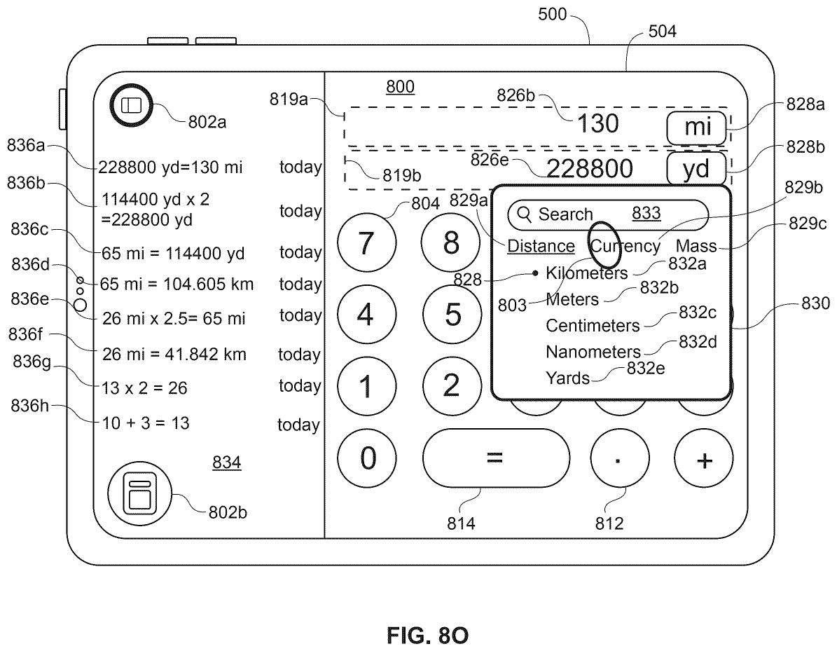

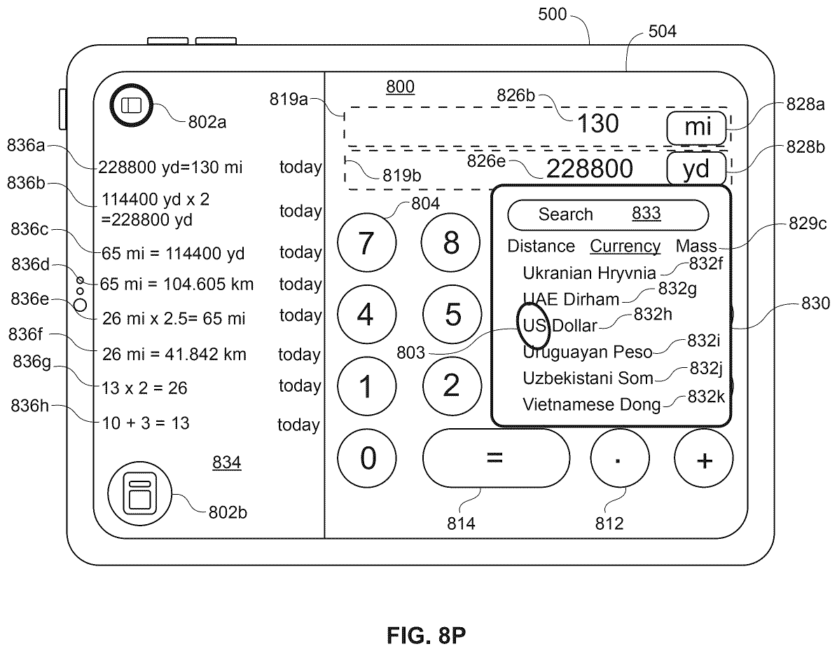

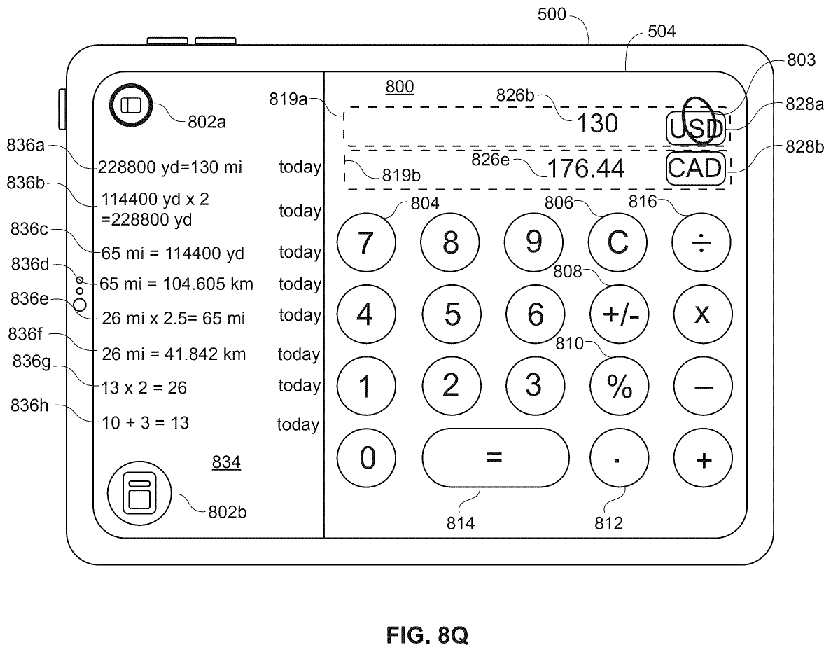

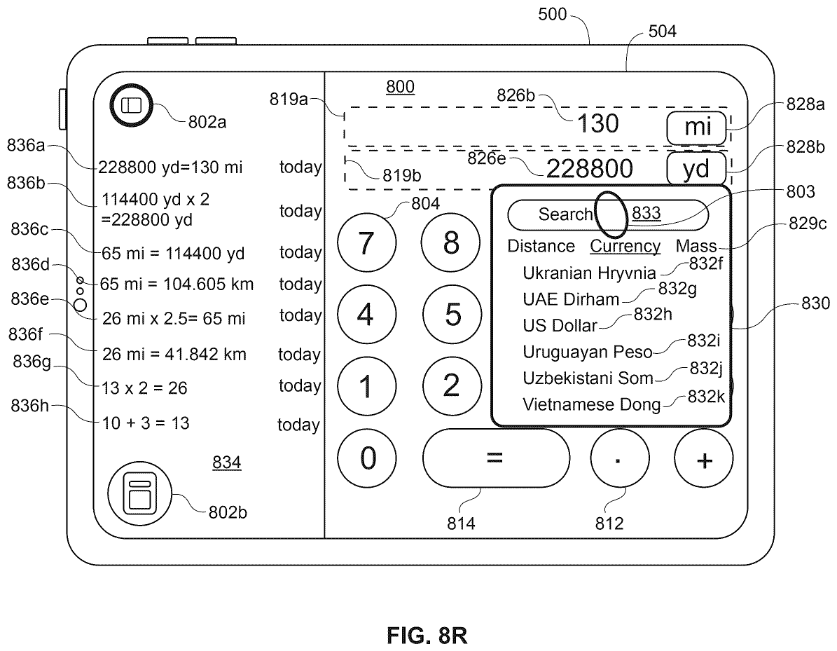

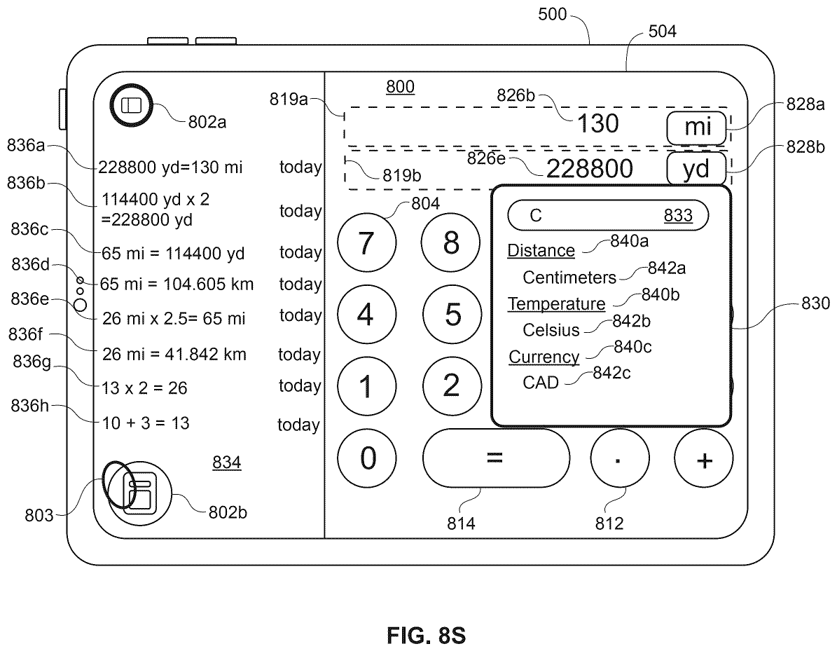

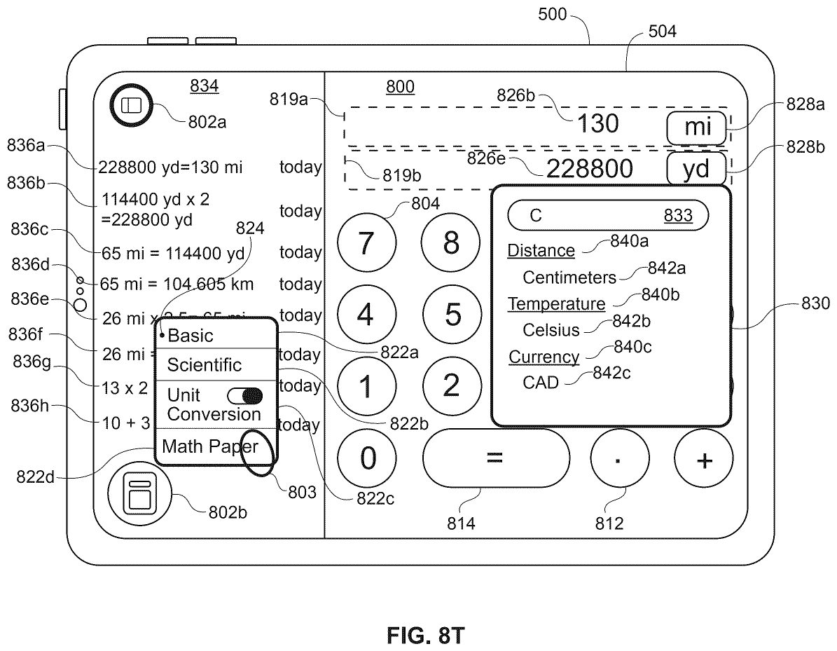

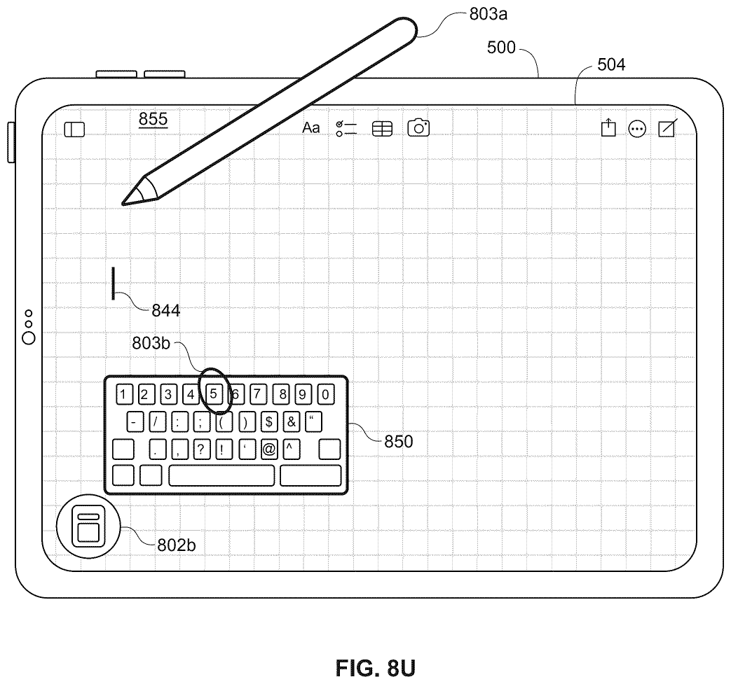

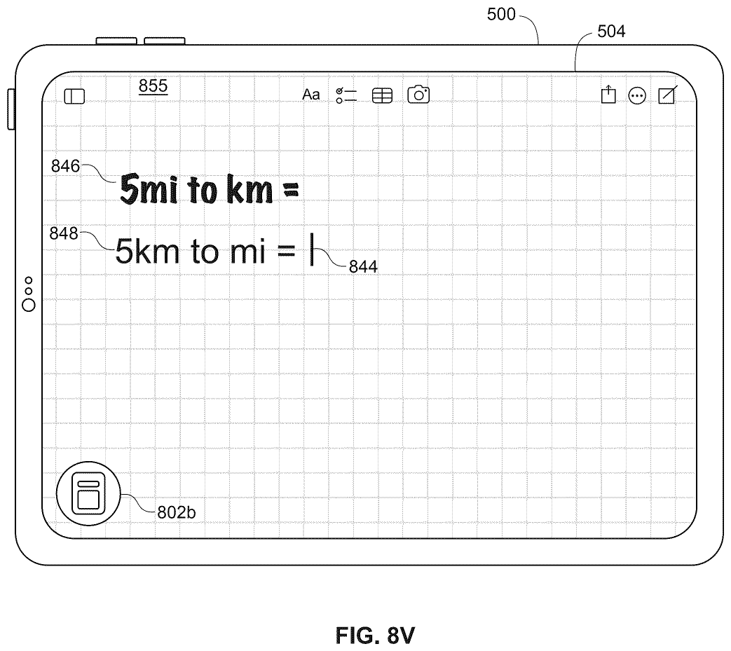

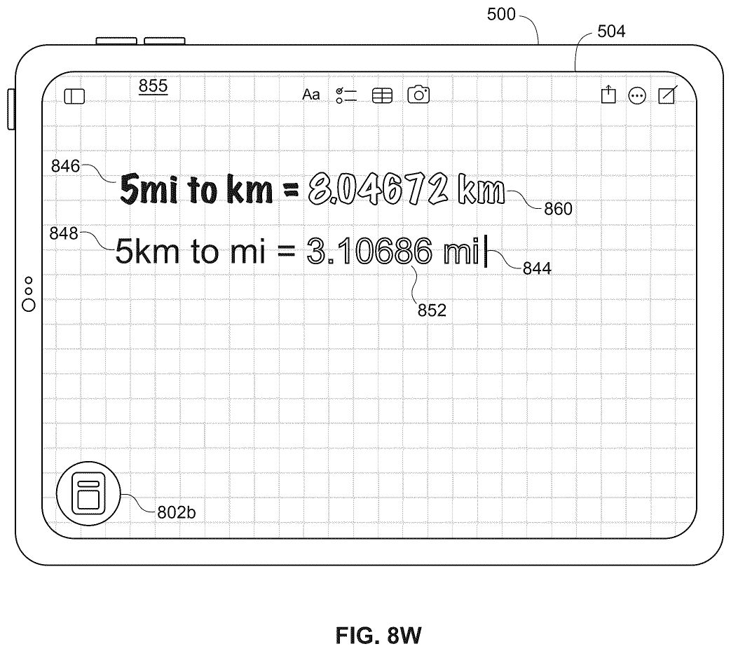

FIG. 6V illustrates a user interface 680 of a calculator application. The user interface 680 includes one or more options representing numbers and operations. The user interface of the calculator application is described in greater detail with reference to FIG. 8A. The user interface 680 includes a mode menu option 682 (corresponding to mode menu option 802b shown in FIG. 8A), that when selected, causes the electronic device 500 to display addition mode options for the calculator application. In FIG. 6V, the electronic device 500 receives a selection input selecting the mode menu option 682 using contact 684a. In some embodiments, contact 684a is a direct contact such as a finger, a mouse click, or a stylus (e.g., stylus 203), or an indirect contact such as a gaze and/or a hand gesture or shape that does not make contact with hardware. In some embodiments, the electronic device 500 is able to receive the inputs described herein with a direct or an indirect contact. In response to receiving the input shown in FIG. 6V, the electronic device 500 displays a mode menu, as shown in FIG. 6W. In some embodiments, the mode menu is described in greater detail in FIG. 8D.

FIG. 6W illustrates the electronic device 500 displaying a mode menu including options 686a through 686d for changing the mode of the calculator application. Option 686a corresponding to a “basic” calculator, which is the mode the calculator application is currently operating in. For example, the “basic” calculator mode includes displaying the one or more options representing numbers and operations shown in FIGS. 6V and 6W. Option 686b corresponding to a scientific calculator mode optionally includes displaying additional options, such as additional operation options not shown in FIGS. 6V-6W. Option 686c controls whether the unit conversion mode, described below with reference to method 900, is on or off. In some embodiments, unit conversion mode is off in FIGS. 6V-6W. In response to detecting interaction with the option 686c, the electronic device 500 transitions from the unit conversion mode being off to the unit conversion mode being, which is described in greater detail in method 900. The menu further includes a math paper option 686d. In some embodiments, in response to detecting selection of the math paper option 686d, the electronic device 500 displays a content entry region such as the one described with reference to method(s) 700, 1100, and/or 1200 that supports typed and/or handwritten equations and/or graphs. In some embodiments, the content entry region has one or more characteristics of the content entry region 602, described in FIG. 6A, except the content entry region is a user interface of a calculator application instead of a notes application. As shown in FIG. 6W, the electronic device 500 detects an input selecting option 686d with contact 684b. In response to detecting the input shown in FIG. 6W, the electronic device 500 operates the calculator in a math paper mode as shown in FIG. 6X.

FIG. 6X illustrates a user interface 687 of the math paper mode of the calculator application. In some embodiments, the user interface 687 has one or more characteristics of user interface 600, shown in FIG. 6A-6V. In some embodiments, while displaying the user interface 687, the electronic device 500 is able to perform one or more operations of user interface 600, as described above, and vice versa. In FIG. 6X, the electronic device 500 displays text 688 of an equation (e.g., a graphing equation). In response to detecting that the text 688 includes a quadratic equation that is able to be graphed, the electronic device 500 displays an indication 690 indicating that text 688 is able to be graphed, as described with reference to method 1100 and/or 1200. In some embodiments, the electronic device 500 displays the indication with representation 690 and option 692 in response to detecting a selection input directed towards text 688 and/or in response to detecting that text 688 satisfies one or more graphing criteria described below with respect to method(s) 1100 and/or 1200 (e.g., without receiving a selection input directed to text 688.

In FIG. 6X, the electronic device 500 receives a selection input with stylus 203 directed towards option 692. In response to receiving the input in FIG. 6X, the electronic device 500 displays a representation 651 of a graph representing the equation of input 688, shown in FIG. 6Y. Additional disclosures describing graphing in the calculator application is described in greater detail in method 1100 and/or 1200.

In FIG. 6Z, the electronic device 500 displays text 692 including an equation in response to receiving a handwritten input with stylus 203. In response to receiving the input in FIG. 6Z, the electronic device 500 displays the solution 694 corresponding to the equation, shown in FIG. 6AA. Displaying the solution in response to receiving the input including the equation and an equals sign is described in greater detail in method 700. Displaying the solution in response to receiving the input including the equation and an equals sign while displaying user interface 687 of the calculator application has one or more characteristics of displaying the solution in response to receiving the input including the equation and an equals sign while displaying user interface 600 of the notes application. In some embodiments, and as described in method 700, displaying the solution while displaying user interface 600 optionally required additional steps (e.g., detecting an equals sign and detecting a selection input directed towards a selectable option), while the solution is displayed automatically after detecting an input with an equals sign while in user interface 687, as described in further detail below with reference to method 700.

FIG. 6BB illustrates a user interface 696 of a messaging application. In FIG. 6BB, the electronic device 500 displays user interface 696 that includes a messaging conversation between Joe (e.g., the user associated with the electronic device 500) and a contact named Jenna. The messaging user interface 696 includes a first user interface object 698a (or representation) of a first message that was added to the messaging conversation from a second user account and/or device (e.g., a second electronic device) associated with Jenna and a second user interface object 698b (or representation) of a second message that was added to the messaging conversation from electronic device 500 and/or a first user account associated with Joe. In some embodiments, the electronic device 500 displays the first user interface object 698a, in messaging user interface 696, in response to electronic device 500 receiving an indication that the device associated with Jenna has added the first message to the messaging conversation, which includes the text “What was the total?”. In some embodiments, the electronic device 500 displays the second user interface object 698b, in messaging user interface 696, in response to electronic device 500 receiving an indication that the device associated with Joe has added the second message, which included the text “I'll do the math!”, to the messaging conversation. For example, the electronic device 500 detects one or more text entry inputs providing the text “I'll do the math!” followed by selection of option 695. Example text entry inputs include handwritten text, interactions with soft keyboard 699 and/or a hardware keyboard, and/or voice inputs.

In FIG. 6BB, the messaging user interface 696 also includes a content entry field 691 that receives inputs to add text, visual media, and/or other content to the messaging conversation. In some embodiments, the electronic device receives content for the content entry field 691 using a soft keyboard 699 with selectable keys such that a user can type text into the content entry field 691. The user interface 696 also includes a selectable option 695, that when selected, causes the electronic device 500 to add the content in the content entry field 691 to the messaging conversation.

In FIG. 6BB, the electronic device 500 receives one or more inputs to add “23+48” to the content entry field 691. In response to receiving the one or more inputs and because of the context of the messaging conversation (e.g., talking about math) and the content in the content entry field 691, the electronic device 500 adds suggestions 697a through 697c to the user interface 696. Suggestion 697a includes text illustrating the equation that is typed into the content entry field 691. In some embodiments, suggestion 697a is displayed before the user finished typing the equation into the content entry field (e.g., autocomplete). Suggestion 697b includes text illustrating the solution to the equation in the content entry field 691. Suggestion 697c includes text of the equation in the content entry field 691 along with an equals sign and the solution. Suggestions 697a when selected (e.g., based on detecting an input directed to the suggestion 697a such as input including contact 693a), causes the electronic device to add the text displayed in suggestion 697a to content entry field 691 (and optionally replaces some or all of the text and/or other content in the content entry field 691 with the text displayed in suggestions 697a). Suggestions 697b when selected (e.g., based on detecting an input directed to the suggestion 697b such as input including contact 693b), causes the electronic device to add the text displayed in Suggestion 697b to content entry field 691 (and optionally replaces some or all of the text and/or other content in the content entry field 691 with the text displayed in suggestions 697b). Suggestions 697c when selected (e.g., based on detecting an input directed to the suggestion 697c such as input including contact 693c), causes the electronic device to add the text displayed in suggestion 697c to content entry field 691 (and optionally replaces some or all of the text and/or other content in the content entry field 691 with the text displayed in suggestions 697c). The inputs shown in FIG. 6BB are optionally performed independently of each other.

FIG. 6CC-6GG illustrates embodiments of user interface 600 including variables with units of measure (also referred to as units or units of measurement). In FIG. 6CC, the electronic device 500 displays text 662e and 662f corresponding to equations with variables. Text 662e includes the variable “x” and text 622f includes the variable “y”. In FIG. 6CC, text 672e defines the variable “x” as “10 miles”, and text 672f defines the variable “y” as “25 cm”. In FIG. 6CC, text 672e and 672f include respective units of measure (e.g., the one or more letters) along with respective numerical values (e.g., the one or more numbers). In some embodiments, after receiving an input with stylus 203 to add text 672e and 672f to assign a numerical value to a variable (e.g., such as described in FIG. 6O-6P), the electronic device 500 displays the respective solutions 6700 and 670p to the equations corresponding to text 662e and 662f while presenting user interface 600 in FIG. 6CC. In some embodiments, the one or more inputs to add text 672e and 672f are not shown in FIG. 6CC.

In FIG. 6CC, the electronic device 500 displays solution 6700 as handwritten text because text 672e is written as handwritten text. Specifically, the electronic device 500 displays the units of measure of the solution 6700 as handwritten text because the units of measure of text 672e is written as handwritten text. Additionally, in FIG. 6CC, the electronic device 500 displays the units of measure of solution 6700 as “miles\hat{ }2” because the equation corresponding to text 662e requires squaring of the variable x, with units of “miles”.

In FIG. 6CC, the electronic device 500 displays solution 670p as font-based text because text 672f is in font-based text. Specifically, the electronic device 500 displays the units of measure of the solution 670p as handwritten text because the units of measure of text 672f is written as handwritten text. In FIG. 6CC, the units of measure of solution 670p is “cm” because the units of measure of text 672f is “cm” and the equation corresponding to text 662f only requires multiplying the variable times 2 (without a specific unit of measure).

FIG. 6DD illustrates an embodiment of a solution 670q not having units of measure even though the associated variables have respective unit of measure. In FIG. 6DD, the electronic device 500 displays text 662g corresponding to an equation with variables a, b, and c. In FIG. 6DD, the electronic device 500 displays solution 670q in response to receiving an input with stylus 203 to add numerical values and units of measure to respective variables. In FIG. 6DD, text 672g through 672i include numerical values and units of measure corresponding to the variables a, b, and c, respectively. Because the units of measurement of the variables cancel out in the mathematical equation, the electronic device 500 displays the solution 670q without a unit of measure.

FIG. 6EE illustrates additional embodiments of text including variables and units. In FIG. 6EE, the electronic device 500 displays text 662h of an equation including one or more letters that have been identified as a variable and one or more letters that have been identified as a unit of measurement. For example, in FIG. 6EE, “cm” is identified as a unit of measurement and “x” is identified as a variable. Identifying variables and units of measurement is described in greater detail in method 700. In FIG. 6EE, the electronic device 500 also displays text 672j, which assigns a numerical value and a unit to the variable “x”. In FIG. 6EE, the units of measurement (e.g., “cm” and “seconds”) are not compatible, as described in greater detail in method 700, and as a result, the electronic device displays solution 670r with a combination of both units of the mathematical equation (e.g., cm/seconds).

FIG. 6EE also includes text 662i of an equation including the addition of two variables. FIG. 6EE includes text 672k, which assigns a numerical value and a unit to the variable “a” and text 672l, which assigns a numerical value and a unit to the variable “b”. In some embodiments, the variable “a” is associated with a first unit “m” and the variable “b” is associated with a second unit “cm”. In some embodiments, both units are units of distance and are therefore compatible with each other. In some embodiments, the electronic device 500 displays solution 670s of the equation corresponding to text 662i with mixed units. For example, in FIG. 6EE, the electronic device 500 displays solution with the first unit and the second unit.

FIG. 6FF illustrates a different embodiment of solving an equation with compatible units. In FIG. 6FF, text 662j corresponds to the equation of text 622i shown in FIG. 6EE. In FIG. 6FF, text 672m and 672n correspond to text 672k and 6721 shown in FIG. 6EE. Specifically, the variables “a” and “b” are assigned to the same respective numerical values and units. However, in FIG. 6FF, the electronic device 500 combines the compatible units “m” and “cm” (e.g., units of distance) into one unit in solution 672t. As described in method 700, in some embodiments, the electronic device 500 combines the units of compatible units into a single unit. In some embodiments, “m” (e.g., meters) comes first in the equation of text 662j, so the electronic device 500 uses “m” in the solution 672t.

In FIG. 6FF, the electronic device 500 receives an input via the stylus 203 to add scribbles over the equal sign of text 662j. In some embodiments, the input corresponds to a request to delete the equal sign. In some embodiments, alternative inputs include erasing/deleting the equal sign (e.g., via stylus input or a keyboard input). In response to receiving the input in FIG. 6FF, the electronic device 500 ceases displaying the solution 672t, shown in FIG. 6GG.

FIG. 6GG illustrates user interface 600 after the electronic device 500 receives an input to delete the equal sign. In FIG. 6GG, the electronic device 500 no longer displays the equal sign and no longer displays the solution 672t. In some embodiments, the one or more criteria that needs to be satisfied for the electronic device 500 to display the solution is described in greater detail in method 700. In some embodiments, after deleting the equal sign, the text 672t no longer satisfies the one or more criteria.

FIG. 7 illustrates a flow diagram illustrating a method in which displays solutions to mathematical equations in response to receiving an input including a mathematical equation according to some embodiments. The method 700 is optionally performed at first electronic device and/or electronic devices such as device 100, device 300, or device 500 as described above with reference to FIGS. 1A-1B, 2-3, 4A-4B and 5A-5H. Some operations in method 700 are, optionally combined and/or order of some operations is, optionally, changed.

In some embodiments, method 900 is performed at an electronic device in communication with one or more display generation components and one or more input devices. For example, the electronic device, display generation component(s), and/or one or more input devices are as described above with reference to method 700.

In some embodiments, method 700 is performed at an electronic device in communication with one or more display generation components and one or more input devices, such as electronic device 500 shown in FIG. 6A. For example, a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external). In some embodiments, the one or more display generation components is a display integrated with the electronic device (optionally a touch screen display), external display such as a monitor, projector, television, a head-mounted display, or a hardware component (optionally integrated or external) for projecting a user interface or causing a user interface to be visible to one or more users, etc. Examples of input devices include physical buttons, knobs, handles, and/or switches of a vehicle, a touch screen, mouse (e.g., external), trackpad (optionally integrated or external), touchpad (optionally integrated or external), microphone for capturing voice commands or other audio input, remote control device (e.g., external), another electronic device (e.g., mobile device that is separate from the electronic device), a handheld device (e.g., external), a controller (e.g., external), a camera, a depth sensor, an eye tracking device, a hand tracking device, and/or a motion sensor (e.g., a hand tracking device, a hand motion sensor). In some embodiments, the hand tracking device is a wearable device, such as a smart glove. In some embodiments, the hand tracking device is a handheld input device, such as a remote control or stylus. In some embodiments, the hand tracking device is camera-based (e.g., a camera is used to determine the position of the hand).

In some embodiments, the electronic device displays (702a), via the one or more display generation components, a user interface that includes a content entry region (e.g., for detecting font-based text input and/or for detecting handwritten input), such as user interface 600 including content entry region 602, shown in FIG. 6A. The user interface for entering text is a user interface of a notes application, a calculator application, an internet browsing application, a messaging application, or a document editing application. In some embodiments, the user interface for entering text includes functions that allow handwritten text inputs and typed text inputs. In some embodiments, the user interface for detecting text includes text entry fields (e.g., the content entry region) accepts font-based text inputs and/or handwritten inputs. In some embodiments, the content entry region is a region in the user interface in which a user is able to input and/or enter text, images, and/or multimedia. For example, in an email composition user interface, a content entry region for the body of the email is capable of detecting (and transmitting over email) text, still images, videos, and/or attachments. In another example, in a note taking application, a content entry region capable of detecting handwritten text, drawings, figures, etc. and capable of including/detecting images, and/or drawings.

In some embodiments, while displaying the user interface including the content entry region, the electronic device detects (702b), via the one or more input devices, an input directed to the content entry region (e.g., a handwritten input or a font-based text input), such as an input via stylus 203 to write text 604, shown in FIG. 6A. In some embodiments, the input is an input to type font-based text (e.g., using a soft keyboard or a hardware keyboard) or to handwrite text (e.g., using an input element such as a stylus or finger). In some embodiments, the input is a touch input (e.g., directed to a soft keyboard or a handwriting input), an air gesture, a mouse input, or an input using an input device such a keyboard or a stylus. In some embodiments, font-based text is computer text and/or digital text and handwritten text is text written by a user (e.g., using a stylus). In some embodiments, font-based text is text that is entered when using a traditional text entry system such as a physical keyboard or soft keyboard. In some embodiments, the text is formatted using a particular font style. For example, the font-based text is Times New Roman with 12 point size or Arial with 10 point size, etc.

In some embodiments, in response to detecting the input (702c), the electronic device displays (702d), in the content entry region, a representation of the input, such as text 604 shown in FIG. 6A. In some embodiments, displaying the representation of the input includes displaying the handwritten and/or font-based characters corresponding to the input. In some embodiments, the handwritten input is not inserted as a handwritten representation of the input (e.g., as a drawing, rich drawing data type, and/or a vector). In some embodiments, the electronic device automatically converts (or has already converted) the handwritten input into font-based text (e.g., recognized and identified the handwriting as characters). In some embodiments, the handwritten input is inserted based on the type of content entry region into which it is being inserted.

In some embodiments, in accordance with a determination that the input satisfies one or more first criteria including a criterion that is satisfied when the input includes a mathematical equation (e.g., a type of text that includes a mathematical equation with numbers and/or mathematical operations symbols and an equals sign), the electronic device displays (702c), in the content entry region, information corresponding to a solution (e.g., an automatically-generated solution or a selectable option, that when selected, causes the electronic device to display the solution to the mathematical equation, as described in greater detail below) to the mathematical equation near the representation of the mathematical equation, wherein the solution was not provided as part of the mathematical equation, such as solution 608 shown in FIG. 6B in response to detecting the writing of the equals sign in text 604. In some embodiments, the electronic device displays the information with similar handwriting to the input if the input is a handwritten input. In some embodiments, the information is displayed as font-based text if the input is a font-based text input. In some embodiments, the electronic device solves the math equation using the input and presents the solution near the equals sign in the input (e.g., to the right of the equals sign and at the same horizontal plane as the input or below the equals sign and below the input). For example, if the input is “4+6=”, then the solution presented adjacent to the equal sign is “10”. In some embodiments, if the input is at a first location in the content entry region, then the information corresponding to the solution is at a second location to the right of or below the first location. In some embodiments, if the input is at a third location, different than the first location in the content entry region, then the information corresponding to the solution is at a fourth location, different than the third location, to the right of or below the third location. In some embodiments, the electronic device automatically displays information corresponding to the solution in response to detecting that the input satisfied one or more first criteria. In some embodiments, the electronic device displays the information corresponding to the solution before the electronic device detects the end of the input (but after the electronic device detects that the input satisfied the one or more first criteria). In some embodiments, the input does not include information corresponding to the solution.

In some embodiments, in accordance with a determination that the input does not satisfy the one or more first criteria (e.g., the input is a second type of text different than the first type of text such as text without numbers, equations, equals signs, or mathematical operation symbols, or a mathematical equation that does not include some indication of completion such as an equal sign for a horizontally written equation or equals line for a vertically written equation), the electronic device forgoes displaying (702f) the information corresponding to the solution to the mathematical equation near the mathematical equation, such as shown by the solution no longer being displayed next to text 616 in FIG. 6F. In some embodiments, the input does not satisfy the one or more first criteria when the input is not text (e.g., font-based text or handwritten text) including a mathematical equation with an equals sign or equals line, if the input is an unsupported mathematical operation, or if the input is an ambiguous mathematical equation. For example, the electronic device forgoes displaying information corresponding to the solution when the input includes an unsupported mathematical operation since the electronic device cannot solve the equation. In some embodiments, the input is a text input including alphabetical characters. In some embodiments, the input is an alphabetical and/or mathematical input that includes numbers and/or mathematical operators but does not include an equals sign or equals line (e.g., such as a user taking text notes). Displaying a solution in accordance with a determination that text displayed in response to detecting an input is a first type of text enhances user interactions with the computer system by reducing the amount of inputs needed to display the solution, and also reduces erroneous inputs to the electronic device.

In some embodiments, the input is a font-based text input, such as text 654 shown in FIG. 6J. In some embodiments, font-based text is computerized text. In some embodiments, a user inputs font-based text using a soft keyboard or a physical keyboard in communication with the electronic device. In some embodiments, the electronic device converts a voice input into a font-based text input. Allowing the electronic device to accept font-based text input enhances user interactions with the computer system allowing the user to choose how to input the mathematical equation.

In some embodiments, the input is a handwritten input, such as text 604 in FIG. 6A. In some embodiments, the input is received from a stylus or other writing device. In some embodiments, the input is received by detecting a finger. In some embodiments, the handwritten input includes a plurality of handwritten characters. Allowing the electronic device to accept a handwritten input enhances user interactions with the computer system allowing the user to choose how to input the mathematical equation.

In some embodiments, the information corresponding to the solution is an indication of completion of a calculation of the mathematical equation without displaying the solution to the mathematical equation, such as the electronic device displaying user interface element 656 in response to detecting the completion of the calculation of the mathematical equation (e.g., text 654), shown in FIG. 6J. In some embodiments, in response to detecting that the one or more first criteria are satisfied, the electronic device displays an indication (e.g., a selectable option) indicating that the mathematical equation is solved without displaying the solution. For example, the electronic device detects a break in typing and/or handwriting greater than a threshold amount of time (e.g., 1 second, 3 seconds, 10 seconds, 30 seconds, or 1 minute), and in response, displays a selectable option to display the solution. In some embodiments, the user does not want the electronic device to automatically display the information corresponding to the solution to the mathematical equation in response to detecting the mathematical equation (e.g., the user intends to solve the mathematical equation on their own, such as doing homework or studying). Displaying an indication of completion of the calculation without displaying the solution enhances user interactions with the computer system by reducing erroneous displays of the solution (e.g., a user doing homework does not want to automatically see the solution to a math equation).

In some embodiments, while displaying the indication of completion, the electronic device detects, via the one or more input devices, a second input directed towards the indication of completion, such as if the electronic device 500 detects an input via stylus 203 directed towards a selectable option to display the solution. In some embodiments, the second input is a selection input (e.g., a tap input, air gesture, a click input, and/or a gaze input) directed towards the indication of completion (e.g., the selectable option). In some embodiments, the input is a voice input requesting display of the solution.

In some embodiments, in response to detecting the second input, the electronic device displays the solution to the mathematical equation, such as solution 608 shown in FIG. 6B. In some embodiments, displaying the solution includes one or more characteristics of the information corresponding to the solution as described above. Displaying the solution in response to detecting an input directed towards the indication of completion reduces erroneous inputs to the electronic device.

In some embodiments, while displaying the information corresponding to the solution to the mathematical equation, the electronic device detects, via the one or more input devices, a second input, such as an input via stylus 203 shown in FIG. 6E in a different portion of the content entry region 602. In some embodiments, the second input corresponds to an input other than a request to commit, such as the third input, as described below. In some embodiments, the second input is optionally a selection input selecting a different content entry region and/or a keyboard input such as a button press of an escape key. In some embodiments, the second input is directed towards a user interface element other than the information corresponding to the solution or the representation of the mathematical equation (e.g., selecting or tapping another area of user interface). In some embodiments, the input is a touch input (e.g., directed to a soft keyboard or a handwriting input), an air gesture, a mouse input, or an input using an input device such a keyboard or a stylus.

In some embodiments, in response to detecting the second input, in accordance with a determination that one or more second criteria are satisfied, including a criterion that is satisfied when a third input corresponding to a request to accept the solution to the mathematical equation was received prior to detecting the second input (e.g., a third input corresponding to a request to commit to displaying the information corresponding to the solution such as a tap input, air gesture or a gaze input directed towards the representation of the information corresponding to the solution), the electronic device continues displaying, in the content entry region, the information corresponding to the solution, such as if the electronic device continues displaying solution 618 if the electronic device 500 receives an input via stylus 203 or via a keyboard to commit the solution 618 shown in FIG. 6E. In some embodiments, the third input corresponding to the request to commit is a keyboard input such as a button press of the space bar (e.g., on a soft or physical keyboard). Alternatively, in some embodiments, the third input corresponding to the request to commit is a tap input (e.g., a tap input on the information corresponding to the solution or on a selectable option, or a voice input. In some embodiments, the information corresponding to the solution remains displayed near the representation of the mathematical equation.

In some embodiments, in response to detecting the second input, in accordance with a determination that the one or more second criteria are not satisfied (e.g., because the third input was not detected prior to detecting the second input), the electronic device ceases display of the information corresponding to the solution, such as shown by receiving input via stylus 203 in FIG. 6E and no longer displaying solution 618 shown in FIG. 6F. In some embodiments, if the electronic device does not detects the third input, different than the second input, then the electronic device ceases to display the information corresponding to the solution. Only displaying the information corresponding to the solution with the one or more second criteria are satisfied reduces the number of inputs needed to show the solution temporarily, thereby reducing erroneous inputs to the electronic device.

In some embodiments, displaying the information corresponding to the solution to the mathematical equation includes displaying the solution to the mathematical equation, such as shown by solution 608 in FIG. 6B. In some embodiments, and as described above, the electronic device does not automatically display the solution after detecting that the input satisfies the one or more first criteria (e.g., the electronic device displays an option that when selected, displays the solution). In some embodiments, the electronic device displays the solution to the equation, automatically, in response to detecting an input that satisfied one or more first criteria. Displaying the solution automatically in response to detecting an input that satisfies the one or more first criteria reduces erroneous inputs to the electronic device.

In some embodiments, displaying the solution to the mathematical equation further comprises in accordance with a determination that the input is a handwritten input including a first characteristic, displaying the solution to the mathematical equation with the first characteristic, such as displaying solution 608 in FIG. 6B in the same style as text 604. In some embodiments, the electronic device displays the solution is displayed in the same style as the handwritten input. In some embodiments, the electronic device mimics the user's handwriting to display the information corresponding to the solution. For example, the electronic device matches the way that the user draws their characters (e.g., based on information captured from previous handwritten inputs of the user). In some embodiments, the first characteristic is a handwriting characteristic (e.g., letter shape, spacing of characters, slope of characters, size of characters, and/or thickness of characters). In some embodiments, the first characteristic is handwriting in general. In some embodiments, if the input includes a third characteristic (e.g., the handwriting includes a third characteristic), then the solution includes the third characteristic. In some embodiments, in accordance with a determination that the input is a font-based input including a second characteristics, displaying the solution to the mathematical equation with a second characteristic different from the first characteristic. In some embodiments, if the input is a font-based input, then the solution is also displayed as font-based text. In some embodiments, the second characteristic is font-based text, in general. In some embodiments, the second characteristic is a characteristic of the text (e.g., font size, font name, and/or whether the font is bold, italic, or underlined). In some embodiments, if the input includes a fourth characteristic (e.g., the font-based input includes a fourth characteristic), then the solution includes the fourth characteristic. Displaying the solution with the same characteristic of the input enhances user interaction with the electronic device by allowing the user to see the equation and the solution with the same characteristics thereby reducing erroneous inputs to the electronic device.

In some embodiments, displaying a representation of the input including the mathematical equation with a visual characteristic having a first value (e.g., in a first color) and the solution with the visual characteristic having a second value different from the first value (e.g., in a second color), such as solution 608 being displayed as white text with an outline and the text 604 being displayed as solid black text, as shown in FIG. 6B. In some embodiments, the solution is displayed in a different color than the mathematical equation. Alternatively, in some embodiments, the visual characteristic is a font type, font size, or font thickness. Alternatively, in some embodiments, the mathematical equation has a visual characteristic having a first value and the solution has a visual characteristics having the first value. Displaying the solution with a different visual characteristic than the equation allows the user to quickly and efficiently identify the solution, thereby reducing erroneous inputs to the electronic device.

In some embodiments, the electronic device 500 displays an indication of a second input including a second mathematical equation with the visual characteristic having a third value different from the first value and different from the second value (e.g., in a third color), such as if text 626 was different handwriting than text 620 shown in FIG. 6I (e.g., different handwritten characteristics). In some embodiments, the second mathematical equation is a handwritten equation and has a fourth characteristic. In some embodiments, the second mathematical equation is a font-based text equation and has a fifth characteristic.

In some embodiments, the electronic device displays (optionally information corresponding to) the solution of the second mathematical equation for the second input with the visual characteristic having the second value (e.g., in the second color), such as the electronic device 500 displaying solution 650 and 652 with the same color (e.g., white with black outline) shown in FIG. 6I. In some embodiments, the solution for a plurality of inputs is presented in the second color, while the plurality of inputs are presented in different colors (e.g., in the first color or the third color), different than the second color. In some embodiments, if the second mathematical equation is displayed with the fourth characteristic, then the solution to the second mathematical equation is also displayed with the fourth characteristic. In some embodiments, if the second mathematical equation is displayed with the fifth characteristic, then the solution to the second mathematical equation is also displayed with the fifth characteristic. Displaying a plurality of solutions with a common value for a visual characteristic that is different than the values of the visual characteristics of the equations allows the user to quickly and efficiently identify the solutions, thereby reducing erroneous inputs to the electronic device.

In some embodiments, while displaying the solution, the electronic device detects, via the one or more input devices, a second input directed towards the solution, such as an input via stylus 203 shown in FIG. 6B. In some embodiments, the second input has one or more characteristics of the inputs described above. In some embodiments, the second input is a selection input directed towards the information corresponding to the solution. In some embodiments, the input is a touch input (e.g., directed to a soft keyboard or a handwriting input), an air gesture, a mouse input, or an input using an input device such a keyboard or a stylus.

In some embodiments, in response to detecting the second input, the electronic device displays an indication of the mathematical equation (and/or the calculation performed by the electronic device to generate the solution) as recognized by the electronic device in font-based text, such as shown by the electronic device 500 displaying user interface element 610 in FIG. 6C. In some embodiments, the electronic device text-recognizes the characters in the handwritten input and displays the font-based text interpretation of the mathematical equation on the indication of the mathematical equation. In some embodiments, if the input is a font-based text input, then the indication of the mathematical equation corresponds to the input. In some embodiments, the indication of the mathematical equation includes the mathematical equation that is being solved. Displaying the indication of the mathematical equation in font-based text in response to detecting an input allows the user to quickly and efficiently view the electronic device's interpretation of the handwritten mathematical equation, thereby reducing erroneous inputs to the electronic device.

In some embodiments, while displaying the indication of the mathematical equation (and/or the calculation performed by the electronic device to generate the solution), the electronic device detects, via the one or more input devices, a third input directed towards the indication of the mathematical equation, such as the input via stylus 203 in FIG. 6C. In some embodiments, the third input has one or more characteristics of the inputs as described above. In some embodiments, the third input is a selection input. In some embodiments, the input is a touch input (e.g., directed to a soft keyboard or a handwriting input), an air gesture, a mouse input, or an input using an input device such a keyboard or a stylus.

In some embodiments, in response to detecting the third input, the electronic device displays a second content entry region, such as if user interface element 610 is a second content entry region, as shown in FIG. 6D. In some embodiments, the second content entry region is displayed near (e.g., to the left, right, above, or below) the indication of the mathematical equation, the input, and/or the information corresponding to the solution. In some embodiments, the second content entry region has one or more characteristics of the content entry region as described above. In some embodiments, the electronic device accepts handwritten or font-based inputs in second content entry region. In some embodiments, the second content entry region is a content entry field, such as a text box, overlaid on or adjacent to the first content entry region.

In some embodiments, while displaying the second content entry region, the electronic device detects, via the one or more input devices, a fourth input directed towards the second content entry region, wherein the fourth input includes changes to the indication of the mathematical equation (and/or the calculation performed by the electronic device to generate the solution), such as an input directed towards one or more keys on the keyboard 612, shown in FIG. 6D. In some embodiments, the fourth input includes one or more characteristics of the inputs as described above. In some embodiments, the fourth input is a handwritten input or a font-based text input, which are described in greater detail above. In some embodiments, the fourth input is not an input directed towards the representation of the input (e.g., the original input/the original mathematical equation). In some embodiments, the changes to the mathematical equation includes changes to the numbers, variables, and/or mathematical operations of the mathematical equation.

In some embodiments, in response to detecting the fourth input, the electronic device updates the indication of the input including the mathematical equation in accordance with the fourth input, such as shown by the electronic device updating user interface element 610 in FIG. 6D to include the updated equation. In some embodiments, the user changes the mathematical equation to a second mathematical equation. For example, the user changes one or more components (e.g., numbers or mathematical operations) in the mathematical equation. In some embodiments, in response to updating the mathematical equation, the electronic device updates the information corresponding to the solution of the mathematical equation. In some embodiments, updating the mathematical equation includes updating the representation of the input (e.g., the mathematical equation) to include the changes to the indication of the mathematical equation. In some embodiments, the indication of the mathematical equation includes the first characteristic (e.g., a first style characteristics), as described above, and updating the mathematical equation includes displaying the changes to the mathematical equation with the first characteristic. For example, the electronic device matches the style of the originally entered mathematical equation (e.g., the same handwriting characteristics). Allowing the user to edit the mathematical equation while displaying the indication of the mathematical equation reduces the number of inputs needed to change the equation, thereby reducing erroneous inputs to the electronic device.

In some embodiments, updating the indication of the input including the mathematical equation in accordance with the fourth input includes updating the visual characteristic of the input including the mathematical equation from having the first value to having a fourth value, different than the first value and the second value, such as if the text 616 and/or the solution 618 shown in FIG. 6E were a different color and/or had a different characteristic than the text 604 and solution 608 shown in FIG. 6D. In some embodiments, and as described above, the visual characteristic of the input includes a color of the input. In some embodiments, after updating the indication of the input including the mathematical equation, the electronic device updates the color of the equation to a fourth color, different than the first color, the second color, and/or the third color, as described above. In some embodiments, the electronic device updates the visual characteristic including adding a visual effect to fade the color of the input from the first color to the fourth color in response to updating the equation. Changing the visual appearance of the input including the mathematical equation in response to changing the equation allows the user to quickly and efficiently identify equations that have been updated, thereby reducing erroneous inputs to the electronic device.

In some embodiments, updating the input including the mathematical equation in accordance with the fourth input includes updating the information corresponding to the solution, such as the electronic device 500 updating solution 608 to solution 618 in response to updating text 604 to text 616 shown in FIG. 6E. In some embodiments, changing the mathematical equation also includes changing the information corresponding to the solution of the mathematical equation. For example, the solution to the mathematical equation is different if the equation is different. In some embodiments, updating the information corresponding to the solution includes continuing to display the information corresponding to the solution with the same characteristic as the mathematical equation (e.g., the first characteristic and/or the second characteristic). Updating the solution to the mathematical equation in response to changing the equation reduces the number of inputs needed to display the solution to the updated mathematical equation, thereby reducing erroneous inputs to the electronic device.

In some embodiments, while detecting the fourth input directed towards the second content entry region including changes to the indication of the mathematical equation, the electronic device ceases display of the information corresponding to the solution of the mathematical equation, such as if the electronic device 500 no longer displayed solution 608 while the user is editing the equation shown in FIG. 6D. In some embodiments, while editing the mathematical equation, the previous solution to the mathematical equation is no longer displayed. In some embodiments, after detecting that the user is finished updating the mathematical equation, the electronic device updates the information corresponding to the solution to be the solution of the updated equation, as described above. Ceasing displaying the information corresponding to the solution of the mathematical equation while the user is editing the mathematical equation enhances user interactions with the electronic device by reducing erroneous displays of the solution.

In some embodiments, displaying, in the content entry region, the information corresponding to the solution to the mathematical equation near the representation of the mathematical equation includes in accordance with a determination that the input is detected in a first direction (e.g., top to bottom or left to right), the electronic device displays, via the one or more display generation components, the information corresponding to the solution to the mathematical equation near the input in a first location, such as text 604 being displayed from left to right and the solution 608 being displayed to the right of the text 604, shown in FIG. 6B. In some embodiments, if the first direction is top to bottom, then the electronic device displays the information corresponding to the solution at a first location that is below the end of the mathematical equation.

In some embodiments, displaying, in the content entry region, the information corresponding to the solution to the mathematical equation near the representation of the mathematical equation includes in accordance with a determination that the input is detected in a second direction (e.g., top to bottom or left to right), different than the first direction, the electronic device displays, via the one or more display generation components, the information corresponding to the solution to the mathematical equation in a second location, different than the first location, such as text 654 being displayed from top to bottom and the solution 660 being displayed below the text 654, shown in FIG. 6K. In some embodiments, if the second direction is left to right, then the electronic device displays the information corresponding to the solution at a second location that is to the right of the end of the mathematical equation. Displaying the solution to the equation near the input enhances user interactions with the electronic device by reducing erroneous displays of the solution (e.g., the user associated a solution to the first equation with the second equation).

In some embodiments, the one or more criteria further include a second criterion that is satisfied when the mathematical equation is able to be solved automatically (e.g., by the electronic device or a server or cloud service that is in communication with the electronic device). In some embodiments, in response to detecting the input (e.g., with stylus 203 to write the equation), in accordance with a determination that the input does not satisfy the one or more criteria, the electronic device displays, via the one or more display generation components, a visual indication indicating that the mathematical equation is not able to be solved automatically (e.g., by the electronic device or a server or cloud service that is in communication with the electronic device) without displaying information corresponding to the solution to the mathematical equation, such as indications 628, 630, 632, and 634 shown in FIG. 6G. In some embodiments, the visual indication includes highlighting around the one or more characters in the mathematical equation that do not satisfy the second criterion. In some embodiments, if the electronic device is unable to solve the mathematical equation, then the information corresponding to the solution to the mathematical equation is not displayed. In some embodiments, the electronic device displays the visual indication that the mathematical equation is not able to be solved automatically after detecting that the user is done writing the equation (e.g., adding the equals sign or pausing text entry for a threshold amount of time, as described above). In some embodiments, the second criterion is satisfied when the electronic device is able to provide a solution to the mathematical equation. For example, the second criterion is satisfied when the mathematical equation does not include ambiguous numbers and/or operators and/or does not include unsupported operations (e.g., operations that result in solutions that are too large, operations including dividing by zero, and other undefined operations).

In some embodiments, in response to detecting the input (e.g., with stylus 203 to write the equation), in accordance with a determination that the input satisfies the one or more criteria, the electronic device forgoes displaying, via the one or more display generation components, the visual indication indicating that the mathematical equation is not able to be solved automatically (e.g., by the electronic device or a server or cloud service that is in communication with the electronic device), such as shown with text 616 that is able to be solved automatically, shown in FIG. 6E (e.g., the electronic device 500 does not display the visual indication and instead, displays the information corresponding to the solution). In some embodiments, the electronic device does not display highlighting around the one or more characters in the mathematical equation. In some embodiments, if the mathematical equation satisfies the second criterion and other criterion in the first one or more criteria, then the electronic device displays the information corresponding to the solution to the mathematical equation because the electronic device is able to solve the equation. Displaying a visual indication indicating that the electronic device cannot solve the mathematical equation allows the user to quickly and efficiently identify the error, thereby reducing erroneous inputs to the electronic device.

In some embodiments, the visual indication indicating that the mathematical equation is not able to be solved automatically includes a highlighting at a location corresponding to (e.g., proximate to, on, or around) the characters of the mathematical equation (e.g., that do not satisfy the second criterion), such as shown by indications 628, 630, 632, and 634, wherein the respective indication is displayed around a portion of the respective text that does not satisfy the second criterion, shown in FIG. 6G. Alternatively or additionally, in some embodiments, the visual indication includes underlining and/or coloring. In some embodiments, the portions of the mathematical equation that satisfy the second criterion are not displayed with the visual indication.

Displaying a visual indication indicating the portion of the input that causes the electronic device not to be able to solve the mathematical equation allows the user to quickly and efficiently identify the error, thereby reducing erroneous inputs to the electronic device.

In some embodiments, in accordance with a determination that the input fails to satisfy the second criterion because the mathematical equation is ambiguous (e.g., ambiguity includes unrecognized symbols, unbalanced parentheses, lack of clarity between two similar-looking characters like power of zero or degrees sign, ambiguous baseline, and/or ambiguous multiplication or decimal), the visual indication indicating that the mathematical equation is not able to be solved automatically has a first appearance with a first value for a respective visual property (e.g., a first color and/or a first line thickness of the highlighting), such as indications 628 and 634 shown in FIG. 6G. In some embodiments, the electronic device displays the portion of the representation of the input that fails to satisfy the second criterion because the portion of the input is ambiguous with a first color, a first line thickness, a first font, a first highlighting that is different than the value for the respective property for the portions of the mathematical equation that satisfy the second criterion.

In some embodiments, in accordance with a determination that the input fails to satisfy the second criterion because the mathematical equation is unsupported by the electronic device), the visual indication indicating that the mathematical equation is not able to be solved automatically has a first appearance with a second value for a respective visual property (e.g., a second color different from the first color and/or second line thickness different from the first line thickness of the highlighting), such as indications 630 and 634 shown in FIG. 6G. In some embodiments, the electronic device displays the portion of the representation of the input that fails to satisfy the second criterion because the portion of the input is unsupported with a second value for the respective visual property (e.g., second color, a second line thickness, a second font, a second highlighting that is different than the first color, the first line thickness, the first font, and the first highlighting of the first value of the visual characteristic). Displaying a visual characteristic of the visual indication with a first value to indicate that the mathematical equation is ambiguous and displaying the visual characteristic with a second value to indicate that the mathematical equation is unsupported allows the user to quickly and efficiently identify the error, thereby reducing erroneous inputs to the electronic device.

In some embodiments, a respective portion (e.g., the first portion or the second portion) of the input fails to satisfy the second criterion because the respective portion of the input is ambiguous, such as indications 628 and 634 shown in FIG. 6G. In some embodiments, the electronic device cannot solve the mathematical equation if a portion of the mathematical equation is ambiguous, such as described above. Displaying a visual indication indicating the portion of the input that causes the electronic device not to be able to solve the mathematical equation allows the user to quickly and efficiently identify the error, thereby reducing erroneous inputs to the electronic device.

In some embodiments, while displaying the visual indication indicating that the mathematical equation is not able to be solved automatically, in accordance with a determination that a respective portion of the input fails to satisfy the second criterion because the respective portion of the input is ambiguous (e.g., ambiguous as described above), the electronic device detects, via the one or more input devices, a second input directed to a respective portion of the representation of the input, such as the inputs via stylus 203 directed towards indications 628 and 634 shown in FIG. 6G. In some embodiments, the second input includes a selection input, such as a tap with a contact (I., a finger, or stylus), selection with an indirect input device (e.g., mouse, remote control, stylus, or trackpad) that is directed to a location of a focus indicator such as a cursor or selection ring) and/or a gaze input (optionally as part of an air gesture). In some embodiments, the input is directed towards the portion of the representation of the input that does not satisfy the second criterion and is displayed with the second value for the visual characteristic.

In some embodiments, in response to detecting the second input, the electronic device displays, via the one or more display generation components, an option to associate the respective portion of the input with first content that satisfies the second criterion, such as options 646a, 646b, 648a, and 648b shown in FIG. 6H. In some embodiments, the option is a first option that includes a non-ambiguous interpretation of the portion of the input. In some embodiments, the electronic device also displays, via the one or more display generation components, a second option to associate the respective portion of the input with second content that satisfies the second criterion and is different from the first content. In some embodiments, the second option is an option that includes a non-ambiguous interpretation of the portion of the input. In some embodiments, the electronic device displays more than two options (e.g., three, four, five, and/or ten) options with content that satisfies the second criterion. In some embodiments, the options (e.g., the first and the second option) displays the respective content in font-based text. In some embodiments, the options display the respective content corresponding to an interpretation of the mathematical equation that satisfies the second criterion. In some embodiments, the electronic device uses artificial intelligence and/or machine learning to generate options that causes the input to satisfy the second criterion. Displaying options to resolve the portion of the input that is ambiguous in response to detecting an input selecting the portion of the input that is ambiguous allows the user to quickly and efficiently identify and resolve the error, thereby reducing erroneous inputs to the electronic device.

In some embodiments, while displaying the option to associate the respective portion of the input with first content that satisfies the second criterion, the electronic device detects, via the one or more input devices, a third input, such as an input via stylus 203 shown in FIG. 6H. In some embodiments, the third input has one or more characteristics of the second input, as described above. In some embodiments, the third input is directed towards the first option or the second option.

In some embodiments, in response to detecting the third input, in accordance with a determination that the third input is directed towards a first option, updating the representation of the input to include the first content, such as if the electronic device receives an input via stylus 203 directed towards options 646a and/or 648a in FIG. 6H, and the electronic device 500 updates text 620 and 626, respectively, with the selected option in FIG. 6I. In some embodiments, updating the representation of the input includes changing the portion of the input that did not satisfy the second criterion to include the first content and not updating the portion of the input that satisfies the second criterion. In some embodiments, updating the representation of the input also includes displaying the information corresponding to the solution since the equation now satisfies the one or more criteria.

In some embodiments, in response to detecting the third input, in accordance with a determination the third input is directed towards a second option, and the electronic device updates the representation of the input to include the second content, such as the electronic device receives an input via stylus 203 directed towards options 646b and/or 648b shown in FIG. 6H, and the electronic device 500 updates text 620 and 626, respectively, with the selected option shown in FIG. 6I. In some embodiments, updating the representation of the input includes changing the portion of the input that did not satisfy the second criterion to include the second content and not updating the portion of the input that satisfies the second criterion. Alternatively, in some embodiments, the electronic device updates the representation of the input to include the second content including updating the portion of the input that satisfies the second criterion. In some embodiments, updating the representation to include the respective content includes updating the information corresponding to the solution (e.g., solving the mathematical equation and displaying the information corresponding to the solution). In some embodiments, updating the representation of the input includes displaying the updated representation including the second content in handwriting (e.g., if the original representation was also displayed in handwriting). In some embodiments, updating the representation of the input includes displaying the updated representation including the second content in font-based text (e.g., if the original representation was also displayed in font-based text). In some embodiments, updating the representation of the input includes displaying the representation of the input with the same characteristics as the original representation of the input (e.g., with the same style characteristics as the original input), as described above. Automatically updating the equation to include the selected option ambiguous allows the user to quickly and efficiently identify and resolve the error, thereby reducing erroneous inputs to the electronic device.

In some embodiments, the second criterion requires that the mathematical equation includes a mathematical operation from a respective set of mathematical operations and that the mathematical equation does not include a mathematical operation not from the respective set of mathematical operations (e.g., the mathematical equation includes an unsupported mathematical operation, as described above, and/or the mathematical equation results in an undefined number or a number that is out of range), such as text 622 and 624 shown in FIG. 6G.

In some embodiments, the determination that the first portion of the input fails to satisfy the second criterion includes a determination that the first portion of the input corresponds to an operation not from the respective set, such as the portion highlighted by indication 630 and 632 shown in FIG. 6G. For example, operations not in the predefined list includes dividing by zero, operations that result in an excessive large number (e.g., large power equations such as 3\hat{ }7\hat{ }23), or other undefined operations. In some embodiments, the second portion of the input optionally satisfies the second criterion. In some embodiments, the second portion of the input optionally does not satisfy the second criterion because the second portion of the input is not from the respective set.

In some embodiments, the determination that the second portion of the input fails to satisfy the second criterion includes a determination that the second portion of the input corresponds to an operation not from the respective set, such as the portion highlighted by indication 630 and 632 shown in FIG. 6G. In some embodiments, the first portion of the input optionally satisfies the second criterion. In some embodiments, the first portion of the input optionally does not satisfy the second criterion because the second portion of the input is not from the respective set. In some embodiments, the portion of the input that does not satisfy the second criterion because the mathematical operation is not from the predefined list includes displaying the respective portion of the input with the third value for the visual characteristics, as described above. In some embodiments, in response to detecting an input directed towards the respective portion of the input that fails to satisfy the second criterion, the electronic device displays a visual indication indicating that the portion of the input is “undefined”. In some embodiments, if a portion of the input fails to satisfy the second criterion, then the electronic device does not display information corresponding to the solution. Displaying a visual indication indicating that the electronic device cannot solve the mathematical equation allows the user to quickly and efficiently identify the error, thereby reducing erroneous inputs to the electronic device.

In some embodiments, the one or more criteria further includes a second criterion that is satisfied in accordance with a determination that the mathematical equation is complete, such as the text 604 including equals signs in FIG. 6A. In some embodiments, the second criterion is satisfied when the electronic device detects that the user has inputted (e.g., by handwriting or font-based text) an equals sign. In some embodiments, the second criterion is satisfied when the electronic device detects that the user has not inputted (e.g., by handwriting or font-based text) text for a threshold amount of time (e.g., 1 second, 5 seconds, 10 seconds, 30 seconds, or 1 minute). In some embodiments, the second criterion is satisfied when the electronic device detects an input directed towards an option that is selectable to solve the respective mathematical equation, as described in greater detail above.

In some embodiments, in accordance with the determination that the input satisfies at least the criterion that is satisfied when the input includes the mathematical equation and the second criterion, the electronic device displays, via the one or more display generation components, the information corresponding to the solution to the mathematical equation, such as after the electronic device 500 detects the text 604 including the equals sign in FIG. 6A, the electronic device 500 displays the solution 608 in FIG. 6B. In some embodiments, if the second criterion is not satisfied, the electronic device does not display the information corresponding to the solution. In some embodiments, and as described above, the information corresponding to the solution is displayed with the same visual characteristics as the mathematical equation corresponding to the input. Alternatively, in some embodiments, the information corresponding to the solution is displayed with a different visual characteristic as the mathematical equation corresponding to the input. Displaying the information corresponding to the solution after detecting that the mathematical equation is complete allows the user to efficiently view the solution without additional inputs, thereby reducing erroneous inputs to the electronic device.

In some embodiments, the second criterion is satisfied when the electronic device has not detected text entry input for at least a threshold amount of time, such as if the electronic device 500 did not detect a text entry input after detecting the input including text 604 shown in FIG. 6A. For example, the user is finished writing the mathematical equation. In some embodiments, the electronic device does not detect a handwritten input or a font-based text input for the threshold amount of time. In some embodiments, the threshold amount of time is 1 second, 5 seconds, 10 seconds, 30 seconds, or 1 minute, as described above. Displaying the information corresponding to the solution after detecting that the mathematical equation is complete allows the user to efficiently view the solution without additional inputs, thereby reducing erroneous inputs to the electronic device.

In some embodiments, the second criterion is satisfied when the input includes an equals sign, such as the text 604 including the equals sign in FIG. 6A. In some embodiments, the equals sign indicated that the user is finished writing the mathematical equation. In some embodiments, the second criterion is satisfied when the input includes an equals sign and the electronic device has not detected the input for the threshold amount of time. In some embodiments, the second criterion is satisfied when the input includes an equals sign after the other components of the input (e.g., the user writes an equals sign after writing the other portions of the equation). Displaying the information corresponding to the solution after detecting that the mathematical equation is complete allows the user to efficiently view the solution without additional inputs, thereby reducing erroneous inputs to the electronic device.

In some embodiments, in accordance with a determination that the user interface including the content entry region is associated with a first application (e.g., notes application), the one or more first criteria is a first set of one or more criteria, such as the first application including user interface 600 shown in FIG. 6A. In some embodiments, while in the user interface is associated with the first application, the one or more criteria includes the criterion that is satisfied when the electronic device receives an input directed towards an indication of completion, as described above. For example, the electronic device does not automatically display the information corresponding to the solution without an additional input from the user (e.g., the input selecting an option to display the information corresponding to the solution, as described above).

In some embodiments, in accordance with a determination that the user interface including the content entry region is associated with a second application (e.g., calculator application), the one or more first criteria is a second set of one or more criteria, different from the first set of one or more criteria, such as the second application including user interface 687 shown in FIG. 6X. In some embodiments, while in the user interface is associated with the second application, the one or more criteria includes the criterion that is satisfied when the electronic device determines that the input is complete, as described above. For example, the electronic device automatically display the information corresponding to the solution without an additional input from the user (e.g., after detecting that the input includes an equals sign and/or after detecting that there is no longer an input for a threshold amount of time). In some embodiments, the information corresponding to the solution is displayed without first displaying an option and detecting an input selecting the option. Automatically changing the one or more criteria based on which application the user interface is located in allows the user to view the solution appropriately without additional inputs, thereby reducing erroneous inputs to the electronic device.

In some embodiments, the mathematical equation further includes a variable, such as text 662a including the variable x, shown in FIG. 6P. In some embodiments, while displaying the mathematical equation and while the variable is associated with a first numerical quantity (e.g., the mathematical equation includes a variable and the user assigns a numerical quantity to the variable), the electronic device displays, via the one or more display generation components, first information corresponding to the solution based on the first numerical quantity of the variable, such as solutions 670e and 670f shown in FIG. 6P based on if variable x is equal to five (e.g., text 672a assigning five to x). In some embodiments, the electronic device displays the information corresponding to the solution by using the first numerical quantity in place of the variable.

In some embodiments, the electronic device detects, via the one or more input devices, a second input corresponding to a request to change the numerical quantity of the variable, such as the one or more inputs via stylus 203 shown in FIGS. 6P and 6Q. In some embodiments, the second input has one or more characteristics of the input described above. In some embodiments, the second input is a typing input to change the numerical quantity of the variable from the first numerical quantity to a second numerical quantity. In some embodiments, the second input is an input including a hover input (e.g., using a contact such as a finger or an indirect input device such as a stylus). In response to detecting the hover input, the electronic device displays a slider that is used to change the numerical quantity of the variable using a sliding input (e.g., a tap and drag using a contact). In some embodiments, the second input is a selection input, as described above (e.g., a tap with a finger or a click with a mouse), directed towards the first numerical quantity of the variable. In response to detecting the selection input, the electronic device displays a slider that is used to change the numerical quantity of the variable.

In some embodiments, in response to detecting the second input, the electronic device updates, via the one or more display generation components, the information corresponding to the solution from the first information to second information different from the first information and based on a second numerical quantity of the variable in accordance with the second input, such as shown by solutions 670i and 670j, which are solutions if the variable x is equal to 100, shown in FIG. 6S. In some embodiments, in response to detecting the second input, the electronic device updates the display of the numerical quantity from the first numerical quantity to the second numerical quantity. In some embodiments, in response to the input, the electronic device displays the information corresponding the solution based on the second numerical quantity. Changing the solution to the mathematical equation automatically after detecting a change in the numerical quantity of the variable reduces the number of inputs needed to modify and solve an equation, thereby reducing erroneous inputs to the electronic device.

In some embodiments, while displaying the mathematical equation including the variable and while the variable is associated with the first numerical quantity, the electronic device displays, via the one or more display generation components, a second mathematical equation including the variable and third information corresponding to a solution to the second mathematical equation, such as text 662a and 662b shown in FIG. 6S both including the variable “x”. For example, the first equation is “3x+2” and the second equation is “4x−5”. Both equations use the same variable “x” with the same first numerical quantity but the respective information corresponding to the solution is different. In some embodiments, the user inputs the second mathematical equation using handwritten text or font-based text.

In some embodiments, in response to detecting the second input, the electronic device updates, via the one or more display generation components, the information corresponding to the solution to the second mathematical equation to fourth information based on the second numerical quantity of the variable, such as the electronic device 500 displaying solution 670j corresponding to text 662b shown in FIG. 6S. In some embodiments, in response to detecting the second input, described in greater detail above, the electronic device updates the information corresponding to the solution for the respective mathematical equations including the variable. In some embodiments, the respective information corresponding to the solution is displayed with the same respective visual characteristics of the respective mathematical equation. Alternatively, in some embodiments, the electronic device only updates the mathematical equation including the variable and not the second mathematical equation. Updating the solution to multiple mathematical equation automatically after detecting a change in the numerical quantity of the variable associated with the multiple mathematical equations reduces the number of inputs needed to modify and solve an equation, thereby reducing erroneous inputs to the electronic device.

In some embodiments, the second input further includes a movement of a scrubber element to update the variable from the first numerical quantity to the second numerical quantity, such as shown by the inputs including stylus 203 directed towards scrub bar 678b and 678c shown in FIG. 6T. In some embodiments, and as described above, in response to the selection input and/or the hover input, the electronic device displays the scrubber element. In some embodiments, the electronic device receives a tap and drag from left to right (e.g., using a contact such as a finger and/or a stylus directed towards the scrubber element) to decrease the numerical quantity (e.g., the second numerical quantity is smaller than the first numerical quantity). In some embodiments, the electronic device receives a tap and drag from right to left to increase the numerical quantity (e.g., the second numerical quantity is larger than the first numerical quantity). Displaying a scrubber element to change the variable allows the user to easily and efficiently change the variable, thereby reducing erroneous inputs to the electronic device.

In some embodiments, updating the variable based on the second input includes in accordance with a determination that the first numerical quantity is a first type of number, updating the variable based on a first rate of change per unit movement in the second input, such as updating the variable x from 5 to 100 shown in FIG. 6S in response to the input via stylus 203 directed towards bar 678a shown in FIG. 6R. In some embodiments, the first type of number is a number with a first amount of significant figures or a first magnitude (e.g., absolute value). In some embodiments, the first rate of change is based on the first type of number, as described below. In some embodiments, the rate of change is based on the approximate magnitude of the number (e.g., the rate of change includes scrubbing through numbers that make a material impact on the value such as a larger rate of change for larger numbers) or based on the number of signification figures.

In some embodiments, updating the variable based on the second input includes in accordance with a determination that the first numerical quantity is a second type of number, updating the variable based on a second rate of change, different from the first rate of change, per unit movement in the second input, such as if the variable x had a different number of significant figures or a different absolute value shown in FIGS. 6R and 6S. In some embodiments, the second type of number is a number with a second amount of significant figures or a second magnitude (e.g., absolute value). In some embodiments, the second rate of change is based on the second type of number, as described below. Basing the rate of change on the type of number allows the user to scrub through numbers efficiently, thereby reducing erroneous inputs to the electronic device.

In some embodiments, the first type of number has a first number of significant figures and the first rate of change is a change based on the first number of significant figures, such as shown by text 672a (e.g., the variable x=5, which has 1 significant figure) in FIG. 6R, and the rate of change is based on one significant figure (e.g., x=5 to x=100 by 1 s), shown in FIG. 6S. In some embodiments, numbers of similar quantities (e.g., numbers that have the same number of significant figures) have the same rate of change. For example, the first number is “4” and has one significant figure. In some embodiments, the rate of change would be based on one significant figure such as changing 4 to 5 or 4 to 3.

In some embodiments, the second type of number has a second number of significant figures different from the first number of significant figures and the second rate of change is a change based on the second number of significant figures, such as if text 672a shown in FIG. 6R assigned x=0.23, and the rate of change would be based on 2 significant figures (e.g., x=0.23 to x=0.74 by 0.01 s). In some embodiments, numbers with more significant figures have a slower rate of change. For example, the second number is 4.02 and the second rate of change is based on two significant figures. In some embodiments, the rate of change includes changing 4.02 to 5.02 by 0.01 increments. In some embodiments, the electronic device uses a rate of change that adjusts the value of the number at a respective location after the first significant figure (or a second significant figure, or a third significant figure). For example, the electronic device adjusts by 10 s for 430 or 400, adjusts by Is for 43 or 40, adjust by 0.1 for 4.3 or for 4, adjusts by 0.01 for 0.43 or 0.4. Basing the rate of change on the type of number allows the user to scrub through numbers efficiently, thereby reducing erroneous inputs to the electronic device.

In some embodiments, the first type of number has a first value of a constant and the first rate of change is a change based on the first value of the constant, such as shown by text 672c and 672d including x=0.00742 and z=742 respectively, shown in FIG. 6T changing to x=0.00762 and z=762 respectively in FIG. 6U. Specifically, even though the numbers have different absolute values, the rate of change is by the second significant figure. In some embodiments, as described above, numbers of similar quantities (e.g., same number of constants) have the same rate of change. For example, the first number is 324.236 and the rate of change is by 10 s-100 s.

In some embodiments, the second type of number has a second value of a constant and the second rate of change is based on the second value of the constant, such as if the numbers assigned to the variables in text 670c and 672d changed by a different rate of change (e.g., changed by a different significant figure (the third significant figure instead of the second). In some embodiments, numbers of with more constants have a higher rate of change. For example, the second number is 2000.01 and the rate of change is by 1000 s. Basing the rate of change on the type of number allows the user to scrub through numbers efficiently, thereby reducing erroneous inputs to the electronic device.

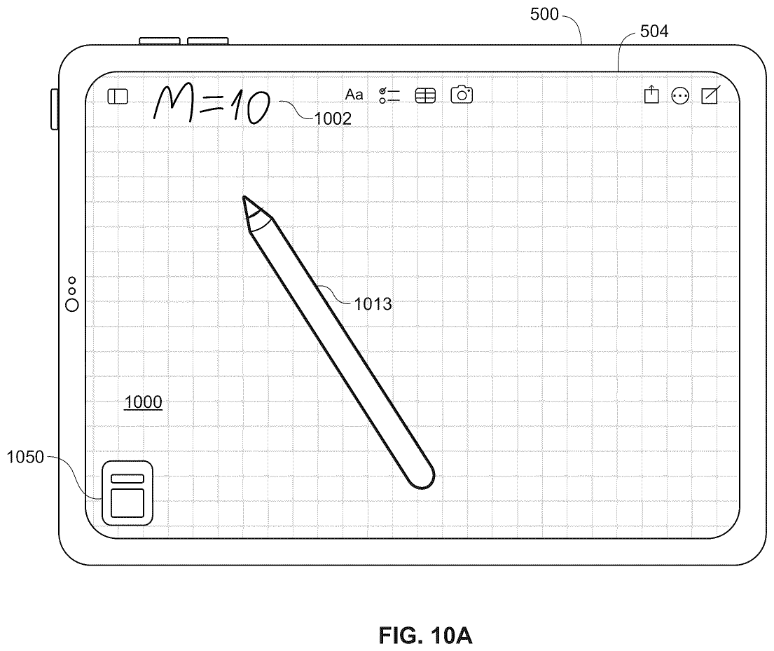

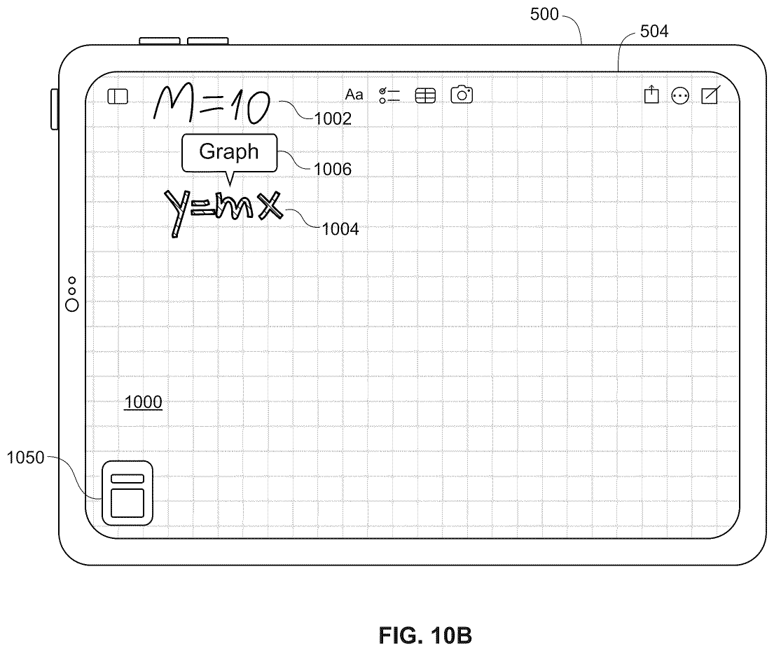

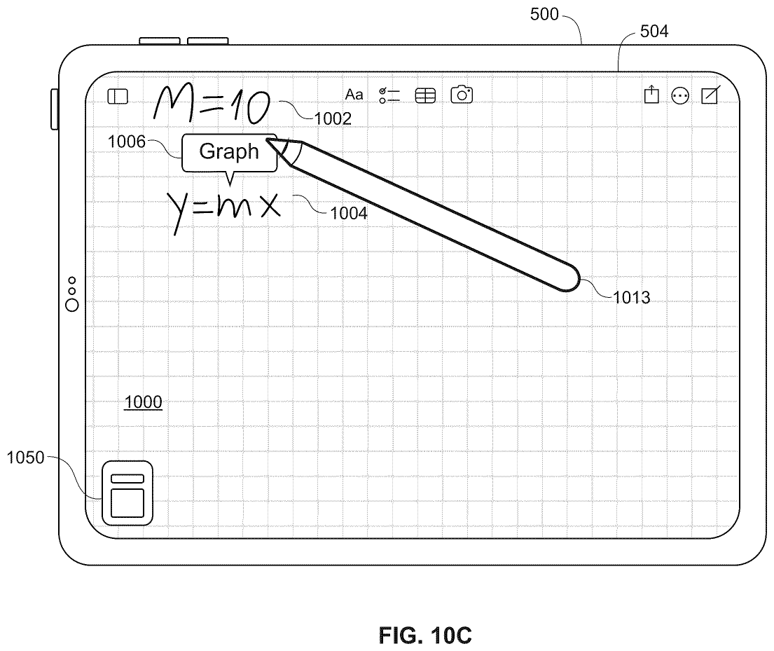

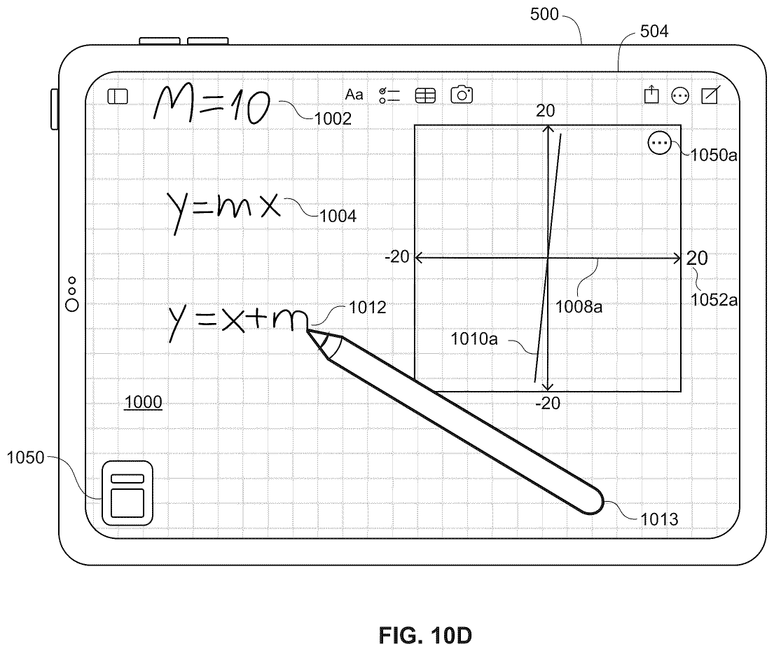

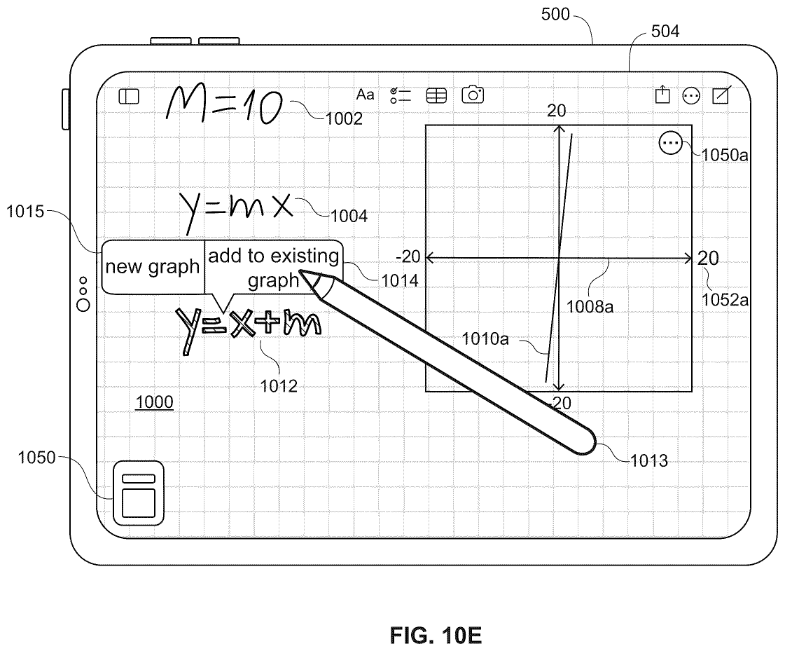

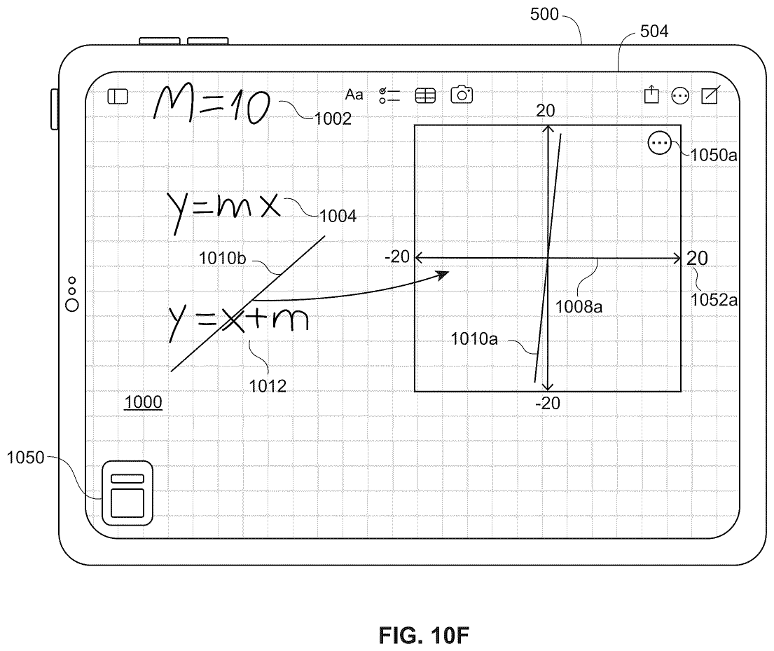

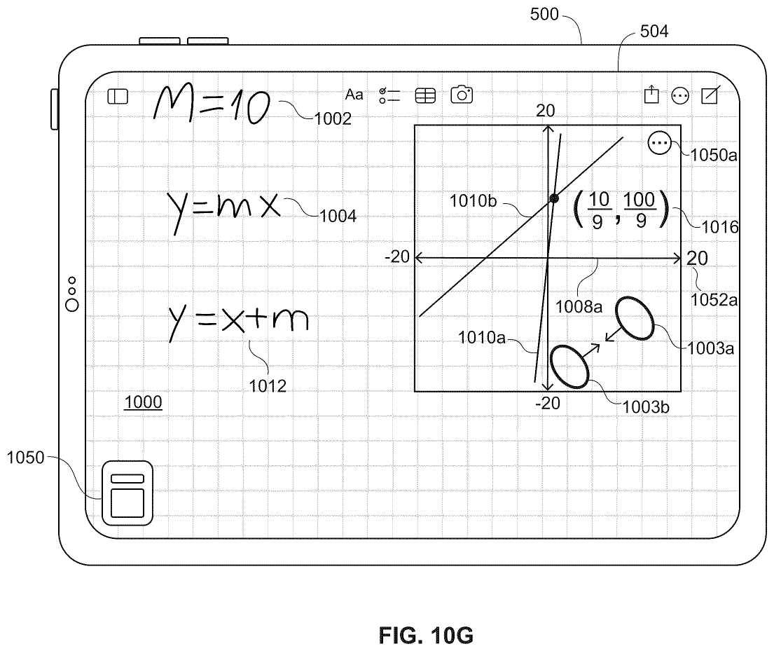

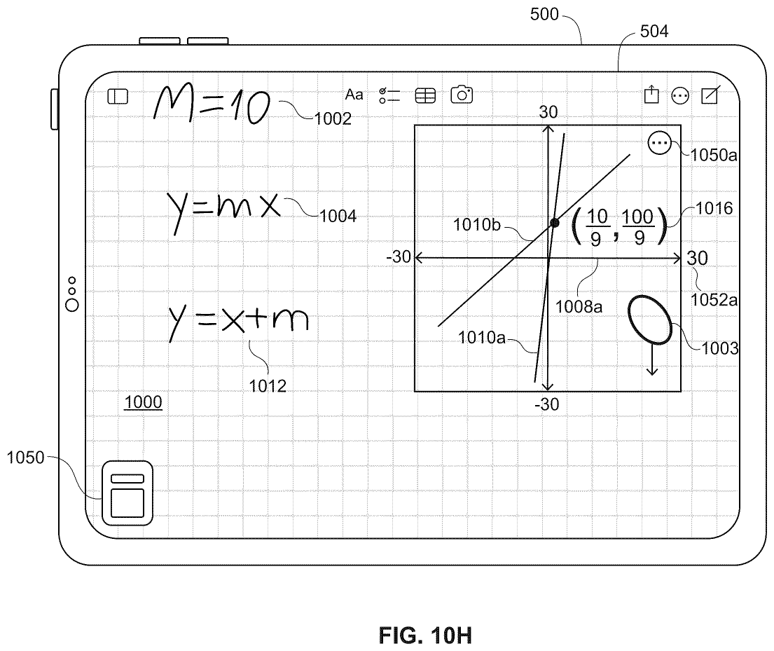

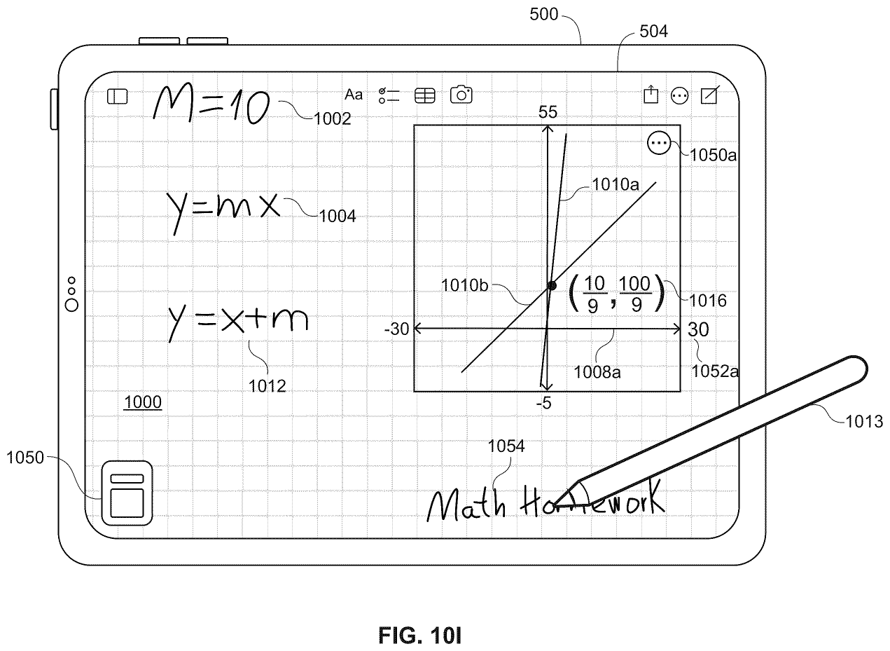

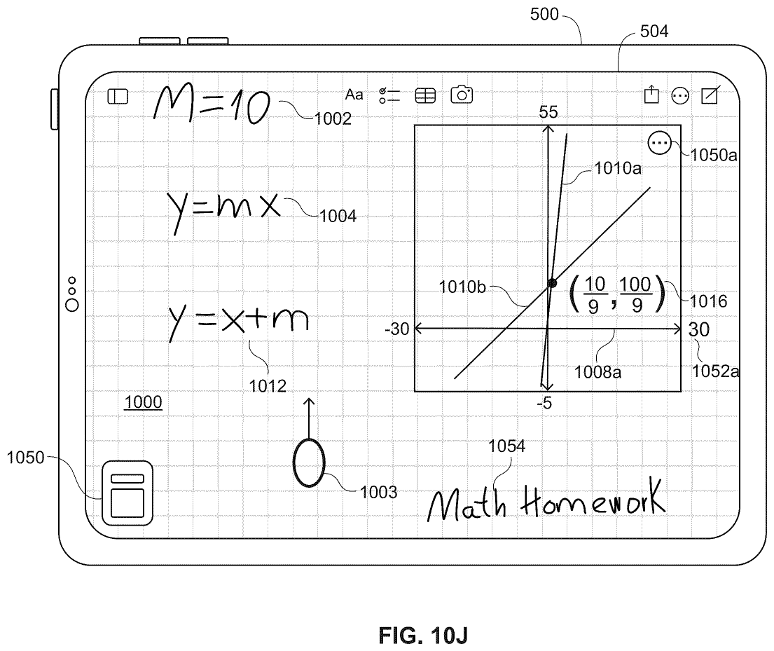

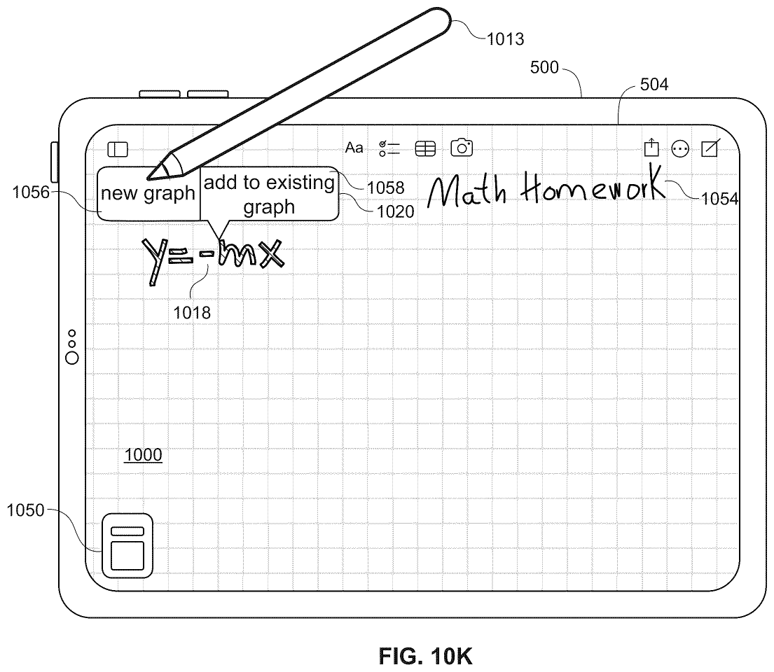

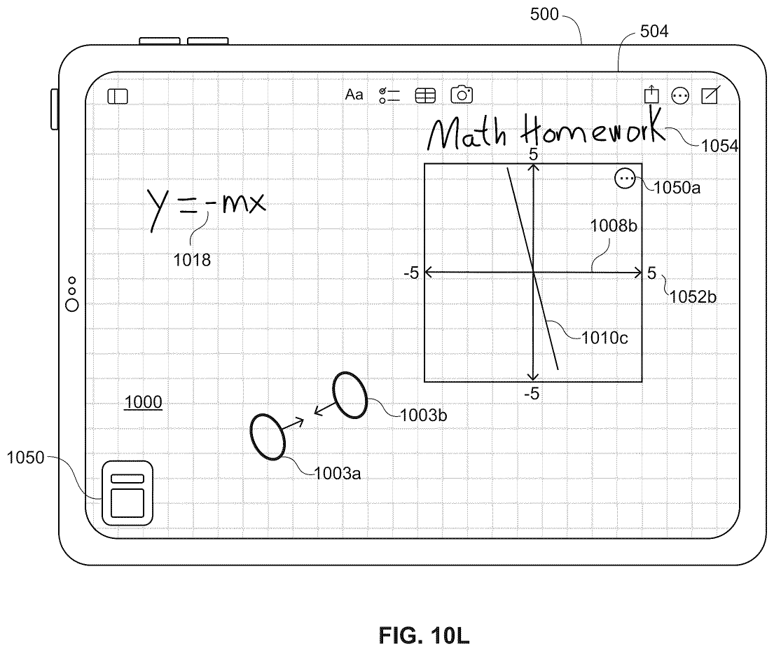

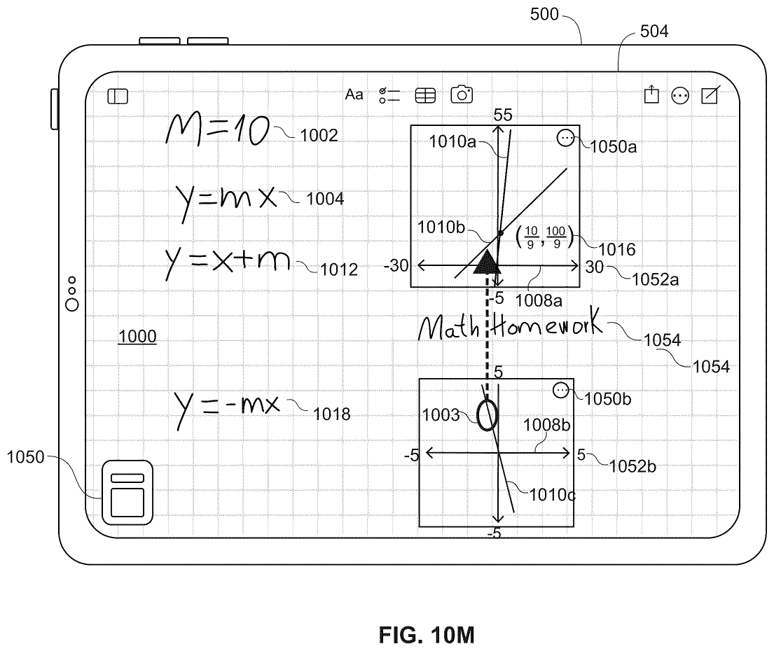

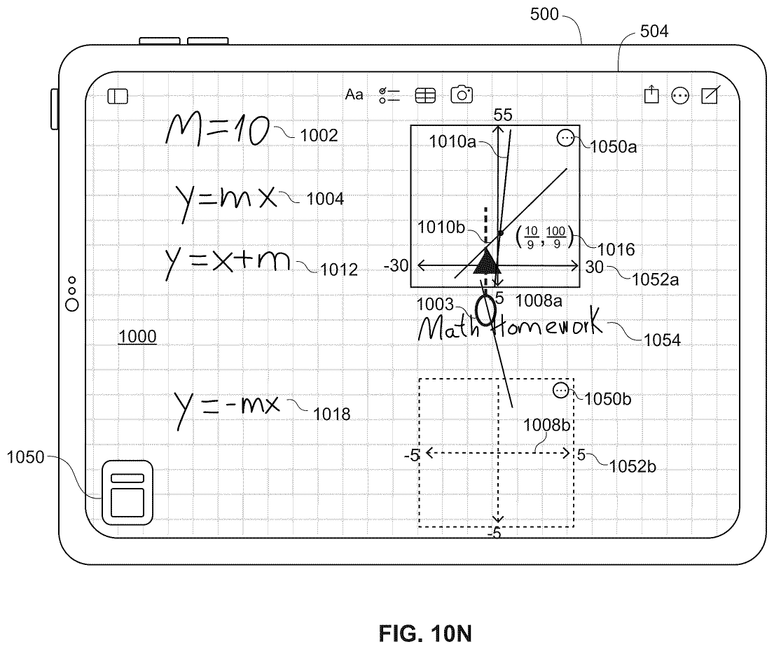

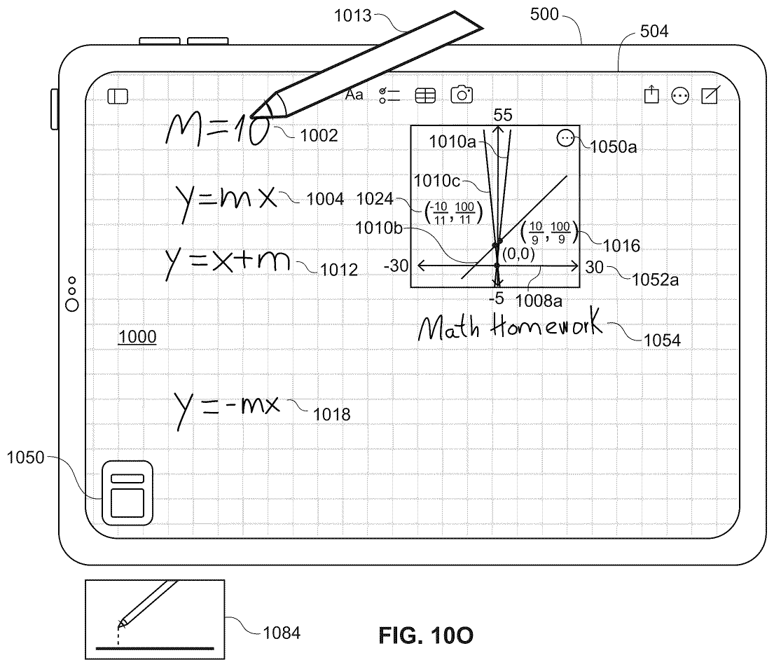

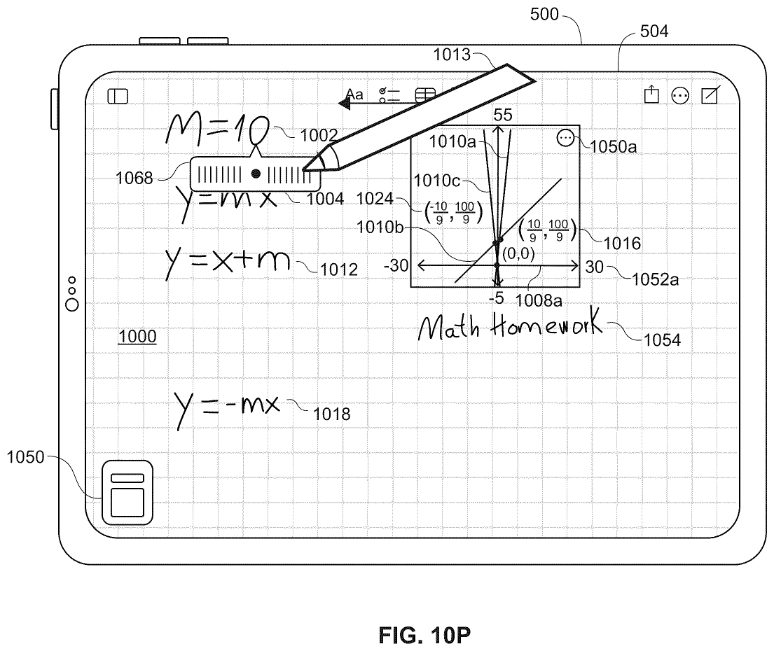

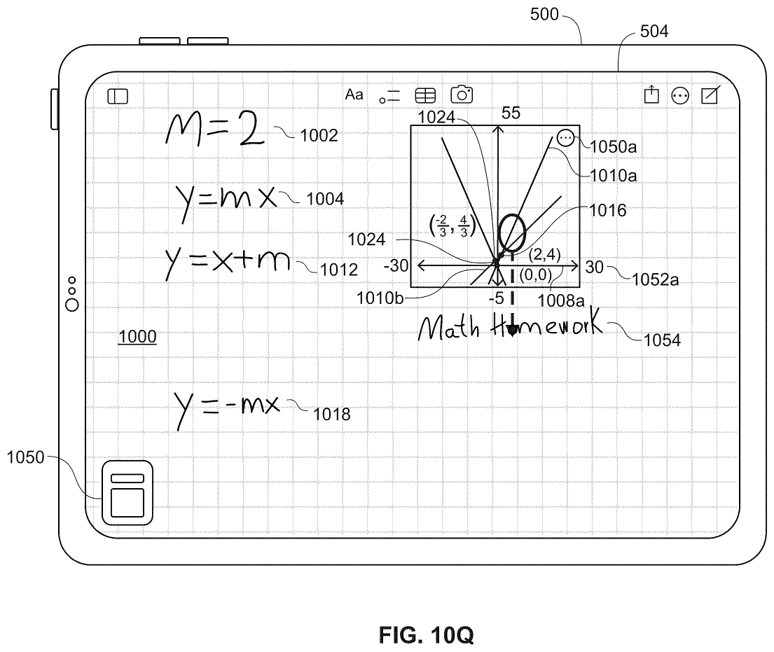

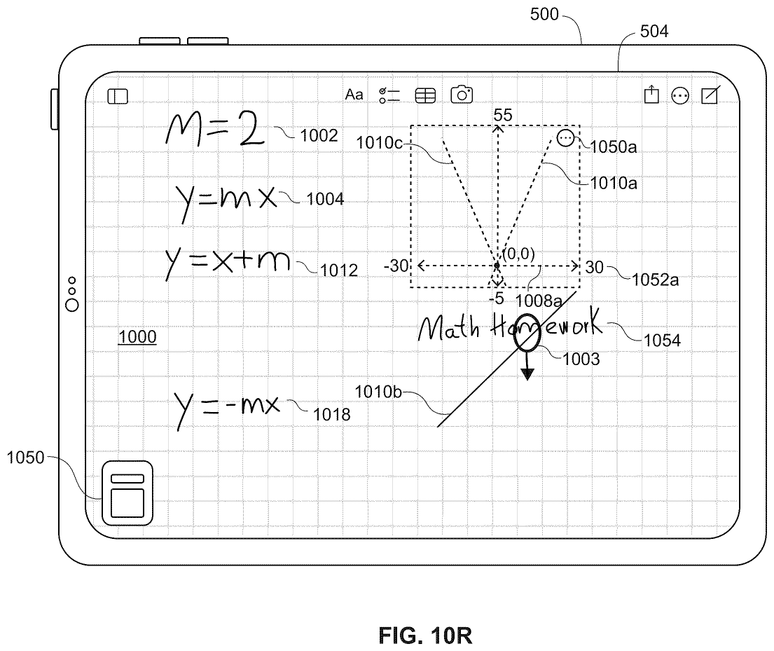

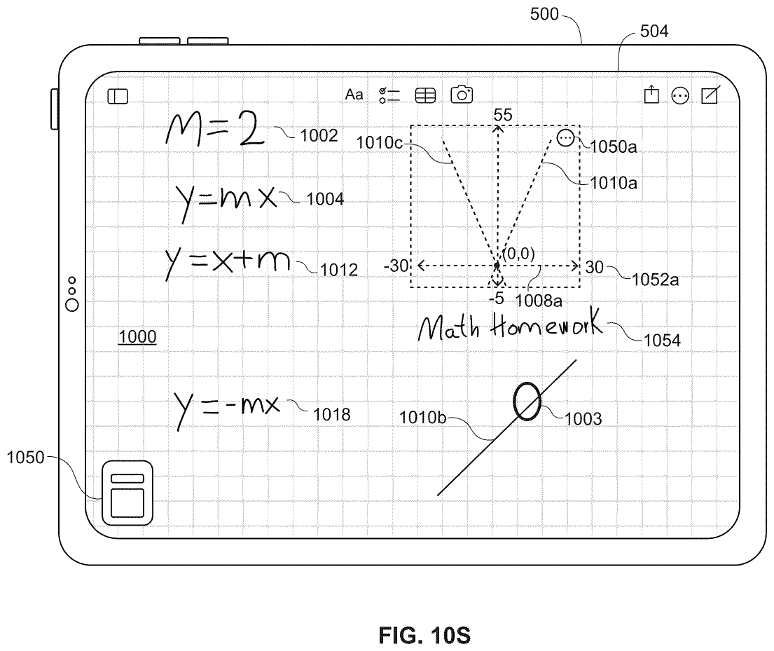

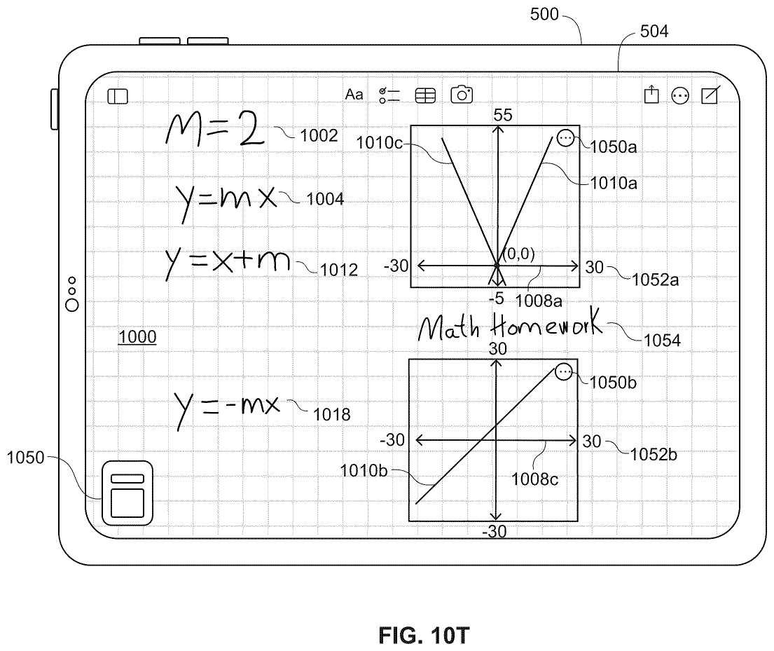

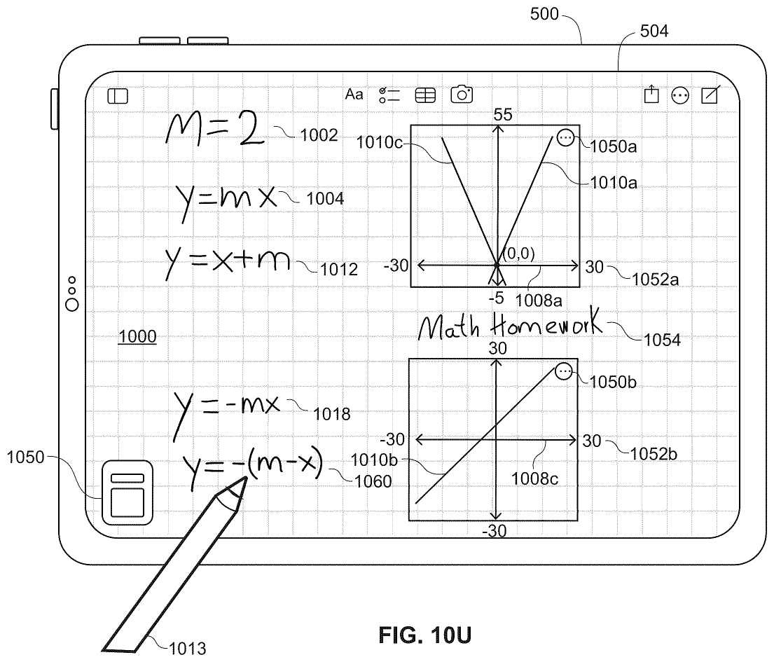

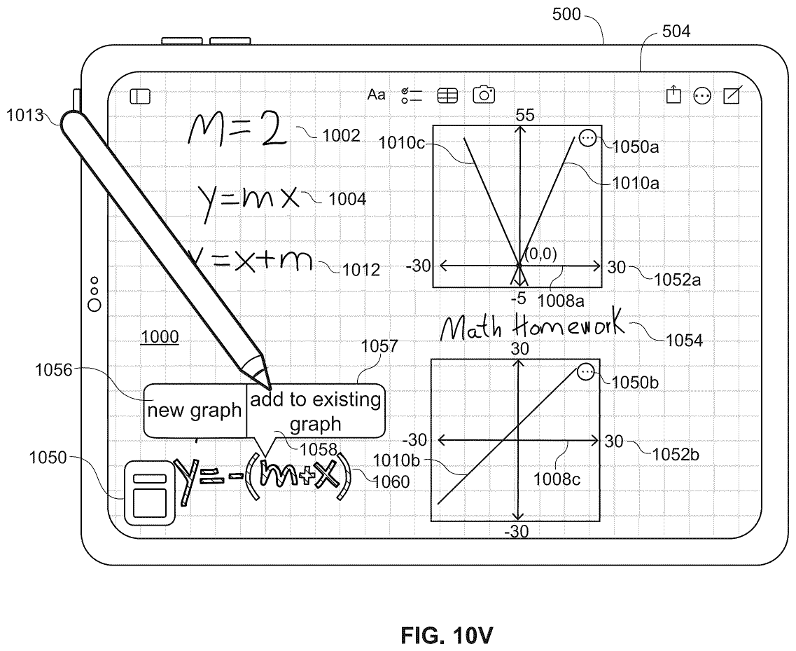

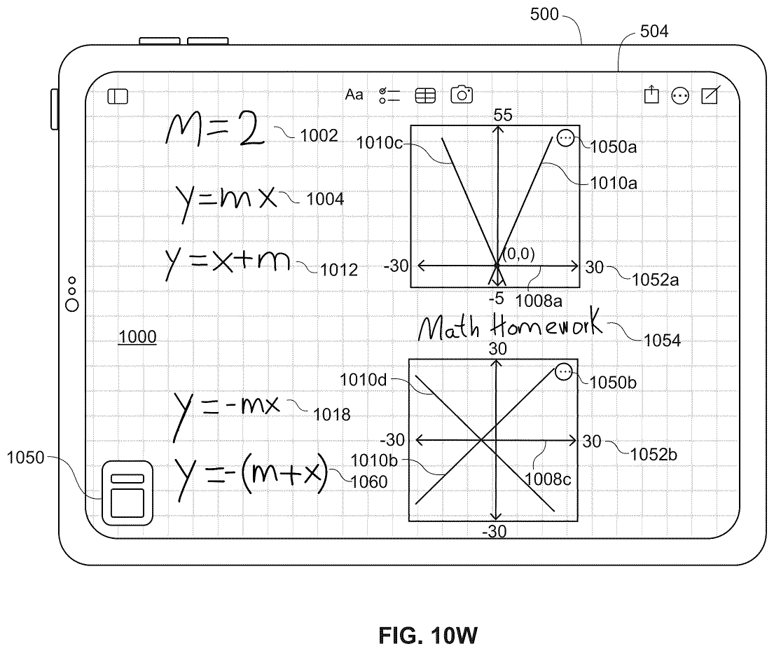

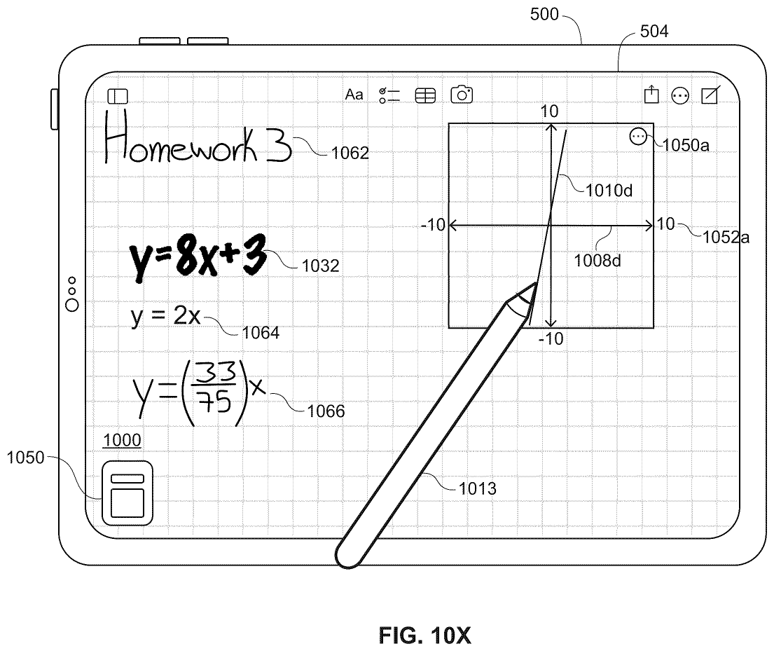

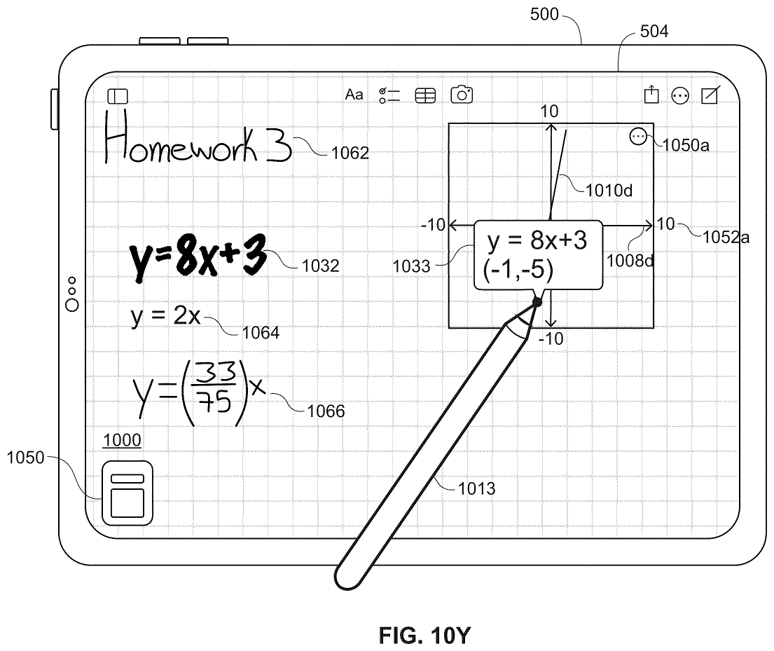

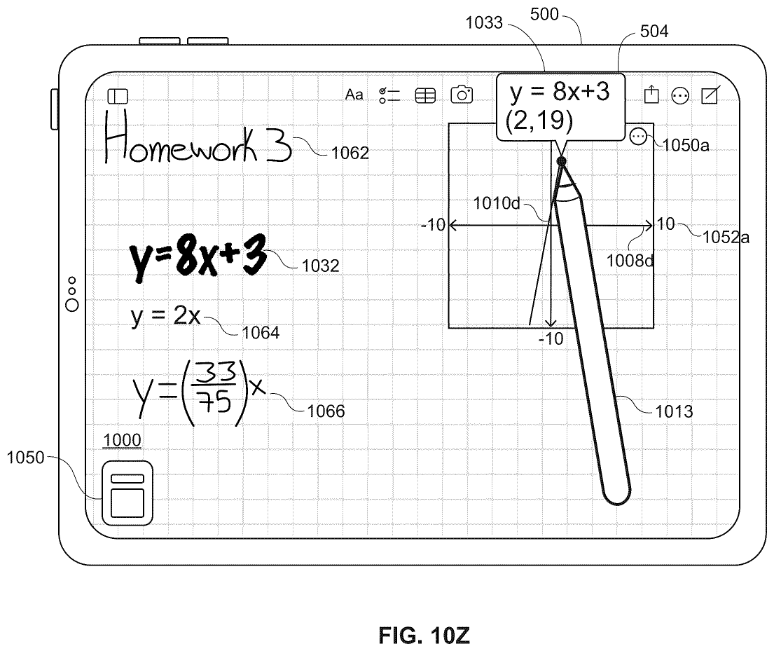

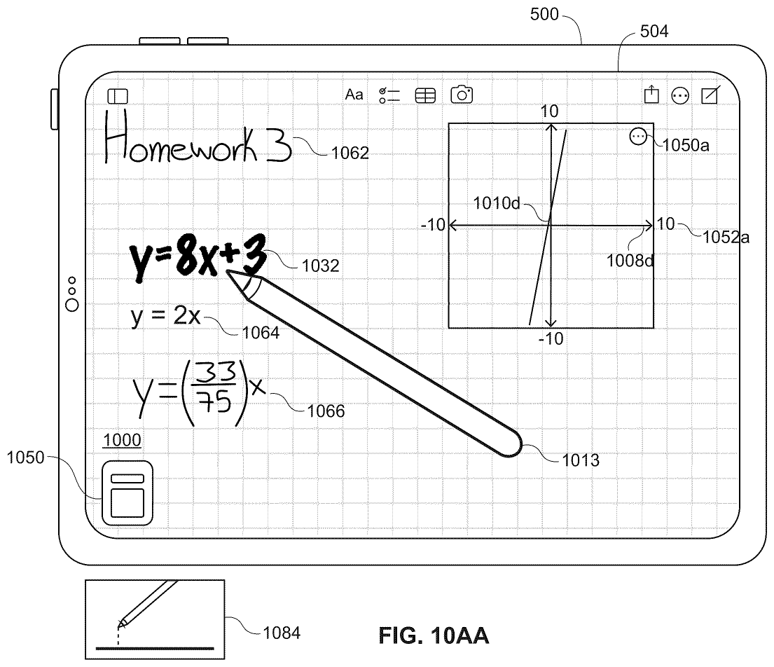

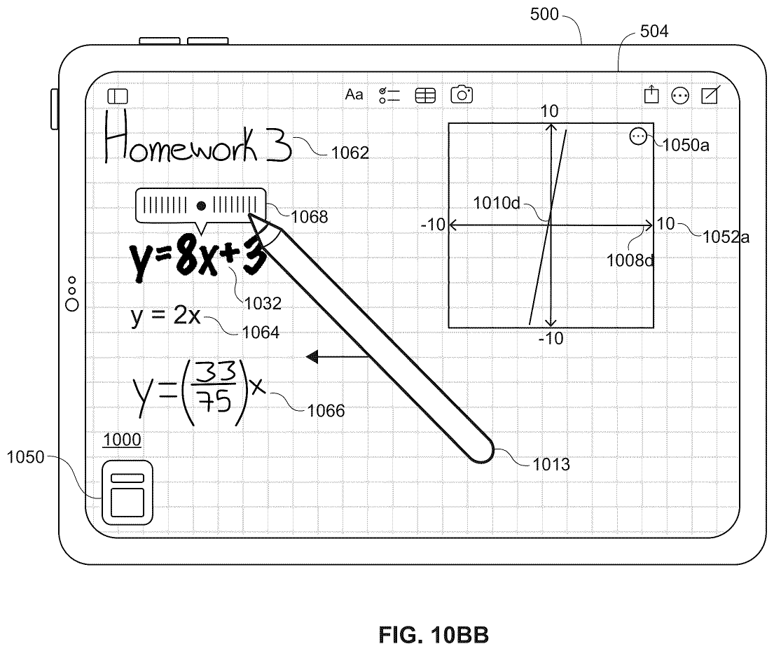

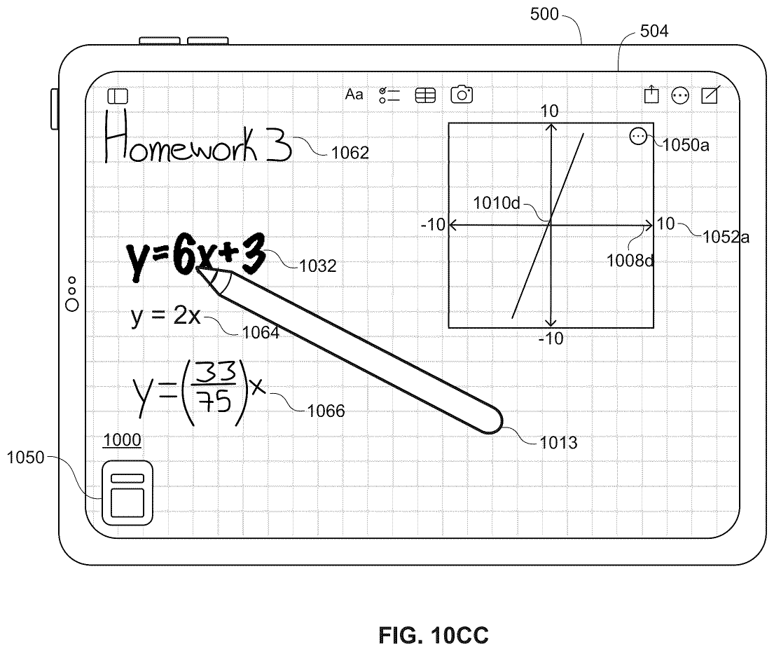

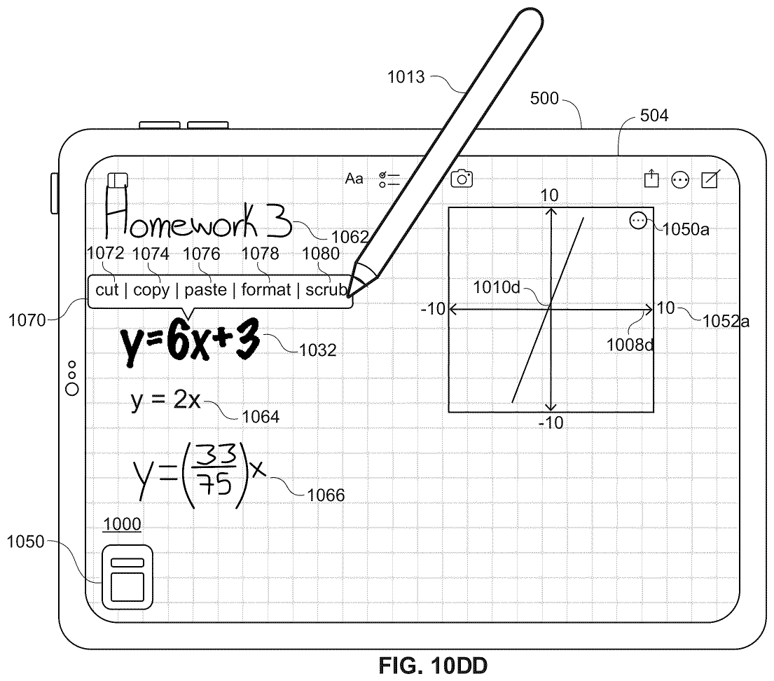

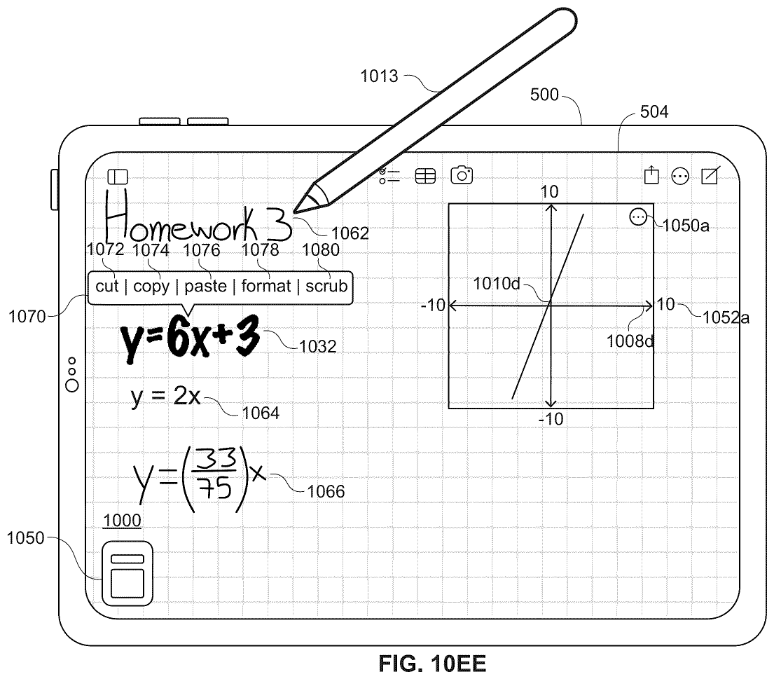

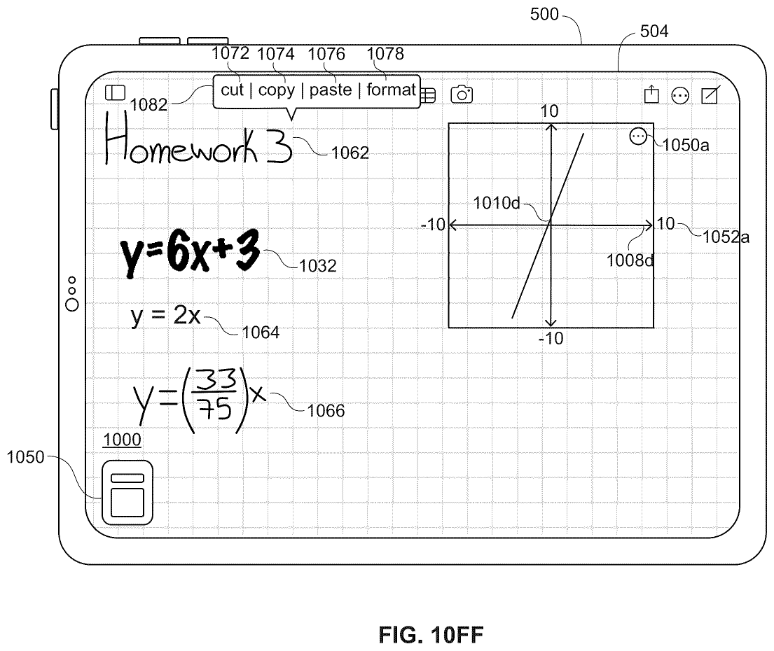

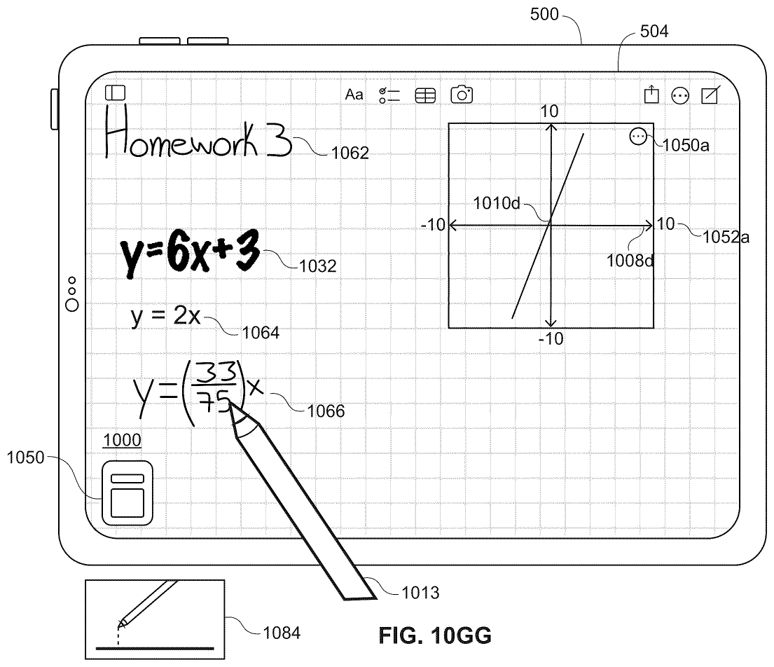

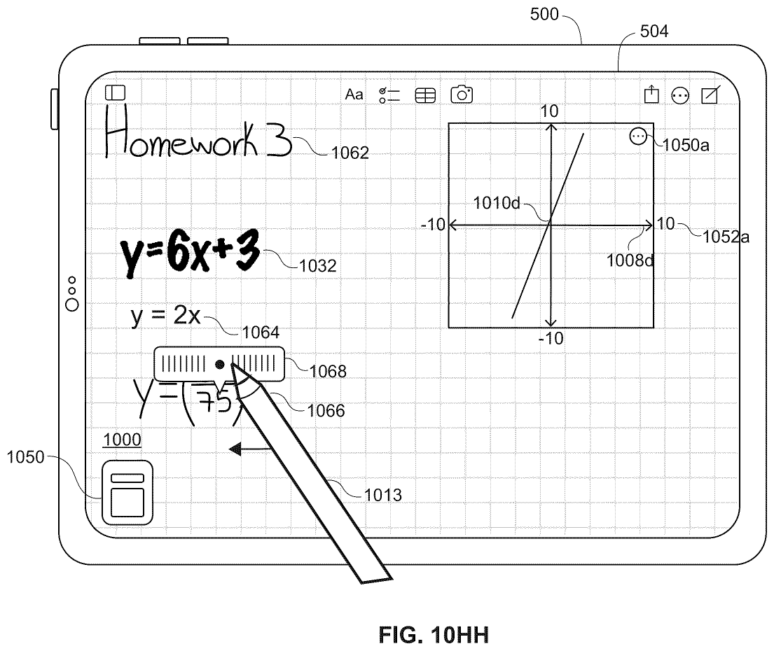

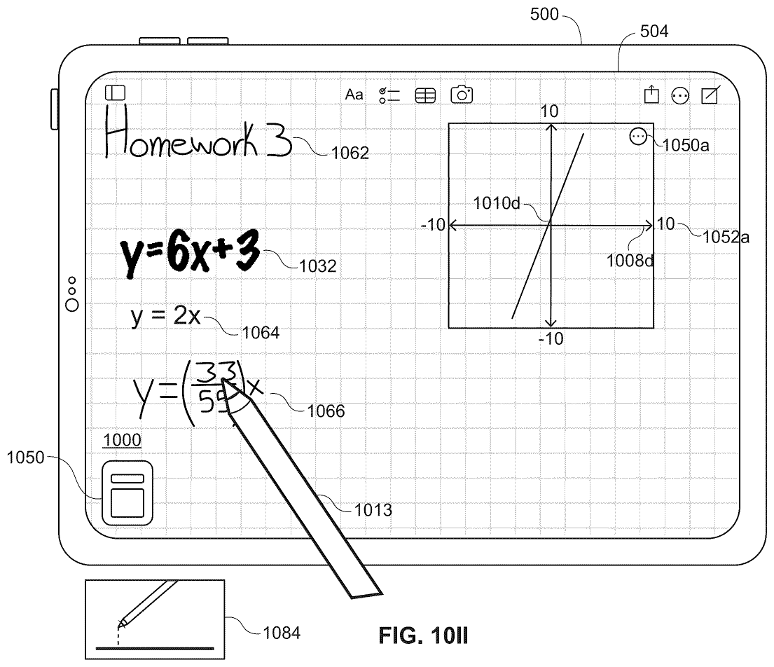

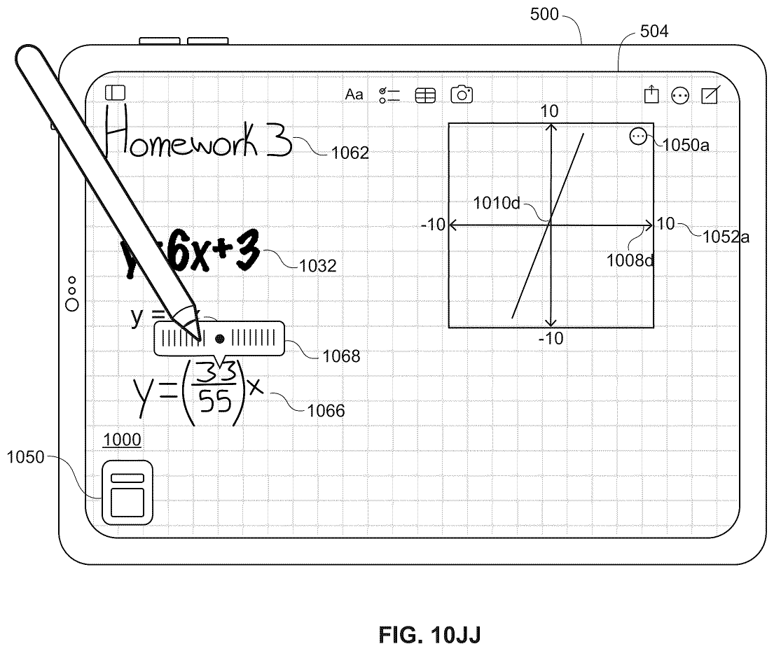

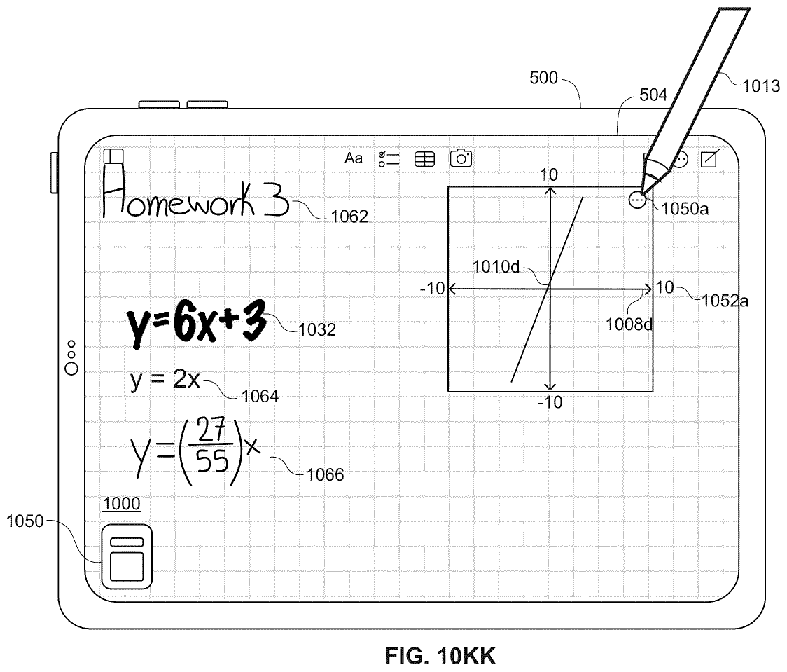

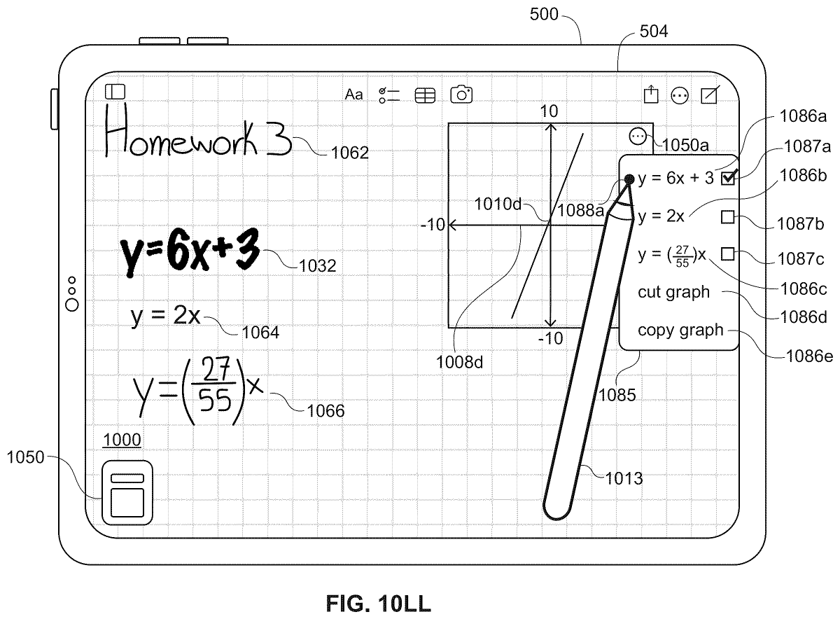

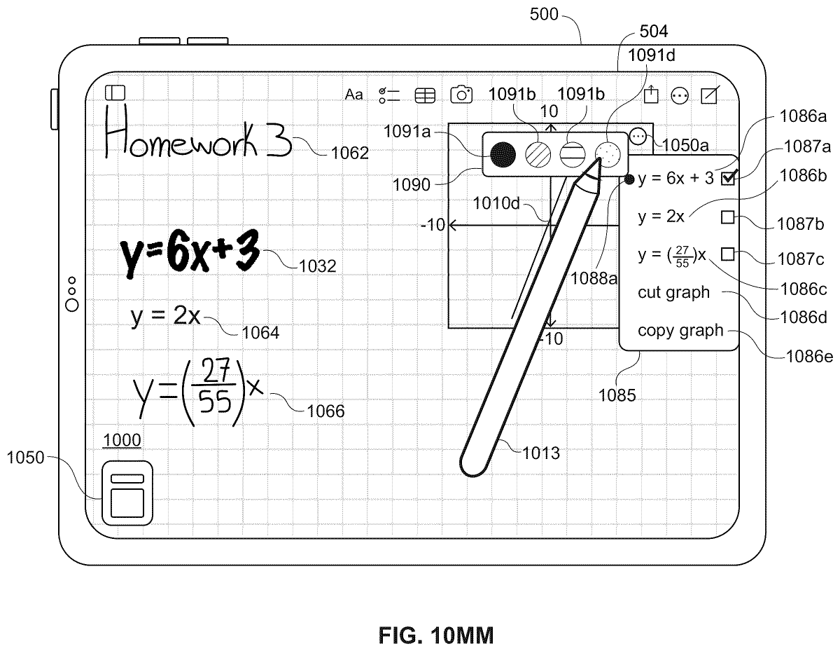

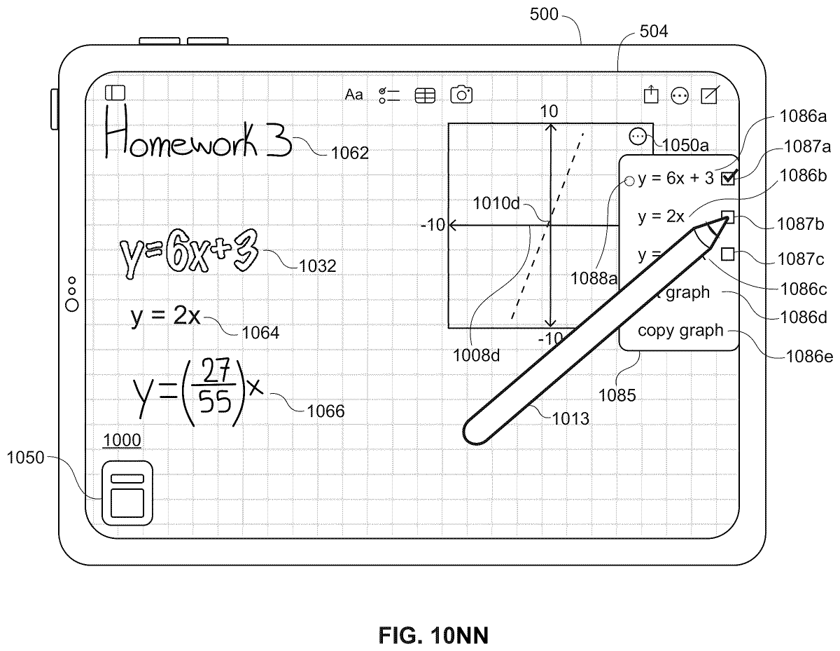

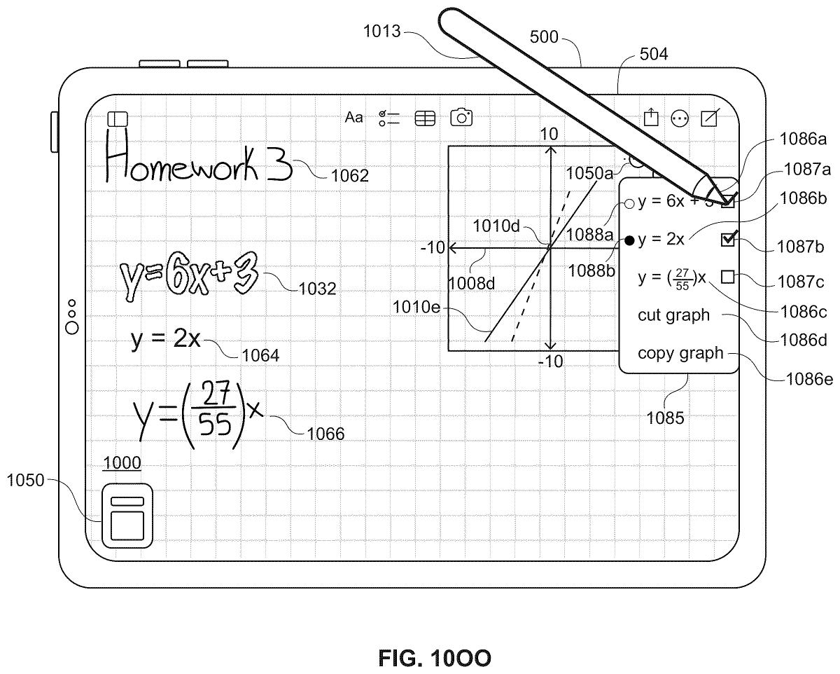

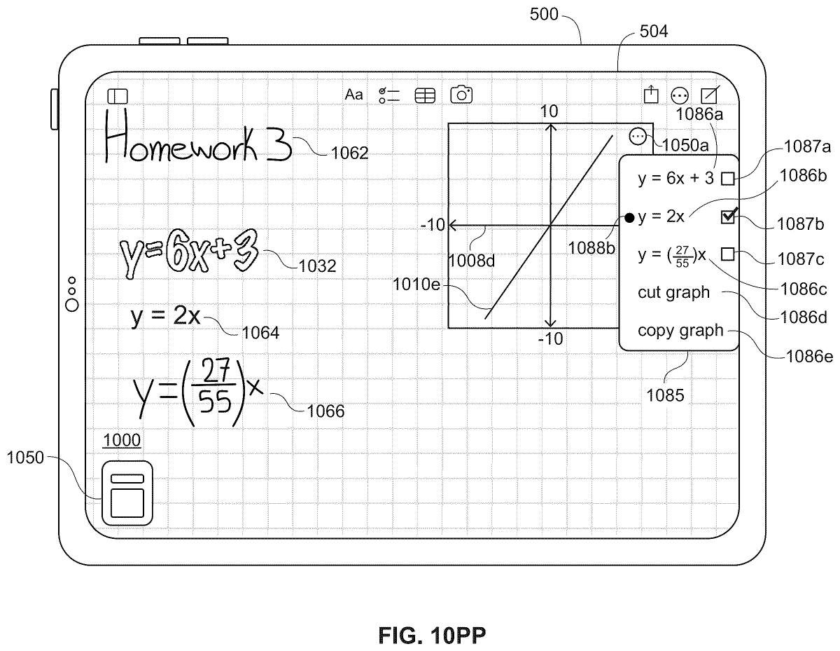

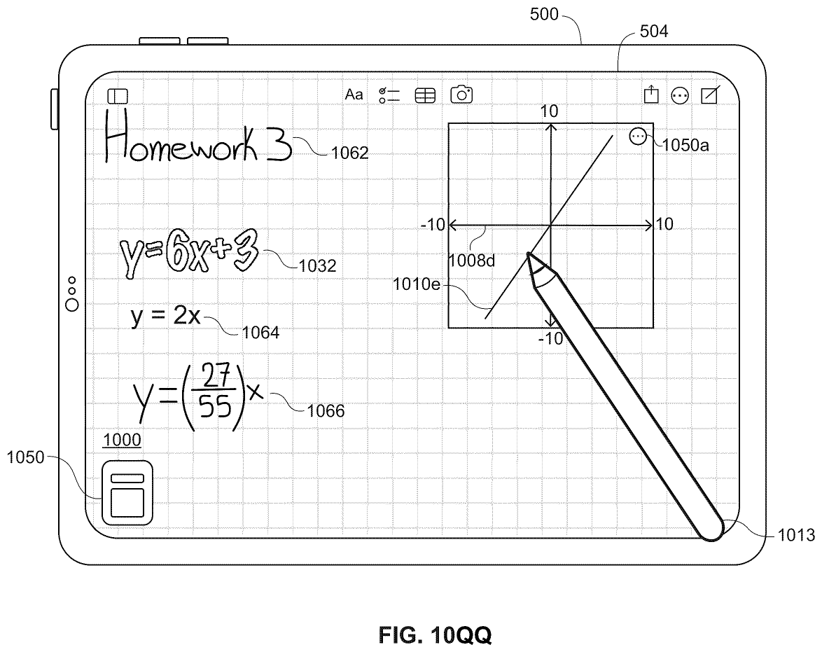

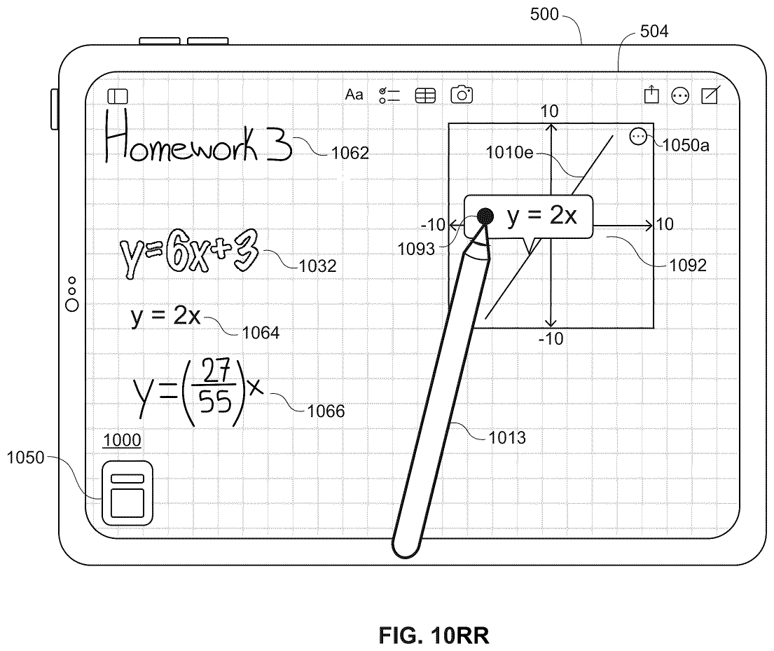

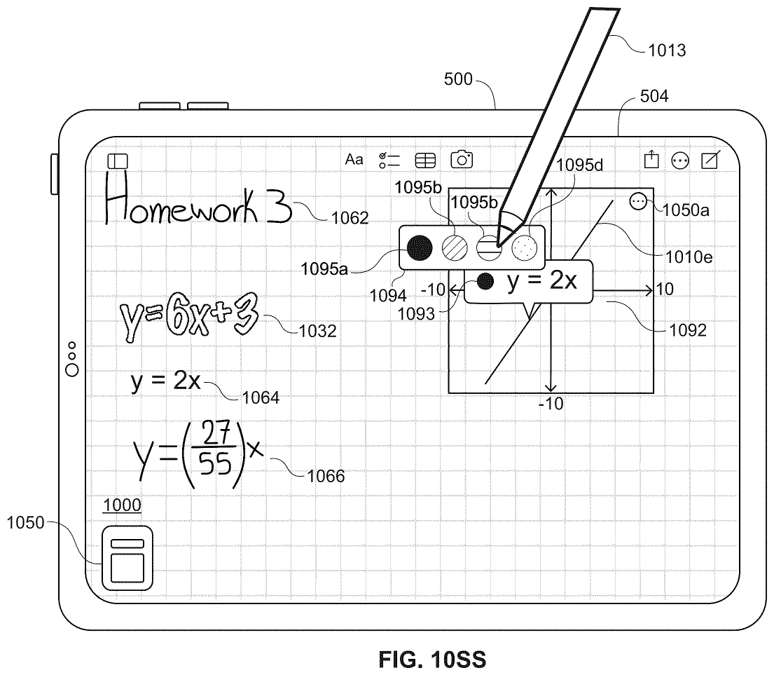

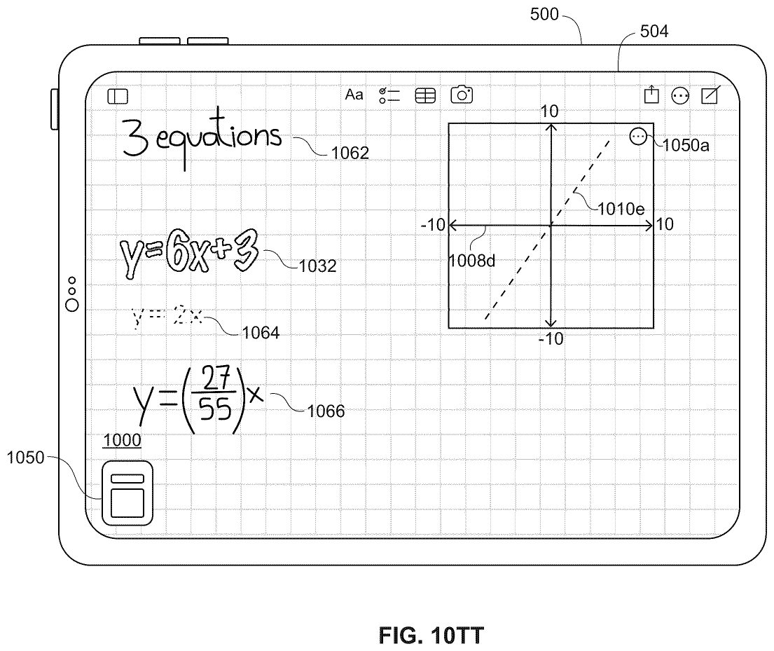

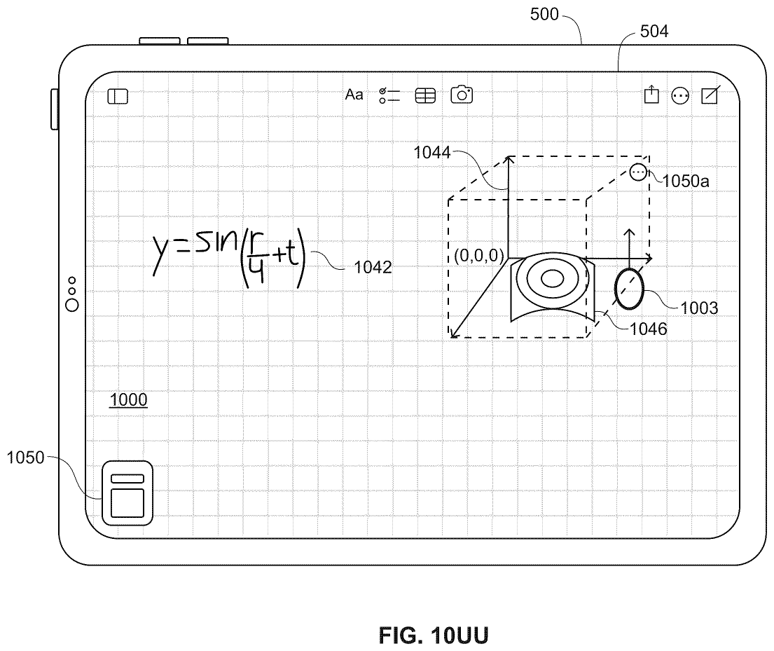

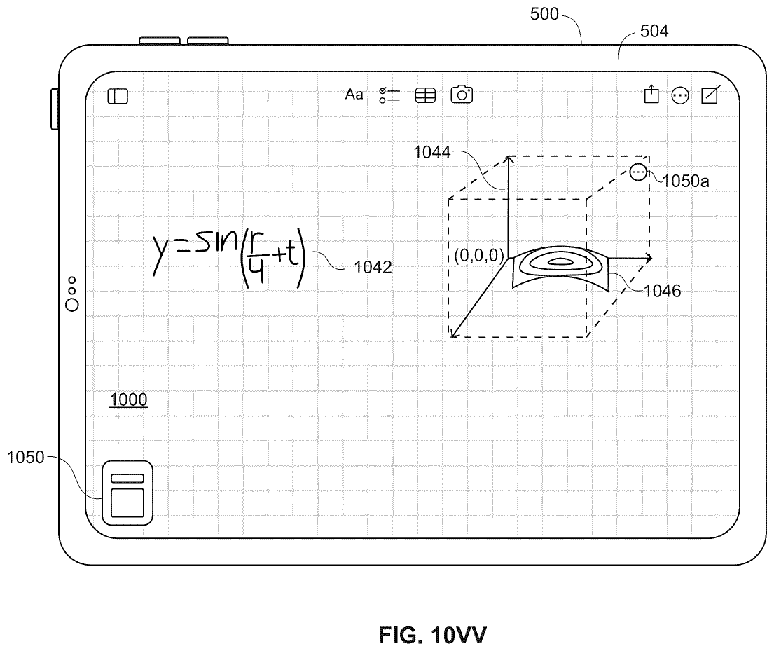

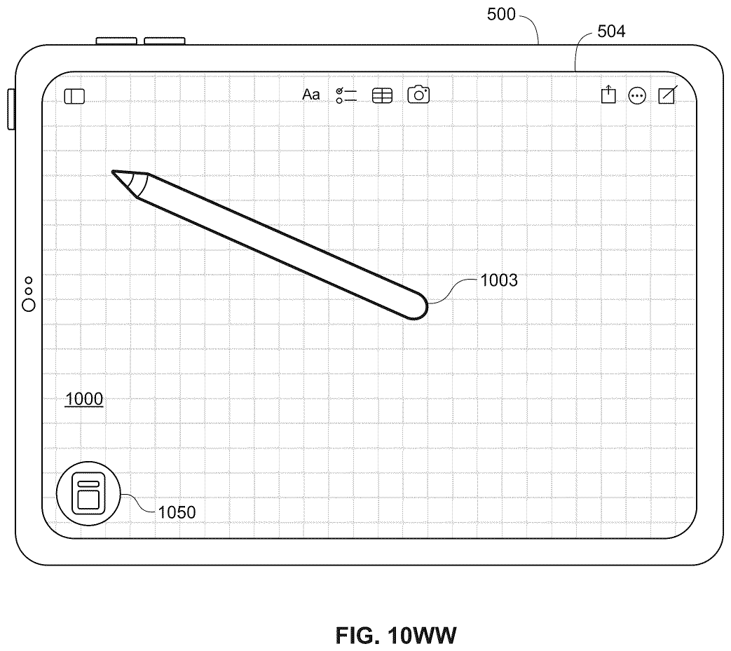

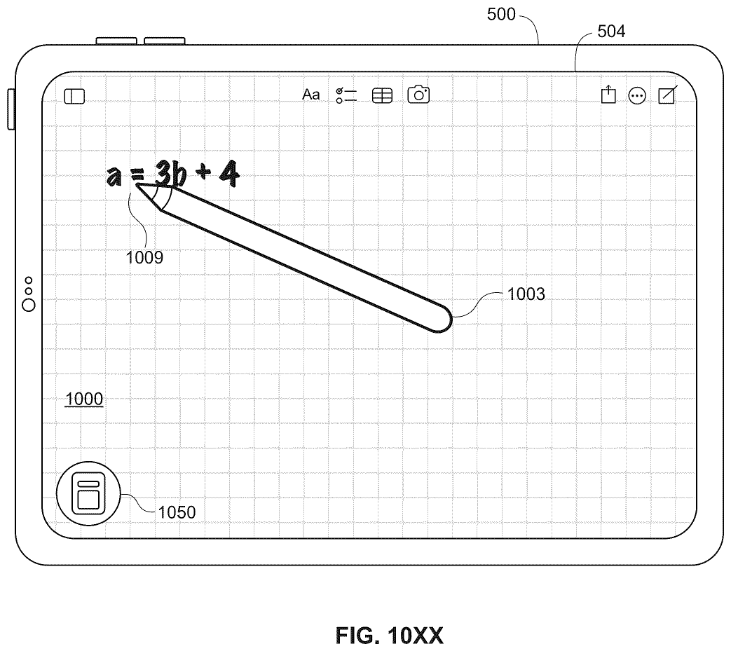

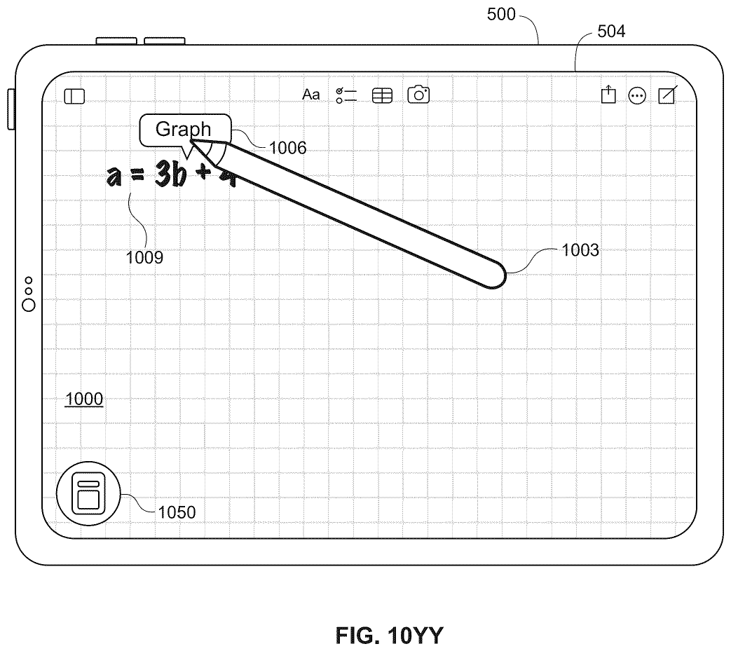

In some embodiments, while displaying the mathematical equation including the variable and while the variable is associated with the first numerical quantity, the electronic device displays, via the one or more display generation components, a first graph that includes a first graphical representation of the mathematical equation in accordance with the first numerical quantity of the variable, such as text 688 and the associated representation 651 shown in FIG. 6Y. In some embodiments, the electronic device displays a selectable option after detecting the mathematical equation including the variable and the electronic device receives a selection input directed towards the selectable option to display the first graph of the mathematical equation, as described in further detail below in FIG. 10C, specifically with reference to the electronic device receiving an input via stylus 10132 directed towards option 1006. In some embodiments, the first graph includes a graphical representation of the mathematical equation, as described in further detail below with reference to FIG. 10C, specifically with reference to the electronic device receiving an input via stylus 10132 directed towards option 1006.

In some embodiments, in response to detecting the second input, the electronic device displays, via the one or more display generation components, the first graph that includes a first graphical representation of the mathematical equation to a second graph that includes a second graphical representation of the mathematical equation in accordance with the second numerical quantity of the variable, wherein the second graphical representation of the mathematical equation is different from the first graphical representation of the mathematical equation (e.g., the second representation of the mathematical equation has a different slope, curvature, x-intercept(s) and/or y-intercept(s) than the first representation of the mathematical equation), such as if the electronic device 500 updates text 688 to change the content of variable x (e.g., from x\hat{ }2 to 3x\hat{ }2), which would change the representation of the graph shown in FIG. 6Y. In some embodiments, in response to detecting the input, the electronic device replaces the first graph with the second graph or modifies the first graph to include the second numerical quantity of the variable instead of the first numerical quantity, as described in further detail below with reference to methods 1100 and/or 1200. Alternatively, in some embodiments, the electronic device displays the first graph and the second graph in the user interface. Automatically updating the graphs as the variable is changed reduces the number of inputs needed to update the graphs, thereby reducing erroneous inputs to the electronic device.

In some embodiments, prior to displaying the user interface including the content entry region, the electronic device displays, via the one or more display generation components, a user interface of a calculator application, such as user interface 680 shown in FIG. 6V. In some embodiments, the user interface includes one or more selectable options representing numbers and mathematical operations. In some embodiments, the user interface of the calculator is a user interface including a simple and/or scientific calculator. In some embodiments, the user interface of the calculator application includes a selectable option that is selectable to change the display of the user interface (e.g., change between simple calculator, scientific calculator, and math paper. In some embodiments, while in the math paper mode, the electronic device displays one or more content entry fields configured to receive mathematical equations, such as described above.

In some embodiments, while displaying the user interface of the calculator application, the electronic device detects, via the one or more input devices, a second input corresponding to a request to use the calculator application to display solutions to mathematical equations in a content entry region, such as with input including contact 684b directed option 686d shown in FIG. 6W. In some embodiments, the second input is a selection input having one or more characteristics of the selection inputs as described above. In some embodiments, the second input is directed towards the selectable option to enter the math paper mode. In some embodiments, the input is a touch input (e.g., directed to a soft keyboard or a handwriting input), an air gesture, a mouse input, or an input using an input device such a keyboard or a stylus.

In some embodiments, in response to detecting the second input corresponding to the request to use the calculator application to display solutions to mathematical equations in the content entry region, the electronic device updates, via the one or more display generation components, the user interface of the calculator application to display the user interface that includes the content entry region, such as user interface 687 shown in FIG. 6X. In some embodiments, the user interface that includes the content entry region is described in greater detail above. In some embodiments, the electronic device ceases displaying the one or more selectable options representing numbers and mathematical operations and displays the content entry region that is configured to receive handwritten and/or typed inputs representing mathematical equations. Including a selectable option to enter a math paper mode while in the calculator application allows the user to efficiently access the math paper mode, thereby reducing erroneous inputs to the electronic device.

In some embodiments, prior to displaying the user interface including the content entry region, displaying, via the one or more display generation components, a user interface of a notes application, such as a different user interface of the application associated with user interface 600, shown in FIG. 6A For example, the user interface of the notes application includes one or more content entry regions to receive and display text, images, and/or freeform writing (e.g., handwriting).

In some embodiments, while displaying the user interface of the notes application, the electronic device detects, via the one or more input devices, a second input corresponding to a request to use the notes application to display solutions to mathematical equations in a content entry region, such as if the electronic device 500 receives an input while displaying the different user interface of the application associated with user interface 600, shown in FIG. 6A, directed towards a selectable option to use the notes application to display solutions to mathematical equations. In some embodiments, the second input is a selection input having one or more characteristics of the selection inputs as described above. In some embodiments, the input is a touch input (e.g., directed to a soft keyboard or a handwriting input), an air gesture, a mouse input, or an input using an input device such a keyboard or a stylus. In some embodiments, the second input is directed towards a selectable option that, when selected, causes the electronic device to initiate displaying information corresponding to solutions when the electronic device detects an input including mathematical equations in the content entry region. In some embodiments, the electronic device displays the information corresponding to a solution to a mathematical equation in accordance with the one or more criteria described above and without needing to receive a request to use the notes application to display information corresponding to solutions. Alternatively, in some embodiments, while in the user interface of the notes application, the electronic device does not display the information corresponding to the solution until the electronic device receives the second input.

In some embodiments, in response to detecting the second input corresponding to the request to user the notes application to display solutions to mathematical equations in the content entry region, the electronic device updates, via the one or more display generation components, the user interface of the notes application to display the user interface that includes the content entry region, such as user interface 600 shown in FIG. 6A. In some embodiments, in response to detecting the second input, the electronic device updates the user interface such that the electronic device recognized inputs including mathematical equations. In some embodiments, if the electronic device recognized an input including a mathematical equation that satisfies one or more criteria, then the electronic device displays the information corresponding to the solution to the mathematical equation, as described above. In some embodiments, the user interface includes the content entry region before and/or while detecting the second input, however, while displaying the content entry region, the electronic device does not solve the mathematical equation until detecting the second input. Including a selectable option to enter an mathematical equation solving mode while in the notes application allows the user to efficiently access the mathematical equation solving mode, thereby reducing erroneous inputs to the electronic device.

In some embodiments, displaying the content entry region of the user interface includes displaying a content entry field, such as content entry field 691 shown in FIG. 6BB. In some embodiments, the electronic device displays a content entry field in an application other than the calculator and/or notes application (e.g., a messaging application, a web browser application, a documents application, and/or an application with one or more selectable options that include text suggestions and/or content entry fields that receives text and/or other content). For example, the electronic device inputs text and/or images into the content entry field to be transmitted to a second user account as part of a messaging conversation.

In some embodiments, displaying the information corresponding to the solution to the mathematical equation includes displaying, via the one or more display generation components, a selectable option that, when selected, causes the electronic device to enter the information corresponding to the solution to the mathematical equation into the content entry field, such as options 697a through 679c shown in FIG. 6BB. In some embodiments, in response to detecting the input including the mathematical equation in the content entry field, the electronic device displays one or more selectable options including the solution to the mathematical equation, a representation of the mathematical equation and the solution to the mathematical equation, and a representation of the mathematical equation without the solution. In some embodiments, the representation of the mathematical equation is an autocomplete suggestion to complete the equation that is currently being inputted. Alternatively, in some embodiments, the representation of the mathematical equation is just the equation as inputted. In some embodiments, the electronic device displays the one or more selectable options as suggestions to add to the content entry field. In some embodiments, the input including the mathematical equation is an input at a soft keyboard, which results in the corresponding mathematical equation to be displayed in the content entry field. In some embodiments, the selectable option is displayed in associated with the soft keyboard (e.g., adjacent, next to, or near the soft keyboard). In some embodiments, the selectable option is displayed in a region that also or otherwise displays predicted language (e.g., text that is not mathematical and text that is mathematical) text suggestions (e.g., autocomplete and/or autocorrect text) that is able to be selected and entered into the content entry field. For example, the predicted language text suggestions includes autocomplete and/or autocorrect text for equations.

In some embodiments, the electronic device detects, via the one or more input devices, a second input selecting the selectable option, such as if an input including a contact was directed towards option 697b shown in FIG. 6BB. In some embodiments, the second input is a selection input such as the selection input described above. In some embodiments, the input is a touch input (e.g., directed to a soft keyboard or a handwriting input), an air gesture, a mouse input, or an input using an input device such a keyboard or a stylus.

In some embodiments, in response to detecting the second input, the electronic device displays, via the one or more display generation components, the information corresponding to the solution in the content entry field, such as if the electronic device 500 replaces the text in field 691 with the text in option 697b shown in FIG. 6BB. In some embodiments, in response to selecting the selectable option including the information corresponding to the solution, the electronic device replaces the mathematical equation in the content entry field with content associated with the selectable option, described in greater detail below. In some embodiments, after displaying the information corresponding to the solution in the content entry field, the electronic device receives a third input corresponding to a request to perform an action with respect to the content in the content entry field. In some embodiments, in response to detecting the third input, the electronic device includes the information corresponding to the solution (e.g., the content) in the corresponding action. For example, while in a messaging conversation, the electronic device sends the message including the content. For example, while in an email compose user interface, the electronic device sends the email including the content. Displaying the information corresponding to the solution as a suggestion allows the user to easily and efficiently replace the equation with the solution while in the content entry region, thereby reducing erroneous inputs to the electronic device.

In some embodiments, displaying the information corresponding to the solution includes displaying the solution without the mathematical equation, such as the text in option 697b shown in FIG. 6BB. In some embodiments, the selectable option includes an indication of the solution to the mathematical equation. In some embodiments, the electronic device replaces the mathematical equation in the content entry field with the solution without the mathematical equation. In some embodiments, the electronic device displays the solution with the visual characteristic with the same value as the input including the mathematical equation. Displaying the information corresponding to the solution as a suggestion allows the user to easily and efficiently replace the equation with the solution while in the content entry region, thereby reducing erroneous inputs to the electronic device.

In some embodiments, displaying the information corresponding to the solution includes displaying the solution with the mathematical equation, such as the text in option 697c shown in FIG. 6BB. In some embodiments, the selectable option includes an indication of the mathematical equation and the solution to the mathematical equation. In some embodiments, the electronic device replaces the mathematical equation in the content entry field with the mathematical equation including the solution (and/or adds the solution to the mathematical equation in the content entry field). In some embodiments, the electronic device displays the solution with the same visual characteristic with the same value as the input including the mathematical equation. Displaying the mathematical equation and the information corresponding to the solution as a suggestion allows the user to easily and efficiently replace the equation with the equation and the solution while in the content entry region, thereby reducing erroneous inputs to the electronic device.

In some embodiments, displaying the information corresponding to the solution includes displaying the mathematical equation without the solution, such as the text in option 697a shown in FIG. 6BB. In some embodiments, the selectable option includes an indication of the mathematical equation without the solution. In some embodiments, the electronic device does not change the input to the content entry field. For example, in response to selecting the selectable option, the electronic device continues to display the mathematical equation without the solution. Displaying the mathematical equation as a suggestion allows the user to easily and efficiently continue displaying the equation without the solution while in the content entry region, thereby reducing erroneous inputs to the electronic device.

In some embodiments, while displaying the representation of the input that satisfies one or more first criteria in a respective user interface (and optionally in response to detecting an input that satisfies one or more first criteria including a criterion that is satisfied when the input includes a mathematical equation, such as a type of text that includes a mathematical equation with numbers and/or mathematical operations symbols and an equals sign, as described above), such as text 604 shown in FIG. 6A, text 653 shown in FIG. 6AA, or text in context entry region 691 shown in FIG. 6BB.

In some embodiments, in accordance with a determination that the respective user interface is a first type of user interface, displaying the information corresponding to the solution includes displaying, via the one or more display generation components, an indication of completion of a calculation of the mathematical equation without displaying the solution, such as if the electronic device 500 does not display the solution 608 shown in FIG. 6B automatically after detecting the indication of completion. In some embodiments, the first user interface is a user interface of an application other than a calculator application (e.g., notes application, messaging application, document application, or other applications including content entry fields). For example, if the user interface is a user interface of a notes application, the electronic device does not automatically display the information corresponding to the solution after detecting an indication of completion (e.g., detecting an equals sign and/or detecting a break in typing and/or handwriting greater than a threshold amount of time, as described above). In some embodiments, indication of completion is described in greater detail above. In some embodiments, the electronic device displays the information corresponding to the solution after detecting an interaction towards the indication of completion (e.g., selecting a selectable option to display the solution, as described above). For example, the user is doing homework or taking notes while in the notes application and optionally does not want the solution to the mathematical equation displayed immediately.

In some embodiments, in accordance with a determination that the respective user interface is a second type of user interface, different from the first type of user interface, displaying the information corresponding to the solution includes displaying, via the one or more display generation components, the solution, such as displaying the solution 694 automatically after detecting the indication of completion shown in FIG. 6AA. In some embodiments, the user interface is a user interface of the calculator application, as described above. In some embodiments, while in the second user interface, the electronic device displays the information corresponding to the solution after detecting an indication of completion, as described above. For example, the user wants to solve a mathematical equation on the calculator. In some embodiments, a setting is available (e.g., displayed in the respective user interface that includes the representation of the input that satisfies the one or more first criteria, displayed in a settings user interface corresponding to the respective user interface, or is displayed in a context user interface that is invoked from the respective user interface) that enables a respective user interface to be switched from being the first type of user interface to being the second type of user interface or enables the respective user interface to be switched from being the second type of user interface to being the first type of user interface. In some embodiments, a context user interface can be invoked from the respective user interface with a long press or alternative click (e.g., option+click right click, or double finger click or tap) in an empty area of the respective user interface. Automatically displaying the information corresponding to the solution while in the second user interface and not the first user interface reduces the number of inputs needed to display the solution, thereby reducing erroneous inputs to the electronic device.

In some embodiments, the visual indication indicating that the mathematical equation is not able to be solved automatically includes a highlighting at a location (e.g., proximate to, on, or around) corresponding to an equals sign (or, alternatively, a different indication of the end of an equation such as a horizontal line under a column of vertical math) of the mathematical equation, such as indications 628 and 632, shown in FIG. 6G-A. In some embodiments, the mathematical equation does not satisfy the second criterion. Alternatively or additionally, in some embodiments, the visual indication includes underlining and/or coloring. In some embodiments, the visual indication also includes highlighting at the location corresponding to the characteristics of the mathematical equation that do not satisfy the second criterion, as described above. Displaying a visual indication indicating the electronic device is not able to solve the mathematical equation allows the user to quickly and efficiently identify the error, thereby reducing erroneous inputs to the electronic device.

In some embodiments, the respective portion of the representation of the input includes the respective portion of the input (e.g., a respective portion of the mathematical equation) that is ambiguous (e.g., ambiguous as described above) or an equal sign of the input. For example, the electronic device is able to receives an input directed towards indications 628 and 634 shown in FIG. 6G, which highlights the portion of the equation that is ambiguous. Alternatively, or additionally, in some embodiments, the electronic device is able to receive an input directed towards indications 628 and 634, shown in FIG. 6G-A, which highlights the equal sign of respective equations that are ambiguous. In some embodiments, the electronic device is able to receive an input directed towards the portion of the mathematical equation that is ambiguous or towards the equal sign of the mathematical equation. Allowing a user to select multiple locations to resolve an ambiguous error allows the user to quickly and efficiently identify and resolve the error, thereby reducing erroneous inputs to the electronic device.

In some embodiments, while displaying the information corresponding to the solution to the mathematical equation near the representation of the mathematical equation (e.g., after detecting that the input satisfies the one or more criteria including the first criterion and the second criterion), the electronic device detects, via the one or more input devices, a second input corresponding to a request to remove the equal sign (e.g., or remove a horizontal line under a column of vertical math), such as shown with input via stylus 203 directed towards the equal sign shown in FIG. 6FF. In some embodiments, the second input is a keyboard input (e.g., a tap input, air gesture, a click input, and/or a gaze input) while attention (e.g., based on a cursor, a touch input, a direct air gesture, gaze, or a substitute for gaze) is directed toward the keyboard to delete the equal sign. In some embodiments, the second input is a stylus input including a scratch out over the equal sign to or other input indicating a request to delete the equal sign (e.g., or remove a horizontal line under a column of vertical math). In some embodiments, the second input is a voice input to delete the equal sign.

In some embodiments, in response to detecting the second input, the electronic device ceases displaying the equals sign (e.g., ceasing to display a horizontal line under a column of vertical math) and the information corresponding to the solution to the mathematical equation, such as shown by text 662j in FIG. 6GG. In some embodiments, after deleting the equal sign, the input (e.g., the mathematical equation) no longer satisfies the one or more criteria including the first criterion and the second criterion, so the electronic device ceases displaying the information corresponding to the solution. In some embodiments, if the electronic device receives an additional input to add the equal sign or other inputs to satisfy the second criterion, then the electronic device redisplays the information corresponding to the solution. In some embodiments, after ceasing displaying the equals sign, the electronic device maintains display of other portions of the mathematical equation to which the electronic device did not detect an input requesting deletion. Automatically removing the information corresponding to the solution after detecting a request to delete the equal sign allows the user to efficiently view or no longer view the solution, therefore reducing erroneous inputs to the electronic device.

In some embodiments, the mathematical equation further includes a term (e.g., a variable (e.g., such as a variable including a numerical quantity as described above) or a term that includes a numerical value) and displaying the information corresponding to the solution to the mathematical equation includes, in accordance with a determination that the term is associated with a first unit of measure (e.g., term x, represented by text 672e shown in FIG. 6CC), displaying a solution to the mathematical equation (e.g., the solution having one or more characteristics of the solution as described above) in the first unit of measure, such as solution 6700, shown in FIG. 6CC. In some embodiments, if the terms (e.g., variables and/or numbers) in the mathematical equation include a first unit of measure, then the solution to the equation (e.g., the information corresponding to the solution) also includes and/or is expressed in the first unit of measure. In some embodiments, a unit of measure is a definite magnitude of a quantity (e.g., a standard of measurement). For example, a unit of measure includes feet, meter, seconds, volts, moles, kilojoules, units of time (e.g., seconds, hours, minutes), units of temperature (e.g., Celsius, Fahrenheit, Kelvin), and other standard units). In some embodiments, the unit of measure is written in simulated handwriting (e.g., based on the user's handwriting or generic simulated handwriting).

In some embodiments, displaying the information corresponding to the solution to the mathematical equation includes in accordance with a determination that the term (e.g., having a first numerical quantity) is associated with a second unit of measure different from the first unit of measure (e.g., term y, represented by text 672f, shown in FIG. 6CC), displaying the solution in the second unit of measure, such as solution 670p, shown in FIG. 6CC. In some embodiments, if the terms (e.g., variables and/or numbers) in the mathematical equation include a second unit of measure, then the solution to the equation (e.g., the information corresponding to the solution) also includes and/or is expressed in a second unit of measure. In some embodiments, the unit of measure is written in simulated handwriting (e.g., based on the user's handwriting or generic simulated handwriting). Including the unit of measure of the term in the solution to the mathematical equation reduces the number of inputs needed to solve an equation in the proper units, thereby reducing erroneous inputs to the electronic device.

In some embodiments, the mathematical equation further includes a term (e.g., such as a variable including a numerical quantity as described above) and displaying a solution to the mathematical equation includes in accordance with a determination that the term is not associated with a unit of measure (e.g., the term, x, represented by text 672a, shown in FIG. 6R), displaying the solution without a unit of measure, such as solutions 670g and 670h, shown in FIG. 6R. In some embodiments, if a unit of measure is not designated with the term, then the solution does not include and/or is not expressed in a unit of measure. In some embodiments, mathematical equations and solutions to mathematical equations do not include units of measure. Including the unit of measure or lack of unit of measure of the term in the solution to the mathematical equation reduces the number of inputs needed to modify and solve an equation, thereby reducing erroneous inputs to the electronic device.

In some embodiments, the mathematical equation further includes a first term associated with a first unit of measure (e.g., and a first numerical quantity) and a second term associated with a second unit of measure (e.g., and a second numerical quantity) and displaying a solution to the mathematical equation includes in accordance with a determination that the first unit of measure and the second unit of measure cancel out in the mathematical equation (e.g., the first unit of measure and the second unit of measure are inverses of each other such as meters (m) and 1/m), displaying, via the display generation component, the solution without displaying the first unit of measure or the second unit of measure, such as the terms represented by text 672g through 672i, and the solution 670q not having a unit of measure, shown in FIG. 6DD. In some embodiments, the electronic device displays the solution to the mathematical equation without the first unit of measure or the second unit of measure because the units of measurement cancel out. In some embodiments, if the units of measurement are not inverses of each other, then the electronic device displays a third unit of measure that is a combination of the first and second unit of measure with the solution. In some embodiments, the third unit of measure is described in greater detail below. Including the proper unit of measure in the solution to the mathematical equation based on the unit of measure of the terms reduces the number of inputs needed to modify and solve an equation, thereby reducing erroneous inputs to the electronic device.

In some embodiments, the mathematical equation further includes a first term associated with a first unit of measure (e.g., and a first numerical quantity, having one or more characteristics of the first unit of measure described above) and a second term associated with a second unit of measure (e.g., and a second numerical quantity, having one or more characteristics of the second unit of measure described above) and displaying a solution to the mathematical equation includes in accordance with a determination that the first unit of measure and the second unit of measure do not cancel out in the mathematical equation, displaying the solution with a third unit of measure determined based on the first unit of measure and the second unit of measure in the mathematical equation, such as solution 670r including both “cm” and “seconds”, shown in FIG. 6EE. In some embodiments, if the units of measurement are not inverses of each other, then the electronic device displays a third unit of measure that is a combination of the first and second unit of measure with the solution. In some embodiments, the third unit of measure is the result of multiplying (or dividing) the first unit of measure and the second unit of measure, in accordance with the rules of mathematics. In some embodiments, if the first and second units of measure do not cancel out, then the solution to the mathematical equation includes multiple units of measurement (e.g., m/s, m/s2, N/m2, or other units of measurement). In some embodiments, the unit of measure is written in simulated handwriting (e.g., based on the user's handwriting or generic simulated handwriting). Including the proper unit of measure in the solution to the mathematical equation based on the unit of measure of the terms reduces the number of inputs needed to modify and solve an equation, thereby reducing erroneous inputs to the electronic device.

In some embodiments, the mathematical equation includes a first term associated with a first unit of measure and a second term associated with a second unit of measure, and displaying a solution to the mathematical equation includes, in accordance with a determination that the first unit of measure and the second unit of measure are compatible (e.g., the first unit of measure and the second unit of measure are units corresponding to the same type of measurement (e.g., distance, temperature, volume, force, time, mass, and other measurements) and optionally in the same measurement system (e.g., metric or imperial)), displaying the solution with the third unit of measure corresponding to the first unit of measure, such as the terms represented by text 672m and 672n, and the solution 672t including the unit of measure associated with the unit of measure of text 672m, shown in FIG. 6FF. In some embodiments, the electronic device displays the solution with the unit of measurement that comes first in the mathematical equation (e.g., the unit of measurement associated with the first term of the mathematical equation). In some embodiments if the first term is positioned before the second term in the input equation, then the electronic device calculates the solution with the first unit of measure. In some embodiments, if the second term is positioned before the first term in the input equation, then the electronic device calculates the solution with the second unit of measure, associated with the second term. In some embodiments, to calculate the solution with the first unit of measure, the electronic device converts the numbers associated with the second unit of measure to the first unit of measure. Alternatively, in some embodiments, the electronic device displays the solution with the unit of measurement corresponding to the second unit of measurement. Automatically picking a unit of measure in the solution to the mathematical equation when the units of measure of the terms are mismatched reduces the number of inputs needed to modify and solve an equation, thereby reducing erroneous inputs to the electronic device.

In some embodiments, the mathematical equation includes a first term associated with a first unit of measure and a second term associated with a second unit of measure, and displaying a solution to the mathematical equation includes in accordance with a determination that the solution includes a value that can be represented in the third unit of measure and a subunit of measure corresponding to the third unit of measure, displaying the solution with a portion of the value in the third unit of measure and a portion of the value in the subunit of measure corresponding to the third unit of measure (e.g., displaying an answer in feet and inches, such as 3 ft 2 inches rather than 38 inches), such as solution 670s including both m and cm, shown in FIG. 6EE. In some embodiments, the electronic device displays the solution with mixed units of measure (e.g., a unit of measure and a subunit of measure) when the units of measure (e.g., the first and second units of measure) are in the same measurement system (e.g., metric or imperial). For example, the electronic device displays the solution with a larger unit (e.g., km, ft, minutes, or other units) and a smaller (subunit) unit (e.g., m, cm, inches, seconds, or other smaller units) if the first unit of measure corresponds to one type of unit (e.g., smaller or larger) and the second unit of measure corresponds to a second type of unit (e.g., smaller or larger). In some embodiments, displaying the solution with the unit of measure and the subunit of measure includes displaying the solution with a unit of measure in the same measurement system (e.g., metric or imperial) and the same type of measurement (e.g., distance, weight, time, or velocity). Automatically displaying mixed units in the solution to the mathematical equation when the units of measure of the terms are mismatched reduces the number of inputs needed to modify and solve an equation, thereby reducing erroneous inputs to the electronic device.

In some embodiments, the mathematical equation includes a first term associated with a first unit of measure and a second term associated with a second unit of measure, and displaying a solution to the mathematical equation includes in accordance with a determination that the first unit of measure and the second unit of measure are not compatible (e.g., they are not in the same measurement system and/or are not the same types of measurement, as described above), displaying the solution with the third unit of measure that is a combination of the first unit of measure and the second unit of measure, such as solution 670r including both cm and seconds, shown in FIG. 6EE. In some embodiments, when multiplying or dividing, the electronic device combines the units of measure for the corresponding terms. In some embodiments, the electronic device combines units of measure that cannot be converted to the other unit of measure (e.g., the first unit of measure cannot be converted to the second unit of measure). For example, seconds cannot be converted to meters, so an equation where meters (m) are divided by seconds(s) would have a solution with units of m/s. Automatically combining units of measure in the solution to the mathematical equation when the units of measure of the terms are not compatible reduces the number of inputs needed to modify and solve an equation, thereby reducing erroneous inputs to the electronic device.

In some embodiments, the electronic device displays, via the one or more display generation components, text defining the term, wherein the determination that the term is associated with the first unit of measure is based on identifying one or more letters after one or more numbers included in the text defining the term, such as text 672j including the letters “seconds” corresponding to a unit, shown in FIG. 6EE. In some embodiments, the text defining the term includes one or more numbers and one or more letters. In some embodiments, the one or more numbers corresponds to the numerical value of the term. In some embodiments, the one or more letters corresponds to the unit of measure. In some embodiments, the one or more letters corresponds to one or more known units of measure (e.g., abbreviations of units of measure) such as in, ft, cm, m, s, m/s, V, Pa, J, N, C, K, kg, g, mol, s, amp, or other units of measure. In some embodiments, the electronic device stores a database of one or more known units of measure on the electronic device or a storage device in communication with the electronic device. Including the unit of measure of the term in the solution to the mathematical equation by first identifying the unit of measure of the term based on the letters in the text reduces the number of inputs needed to modify and solve an equation, thereby reducing erroneous inputs to the electronic device.

In some embodiments, displaying the solution to the mathematical equation including a respective unit of measure (e.g., the first unit of measure or the second unit of measure) includes in accordance with a determination that the input including the mathematical equation and the term including the respective unit of measure is a handwritten input including a first characteristic (e.g., the first characteristic as described above), displaying the solution including the respective unit of measure with the first characteristic, such as text 672e having a first characteristic, and solution 6700 including units of measure, having the first characteristic, shown in FIG. 6CC. In some embodiments, if the unit of measure of the term is written in a first characteristic, then the electronic device displays the respective unit of measure of the solution with the first characteristic. For example, if the unit of measure of the term is handwritten, then the respective unit of measure of the solution is also written with the same style. In some embodiments, and as described above, the electronic device mimics the user's handwriting. In some embodiments, if the unit of measure of the term is written in a second characteristic, then the electronic device displays the respective unit of measure of the solution with the second characteristic In some embodiments, displaying the solution to the mathematical equation including a respective unit of measure (e.g., the first unit of measure or the second unit of measure) includes, in accordance with a determination that the input including the mathematical equation and the term including the respective unit of measure is a typed, displaying the solution including the respective unit of measure with a font that matches the typed input. Displaying the solution with a respective unit of measure with the same characteristic of the unit of measure associated with the input enhances user interaction with the electronic device by allowing the user to see the equation and the solution with the same characteristics thereby reducing erroneous inputs to the electronic device.

In some embodiments, the mathematical equation includes one or more letters (e.g., having one or more characteristics of the one or more letters as described above) that are recognized as a unit and displaying, in the content entry region, information corresponding to a solution to the mathematical equation near the representation of the mathematical equation comprises in accordance with a determination that the one or more letters have been defined (e.g., elsewhere in a document that includes the equation or in another related document) as a constant, identifying the one or more letters as the constant and using the value of the constant in the equation to determine the solution, such as x in text 662e being defined as a content by text 672e, shown in FIG. 6CC In some embodiments, the electronic device determines that one or more letters have been defined as a constant when the electronic device detects additional inputs including text further defining the one or more letters as being equivalent to a corresponding numerical value (e.g., m=35 or s=100). In some embodiments, the electronic device determines that the one or more letters have been defined as a constant when the one or more letters do not correspond to known units or abbreviations of units.

In some embodiments, the mathematical equation includes one or more letters (e.g., having one or more characteristics of the one or more letters as described above) that are recognized as a unit and displaying, in the content entry region, information corresponding to a solution to the mathematical equation near the representation of the mathematical equation comprises in accordance with a determination that the one or more letters have not been defined as a constant, identifying the one or more letters as the first unit of measure and using the first unit of measure in the equation to determine the solution (e.g., to determine units for the solution as described in greater detail above), such as “cm” being used as a unit of measure in solution 670p, because “cm” has not been defined as a constant, shown in FIG. 6CC. In some embodiments, the electronic device determines that one or more letters have not been defined as a constant (e.g., and, optionally, have been defined as a unit of measure) when the electronic device does not detect additional inputs including text further defining the one or more letters as being equivalent to a corresponding numerical value. In some embodiments, the electronic device determines that one or more letters have been defined as a unit of measure when the one or more letters corresponds to known units or abbreviations of units. In some embodiments, defining a sequence of one or more letters as a constant takes precedence over the use of the sequence of one or more letters as a unit (e.g., if the sequence of one or more letters has been defined as a constant it will not be interpreted as a unit instead). For example, if the document includes a statement that m=35, the letter m can't be used as a unit to represent meters (e.g., “10 m+5” would be interpreted as 355 instead of being interpreted as 15 meters) and the user would have to write or type “meters” or another equivalent to use units of meters (e.g., “10 meters+5” would be interpreted as 15 meters). As another example, if the document includes a statement that s=100, the letter s can't be used as a unit of “seconds” (e.g., “10 s+5” would be interpreted as 1005 instead of being interpreted as 15 seconds) and the user would have to write or type “seconds” or another equivalent to use units of seconds (e.g., “10 seconds+5” or “10 sec+5” would be interpreted as 15 seconds). Automatically determining terms and units of measures when there are multiple letters in the mathematical equation reduces the number of inputs needed to modify and solve an equation, thereby reducing erroneous inputs to the electronic device.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 900, 1100, and 1200) are also applicable in an analogous manner to method 700 described above with respect to FIG. 7. For example, the operation of detecting mathematical equations and displaying solutions to mathematical equations described above with reference to method 700 optionally has one or more of the characteristics of performing unit conversion, graphing mathematical equations, and displaying a menu of potions to modify one or more portions of a graph described herein with reference to other methods described herein (e.g., methods 900, 1100, and 1200). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 7 are, optionally, implemented by components depicted in FIGS. 1A-1B. For example, displaying operation 702a, 702d, 702e and 702f, and detecting operation 702b are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Users interact with electronic devices in many different manners. In some embodiments, an electronic device is in communication with one or more input devices, one or more display generation components, and wireless circuitry. In some embodiments, the electronic device presents a calculator user interface that includes selectable options for performing mathematical computations. Additionally or alternatively, in some embodiments, the calculator user interface performs conversions between different units of measure in the same category. The electronic device performs calculations in accordance with user inputs and displays the result of the calculations in two units that are equivalent quantities. Performing unit conversions in the calculator application reduces inputs needed to perform computations and unit conversions together and reduces user errors. It is understood that people use devices. When a person uses a device, that person is optionally referred to as a user of the device.

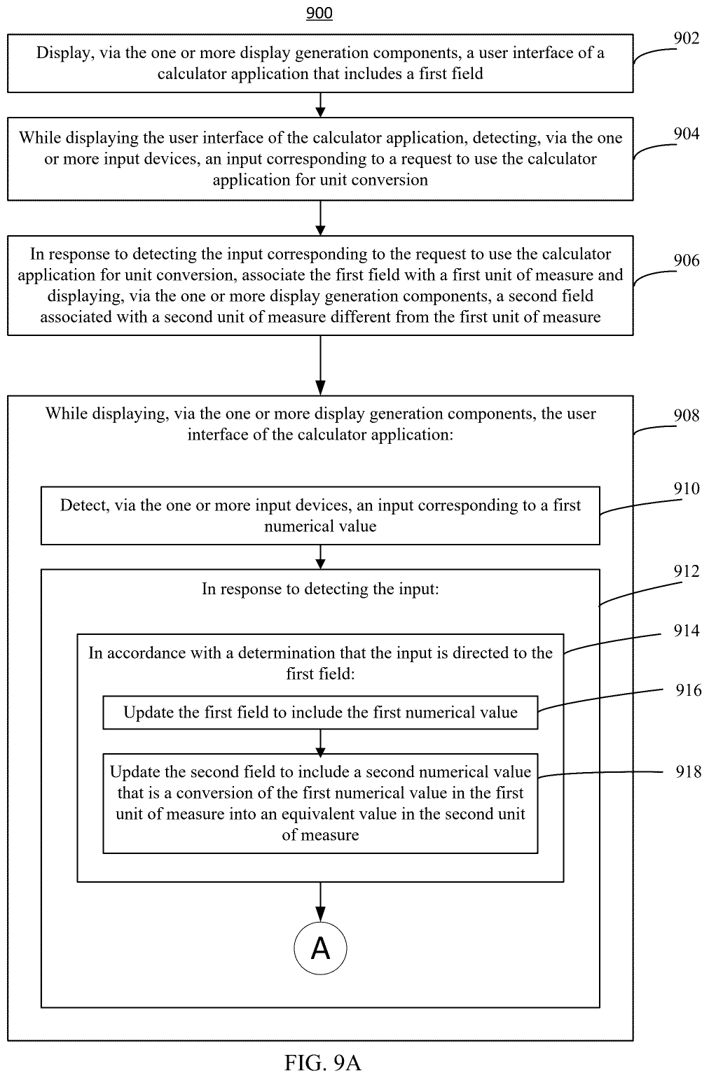

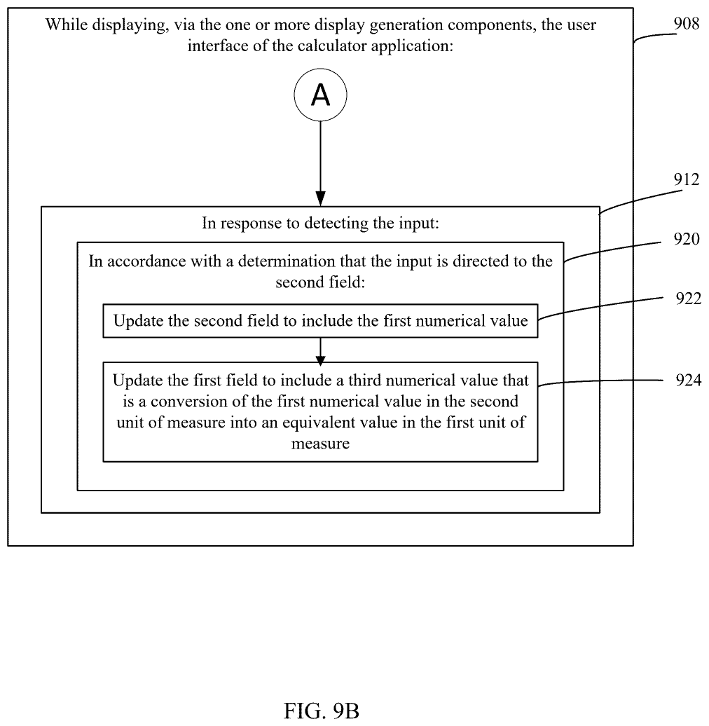

FIGS. 8A-8W illustrate exemplary ways in which an electronic device performs unit conversions using a calculator application according to some embodiments. The embodiments in these figures are used to illustrate the processes described below, including the processes described with reference to FIGS. 9A-9B. Although FIGS. 8A-8W illustrate various examples of ways an electronic device is able to perform the processes described below with respect to FIGS. 9A-9B, it should be understood that these examples are not meant to be limiting, and the electronic device is able to perform one or more processes described below with reference to FIGS. 9A-9B in ways not expressly described with reference to FIGS. 8A-8W.

FIG. 8A illustrates the electronic device presenting an example calculator user interface. As shown in FIG. 8A, the calculator application includes a field 818 towards which inputs for performing mathematical operations are directed. Inputs include interactions with the selectable options in the calculator user interface described herein, voice inputs described herein, and/or handwritten inputs described herein. As shown in FIG. 8A, the field 818 includes the number 0. The calculator user interface further includes a plurality of number options 804, an equals option 814, a clear option 806, a positive/negative option 808, a percent option 810, a decimal point option 812, and/or a plurality of operation options 816. In some embodiments, in response to detecting one or more inputs selecting a sequence of options 804 through 816, the electronic device 500 updates field 818 in accordance with the detected inputs. In some embodiments, after detecting a sequence of inputs defining a mathematical equation (e.g., with one or more numbers and/or operations), the electronic device 500 detects an input selecting the equals sign option 814. In response to detecting the sequence of inputs defining the mathematical equation followed by the input selecting the equals sign option 814, the electronic device 500 updates field 818 to display the result of the mathematical operation. The calculator user interface further includes a sidebar option 802a and a mode menu option 802b. These options, including the operations performed by the electronic device in response to detecting an input selecting these options, are described in further details below.

As shown in FIG. 8A, the electronic device 500 detects an input including selection of one of the number options 804 with contact 803. In response to detecting this input, the electronic device 500 updates field 818 to display the number “1” in accordance with the input.

FIG. 8B illustrates the electronic device 500 displaying the number “13” in field 818 in response to detecting the input illustrated in FIG. 8A and one or more additional inputs. For example, the electronic device detects inputs corresponding to typing the mathematical equation “10+3” followed by selection of the equals sign option 814. In response to this sequence of inputs, the electronic device 500 solves the mathematical equation “10+3” and displays an indication 826a of the equation and an indication 826b of the answer in field 818. Additionally or alternatively, in some embodiments, the electronic device 500 displays the content shown in field 818 in FIG. 8B in response to detecting one or more voice inputs and/or handwritten inputs. As shown in FIG. 8B, while the electronic device 500 displays “13” in field 818, the electronic device 500 detects an input including selection of an operation option 816 with contact 803. In some embodiments, in response to detecting the input shown in FIG. 8B followed by selection of one or more number options, then selection of the equals option 814, the electronic device 500 displays the result of the mathematical equation in field 818, as shown in FIG. 8C.

FIG. 8C illustrates the electronic device 500 displaying the number “26” in the field in response to detecting the input shown in FIG. 8B followed by one or more additional inputs providing additional number(s) and selection of the equals sign option 814. The electronic device displays the indication 826b of the result of the mathematical equation and the indication 826a of the mathematical equation in the field 818. As shown in FIG. 8C, the visual indication 826b of the solution is displayed larger than the indication 826a of the equation. In some embodiments, the electronic device 500 displays the indications 826a and 826b in different colors and/or with other differences in visual characteristics. In some embodiments, field 818 is associated with a single unit of measure, or not associated with a unit of measure because the calculator is not in the unit conversion mode. In FIG. 8C, the electronic device 500 detects an input selecting the mode menu option 802b with contact 803. In some embodiments, other types of inputs described herein are possible. In response to detecting the input shown in FIG. 8C, the electronic device presents a mode menu as shown in FIG. 8D.

FIG. 8D illustrates the electronic device 500 displaying a menu including options 822a through 822d for changing the mode of the calculator application. Option 822a corresponding to a “basic” calculator optionally includes an indication 824 that this is the mode the calculator application is currently operating in. For example, the “basic” calculator mode includes displaying the options 804 through 814 shown in FIGS. 8A-8C. Option 822b corresponding to a scientific calculator mode optionally includes displaying additional options, such as additional operation options 816 not shown in FIGS. 8A-8C. Toggle 822c controls whether the unit conversion mode is on or off. In some embodiments, unit conversion mode is off in FIGS. 8A-8C. In response to detecting interaction with the unit conversion mode toggle 822c, the electronic device 500 transitions from the unit conversion mode being off to the unit conversion mode being on in FIGS. 8E-8U. The menu further includes a math paper option 822d. In some embodiments, in response to detecting selection of the math paper option 822d, the electronic device 500 displays a content entry region such as the one described with reference to method(s) 700, 1100, and/or 1200 that supports typed and/or handwritten equations and/or graphs. As shown in FIG. 8D, the electronic device 500 detects an input interacting with toggle 822c with contact 803. In response to detecting the input shown in FIG. 8D, the electronic device 500 operates the calculator in a unit conversion mode as shown in FIG. 8E.

FIG. 8E illustrates the electronic device 500 displaying the calculator application in the unit conversion mode. As shown in FIG. 8E, the calculator user interface in the unit conversion mode includes two fields associated with respective units of measure: field 819a associated with miles and field 819b associated with kilometers. In some embodiments, the unit conversion mode is a toggle of the basic calculator mode and the scientific calculator mode. Because the electronic device 500 was using the calculator application in the basic calculator mode when the electronic device 500 detected the input toggling on unit conversion mode, the calculator application user interface is a basic calculator with unit conversion. If the calculator application had been in the scientific calculator mode when the electronic device 500 detected the input to toggle on the unit conversion mode, then the electronic device 500 would display the scientific calculator user interface with two entry fields 819a and 819b instead.

The two entry fields 819a and 819b are associated with respective units of measure. For example, the first entry field 819a is displayed with an indication 828a that the field is associated with miles and the second entry field 819b is displayed with an indication 828b that the field is associated with kilometers. In some embodiments, in response to detecting an input selecting indication 828a or indication 828b, the electronic device 500 initiates a process to change the unit of measure associated with the respective field, as described in more detail below. The first field 819a includes an indication 826b of a number (e.g., “26”) and the second field 828b includes an indication 826c of a number (e.g., “41.842”) that is the equivalent quantity as the number corresponding to indication 826b in the first unit of measure (e.g., miles), in the second unit of measure (e.g., kilometers). In some embodiments, the electronic device 500 is able to perform mathematical calculations in either unit and presents the solution in both units, as will be described herein. In FIG. 8E, the electronic device 500 detects an input selecting field 819a with contact 803. In some embodiments, in response to detecting the input in FIG. 8E, the electronic device 500 directs inputs providing mathematical operations and/or numbers to the first field 819a and not to the second field 819b. In some embodiments, if the electronic device 500 had detected an input selecting the second field 819b, then the electronic device 500 would direct subsequent inputs to the second field 819b and not to the first field 819a.

In FIG. 8F, the electronic device 500 detects an input directed to an operation option 816. In some embodiments, because the electronic device 500 detected the input in FIG. 8E directed to the first field 819a, the electronic device 500 directs the input in FIG. 8F to the first field 819a. In some embodiments, after detecting the input in FIG. 8F, the electronic device 500 detects subsequent inputs providing a number with which to multiply the number in the first field 819a. Also, as shown in FIG. 8F, in response to detecting the input described above with reference to FIG. 8E, the electronic device 500 displays backspace option 807 in place of the clear option 806 that the electronic device had displayed in FIG. 8E. In some embodiments, in response to detecting selection of the clear option 806, the electronic device 500 deletes the contents of the first field 819a, second field 819b, or both. In some embodiments, in response to detecting selection of the backspace option 807, the electronic device 500 deletes the leftmost character from the first field 819a.

For example, in FIG. 8G, the electronic device 500 displays “26×2.5” in the first field 819a in response to detecting further inputs selecting number options 804 and the decimal point option 812 to enter “2.5” after detecting the input selecting the operation option 816 in FIG. 8F. In some embodiments, the electronic device 500 displays the indication 826d in the first field 819a in a different color than the color of the indication 826e in the second field 819b because the indication 826d in the first field 819a corresponds to a mathematical equation and the indication 826e in the second field 819b corresponds to a solution to a mathematical equation. As shown in FIG. 8G, the electronic device 500 detects an input selecting the equals sign option 814 with contact 803 or an equivalent voice input or other input. In response to detecting the input directed to the equals sign option 814, the electronic device 500 displays the solution to the mathematical equation shown in the first field 819a in the first unit of measure and in the second unit of measure, as shown in FIG. 8H.

FIG. 8H shows the electronic device 500 displaying the calculator user interface updated to include the solution to the mathematical equation in the first unit of measure in the first field 819a and in the second unit of measure in the second field 819b. In some embodiments, the indication 826b in the first unit of measure corresponding to the first field 819a is equivalent to the indication 826e in the second unit of measure corresponding to the second field 819b. Thus, the electronic device 500 solves mathematical equations and performs unit conversions together in the calculator user interface.

As shown in FIG. 8H, the electronic device 500 detects an input selecting the indication 828b of the unit of measure associated with the second field 819b. Additionally or alternatively, the electronic device 500 detects a voice input or other input described herein. In response to detecting the input, the electronic device 500 displays a unit selection user interface element associated with the second field 819b as shown in FIG. 8I. In some embodiments, if the input had been directed to the indication 828a of the first unit of measure of the first field 819b, then the electronic device 500 would display a unit selection user interface element associated with the second field.

FIG. 8I illustrates the electronic device displaying the unit selection user interface element 830 in response to detecting the input described above with reference to FIG. 8H. In some embodiments, because the input was directed to the second field 819b, the unit selection user interface element 830 is for changing the unit associated with the second field 819b as described above. As shown in FIG. 8I, the unit selection user interface element 830 includes a search field 833, category options 829a through 829c, and unit options 832a through 832e within a selected category. For example, as shown in FIG. 8I, the option 832a associated with a distance category is indicated as being selected and the unit selection user interface element further includes options 832a through 832e associated with units of distance. In some embodiments, if a different category were selected, such as in response to detecting an input selecting option 829b or option 829c, the electronic device 500 would display options associated with units of measure in the selected category instead. As shown in FIG. 8I, the electronic device 500 detects an input selecting one of the unit options 832c (e.g., “Yards”). In some embodiments, in response to detecting the input selecting the option 832e, the electronic device 500 updates the second field 819b to be associated with the selected unit of measure. In some embodiments, additionally or alternatively, the electronic device 500 updates the second field 819b to be associated with the second field of measure in response to detecting a voice input or other type of input.

FIG. 8J illustrates the electronic device 500 displaying the calculator user interface after updating the unit of measure associated with the second field 819b in response to detecting the input described above with reference to FIG. 8I. As shown in FIG. 8J, the electronic device 500 updates the indication 826e included in the second field 819b to be the equivalent quantity in the new unit of measure as the quantity in the previous unit of measure, which is also an equivalent quantity of the numerical value represented by indication 826b in the first field 819a in the unit of measure associated with the first field 819a. As shown in FIG. 8J, the electronic device 500 detects an input directed to the second field 819b, such as contact 803 selecting the indication 826e in the second field 819b. In some embodiments, in response to detecting the input shown in FIG. 8J, the electronic device 500 directs subsequent inputs selecting mathematical operations and/or numbers to the second field 819b.

In FIG. 8K, the electronic device 500 detects selection of an operation option 816 with contact 803. In some embodiments, the electronic device 500 detects one or more additional inputs continuing to provide a mathematical equation. In some embodiments, the electronic device 500 detects one or more voice inputs or other inputs providing a mathematical equation to the calculator application. In some embodiments, in response to detecting the input(s), the electronic device 500 updates the second field 819b to include an indication of the mathematical equation, as shown in FIG. 8L.

FIG. 8L illustrates the electronic device 500 displaying the calculator user interface with an indication 826e of an equation in the second field 819b in response to detecting the input(s) described above with reference to FIG. 8K. As described above, in some embodiments, the electronic device 500 displays the indication 826b in the first field 819a in a first color and the indication 826e in the second field 819b in a second color different from the first color. As shown in FIG. 8L, while displaying the indication 826e of the equation, the electronic device 500 detects an input directed to the equals sign option 814. Additionally or alternatively, in some embodiments, the electronic device 500 detects an input (e.g., a voice input or handwriting input) indicating the end of the equation and/or a request to solve the equation. In response to detecting the input, the electronic device 500 presents the solution to the equation in the first field 819a in the first unit of measure and in the second field 819b in the second unit of measure, as shown in FIG. 8M.

FIG. 8M illustrates an example of the electronic device 500 displaying the solution to the equation in the first unit of measure in the first field 819a and in the second unit of measure in the second field 819b. As described above, in some embodiments, the quantity in the first field 819a in the first unit of measure is an equal quantity to the quantity in the second field 819b in the second unit of measure. As shown in FIG. 8M, the electronic device 500 detects an input including selection of sidebar option 802a with contact 803. In some embodiments, the electronic device 500 detects a different input selecting sidebar option 802a. In response to detecting the input, the electronic device 500 displays a sidebar user interface element that includes a history of operations performed using the calculator application, as shown in FIG. 8N.

FIG. 8N illustrates the electronic device 500 displaying the calculator application user interface with a sidebar user interface element 834 that includes indications 836a through 836h of previously-performed operations using the calculator application. In some embodiments, the electronic device 500 displays the user interface illustrated in FIG. 8N in response to detecting one of the inputs described above with reference to FIG. 8M. The sidebar user interface element 834 includes indications 836a through 836h of operations previously-performed with the calculator application including indications 836a, 836c, 836d, and 836f of unit conversions, indications 836b and 836e of computations performed with unit conversions, and indications 836g and 836h of computations performed without unit conversions. In some embodiments, in response to detecting selection of one of the indications 836a through 836h, the electronic device 500 displays the solution(s) and/or unit conversion result(s) in fields 819a and 819b of the calculator application user interface. As shown in FIG. 8N, while the electronic device 500 displays sidebar 834, the electronic device 500 displays options 804 through 816 at smaller sizes than the sizes at which electronic device 500 displays these options while not displaying the sidebar user interface element 834. In some embodiments, in response to detecting selection of sidebar option 802a while displaying sidebar user interface element 834, the electronic device 500 ceases display of sidebar user interface element 834.

As shown in FIG. 8N, the electronic device 500 detects an input selecting indication 828a with contact 803. In some embodiments, the electronic device 500 detects a different input directed to indication 828a. In response to detecting the input, the electronic device 500 displays the unit selection user interface element configured to change the unit of measure associated with the first field 819a, as shown in FIG. 8O.

FIG. 8O illustrates an example of the electronic device 500 displaying the unit selection user interface element 830 configured to change the unit of measure associated with the first field 819a. The unit selection user interface element 830 includes the elements described above with reference to FIG. 8I. As shown in FIG. 8O, the electronic device 500 detects an input selecting the currency category option 829b with contact 803. In some embodiments, the electronic device 500 detects a different input selecting the currency category option 829b. In response to detecting the input, the electronic device 500 updates the unit selection user interface element 830 to include options for units of measure in the currency category, as shown in FIG. 8P.

FIG. 8P illustrates the electronic device 500 displaying the unit selection user interface element 830 with options 832f through 832k for selecting a unit of measure in the currency category to associate with the first field 819a. In some embodiments, the electronic device 500 displays the updated unit selection user interface element 830 in response to one of the inputs described above with reference to FIG. 8O. In response to detecting selection of one of the options 832f through 832k, the electronic device 500 updates the first field 819a to be associated with the unit of measure corresponding to the selected option and updates the second field 819b to be associated with a different unit of measure in the same category (e.g., currency). In some embodiments, the electronic device 500 selects a most recently-used unit of measure to associated with the second field 819b. In some embodiments, the electronic device selects a unit of measure most recently used in conjunction with the unit of measure newly associated with the first field 819a to associate with the second field 819b. For example, as shown in FIG. 8P, the electronic device 500 detects an input selecting option 832h with contact 803. In some embodiments, other types of inputs are possible. In response to detecting the input, the electronic device 500 updates the first field 819a to be associated with US dollars and updates the second field 819b to be associated with a different unit of measure in the same category, as shown in FIG. 8Q.

FIG. 8Q illustrates the electronic device 500 displaying the calculator user interface with the first field 819a updated to be associated with US dollars and the second field 819b updated to be associated with Canadian dollars. In some embodiments, the electronic device 500 selects the unit of measure to associate with the first field 819a based on which option was selected in FIG. 8R. In some embodiments, the electronic device 500 selects the unit of measure to associated with the first field 819a based on a different input, such as a voice input requesting to associate the first field 819a with US dollars. In some embodiments, the electronic device 500 selects the unit of measure to associate with the second field 819b as described above. As shown in FIG. 8Q, the electronic device 500 detects an input selecting the indication 828 with contact 803 again. In some embodiments, the electronic device 500 detects a different input. In response to detecting the input, the electronic device 500 displays the unit selection user interface element 830 as shown in FIG. 8R.

FIG. 8R illustrates the electronic device 500 displaying the unit selection user interface element 830. In some embodiments, the unit selection user interface element 830 includes options 832f through 832 associated with units of currency, as described above with reference to FIG. 8P. As shown in FIG. 8R, the electronic device 500 detects an input directed to search field 833, such as with contact 803 or another input. In some embodiments, the electronic device 500 detects one or more additional inputs defining a search query. In some embodiments, the one or more inputs are touch inputs, handwritten inputs, and/or voice inputs. In response to the sequence of one or more inputs, the electronic device 500 displays results corresponding to the search query, as shown in FIG. 8S.

FIG. 8S illustrates the electronic device 500 displaying results corresponding to the search query in the unit selection user interface element 830. In some embodiments, the electronic device 500 displays the search results in response to detecting the sequence of inputs described above with reference to FIG. 8R. In some embodiments, the search results include sections based on category, denoted by headers 840a through 840c and options 842a through 842c corresponding to units matching the search query. For example, the electronic device 500 displays an option 842a to associate the first field 819a with centimeters under the header 840a for units of distance, an option 842b to associate the first field 819a with Celsius under the header 840b for units of temperature, and an option 842c to associate the first field 819a with Canadian dollars under the header 840c for units of currency.

In FIG. 8S, the electronic device detects an input directed towards option 802b, such as with contact 803, or with another input. In response to detecting the input in FIG. 8S, the electronic device 500 displays the menu including options 822a through 822d for changing the mode of the calculator application, shown in FIG. 8T. In FIG. 8T, the electronic device 500 detects an input directed towards option 822d, such as with contact 803, or with another input. In response to detecting the input in FIG. 8T, the electronic device 500 displays a user interface 855 which supports typed and/or handwritten equations and/or graphs, shown in FIG. 8U. In some embodiments, user interface 855 has one or more characteristics of user interface 687, shown in FIG. 6X and described in method 700, or user interface 1000, shown in FIG. 10A and described in method 1100 and 1200.

FIG. 8U illustrates the user interface 855 that includes a content entry region that supports typed and/or handwritten equations and/or graphs. In FIG. 8U, the electronic device 500 detects one or more inputs using stylus 803a or with contact 803b directed towards a virtual keyboard 850 to add text to user interface 855. In some embodiments, the electronic device 500 optionally receives inputs via a physical keyboard or a voice command. In FIG. 8U, the electronic device 500 displays cursor 844, which indicates where the text inputted using the keyboard 850 and contact 803b will be displayed.

FIG. 8V illustrates the user interface 855 after the electronic device 500 detects the handwritten (e.g., using stylus 803a) and typed inputs (e.g., using contact 803b directed towards keyboard 850) shown in FIG. 8U. In FIG. 8V, the electronic device 500 displays text 846, which was text detected via the stylus 803a, and text 848, which is text detected via keyboard 850. In FIG. 8V, text 846 and text 848 represent respective requests for conversion from a first unit of measure (e.g., mi and km, respectively) to a second unit of measure (e.g., km and mi, respectively). For example, text 846 represents a request to convert 5 mi to km and text 848 represents a request to convert 5 km to mi.

In response to detecting the text 846 and 848 corresponding to requests to convert units, the electronic device 500 displays the resulting conversion 860 and 852, shown in FIG. 8W. For example, in FIG. 8W, conversion 860 is the equivalent distance in km of 5 mi and conversion 852 is the equivalent distance in mi of 5 km.

FIGS. 9A-9B illustrate a flow diagram illustrating a method in which an electronic device performs unit conversions using a calculator application according to some embodiments. The method 900 is optionally performed at first electronic device and/or electronic devices such as device 100, device 300, or device 500 as described above with reference to FIGS. 1A-1B, 2-3, 4A-4B and 5A-5H. Some operations in method 900 are, optionally combined and/or order of some operations is, optionally, changed.

In some embodiments, method 900 is performed at an electronic device in communication with one or more display generation components and one or more input devices. For example, the electronic device, display generation component(s), and/or one or more input devices are as described above with reference to method 700, such as electronic device 500, display generation component 504, and/or stylus 203 in FIG. 6A.

In some embodiments, the electronic device displays (902), via the one or more display generation components, a user interface of a calculator application that includes a first field, such as field 819a in FIG. 8E. The calculator application optionally includes functions such as performing mathematical calculations, graphing mathematical equations, and/or additional or alternative functions described herein. In some embodiments, the user interface of the calculator application further includes selectable options to enter numbers and/or perform operations on numbers included in the first and/or second field. In some embodiments, inputs directed to the fields include selection of selectable options using a touch screen, air gesture, eye tracking, hand tracking, or hardware input devices. In some embodiments, inputs directed to the fields include voice inputs, keyboard inputs, handwritten input (e.g., with a stylus, a portion of the user's body such as a finger, or other object) or other inputs indicating numbers and/or operations without selecting the displayed selectable options. In some embodiments, the first field is a field to which inputs detected using the user interface are directed, such as inputs entering numbers and/or mathematical operations to be performed on numbers. In some embodiments, in response to detecting an input directed to the first field entering numbers and/or mathematical operations, the electronic device displays a number in accordance with the input in the first field.

In some embodiments, while displaying the user interface of the calculator application, the electronic device 500 detects (904), via the one or more input devices, an input corresponding to a request to use the calculator application for unit conversion, such as the input in FIG. 8D including contact 803.

In some embodiments, in response to detecting the input corresponding to the request to use the calculator application for unit conversion, the electronic device 500 associates the first field with a first unit of measure and displays (906), via the one or more display generation components, a second field associated with a second unit of measure different from the first unit of measure, such as first field 819a associated with the unit of measure indicated by indication 828a and second field 819b associated with the unit of measure indicated by indication 828b in FIG. 8E. In some embodiments, the second field is a field to which inputs detected using the user interface are directed, such as inputs entering numbers and/or mathematical operations to be performed on numbers. In some embodiments, in response to detecting an input directed to the second field entering numbers and/or mathematical operations, the electronic device displays a number in accordance with the input in the first field. In some embodiments, the first unit of measure and second unit of measure are different units of measure for the same category of units of measure (e.g., units of distance, mass, weight, velocity, currency, current, or the like), thus, it is possible to convert measurements between the first and second units of measure. In some embodiments, the first field and the second field display values that are equivalent in quantity for the first and second units of measure, respectively, as described in more detail below. For example, the first and second units of measure are units of distance/length, volume, weight, currency, time, temperature, pressure, and/or electrical characteristics.

In some embodiments, while displaying, via the one or more display generation components, the user interface of the calculator application (908), the electronic device detects (910), via the one or more input devices, an input corresponding to a first numerical value, such as the inputs in FIGS. 8E-8G with contact 803. In some embodiments, the input includes selection of one or more selectable options described above. In some embodiments, the input does not include selection of the one or more selectable options described above. In some embodiments, the input is an input entering a number without including a mathematical operation (optionally other than converting between the first and second units). In some embodiments, the input is a mathematical expression including number(s) and/or mathematical operation(s). Examples of mathematical operations include addition, subtraction, multiplication, division, and exponents. In some embodiments, the input is an input to type the first numerical value using a keyboard or soft keyboard. In some embodiments, the input is an input to hand write the first numerical value. In some embodiments, the input is a voice input that includes speaking the first numerical value.

In some embodiments, while displaying, via the one or more display generation components, the user interface of the calculator application (906), in response to detecting the input (912), in accordance with a determination that the input is directed to the first field (914) (e.g., the first field has the input focus while the electronic device detects the input, such as in response to detecting selection of the first field prior to detecting the input), the electronic device updates (916) the first field to include the first numerical value, such as the numerical value 826b in field 819a in FIG. 8H. In some embodiments, if the input includes entry of a number without mathematical operations, then the first numerical value is the number included in the input. In some embodiments, if the input includes one or more mathematical operations, then the first numerical value is the solution to the mathematical operations of the input.

In some embodiments, while displaying, via the one or more display generation components, the user interface of the calculator application (906), in response to detecting the input (912), in accordance with a determination that the input is directed to the first field (914), the electronic device updates (906) the second field to include a second numerical value that is a conversion of the first numerical value in the first unit of measure into an equivalent value in the second unit of measure, such as numerical value 826e in field 819b of FIG. 8H. In some embodiments, the input does not include operations to convert the first numerical value to the second numerical value; optionally, the electronic device automatically displays the second numerical value in the second unit of measure concurrently with the first numerical value in the first unit of measure.

In some embodiments, while displaying, via the one or more display generation components, the user interface of the calculator application (909), in response to detecting the input (912), in accordance with a determination that the input is directed to the second field (920) (e.g., the second field has the input focus while the electronic device receives the input, such as in response to detecting selection of the second field prior to detecting the input), the electronic device updates (922) the second field to include the first numerical value, such as numerical value 826e in field 819b of FIG. 8M, optionally similar to the manner in which the first numerical value corresponds to the numerical value of the input as described above.

In some embodiments, while displaying, via the one or more display generation components, the user interface of the calculator application (909), in response to detecting the input (912), in accordance with a determination that the input is directed to the second field (920), the electronic device updates (924) the first field to include a third numerical value that is a conversion of the first numerical value in the second unit of measure into an equivalent value in the first unit of measure, such as numerical value 826b in field 819a in FIG. 8M, optionally similar to the manner in which the electronic device updates the second field to include the second numerical value that is a conversion of the first numerical value in the first unit of measure to the second numerical value in the second unit of measure described above. Displaying a number in the first unit of measure and a number in the second unit of measure that are equivalent quantities in response to detecting the input directed to the first or second field enhances user interactions with the electronic device by reducing user error when converting units of measure using a calculator application.

In some embodiments, while displaying, via the one or more display generation components, the user interface of the calculator application including the first field associated with the first unit of measure and the second field associated with the second unit of measure (e.g., the calculator application is configured to perform unit conversion), the electronic device detects, via the one or more input devices, a second input directed to the first field or the second field that includes a mathematical equation, such as inputs with contact 803 in FIGS. 8J-8L. In some embodiments, the second input includes one or more numbers and one or more mathematical operations. The second input is optionally a sequence of inputs, such as selection of multiple displayed options in the user interface of the calculator application corresponding to digits and/or mathematical operations. In some embodiments, the second input includes a voice input, a handwritten input, and/or a typed input.

In some embodiments, in response to detecting the second input (and optionally a further input), the electronic device displays the solution to the mathematical equation in both the first unit of measure and the second unit of measure concurrently, such as in fields 819a and 819b of FIG. 8M. In some embodiments, the electronic device displays the solution in the first unit of measure in the first field and displays the solution in the second unit of measure in the second field. Detecting inputs defining mathematical equations while the calculator application is configured to perform unit conversion reduces time, inputs, and user error when performing calculations and unit conversions together with a calculator application.

In some embodiments, in response to detecting the second input, in accordance with the determination that the second input is directed to the first field, the electronic device updates the first field to include first text corresponding to the mathematical equation with a visual characteristic having a first value, such as displaying equation 826d in field 819a in FIG. 8G with a first color. In some embodiments, the electronic device directs the input focus to the first field in response to detecting an input selecting the first field prior to detecting the second input. In some embodiments, the electronic device directs the input focus to the first field in response to detecting the second input including an indication of the first unit of measure. In some embodiments, the first text includes text of the number(s) and/or mathematical operations included in the mathematical equation. In some embodiments, the first field further includes third text corresponding to the solution to the mathematical equation in the first unit of measure in response to detecting the second input directed to the first field. In some embodiments, the third text is displayed with the visual characteristic having a second value in response to detecting the second input directed to the first field. In some embodiments, the third text is displayed with the visual characteristic having the first value in response to detecting the second input directed to the first field. In some embodiments, the third text is displayed with the visual characteristic having a third value different from the first and second values in response to detecting the second input directed to the first field. In some embodiments, the electronic device forgoes displaying the third text in the first field until further input is detected, such as an input directed to the second field as described below, an input directed to a selectable option the electronic device displays in the user interface of the calculator application, such as an equals sign option, and/or a spoken, typed, or handwritten input. In some embodiments, in response to detecting the second input directed to the first field, the first text is associated with the first unit of measure and/or the equation is in the first unit of measure. In some embodiments, the electronic device displays the first text while detecting a first portion of the second input (e.g., one or more inputs specifying numbers and/or operations of the equation) and, in response to detecting a second portion of the second input after the first portion, the electronic device displays the solution in the first unit of measure with the visual characteristic having the second value described below. In some embodiments, the second portion of the input is a portion that corresponds to a request to solve the equation, such as selection of an “enter” or “equals” option.

In some embodiments, in response to detecting the second input, in accordance with the determination that the second input is directed to the first field, the electronic device updates the second field to include second text corresponding to a solution to the mathematical equation converted from the first unit of measure to the second unit of measure with the visual characteristic having a second value different from the first value, such as displaying numerical value 826e in field 819b in a second color different from the first color in FIG. 8G. In some embodiments, the visual characteristic is different from a location in the user interface; thus, displaying the first text with a first visual characteristic having the first value and second text with the visual characteristic having a second, different value includes displaying the first text and second text with a difference in addition to being displayed at different locations in the user interface. In some embodiments, the visual characteristic is color. Additionally, in some embodiments, it is possible for the electronic device to display the first text with the first visual characteristic having the first value at different locations in the user interface, such as in either the first field or the second field, as further described below. In some embodiments, the visual characteristic is a characteristic other than color, such as size, line style, and/or translucency.

In some embodiments, in response to detecting the second input, in accordance with the determination that the input is directed to the second field, the electronic device updates the second field to include the first text corresponding to the mathematical equation with the visual characteristic having a third value, such as displaying equation 826e in field 819b in the first color. In some embodiments, the electronic device directs the input focus to the second field in a manner similar to the manner described above of directing the input focus to the first field. In some embodiments, the second field further includes the second text corresponding to the solution to the mathematical equation in the second unit of measure in response to detecting the second input directed to the second field in manner similar to the above-described manner of displaying the third text in the first field in response to detecting the second input directed to the first field. In some embodiments, the electronic device forgoes displaying the second text in the second field until further input is detected, such as an input directed to the first field as described below, or one of the inputs described above with reference to forgoing displaying the third text in the first field in response to detecting the second input directed to the first field. In some embodiments, in response to detecting the second input directed to the second field, the first text is associated with the second unit of measure and/or the equation is in the second unit of measure. In some embodiments, the third value is the same as the first value. In some embodiments, the third value is different from the first value. In some embodiments, the electronic device displays the first text with the visual characteristic having the first third while detecting the first portion of the second input as described above and, in response to detecting the second portion of the second input, displays the solution in the second unit of measure with the visual characteristic having the fourth value described below.

In some embodiments, in response to detecting the second input, in accordance with the determination that the input is directed to the second field, the electronic device 500 updates the first field to include third text corresponding to the solution to the mathematical equation converted from the second unit of measure to the first unit of measure with the visual characteristic having a fourth value different from the third value, such as displaying the numerical value 826b in field 819a in the second color. In some embodiments, the visual characteristic is one of the visual characteristics described above with reference to the visual characteristics having the first or second value. In some embodiments, the fourth value is the same as the second value. In some embodiments, the fourth value is different from the second value. Concurrently displaying the equation in one unit and the solution to the equation in another unit converted from the unit of the equation reduces time, inputs, and user error when performing calculations and unit conversions together with a calculator application.

In some embodiments, while displaying, in the first field, the first text corresponding to the mathematical equation and displaying, in the second field, the second text corresponding to the solution to the mathematical equation converted from the first unit of measure to the second unit of measure (e.g., as described above), the electronic device detects, via the one or more input devices, an input directed to the second field (such as input in FIG. 8G being directed to field 826c instead). In some embodiments, the input corresponds to selection of the second field.

In some embodiments, while displaying, in the first field, the first text corresponding to the mathematical equation and displaying, in the second field, the second text corresponding to the solution to the mathematical equation converted from the first unit of measure to the second unit of measure (e.g., as described above), in response to detecting the input directed to the second field, the electronic device ceases display of the first text in the first field, such as displaying numerical value 826b in field 819a in FIG. 8H. In some embodiments, the electronic device maintains display of the first text at a location in the user interface other than the first field after ceasing display of the first text in the first field. For example, the electronic device maintains display of the first text in a sidebar region of the user interface including indications of one or more operations previously performed with the calculator application, as described in more detail below.

In some embodiments, while displaying, in the first field, the first text corresponding to the mathematical equation and displaying, in the second field, the second text corresponding to the solution to the mathematical equation converted from the first unit of measure to the second unit of measure (e.g., as described above), in response to detecting the input directed to the second field, the electronic device displays, via the one or more display generation components, fourth text corresponding to the solution to the mathematical equation in the first unit of measure in the first field (while maintaining display of the second text in the second field), such as displaying numerical value 826b in field 819a in FIG. 8H. In some embodiments, the electronic device displays the fourth text with the visual characteristic having the second value, the same value of the visual characteristic of the second text in the second field. In some embodiments, the electronic device displays the fourth text with the visual characteristic having a value different from the second value, a different value of the visual characteristic from the value of the visual characteristic of the second text in the second field. In some embodiments, the electronic device displays the fourth text with the visual characteristic having the first value, the same value of the visual characteristic with which the electronic device displayed the first text in the first field. In some embodiments, the electronic device displays the fourth text with the visual characteristic having a value different from the first value, a different value of the visual characteristic from the value of the visual characteristic with which the electronic device displayed the first text in the first field. Optionally, in some embodiments, the electronic device maintains display of the first text in the first field while displaying the fourth text in the first field in response to detecting the input directed to the second field.

In some embodiments, the electronic device detects, via the one or more input devices, an input directed to the first field, such as receiving an input directed to field 819a in FIG. 8L. In some embodiments, the input corresponds to selection of the second field.

In some embodiments, in response to detecting the input directed to the second field, the electronic device ceases display of the first text in the second field, such as ceasing display of text 826e in field 819b in FIG. 8L. In some embodiments, the electronic device maintains display of the first text at a location in the user interface other than the second field after ceasing display of the first text in the second field in a manner similar to the manner described above of maintaining display of the first text at the location in the user interface other than the first field after ceasing display of the first text in the first field.

In some embodiments, in response to detecting the input directed to the second field, the electronic device displays, via the one or more display generation components, fifth text corresponding to the solution to the mathematical equation in the second unit of measure in the second field, such as displaying numerical value 829e in field 819b in FIG. 8M (while maintaining display of the third text in the first field). In some embodiments, the electronic device displays the fifth text with the visual characteristic having the fourth value, the same value of the visual characteristic of the third text in the first field. In some embodiments, the electronic device displays the fifth text with the visual characteristic having a value different from the fourth value, a different value of the visual characteristic from the value of the visual characteristic of the third text in the first field. In some embodiments, the electronic device displays the fifth text with the visual characteristic having the third value, the same value of the visual characteristic with which the electronic device displayed the first text in the second field. In some embodiments, the electronic device displays the fifth text with the visual characteristic having a value different from the third value, a different value of the visual characteristic from the value of the visual characteristic with which the electronic device displayed the first text in the second field. Optionally, in some embodiments, the electronic device maintains display of the first text in the first field while displaying the fifth text in the second field in response to detecting the input directed to the first field. Updating the calculator user interface to include the solution to the mathematical equation in the unit corresponding to the field into which the mathematical equation was entered reduces time, inputs, and user error when performing calculations and unit conversions together with a calculator application.

In some embodiments, while displaying the user interface of the calculator application, the electronic device detects, via the one or more input devices, an input corresponding to a request to use the calculator application to display solutions to equations in a content entry region; (e.g., as described above with reference to method 700, such as the display of solution 608 to text 604 in FIG. 6B), such as an input selecting option 822d in FIG. 8D. In some embodiments, detecting this input includes detecting selection of a selectable option included in a menu of options corresponding to different modes and/or operations of the calculator application. In some embodiments, prior to displaying the menu, the electronic device receives an input selecting a menu option included in the user interface of the calculator application. In some embodiments, the electronic device displays the menu in response to detecting the input selecting the menu option.

In some embodiments, while displaying the user interface of the calculator application, in response to detecting the input corresponding to the request to use the calculator application to display solutions to equations in the content entry region, the electronic device updates, via the one or more display generation components, the user interface of the calculator application to include the content entry region (e.g., as described above with reference to method 700, such as content entry region 602 in FIG. 6A). In some embodiments, updating the user interface of the calculator application includes ceasing display of one or more elements of the user interface of the calculator application displayed while the input was detected. For example, the electronic device ceases display of the first and/or second field. As another example, the electronic device ceases display of one or more selectable options that, when selected, cause the electronic device to insert numbers and/or portions of mathematical equations into the first field or the second field, such as options 804 through 816 in FIG. 8A. The content entry region is described in more detail above with reference to method 700, such as the content entry region 602 in FIG. 6A.

In some embodiments, while displaying the user interface of the calculator application, while displaying the content entry region in the user interface of the calculator application, the electronic device detects, via the one or more input devices, an input directed to the content entry region (e.g., as described above with reference to method 700, such as with stylus 203 shown in FIG. 6A). In some embodiments, while displaying the user interface of the calculator application, while displaying the content entry region in the user interface of the calculator application, in response to detecting the input, the electronic device displays, in the content entry region a representation of the input, as described above with reference to method 700, such as text 604 in FIG. 6A. In some embodiments, while displaying the user interface of the calculator application, while displaying the content entry region in the user interface of the calculator application, in response to detecting the input, in accordance with a determination that the input satisfies one or more first criteria including a criterion that is satisfied when the input includes a mathematical equation, the electronic device displays, in the content entry region, information corresponding to a solution to the mathematical equation near the representation of the input, wherein the solution was not provided as part of the input; and as described above with reference to method 700, such as solution 608 in FIG. 6B. In some embodiments, while displaying the user interface of the calculator application, while displaying the content entry region in the user interface of the calculator application, in response to detecting the input, in accordance with a determination that the input does not satisfy the one or more first criteria, forgoes displaying the information corresponding to the solution to the input near the input, optionally as described above with reference to method 700, such as the inputs with stylus 203 in FIG. 6G writing text 622 and 624, resulting in no solution being displayed for this text in FIG. 6I. Displaying a solution in accordance with a determination that text displayed in response to detecting an input is a first type of text enhances user interactions with the computer system by reducing the amount of inputs needed to display the solution, and also reduces erroneous inputs to the electronic device.

In some embodiments, the one or more first criteria include a criterion that is satisfied when the input includes a request to convert a fourth numerical value in a third unit of measure to a respective numerical value in a fourth unit of measure, such as the inputs shown in FIG. 8V, and displaying the information corresponding to the solution includes displaying, via the display generation component, a fifth numerical value that is a conversion of the fourth numerical value in the third unit of measure into an equivalent value in the fourth unit of measure (and, optionally a representation of the third unit of measure that is displayed in simulated handwriting next to the fourth numerical value), such as text 860 and 844 in FIG. 8W. In some embodiments, the input is a text input, such as the text inputs, including handwriting and/or typed inputs, described with reference to method 700 and/or FIGS. 6A and 6D. In some embodiments, the input includes the fourth numerical value, an indication of the third unit, and an indication of the fourth unit without including an indication of the respective numerical value or the fifth numerical value. In some embodiments, the input includes an equals sign (or a horizontal line below a column of vertical math). In some embodiments, the one or more criteria include a criterion that is satisfied when the input includes an equals sign (or a horizontal line below a column of vertical math) and is not satisfied when the input does not include an equals sign (or a horizontal line below a column of vertical math). In some embodiments, the one or more criteria are satisfied when the input includes the unit conversion request described herein without including a mathematical equation. In some embodiments, the input includes a mathematical equation including units and/or a unit conversion request and the one or more criteria include a criterion that is satisfied when the input includes the mathematical equation, unit(s), and/or unit conversion request. In some embodiments, the electronic device displays the information corresponding to the solution automatically in response to receiving the input that satisfies the one or more first criteria without receiving an additional input as described in more detail above with reference to method 700 and/or FIGS. 6A and 6B. In some embodiments, the electronic device displays the information corresponding to the solution in response to detecting an input requesting display of the solution, as described in more detail above with reference to method 700 and/or FIGS. 6J-6K. Performing unit conversion in response to detecting a text input including a unit conversion request enhances user interactions with the electronic device by reducing the inputs needed to perform unit conversions while entering other text in a user interface.

In some embodiments, while displaying the user interface of the calculator application, in response to detecting the input corresponding to the request to use the calculator application for unit conversion, the electronic device displays a first visual indication that indicates that the first field is associated with the first unit of measure, such as indication 828a in FIG. 8E. In some embodiments, the electronic device displays the first visual indication in the first field. In some embodiments, the electronic device displays the first visual indication proximate to the first field. In some embodiments, the first visual indication includes text indicating the first unit of measure. For example, if the first unit of measure is seconds, the first visual indication includes the text “seconds,” “sec,” or “s.”

In some embodiments, while displaying the user interface of the calculator application, in response to detecting the input corresponding to the request to use the calculator application for unit conversion, the electronic device displays a second visual indication that indicates that the second field is associated with the second unit of measure, such as indication 828b in FIG. 8E. In some embodiments, the electronic device displays the second visual indication in the second field. In some embodiments, the electronic device displays the second visual indication proximate to the second field. In some embodiments, the second visual indication includes text indicating the second unit of measure. For example, if the second unit of measure is centimeters, the first visual indication includes the text “centimeters” or “cm.” In some embodiments, the electronic device displays the first visual indication and the second visual indication concurrently. Displaying the visual indications of the first unit of measure and second unit of measure as described above enhances user interactions with the electronic device by reducing user error when converting units of measure using a calculator application.

In some embodiments, while displaying the user interface of the calculator application, while the first field is associated with the first unit of measure, the electronic device detects, via the one or more input devices, an input selecting the first visual indication such as input with contact 803 in FIG. 8H. In some embodiments, the input selecting the first visual indication includes a tap or air gesture directed to a location in the user interface at which the electronic device displays the first visual indication. In some embodiments, the input selecting the first visual indication includes an input the electronic device receives using a hardware input device, such as a mouse, trackpad, or keyboard. In some embodiments, the input selecting the first visual indication includes a voice input.

In some embodiments, while displaying the user interface of the calculator application, while the first field is associated with the first unit of measure, in response to detecting the input selecting the first visual indication, the electronic device updates the calculator user interface to include an option for associating the first field with a third unit of measure different from the first unit of measure, such as options 832a through 832e in FIG. 8I. In some embodiments, the option is included in a menu of options associated with a plurality of different units of measure. In some embodiments, the options in the menu are associated with units of measure that measure the same characteristic measured by the first unit of measure and the menu does not include options associated with units of measure that measure other characteristics. In some embodiments, the options in the menu are associated with units of measure that measure the different characteristics.

In some embodiments, while displaying the user interface of the calculator application, while the first field is associated with the first unit of measure, while displaying the option for associating the first field with the third unit of measure, detecting, via the one or more input devices, an input directed to the option for associating the first field with the third unit of measure, such as the input with contact 803 in FIG. 8I. In some embodiments, the input directed to the option for associating the first field with the third unit of measure includes a tap or air gesture directed to a location in the user interface at which the electronic device displays the option for associating the first field with the third unit of measure. In some embodiments, the electronic device receives the input directed to the option for associating the first field with the third unit of measure using a hardware input device, such as a mouse, trackpad, or keyboard. In some embodiments, the input directed to the option for associating the first field with the third includes a voice input.

In some embodiments, while displaying the user interface of the calculator application, in response to detecting the input directed to the option for associating the first field with the third unit of measure, the electronic device updates the first field to be associated with the third unit of measure and not associated with the first unit of measure, such as in FIG. 8J as indicated by indication 828b. In some embodiments, while the first field is associated with the first unit of measure, the electronic device displays the first numerical value or the third numerical value as described above in the first field that represents a respective quantity in the first unit of measure. In some embodiments, updating the first field to be associated with the third unit of measure includes displaying a fourth numerical value that represents the respective quantity in the third unit of measure. In some embodiments, in accordance with the electronic device making a determination that the third unit of measure measures the same characteristic measured by the first unit of measure, in response to updating the first field to be associated with the third unit of measure, the electronic device maintains the second field, including maintaining the association of the second field with the second unit of measure and maintaining display of a respective numerical value the electronic device displayed in the second field while the first field was associated with the first unit of measure. In some embodiments, in accordance with the electronic device making a determination that the third unit of measure measures a different characteristic from the characteristic measured by the first unit of measure, in response to updating the first field to be associated with the third unit of measure, the electronic device updates the second field. In some embodiments, updating the second field in response to associating the first field with the third unit of measure includes associating the second field with a fifth unit of measure that measures the same characteristic measured by the third unit of measure and updates the second field to include a respective numerical value that is the equivalent quantity in the fifth unit of measure as the quantity in the third unit of measure the electronic device displays in the first field.

In some embodiments, while the second field is associated with the second unit of measure, the electronic device detects, via the one or more input devices, an input selecting the second visual indication; such as in FIG. 8M. In some embodiments, the input selecting the second visual indication has one or more of the characteristics of the input selecting the first visual indication described above. In some embodiments, while the second field is associated with the second unit of measure, in response to detecting the input selecting the second visual indication, the electronic device updates the calculator user interface to include an option for associating the second field with a fourth unit of measure different from the second unit of measure; and such as in FIG. 8N. In some embodiments, the electronic device displays the option for associating the second field with the fourth unit of measure in a menu having one or more of the characteristics of the menu including the option to associate the first field with the third unit of measure described above. In some embodiments, while the second field is associated with the second unit of measure, while displaying the option for associating the second field with the fourth unit of measure, the electronic device detects, via the one or more input devices, an input directed to the option for associating the second field with the fourth unit of measure; and such as in FIG. 8IB. In some embodiments, the input directed to the option for associating the second field with the fourth unit of measure has one or more of the characteristics of the input directed to the option for associating the first field with the third unit of measure described above. In some embodiments, while the second field is associated with the second unit of measure, in response to detecting the input directed to the option for associating the second field with the fourth unit of measure, the electronic device updates the second field to be associated with the fourth unit of measure and not associated with the second unit of measure, such as in FIG. 8J. In some embodiments, updating the second field to be associated with the fourth unit of measure includes updating the quantity displayed in the second field in a manner similar to the above-described manner of updating the quantity displayed in the first field in response to updating the first field to be associated with the third unit of measure. In some embodiments, in accordance with the electronic device making a determination that the fourth unit of measure measures the same characteristic measured by the second unit of measure, in response to updating the second field to be associated with the fourth unit of measure, the electronic device maintains the first field in a manner similar to the above-described manner of maintaining the second field in accordance with a determination that the first and third units of measure the same characteristic. In some embodiments, in accordance with the electronic device determining that the fourth unit of measure measures a different characteristic from the characteristic measured by the second unit of measure, in response to updating the second field to be associated with the fourth unit of measure, the electronic device updates the first field in a manner similar to the above-described manner of updating the second field in response to updating the first field to be associated with a third unit of measure that measures a characteristic different from the characteristic measured by the first unit of measure. Updating the units of measure associated with the first field or second field reduces user error when converting units using a calculator application.

In some embodiments, while displaying the user interface of the calculator application, in response to detecting the input directed to the option for associating the first field with the third unit of measure, in accordance with a determination that the third unit of measure is in a first category of units of measure that is different from a second category of units of measure of the first unit of measure, updating the second field to be associated with a fifth unit of measure that is in the first category of units of measure, such as the units indicated by indications 828a and 828b in FIG. 8Q. In some embodiments, in accordance with a determination that the third unit of measure is in the second category of units, the second field continues to be associated with the second unit of measure. In some embodiments, the electronic device selects the fifth unit of measure as described in more detail below. In some embodiments, the electronic device also updates the second field to include a respective numerical value that is the equivalent quantity in the fifth unit of measure to the first quantity in the third unit of measure when associating the second field with the fifth unit of measure.

In some embodiments, in response to detecting the input directed to the option for associating the second field with the fourth unit of measure, in accordance with a determination that the fourth unit of measure is in a third category of units of measure that is different from the second category of units of measure of the second unit of measure, updating the first field to be associated with a sixth unit of measure that is in the third category of units of measure. In some embodiments, in accordance with a determination that the fourth unit of measure is in the second category of units, the first field continues to be associated with the first unit of measure. In some embodiments, the electronic device selects the sixth unit of measure as described in more detail below. In some embodiments, the electronic device also updates the first field to include a respective numerical value that is the equivalent quantity in the sixth unit of measure to the second quantity in the fourth unit of measure when associating the first field with the sixth unit of measure. Updating both fields to remain in the same category of units of measure in response to detecting an input changing the category of units associated with one of the fields enhances user interactions with the electronic device by reducing the number of inputs needed to continue converting quantities between the first and second fields and reduces user errors.

In some embodiments, the fifth unit of measure is selected to be associated with the second field based on (e.g., in accordance with a determination that) the fifth unit of measure and the third unit of measure being a more frequent combination of units than other units of measure in the first category of units of measure and the third unit of measure, such as the units of measure indicated by indications 828a and 828b in FIG. 8Q. In some embodiments, if a respective unit of measure and the third unit of measure was a more frequent combination of units than the combination of the fifth unit of measure and the third unit of measure, then the electronic device would associate the second field with the respective unit of measure instead. In some embodiments the frequency is a frequency with which the electronic device has performed unit conversions between various pairs of units. In some embodiments, the frequency is a frequency with which multiple electronic devices (e.g., including electronic devices not associated with the same user account as the electronic device) have performed unit conversions between various pairs of units. In some embodiments, the sixth unit of measure is selected to be associated with the first field based on (e.g., in accordance with a determination that) the sixth unit of measure and the fourth unit of measure being a more frequent combination of units than other units of measure in the third category of units of measure and the fourth unit of measure. In some embodiments, if a respective unit of measure and the fourth unit of measure was a more frequent combination of units than the combination of the sixth unit of measure and the fourth unit of measure, then the electronic device would associate the first field with the respective unit of measure instead. The electronic device optionally determines frequency of converting quantities between pairs of units as described above with respect to associating the second field with the fifth unit of measure. Selecting the unit of measure to convert the selected unit of measure to based on frequency of converting quantities between units enhances user interactions with the electronic device by reducing user inputs needed to perform frequently-performed operations and reducing user errors.

In some embodiments, the fifth unit of measure is selected to be associated with the second field based on (e.g., in accordance with a determination that) the fifth unit of measure and the third unit of measure being used in combination more recently than other units of measure in the first category of units of measure and the third unit of measure, such as the units of measure indicated by indications 828a and 828b in FIG. 8Q. In some embodiments, if a respective unit of measure and the third unit of measure was a more recent combination of units than the combination of the fifth unit of measure and the third unit of measure, then the electronic device would associate the second field with the respective unit of measure instead. In some embodiments the recency is a recency with which the electronic device has performed unit conversions between various pairs of units.

In some embodiments, the sixth unit of measure is selected to be associated with the first field based on (e.g., in accordance with a determination that) the sixth unit of measure and the fourth unit of measure being used in combination more recently than other units of measure in the third category of units of measure and the fourth unit of measure. In some embodiments, if a respective unit of measure and the third unit of measure was a more recent combination of units than the combination of the sixth unit of measure and the third unit of measure, then the electronic device would associate the first field with the respective unit of measure instead. In some embodiments the recency is a recency with which the electronic device has performed unit conversions between various pairs of units. Selecting the unit of measure to convert the selected unit of measure to based on recency of converting quantities between units enhances user interactions with the electronic device by reducing user inputs needed to perform frequently-performed operations and reducing user errors.

In some embodiments, updating the calculator user interface to include the option for associating the first field with the third unit of measure includes displaying a unit selection user interface element associated with the first field that further includes one or more first selectable options that, when selected, cause the electronic device to associate the first field with one or more units of measure different from the third unit of measure in the same category as the third unit of measure, such as options 832a through 832e in FIG. 8O. In some embodiments, while the unit selection user interface element includes the selectable options associated with units of measure in the same category as the third unit of measure, the unit selection user interface element does not include options associated with units of measure in categories different from the category of the third unit of measure.

In some embodiments, updating the calculator user interface to include the option for associating the first field with the third unit of measure includes displaying a unit selection user interface element associated with the first field that further includes one or more second selectable options that, when selected, cause the electronic device to update the unit selection user interface element associated with the first field to include selectable options that, when selected, causes the electronic device to associate the first field with units of measure in categories different from the category of the third unit of measure, such as options 829a through 829c in FIG. 8O. In some embodiments, the one or more selectable options include an option that, when selected, causes the electronic device to display options associated with a first respective category of units of measure (and not options associated with units of measure associated with other categories) and an option that, when selected, causes the electronic device to display options associated with a second respective category of units of measure (and not options associated with units of measure associated with other categories).

In some embodiments, updating the calculator user interface to include the option for associating the second field with the fourth unit of measure includes displaying a unit selection user interface element associated with the second field that further includes one or more third selectable options that, when selected, cause the electronic device to associate the second field with one or more units of measure different from the fourth unit of measure in the same category as the fourth unit of measure, optionally as described above with reference to the unit selection user interface element associated with the first field; and In some embodiments, the appearances of the unit selection user interface element associated with the first field and the unit selection user interface element associated with the second field are the same, but the functionality of these user interface elements differ in which field they modify. For example, the unit selection user interface element associated with the first field includes options for setting the unit of measure associated with the first field and the unit selection user interface element associated with the second field includes options for setting the unit of measure associated with the second field.

In some embodiments, updating the calculator user interface to include the option for associating the second field with the fourth unit of measure includes displaying a unit selection user interface element associated with the second field that further includes one or more fourth selectable options that, when selected, cause the electronic device to update the unit selection user interface element associated with the second field to include selectable options that, when selected, causes the electronic device to associate the second field with units of measure in categories different from the category of the fourth unit of measure, optionally as described above with reference to the unit selection user interface element associated with the first field. Displaying options to associate a respective field with units of measure in a respective category and options to display other options to associate the respective field with units of measure in other respective categories enhances user interactions with the electronic device by reducing the inputs needed to find a desired unit.

In some embodiments, updating the calculator user interface to include the option for associating the first field with the third unit of measure includes displaying a unit selection user interface element associated with the first field that further includes a search field, such as search field 833 in FIG. 8R. In some embodiments, in response to detecting an input directed to the search field that includes a search query, the electronic device displays one or more options for associating the first field with units of measure matching the search query, as described in more detail below.

In some embodiments, updating the calculator user interface to include the option for associating the second field with the fourth unit of measure includes displaying a unit selection user interface element associated with the second field that further includes the search field, optionally as described with respect to the unit selection user interface element associated with the first field but pertaining to options for changing the unit of measure associated with the second field, such as search field 833.

In some embodiments, while displaying the unit selection user interface element associated with the first field, the electronic device detects, via the one or more input devices, a first input directed to the search field that corresponds to a request to search for a search query, such as input with contact 803 directed to search field 833 in FIG. 8R. In some embodiments, the first input is a voice input as described above. In some embodiments, the first input is a typed text input as described above. In some embodiments, the first input is a handwritten text input as described above. In some embodiments, the search query includes one or more words and/or portions of words. The words and/or portions of words optionally include one or more units of measure and/or portions of the names of units of measure.

In some embodiments, while displaying the unit selection user interface element associated with the first field, the electronic device, in response to detecting the first input directed to the search field, the electronic device displays in the unit selection user interface element associated with the first field, via the one or more display generation components, a selectable option that, when selected, causes the electronic device to associate the first field with a respective unit of measure corresponding to the search query, such as options 842a through 842c in FIG. 8S. In some embodiments, in response to detecting selection of the selectable option, the electronic device associates the first field with the respective unit of measure as described herein with respect to changing the units of measure associated with the first or second field in response to detection selection of options. In some embodiments, the respective unit of measure is a search result of the search query. In some embodiments, the electronic device displays additional options associated with other units of measure that are search results of the search query

In some embodiments, while displaying the unit selection user interface element associated with the second field, the electronic device detects, via the one or more input devices, a second input directed to the search field that corresponds to a request to search for the respective unit of measure, (e.g., similar to the first input described above), such as the input with contact 803 in FIG. 8R. In some embodiments, while displaying the unit selection user interface element associated with the second field, in response to detecting the second input directed to the search field, the electronic device displays in the unit selection user interface element associated with the second field, via the one or more display generation components, a selectable option that, when selected, causes the electronic device to associate the second field with the respective unit of measure, such as options 842a through 842c in FIG. 8S and optionally similar to the selectable option that, when selected, causes the electronic device to associate the first field with the respective field of measure as described above. Displaying a search field in the unit selection user interface elements enhances user interactions with the electronic device by reducing the number of inputs needed to find an option associated with a desired unit of measure.

In some embodiments, while displaying the unit selection user interface element associated with the first field, in response to detecting the first input directed to the search field, the electronic device concurrently displays in the unit selection user interface element associated with the first field, via the one or more display generation components, the selectable option that, when selected, causes the electronic device to associate the first field with the respective unit of measure visually associated with additional selectable options that, when selected, causes the electronic device to associate the first field with respective units of measure in the same category as the respective unit of measure, such as one of options 842a through 842c in FIG. 8S. In some embodiments, the additional selectable options are associated with units of measure that are results for the search query described above.

In some embodiments, while displaying the unit selection user interface element associated with the first field, in response to detecting the first input directed to the search field, the electronic device concurrently displays in the unit selection user interface element associated with the first field, via the one or more display generation components, visually associated with each other, a plurality of selectable options that, when selected, cause the electronic device to associate the first field with units of measure in a category other than the category of the respective unit of measure, such as one of options 842a through 842c in FIG. 8S. In some embodiments, the electronic device displays the results of the search in sections based on categories of units of measure.

In some embodiments, while displaying the unit selection user interface element associated with the second field, in response to detecting the second input directed to the search field, the electronic device concurrently displays in the unit selection user interface element associated with the second field, via the one or more display generation components, the selectable option that, when selected, causes the electronic device to associate the second field with the respective unit of measure visually associated with additional selectable options that, when selected, causes the electronic device to associate the second field with respective units of measure in the same category as the respective unit of measure, optionally as described above with reference to the unit selection user interface element associated with the first field but for options to associate the second field with a different unit of measure and visually associated with each other, a plurality of selectable options that, when selected, cause the electronic device to associate the second field with units of measure in a category other than the category of the respective unit of measure, as described above with reference to the unit selection user interface element associated with the first field but for options to associate the second field with a different unit of measure. Displaying the results of the search in sections associated with respective categories of units of measure enhances user interactions with the electronic device by reducing the time it takes to find a desired unit of measure.

In some embodiments, while displaying the user interface of the calculator application, the electronic device displays, via the one or more display generation components, the first numerical value in the first field and the second numerical value in the second field, optionally as described above, such as fields 819a and 819b in FIGS. 8E-8S.

In some embodiments, while displaying the user interface of the calculator application, the electronic device displays in the user interface of the calculator application, via the one or more display generation components, a respective selectable option that, when selected, causes the electronic device to display the second numerical value in the first field, such as displaying an option in FIG. 8E that, when selected causes the electronic device to display the numerical value 826c in field 819a.

In some embodiments, while displaying the user interface of the calculator application,

the electronic device detects, via the one or more input devices, an input directed to the respective selectable option, such as one of the inputs with contact 803 shown in FIGS. 8A-8S. In some embodiments, the input is a selection input as described herein, directed to the respective selectable option. Additionally or alternatively, in some embodiments, the input is a voice input requesting to display the second numerical value in the first field. The voice input optionally is not directed to the respective selectable option.

In some embodiments, while displaying the user interface of the calculator application, in response to detecting the input directed to the respective selectable option, the electronic device displays in the first field, via the one or more display generation components, the second numerical value, such as displaying numerical value 826c in FIG. 8E in field 819a. In some embodiments, the electronic device ceases to display the first numerical value in the first field.

In some embodiments, while displaying the user interface of the calculator application, in response to detecting the input directed to the respective selectable option, the electronic device displays in the second field, via the one or more display generation components, a fourth numerical value that is a conversion of the second numerical value in the first unit of measure into an equivalent value in the second unit of measure, such as displaying a numerical value in field 819b that is the equivalent value in the second unit of measure to numerical value 826c in the first unit of measure. In some embodiments, if the second field were associated with a third unit of measure different from the second unit of measure, the electronic device would display a fifth numerical value in the second field that is a conversion of the second numerical value in the first unit of measure into an equivalent value in the third unit of measure. Displaying a conversion of the second numerical value from the first unit of measure to the second unit of measure in the second field in response to the input requesting to display the second numerical value in the first field enhances user interactions with the computer system by enabling the use to quickly correct user errors, such as entering the second numerical value into the second field instead of the first.

In some embodiments, while displaying the user interface of the calculator application, the electronic device detects, via the one or more input devices, an input selecting a respective field (e.g., the first field or the second field), such as the input with contact 803 in FIG. 8E selecting field 819a. This input optionally has one or more characteristics of other inputs selecting the first field or the second field described above.

In some embodiments, while displaying the user interface of the calculator application, in response to detecting the input selecting the respective field (e.g., the first field or the second field), the electronic device updates the user interface of the calculator application to include a backspace option, such as option 807 in FIG. 8F. In some embodiments, prior to detecting the input selecting the first field or the second field, the user interface of the calculator application did not include the backspace option. In some embodiments, in response to detecting an input selecting a user interface element other than the first field, the second field, or the backspace option, the electronic device ceases display of the backspace option. In some embodiments, in response to detecting an input (e.g., voice input, typed input, and/or handwritten input) entering numbers and/or portions of a mathematical equation into the first field or second field, the electronic device ceases displaying the backspace option.

In some embodiments, while displaying the user interface of the calculator application, the electronic device detects, via the one or more input devices, an input directed to the backspace option, such as an input selecting the backspace option 807 in FIG. 8F. In some embodiments, the input is a selection input directed to the backspace option similar to the other selection inputs described herein. In some embodiments, the input is a backspace input including handwritten input, typed input (e.g., selection of a backspace key of a keyboard), or a voice input.

In some embodiments, in response to detecting the input directed to the backspace option, the electronic device deletes a portion of content shown in the respective field, such as field 819a or 819b in FIG. 8F. In some embodiments, the portion of the content includes a last character in a string of characters shown in the first field. In some embodiments, the portion of content includes a character adjacent to an insertion marker included in the first field. In some embodiments, in response to detecting repeated inputs directed to the backspace option (or other backspace inputs), the electronic device deletes additional characters from the first field. Displaying the backspace option and deleting content from the first field or second field in response to detecting an input directed to the first field reduces time, inputs, and errors when performing calculations and/or unit conversion with the calculator application.

In some embodiments, while displaying the user interface of the calculator application, prior to detecting the input selecting a respective field (e.g., the first field or the second field), the electronic device displays, at a respective location in the user interface of the calculator application, a clear option such as option 806 in FIG. 8E. In some embodiments, the clear option is displayed proximate to selectable options that, when selected, cause the electronic device to enter a respective character (e.g., of a number or mathematical operation) into one of the first or second field that has the current input focus. In some embodiments, while displaying the clear option, the electronic device forgoes displaying the backspace option.

In some embodiments, while displaying the user interface of the calculator application, prior to detecting the input selecting a respective field (e.g., the first field or the second field), the electronic device detects, via the one or more input devices, an input selecting the clear option, such as the clear option 806 in FIG. 8E. In some embodiments, the input selecting the clear option has one or more of the characteristics of selection inputs described herein. In some embodiments, the input includes a voice input, a handwritten input, a typed input, and/or an input detected using a hardware input device.

In some embodiments, while displaying the user interface of the calculator application, prior to detecting the input selecting a respective field (e.g., the first field or the second field), in response to detecting the input selecting the clear option, the electronic device deletes at least a portion of the content shown in the first field and the content shown in the second field, such as fields 819a and 819b in FIG. 8E. In some embodiments, deleting at least the portion of the content includes deleting all content shown in the first field and the second field. In some embodiments, deleting at least the portion of the content includes deleting a number (one or more digits) entered into the first or second field after entering a mathematical operator and maintaining display of at least the operator. In some embodiments, after detecting the input selecting the clear option, the electronic device maintains display of the clear option.

In some embodiments, while displaying the user interface of the calculator application, in response to detecting the input selecting the respective field, the electronic device ceases display of the clear option and displays the backspace option at the respective location in the user interface of the calculator application, such as backspace option 807 in FIG. 8F. In some embodiments, the electronic device displays either the clear option or the backspace option at the respective location and does not display the other option. Replacing the clear option with the backspace option enhances user interactions with the computer system by reducing inputs and user error when revising an input directed to the first or second field while using the calculator application.

In some embodiments, while displaying the user interface of the calculator application, the electronic device 500 displays, via the one or more display generation components, a history option in the user interface of the calculator application; such as option 802a in FIG. 8M.

In some embodiments, while displaying the user interface of the calculator application, the electronic device 500 detects, via the one or more input devices, an input selecting the history option, such as input with contact 803 in FIG. 8M. In some embodiments, the input selecting the history option has one or more of the characteristics of other selection options described herein. In some embodiments, the electronic device receives an input including a voice input or via a hardware device that corresponds to the function of the history option but is not directed to the history option spatially.

In some embodiments, while displaying the user interface of the calculator application, in response to detecting the input selecting the history option, the electronic device displays, via the one or more display generation components, a visual indication of one or more operations previously performed using the calculator application, such as indications 836a through 836h in FIG. 8N. In some embodiments, the electronic device displays a plurality of indications of a plurality of operations previously performed using the calculator application. In some embodiments, the operations include operations performed while the calculator is in the unit conversion mode and/or operations performed while the calculator is in a basic calculator mode for solving mathematical equations without unit conversion. In some embodiments, the electronic device displays the visual indication of the operation in a sidebar region of the user interface. In some embodiments, the indication includes an indication of an input provided to the calculator application, such as an input entering a number for unit conversion and/or a mathematical equation and an indication of the result of the unit conversion and/or the solution to the mathematical equation. In some embodiments, prior to displaying the sidebar region, the user interface includes respective content spanning a first region of the user interface and a second region of the user interface and while displaying the sidebar region, the electronic device displays the sidebar region in the first region and the respective content in the second region but not in the first region. In some embodiments, in response to detecting selection of one of the indications, the electronic device displays the solution(s) associated with the indication in the first field and/or second field. Displaying the indication of the operation previously performed using the calculator application in the user interface of the calculator application enhances user interactions with the electronic device by reducing inputs and user errors when the user wishes to view operations previously performed with the calculator application.

In some embodiments, while displaying the user interface of the calculator application without the visual indication of the operation previously performed using the calculator application, displaying one or more options for entering numerical values into a respective field (e.g., the first field or the second field) at a first size, such as the display of options 804 through 816 in FIG. 8M. In some embodiments, in response to detecting an input selecting a respective one of the one or more options for entering numerical values into the first field or the second field, the electronic device enters a number corresponding to the selected option into the one of the first or second field that has the current input focus. In some embodiments, the electronic device additionally displays one or more options for entering mathematical operations into the first field or the second field. In some embodiments, the electronic device displays the one or more options in the first region and the second region described above while not displaying the visual indication of the operation previously performed using the calculator application.

In some embodiments, while displaying the user interface of the calculator application with the visual indication of the operation previously performed using the calculator application, displaying the one or more options for entering numerical values into the respective field at a second size that is smaller than the first size, such as the display of options 804 through 816 in FIG. 8N. In some embodiments, as described above, while displaying the visual indication of the operation previously performed using the calculator application in a first region of the user interface, the electronic device displays the one or more selectable options in the second region and not in the first region. In some embodiments, displaying the one or more options at the second size includes displaying the same options that were displayed at the first size. In some embodiments, the selectable options are number and operation options of a calculator application. Reducing the size of the one or more options while displaying the visual indication of the operation previously performed with the calculator application enhances user interactions with the electronic device by preserving the functionality of the calculator application while displaying the indication of the operation.

In some embodiments, while displaying, via the one or more display generation components, the user interface of the calculator application, the electronic device detects, via the one or more input devices, a second input that includes a mathematical equation, such as the inputs with contact 803 in FIG. 8J-8L. In some embodiments, the second input that includes the mathematical equation has one or more of the characteristics of the second input including the mathematical equation described above.

In some embodiments, while displaying, via the one or more display generation components, the user interface of the calculator application, in response to detecting the second input, the electronic device displays, via the one or more display generation components, in the user interface of the calculator application, first text corresponding to the mathematical equation and second text corresponding to a solution to the mathematical equation, such as indication 826c and numerical value 826b in FIG. 8G. In some embodiments, the first text corresponding to the mathematical equation and the second text corresponding to the solution to the mathematical equation have one or more of the characteristics of the first text corresponding to the mathematical equation and the second text corresponding to the solution to the mathematical equation described above. In some embodiments, the first text and second text are in the same field, such as the first field or the second field. In some embodiments, the first text and second text are in different fields, such as the first field and the second field. Concurrently displaying the first text corresponding to the mathematical equation and the second text corresponding to the solution to the mathematical equation enhances user interactions with the electronic device by reducing user error when using the calculator application.

In some embodiments, in accordance with a determination that the user interface of the calculator application includes the first field but not the second field while the second input is detected, the first text corresponding to the mathematical equation and the second text corresponding to the solution to the first equation are in the same unit of measure, such as in FIG. 8D. In some embodiments, the user interface of the calculator application includes the first field but not the second field when the calculator application is configured to perform calculations without performing integrated unit conversion. In some embodiments, while the user interface of the calculator application includes the first field without including the second field, the first field is not associated with a particular unit of measure. In some embodiments, the first field is associated with an unspecified unit of measure. In some embodiments, the mathematical equation and its solution are in the same unit of measure when the calculator application includes the first field but not the second field. In some embodiments, while the user interface of the calculator application includes the first field without including the second field, the electronic device displays the first text and the second text in the first field. In some embodiments, displaying the first text and the second text in the first field includes displaying the first text with a visual characteristic having a first value and the second text with the visual characteristic having a second value different from the first value in a manner similar to the manner described above of displaying the first text and second text with the visual characteristic having the first value or the second value, respectively.

In some embodiments, in accordance with a determination that the user interface of the calculator application includes the first field associated with the first unit of measure and the second field associated with the second unit of measure while the second input is detected, the first text corresponding to the mathematical equation and the second text corresponding to the solution to the first equation are in different units of measure, such as in FIG. 8G. In some embodiments, the mathematical equation is in the first field in the first unit of measure and the solution to the mathematical equation is in the second field in the second unit of measure. In some embodiments, the mathematical equation is in the second field in the second unit of measure and the solution to the mathematical equation is in the first field in the first unit of measure. In some embodiments, the electronic device displays indications of the units of measure associated with the fields as described in more detail above. Displaying a solution to a mathematical equation in a different unit of measure from the unit of measure of the mathematical equation enhances user interactions with the electronic device by reducing human error when performing calculations and unit conversion together in a calculator application.

In some embodiments, detecting the input corresponding to the request to use the calculator application for unit conversion includes detecting selection of a unit conversion option included in a menu, such as toggle 822c in FIG. 8D. In some embodiments, the menu includes one or more additional options corresponding to other functions of the calculator application, such as basic calculations, scientific calculator functions, unit conversions, and/or calculations in a content entry region according to method 700 and/or 1100, such as content entry region 602 in FIG. 6A and/or user interface 1000 in FIG. 10A. In response to detecting selection of the basic calculations option, the electronic device updates the user interface of the calculator application to include selectable options for performing basic mathematical operations, such as number options and/or operation options including basic operations like addition, subtraction, multiplication, and division and not including operation options for more advanced operations like trigonometry, exponents, and/or logarithms. In response to detecting selection of the scientific calculations option, the electronic device updates the user interface of the calculator application to include selectable options for performing basic and more advanced mathematical operations, such as number options and/or operation options including basic operations like addition, subtraction, multiplication, division, trigonometry, exponents, and/or logarithms. In some embodiments, the unit conversions option is a toggle applied or not applied to the basic calculator and the scientific calculator and in response to detecting that the unit conversions option is toggled on, the electronic device displays the calculator application with two fields for two units of measure as described above and in response to detecting that the unit conversions option is toggled off, the electronic device displays the calculator application with one field. In response to detecting selection of the option to perform calculations and/or graphing in the content entry region, the electronic device displays the user interface described with reference to method(s) 700, 1100, and/or 1200, such as content entry region 602 in FIG. 6A and/or user interface 1000 in FIG. 10A.

In some embodiments, while displaying the user interface of the calculator application and prior to displaying the menu, the electronic device displays a menu option in the user interface of the calculator application, such as option 802b in FIG. 8C. In some embodiments, while displaying the menu option, the electronic device detects, via the one or more input devices, an input selecting the menu option, such as input with contact 803 in FIG. 8C. In some embodiments, the input selecting the menu option has one or more characteristics of other selection inputs described herein. In some embodiments, the input is a voice input, handwritten input, typed input, or input detected using a hardware devices that is not spatially directed to the menu option. In some embodiments, in response to detecting the input selecting the menu option, displaying, via the one or more display generation components, the menu including the unit conversion option, such as toggle 822c in FIG. 8D and as described above. In some embodiments, the electronic device displays the menu option in a user interface of the calculator application associated with a function other than unit conversion, such as basic calculations, scientific calculator functions, or calculations in a content entry region according to method 700 and/or 1100, such as content entry region 602 in FIG. 6A and/or user interface 1000 in FIG. 10A. Displaying the menu option to change the functionality of the calculator application enhances user interactions with the electronic device by reducing the number of inputs and/or user error when performing different mathematical equations.

It should be understood that the particular order in which the operations in FIGS. 9A-9B have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 1100, and 1200) are also applicable in an analogous manner to method 900 described above with respect to FIGS. 9A-9B. For example, the operation of performing unit conversions described above with reference to method 900 optionally has one or more of the characteristics of detecting mathematical equations and displaying solutions to mathematical equations, graphing mathematical equations, and displaying a menu of potions to modify one or more portions of a graph described herein with reference to other methods described herein (e.g., methods 700, 1100, and 1200). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 7 are, optionally, implemented by components depicted in FIGS. 1A-1B. For example, displaying operation 902, and detecting operation 910 are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Users interact with electronic devices in many different manners. In some embodiments, an electronic device is in communication with one or more input devices, one or more display generation components, and wireless circuitry. In some embodiments, the electronic device presents graphs of mathematical equations displayed in a user interface in response to detecting one or more inputs. The equations optionally include handwritten equations and/or equations displayed in font-based text. The electronic device provides ways of editing existing graphs of equations, such as separating and/or combining graphs of multiple equations, changing the color of displayed graphs, and/or adjusting the size and/or scale of a graph. Graphing mathematical equations provides an efficient way of visualizing mathematical equations. It is understood that people use devices. When a person uses a device, that person is optionally referred to as a user of the device.

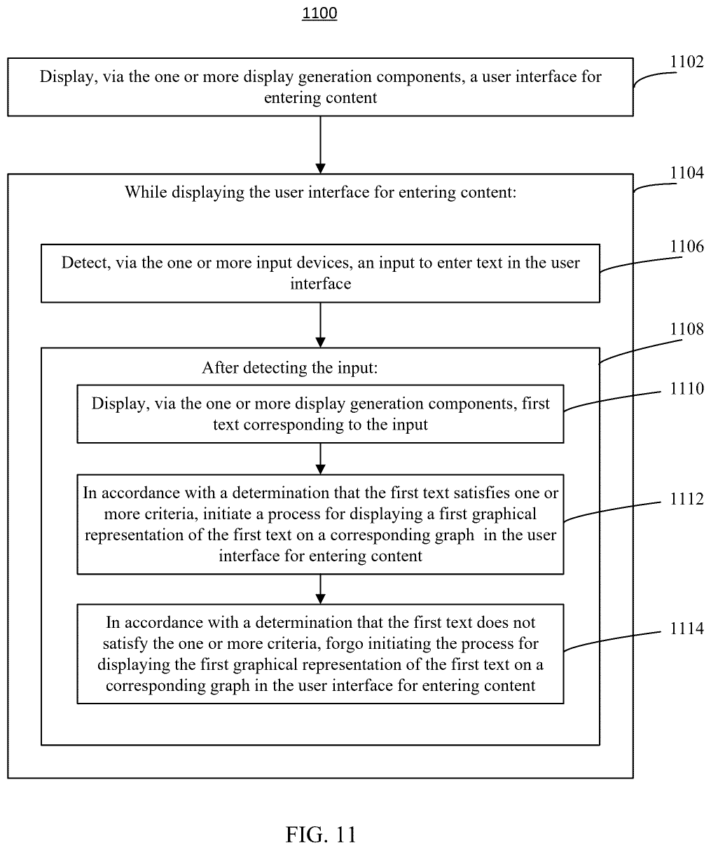

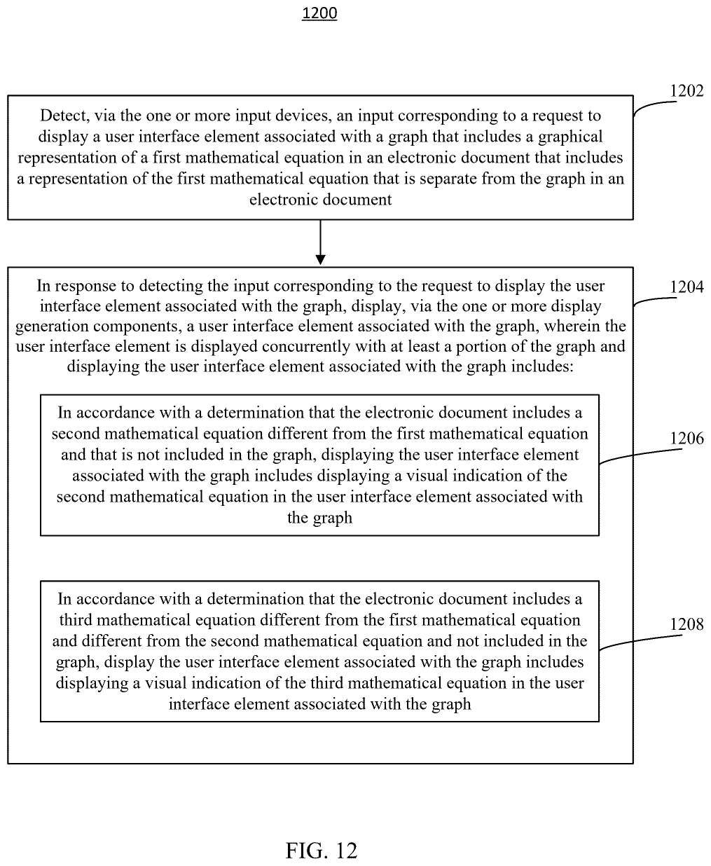

FIGS. 10A-10XX illustrate exemplary ways in which an electronic device presents and/or edits graphs of mathematical equations according to some embodiments. The embodiments in these figures are used to illustrate the processes described below, including the processes described with reference to FIGS. 11 and 12 Although FIGS. 10A-10XX illustrate various examples of ways an electronic device is able to perform the processes described below with respect to FIGS. 11 and 12, it should be understood that these examples are not meant to be limiting, and the electronic device is able to perform one or more processes described below with reference to FIGS. 11 and 12 in ways not expressly described with reference to FIGS. 10A-10XX.

FIG. 10A illustrates the electronic device 500 displaying a user interface 1000 for presenting content. In some embodiments, the user interface 1000 has one or more features of user interfaces described above with reference to method 700. For example, the electronic device displays handwritten text 1002 in the user interface 1000 in response to detecting a handwriting input with stylus 1013. Additionally or alternatively, the electronic device 500 displays other content in the user interface 1000 such as font-based writing (e.g., in response to detecting a voice input and/or an input using a soft keyboard or hardware keyboard), handwritten drawings, and/or other images. In some embodiments, text 1002 assigns a numerical value to a variable. When performing mathematical operations that include the variable, the electronic device 500 will perform the operations, such as computations and/or graphing, with the assigned numerical value in place of the variable. Examples of computations involving variables assigned to numerical values are described above with reference to method 700.

In some embodiments, the user interface 1000 is a user interface of a calculator application and further includes mode option 1050 described above with reference to method 700 and/or method 900. In FIG. 10A, the electronic device 500 detects handwritten input provided by stylus 1013. Additionally or alternatively, in some embodiments, the electronic device 500 detects other types of inputs (e.g., typed inputs and/or voice inputs) for adding content to the user interface. In response to detecting the input, the electronic device 500 displays additional content in the user interface 1000, as shown in FIG. 10B.

FIG. 10B illustrates the electronic device 500 displaying handwritten text 1004 in the user interface 1000 in response to detecting the input described above with reference to FIG. 10A. In some embodiments, the electronic device 500 identifies that the text 1004 satisfies one or more graphing criteria described below with respect to method(s) 1100 and/or 1200, such as being a mathematical equation with multiple predefined variables (e.g., x and y) and/or in a predefined format (e.g., equating “y” to a function of “x”). In some embodiments, in accordance with a determination that the text 1004 satisfies the criteria, the electronic device 500 displays the text 1004 with a visual characteristic that indicates that the text 1004 satisfies the one or more criteria, such as an animated color effect. This effect is represented by the fill pattern of the text 1004 in FIG. 10B. Additionally, the electronic device 500 displays a selectable option 1006 that, when selected, causes the electronic device 500 to display a graph of the mathematical equation represented by text 1004. As shown in FIG. 10B, the text 1004 includes the variable “m” that is assigned to a numerical value with text 1002. Thus, when the electronic device 500 displays a graph of the mathematical equation of text 1004, the electronic device 500 uses the numerical value assigned by text 1002 as the value for the variable in text 1004. In some embodiments, the visual characteristic of text 1004 shown in FIG. 10B is temporary. For example, the visual characteristic includes an animation with a finite duration. After the temporary duration of the visual characteristic of text 1004 in FIG. 10B, the electronic device 500 displays the text 1004 with a different visual characteristic, as shown in FIG. 10C.

FIG. 10C illustrates the electronic device 500 displaying the text 1004 with a different visual characteristic from the visual characteristic shown in FIG. 10B. For example, the electronic device 500 transitions from displaying the text 1004 with an animated color in FIG. 10B to a non-animated color in FIG. 10C. FIG. 10C also shows the electronic device 500 detecting an input directed towards option 1006. For example, the electronic device 500 detects selection of option 1006 with stylus 1013. In some embodiments, the electronic device 500 detects a different input either directed to option 1006 or a different input not directed to option 1006 that corresponds to a request to graph the equation represented by text 1004. In response to detecting the input, the electronic device 500 displays a graph of the equation represented by text 1004, as shown in FIG. 10D.

FIG. 10D illustrates the electronic device 500 displaying the user interface 1000 with a graphical representation 1010a of the equation corresponding to text 1004. In some embodiments, the electronic device 500 displays the graphical representation 1010a in response to detecting the input described above with reference to FIG. 10C. Graphical representation 1010a is plotted on axes 1008a with scale indicated by indications 1052a. The electronic device 500 displays option 1050a overlaid on graphical representation 1010a. As will be described in more detail below with reference to FIGS. 10LL-10UU and/or method 1200, in response to detecting selection of option 1050a, the electronic device 500 displays a menu that includes options for changing which equation(s) are plotted on axes 1008a and/or changing visual characteristics (e.g., colors) with which to display the graphs of various equations on axes 1008a.

FIG. 10D also shows the electronic device 500 detecting a handwriting input with stylus 1013. In response to detecting the handwriting input, the electronic device 500 displays text 1012 in response to detecting a handwritten input. As described above, in some embodiments, other text inputs are possible, such as typing and/or voice inputs.

In FIG. 10E, the electronic device 500 detects that the text 1012 satisfies the one or more graphing criteria. In accordance with the determination that the text 1012 satisfies the one or more graphing criteria, the electronic device 500 displays the text 1012 with the visual characteristic indicating that the criteria are satisfied (e.g., an animated color effect) and displays options 1014 and 1015. In some embodiments, in response to detecting selection of option 1015, the electronic device 500 displays a graph of the equation of text 1012 on a new set of axes different from axes 1008a. In some embodiments, in response to detecting selection of option 1014, the electronic device 500 displays a graph of the equation of text 1012 on axes 1008a. The electronic device 500 displays options 1015 and 1014 in FIG. 10E because the electronic device 500 detects that the text 1012 satisfies the one or more graphing criteria while the user interface 1000 already includes a graphical representation 1010a on axes 1008a. The electronic device 500 displayed option 1006 in FIG. 10C because the electronic device 500 detected that text 1004 satisfies the one or more graphing criteria while the user interface 1000 did not include a graph of a equation on a set of axes.

As shown in FIG. 10E, the electronic device 500 detects selection of option 1014 with stylus 1013. In some embodiments, the electronic device 500 detects a different input as described herein corresponding to a request to add a graph of the equation of text 1012 to the axes 1008a. In response to detecting the input, the electronic device 500 displays a graph of the equation of text 1012 on the set of axes 1008a, as shown in FIGS. 10F-10G.

FIG. 10F illustrates the electronic device 500 displaying an animated transition to displaying a graphical representation 1010b of the equation of text 1012 on axes 1008a. The animated transition optionally includes displaying movement of graphical representation 1010b from the location of text 1012 to axes 1008a. Other animated transitions are possible.

In FIG. 10G, the electronic device 500 displays the graphical representation 1010b of the equation of text 1012 on axes 1008a. The electronic device 500 displays an indication 1016 of the point at which graphical representation 1010b and graphical representation 1010a intersect. As shown in FIG. 10G, the electronic device 500 detects an input corresponding to a request to adjust the scale of the graphical representations 1010a and 1010b, such as movement of contacts 1003a and 1003b. In some embodiments, other inputs are possible. In response to detecting the input, the electronic device 500 adjusts the scale of the graphical representations 1010a and 1010b in accordance with the input. For example, the input shown in FIG. 10G is a request to adjust the scale to zoom the graphical representations 1010a and 1010b out. Thus, as shown in FIG. 10H, in response to detecting the input, the electronic device 500 adjusts the scale to zoom the graphical representations 1010a and 1010b out. In other situations, the electronic device 500 optionally detects an input requesting to adjust the scale to zoom the graph in.

FIG. 10H illustrates the electronic device 500 displaying the graphical representations 1010a and 1010b with a scale zoomed out compared to the scale of graphical representations 1010a and 1010b in FIG. 10I, as indicated by the indications 1052a. The electronic device 500 thus displays the graphical representations 1010a and 1010b over a larger range of values in FIG. 10H than was the case in FIG. 10G. The electronic device 500 maintains display of the indication 1016 of the intersection of graphical representations 1010a and 1010b and menu option 1050a. As shown in FIG. 10H, the electronic device 500 detects an input corresponding to a request to pan the graphical representations 1010a and 1010b, such as movement of contact 1003. In some embodiments, other types of inputs described herein are possible. In response to detecting the input, the electronic device 500 pans the graphical representations 1010a and 1010b in accordance with the input. For example, because the input shown in FIG. 10H is a request to pan the graphical representations 1010a and 1010b down, the electronic device 500 pans the graphical representations 1010a and 1010b down in response to detecting the input. In some embodiments, the electronic device 500 detects an input corresponding to a request to pan the graphical representations 1010a and 1010b in a different direction, such as up or in a horizontal direction and, in response to detecting one of those inputs, the electronic device 500 would pan the graphical representations 1010a and 1010b in the direction corresponding to the input.

FIG. 10I illustrates the electronic device 500 displaying the graphical representations 1010a and 1010b panned in accordance with the input described above with reference to FIG. 10H. As shown in FIG. 10I, the electronic device 500 adjusts the position of the origin of the axes 1008a and the scale of the y-axis, as indicated by indications 1052a. In FIG. 10I, the electronic device 500 detects an input with stylus 1013 handwriting the text 1054 “Math Homework.” In some embodiments, other text inputs are possible as described herein.

In FIG. 10J, the electronic device 500 detects an input requesting to scroll the user interface 1000, such as with movement of contact 1003. In some embodiments, other scrolling inputs are possible. In response to detecting the input, the electronic device 500 scrolls the user interface 1000 in accordance with the input. For example, the input in FIG. 10J is a request to scroll down so in response to detecting the input, the electronic device 500 scrolls the user interface 1000 down. In some embodiments, in response to detecting an input requesting to scroll in a different direction, the electronic device 500 scrolls in accordance with the input.

FIG. 10K illustrates the electronic device 500 displaying the user interface 1000 after scrolling in response to the input described above with reference to FIG. 10J. The electronic device 500 displays a portion of the user interface 1000 in which text 1054 is visible, but the other content shown in FIG. 10J is not visible, including graphical representations 1010a and 1010b. The electronic device 500 displays text 1018 with the visual characteristic indicating that text 1018 satisfies the one or more graphing criteria described herein. In some embodiments, the electronic device 500 displays text 1018 in response to detecting a text entry input. For example, 1018 is handwritten text displayed in response to detecting a handwriting input, such as with stylus 1013. Other text entry inputs are possible. Also in response to detecting that the text 1018 satisfies the one or more graphing criteria, the electronic device 500 displays user interface element 1020 with an option 1056 to display a graph of the equation of text 1018 on a new set of axes and an option 1057 to display a graph of the equation of text 1018 on an existing set of axes. Although portions of the user interface including the axes 1008a shown in FIG. 10J are not visible in FIG. 10K, the electronic device 500 displays the options 1056 and 1057. Additionally, although the text 1002 assigning a numerical value to variable “m” shown in FIG. 10J is not visible in FIG. 10K, the electronic device 500 assigns the numerical value of the variable specified with text 1002 to the variable in text 1018. As shown in FIG. 10K, the electronic device 500 detects an input requesting to display the graph of the equation of text 1018 on a new set of axes, such as detecting the stylus 1013 selecting option 1056. Other inputs are possible. In response to detecting the input, the electronic device 500 displays the graph of the equation of text 1018 on a new set of axes in the user interface 1000. If the electronic device 500 had detected an input requesting to display the graph of the equation of text 1018 on the existing set of axes, the electronic device 500 would add the graph of the equation of text to axes 1008a shown in FIG. 10J.

FIG. 10L illustrates the electronic device 500 displaying graphical representation 1010c corresponding to the equation of text 1018 in the user interface 1000. The electronic device 500 optionally displays the graphical representation 1010c on the set of axes 1008b with indications 1052b of the scale of axes 1008b and with menu option 1050b. In response to detecting selection of menu option 1050b, the electronic device 500 displays a menu similar to the menu described above with reference to menu option 1050a, except the menu includes selectable options for performing operations directed to graphical representation 1010c on axes 1008b. As shown in FIG. 10L, the electronic device 500 detects an input requesting to zoom the user interface 1000 out, such as movement of contacts 1003a and 1003b. In some embodiments, other zoom inputs are possible. In some embodiments, zoom inputs requesting to zoom in are possible. Because the input shown in FIG. 10L is a request to zoom the user interface 1000 out, in response to detecting the input, the electronic device 500 zooms the user interface 1000 out, as shown in FIG. 10M.

FIG. 10M illustrates the electronic device 500 displaying the user interface 1000 zoomed out in accordance with the input described above with reference to FIG. 10N. As shown in FIG. 10M, text 1002, 1004, 1012, 1018, and 1054 and graphical representations 1010a, 1010b, and 1010c are visible in the user interface 1000 after zooming out. In FIG. 10M, the electronic device 500 detects an input moving graphical representation 1010c away from axes 1008b, such as touchdown of contact 1003 at graphical representation 1010c and movement of contact 1003 away from axes 1008b. In some embodiments, other inputs described herein are possible. FIG. 10N illustrates a continuation of the input shown in FIG. 10M. For example, the electronic device 500 detects that the contact 1003 is maintained through the movement of the contact 1003. The electronic device 500 displays the graphical representation 1010c at the location in the user interface 1000 corresponding to contact 1003. In some embodiments, if the electronic device 500 were to detect liftoff of contact 1003 at the location shown in FIG. 10N, the electronic device 500 would display the graphical representation 1010c on axes 1008b as shown in FIG. 10M. In some embodiments, and as shown in FIG. 10N, the electronic device 500 detects continuation of the input, such as continued movement of contact 1003 moving graphical representation 1010c towards axes 1008a. As shown in FIG. 10N, while the electronic device 500 detects the input shown in FIG. 10N, the electronic device 500 displays the axes 1008b with less visual emphasis than the amount of visual emphasis in FIG. 10M. In some embodiments, if the electronic device 500 were to detect liftoff of contact 1003 at the location shown in FIG. 10N, the electronic device 500 would display axes 1008b with the same visual emphasis shown in FIG. 10M in response to detecting the liftoff. Although the decreased visual emphasis is illustrated as using dotted lines instead of solid lines in FIG. 10N, in some embodiments, the electronic device 500 reduces the visual emphasis using other techniques, such as using lighter color(s), more translucency, and/or a smaller size to display the axes 1008b. FIG. 10O illustrates the electronic device 500 displaying graphical representation 1010c of text 1018 on axes 1008a in response to detecting continuation of the input shown in FIGS. 10M-10N. Because graphical representation 1010c was the only graph displayed on axes 1008a in FIG. 10M, the electronic device 500 ceases displaying axes 1008a in FIG. 10O.

In some embodiments, the electronic device 500 scrubs the assigned numerical value of a variable as described above with reference to method 700 and below with reference to method(s) 1100 and/or 1200. In some embodiments, the electronic device 500 initiates adjusting the numerical value in response to detecting a hover input directed to the numerical value in the user interface 1000.

For example, FIG. 10O illustrates the electronic device 500 detecting a hover input of stylus 1013 directed to the numerical value “10” in text 1002. The stylus 1013 hovers above the surface of display generation component 504, as represented by legend 1084. In some embodiments, other inputs requesting to initiate a process to adjust the numerical value are possible as described herein. In response to detecting the input, the electronic device 500 displays an interactive element for adjusting the numerical value, as shown in FIG. 10P.

FIG. 10P illustrates the electronic device 500 displaying interactive element 1068 for adjusting the numerical value in text 1002. For example, the interactive element 1068 is a virtual scrubber, dial, or slider. The electronic device 500 displays the interactive element 1068 in response to detecting the input described above with reference to FIG. 10O. The interactive element 1068 includes a portion, such as the dot, that corresponds to the numerical value when the interactive element 1068 was initially displayed (e.g., 10). In response to detecting interaction with the interactive element 1068, the electronic device 500 adjusts the position of the portion corresponding to the numerical value when the interactive element 1068 was initially displayed. In some embodiments, in response to further interaction with the interactive element 1068 that corresponds to displaying the portion in the middle of the interactive element 1068 as shown in FIG. 10P, the electronic device 500 adjusts the numerical value to its value when the interactive element 1068 was initially displayed. As shown in FIG. 10P, the electronic device 500 detects an input interacting with interactive element 1068, such as with stylus 1013. Other inputs interacting with interactive element 1068 and/or other inputs adjusting the numerical value are possible. In response to detecting the input, the electronic device 500 adjusts the numerical value of text 1002 in accordance with the input, as shown in FIG. 10Q, such as in a direction and by an amount corresponding to a movement portion of the input as described below with reference to method(s) 1100 and/or 1200.

FIG. 10Q illustrates the electronic device 500 displaying text 1002 with the numerical value updated in accordance with the input described above with reference to FIG. 10P. As shown in FIG. 10Q, the electronic device 500 displays text 1002 updated to indicate “m=2.” Because text 1004, 1012, and 1018 include equations using the variable that was adjusted in response to the input described with reference to FIG. 10P, the electronic device 500 adjusts the numerical value corresponding to the variable in text 1004, 1012, and 1018 and adjusts graphical representations 1010a, 1010b, and 1010c accordingly. The electronic device 500 also updates the indications 1024 and 1016 of the intersections of pairs of graphical representations 1010a, 1010b, and/or 1010c in accordance with the updated numerical value in text 1004, 1012, and 1018. FIG. 10Q also shows the electronic device 500 detecting an input corresponding to a request to move graphical representation 1010b away from axes 1008a, such as detecting contact 1003 at the location of graphical representation 1010b followed by movement of the contact 1003 away from axes 1008a. In some embodiments, other inputs for moving graphical representation 1010b are possible as described above and below with reference to method(s) 1100 and/or 1200. In response to detecting the input, the electronic device 500 displays movement of graphical representation 1010b, as shown in FIG. 10R.

FIG. 10R illustrates the electronic device 500 displaying graphical representation 1010b at a location in user interface 1000 corresponding to the continuation of the input described above with reference to FIG. 10Q, such as the current location of contact 1003 in FIG. 10R. In response to continuing to detect the input, the electronic device 500 displays axes 1008a and graphical representations 1010a and 1010c with reduced visual emphasis as described above with reference to FIG. 10N. If the electronic device 500 were to detect liftoff of contact 1003 at the location shown in FIG. 10R, the electronic device 500 would return graphical representation 1010b to axes 1008a as shown in FIG. 10Q, including displaying axes 1008a and graphical representations 1010a and 1010c with the amount of visual emphasis shown in FIG. 10Q. In some embodiments, the electronic device 500 detects further movement of contact 1003, as shown in FIG. 10R, to the location shown in FIG. 10S. In some embodiments, the electronic device 500 detects liftoff of contact 1003 from the location shown in 10S. In response to detecting liftoff of the contact 1003 at the location shown in FIG. 10S, the electronic device 500 displays the graphical representation 1010b on a new set of axes separate from axes 1008a, as shown in FIG. 10T.

FIG. 10T illustrates the electronic device 500 displaying graphical representation 1010b on a new set of axes 1008c in response to detecting the input described above with reference to FIGS. 10Q-10S. The axes 1008c are displayed with an indication 1052b of the scale of axes 1008b and menu option 1050b.

FIG. 10U illustrates the electronic device 500 displaying text 1060 in response to detecting a handwriting input with stylus 1013. In some embodiments, other text inputs are possible as described herein.

In FIG. 10V, the electronic device 500 displays the text 1060 with the visual characteristic that indicates that text 1060 satisfies the one or more graphing criteria, as described herein and displays a menu 1058 with the option 1056 to display a graph of the equation of text 1060 on a new set of axes and the option 1057 to display the graph of the equation of text 1060 on an existing set of axes. In some embodiments, the electronic device 500 detects an input requesting to display the graph of the equation of text 1060 on an existing set of axes, such as detecting selection of option 1057 with stylus 1013, as shown in FIG. 10V. Other inputs described herein are possible. In response to detecting the input, the electronic device 500 displays the graph of the equation of text 1060 on axes 1008c, as shown in FIG. 10W.

FIG. 10W illustrates the electronic device 500 displaying graphical representation 1010d corresponding to text 1060 on axes 1008c in response to detecting the input described above with reference to FIG. 10V. In some embodiments, the electronic device 500 displays the graphical representation 1010d on axes 1008c instead of on axes 1008a because axes 1008c are closer to text 1060 than axes 1008a are.

FIG. 10X illustrates the electronic device 500 displaying the user interface 1000 with text 1062, 1032, 1064, and 1066, and a graphical representation 1010d corresponding to text 1032 on axes 1008d. The text includes a mix of handwritten text, such as text 1062, 1032, and 1066 and font-based text 1064. As shown in FIG. 10X, the electronic device 500 detects an input directed to graphical representation 1010d, such as with stylus 1013. Other inputs described herein are possible. In response to detecting the input, the electronic device 500 displays an indication of the equation of the graphical representation 1010d, as shown in FIG. 10Y.

FIG. 10Y illustrates the electronic device 500 displaying an indication 1033 of the equation of the graphical representation 1010d and a point on the graphical representation 1010d corresponding to the location of the input, as described in more detail below with reference to method 1100. In some embodiments, the electronic device 500 detects movement of the input, such as movement of the stylus 1013 as shown in FIG. 10Y. In response to detecting the movement of the input, the electronic device 500 updates the indication 1033 to include text indicating a different point on the graphical representation 1010d corresponding to the updated location of the stylus 1013, as shown in FIG. 10Z. FIG. 10Z illustrates the electronic device 500 displaying updated indication 1033 that indicates the point on graphical representation 1010d corresponding to the updated location of the stylus and the equation of graphical representation 1010d.

FIG. 10AA illustrates the electronic device 500 detecting an input requesting to change one of the numerical values (e.g., “8”) in text 1032. For example, the electronic device 500 detects the stylus 1013 hovering over the “8” in text 1032 as indicated by legend 1084 in FIG. 10AA. Other inputs described herein are possible. In response to detecting the input, the electronic device 500 displays an interactive element for adjusting the numerical value, as shown in FIG. 10BB and as described in more detail above and with reference to method(s) 700, 1100, and/or 1200.

FIG. 10BB illustrates the electronic device 500 displaying interactive element 1068 for adjusting the numerical value included in text 1032. In some embodiments, the electronic device 500 displays the interactive element 1068 in response to detecting the input described above with reference to FIG. 10AA. In FIG. 10BB, the electronic device 500 detects an input directed to interactive element 1068 to adjust the numerical value of text 1032. For example, the electronic device 500 detects interaction with the interactive element 1068 with stylus 1013. Other inputs described herein are possible. In response to detecting the input, the electronic device 500 adjusts the numerical value included in text 1032 as shown in FIG. 10CC.

FIG. 10CC illustrates the electronic device 500 displaying text 1032 with the updated numerical value in accordance with the input described above with reference to FIG. 10BB. Additionally, the electronic device 500 updates graphical representation 1010d in accordance with the updated numerical value. In FIG. 10CC, the electronic device 500 detects an input directed to the numerical value “6” in text 1032, such as a tap with stylus 1013. Other selection inputs described herein are possible. In response to detecting the input, the electronic device 500 displays a menu of respective options that, when selected, cause the electronic device 500 to perform respective actions with respect to the text 1032, as shown in FIG. 10DD.

FIG. 10DD illustrates the electronic device 500 displaying a menu 1070 of respective options 1072 through 1080 that, when selected, cause the electronic device 500 to perform respective actions with respect to the text 1032. The electronic device 500 optionally displays menu 1070 in response to detecting the input described above with reference to FIG. 10CC. Option 1072, when selected, causes the electronic device 500 to cut a portion of text 1032 to the system clipboard and cease displaying that portion in the user interface 1000. Option 1074, when selected, causes the electronic device 500 to copy a portion of text 1032 to the system clipboard and continue displaying that portion in the user interface. Option 1076, when selected, causes the electronic device 500 to paste a portion of content from the office clipboard into text 1032. Option 1078, when selected, displays a menu with options for changing the formatting of text 1032. Option 1080, when selected, causes the electronic device 500 to scrub the numerical value included in text 1032 to which the input was directed. For example, because the input shown in FIG. 10CC was directed to “6,” the electronic device 500 displays an interactive element for changing the numerical value “6.” If the input had been directed to “3,” the electronic device 500 would display an interactive element for changing the numerical value “3.” As shown in FIG. 10DD, the electronic device 500 detects an input selecting option 1080, such as a tap with stylus 1013. In some embodiments, other selection inputs described herein are possible. In response to detecting the input, the electronic device 500 displays the interactive element 1068 as shown in FIG. 10BB.

In FIG. 10EE, the electronic device 500 detects selection of text 1062. Text 1062 includes a numerical value “3,” but the numerical value is not part of a mathematical equation and/or expression. In some embodiments, the input in FIG. 10EE is the same as the input in FIG. 10DD, except the input is directed to text 1062 instead of being directed to text 1032. For example, the input is a tap with stylus at the location of the numerical value “3” in text 1062. Other selection inputs described herein are possible. In response to detecting the input, the electronic device 500 displays a menu of respective options that, when selected, causes the electronic device 500 to perform respective actions with respect to text 1062, as shown in FIG. 10FF.

FIG. 10FF illustrates the electronic device 500 displaying menu 1082 of options 1072 through 1078 that, when selected, causes the electronic device 500 to perform respective actions with respect to text 1062. As shown in FIG. 10FF, the menu 1082 includes the cut option 1072, copy option 1074, paste option 1076, and format option 1078. These options 1072 through 1074 have the same functions described above with reference to FIG. 10EE, except with respect to text 1062 instead of text 1032. As shown in FIG. 10FF, the menu 1082 does not include a scrub option 1080 because text 1062 does not include a mathematical equation and/or equation, despite including numerical value “3.”

In some embodiments, the electronic device 500 adjusts the values of the numerator and/or denominator of a fraction separately using interactive elements. In FIG. 10GG, the electronic device 500 detects an input directed to the denominator “75” in a mathematical equation included in text 1066. For example, the input is a hover, indicated by legend 1084, with stylus 1013 over the location at which “75” is displayed in the text 1066. In some embodiments, other inputs are possible as described herein. In response to detecting the input, the electronic device 500 displays an interactive element for adjusting the numerical value “75,” as shown in FIG. 10HH.

FIG. 10HH illustrates the electronic device 500 displaying an interactive element 1068 for adjusting the numerical value “75” in text 1066. In some embodiments, the electronic device 500 displays the interactive element 1068 in response to detecting the input described above with reference to FIG. 10GG. In some embodiments, the electronic device 500 displays the interactive element 1068 in response to detecting selection of a “scrub” option displayed in a menu of respective options that, when selected, causes the electronic device 500 to perform respective actions with respect to text 1066.

As shown in FIG. 10HH, the electronic device 500 detects an input interacting with interactive element 1068, such as movement of contact with stylus 1013. In some embodiments, other inputs are possible. In response to detecting the input, the electronic device 500 updates the numerical value in accordance with the input, as shown in FIG. 10II.

FIG. 10II illustrates the electronic device 500 displaying text 1066 with the numerical value of the denominator updated in accordance with the input described above with reference to FIG. 10HH. For example, the updated numerical value is “55.” If the electronic device 500 was displaying a graph of the mathematical equation of text 1066, the electronic device 500 would also update the graph in accordance with the updated numerical value, as described above and below with reference to method(s) 1100 and/or 1200. Also shown in FIG. 10II, the electronic device 500 detects an input directed to the numerator “33” in text 1066. For example, the electronic device 500 detects the stylus 1013 hovering, as indicated by legend 1084, over the location of the numerical value “33” in the text 1066. In some embodiments, other inputs described herein are possible, including detecting selection of a “scrub” option described above. In response to detecting the input, the electronic device 500 displays an interactive element for updating the numerical value “33,” as shown in FIG. 10JJ.

FIG. 10JJ illustrates the electronic device 500 displaying interactive element 1068 for adjusting numerical value “33” in text 1066. In some embodiments, the electronic device 500 displays the interactive element 1068 in response to detecting an input described above with reference to FIG. 10II. As shown in FIG. 10JJ, the electronic device 500 detects an input interacting with interactive element 1068, such as movement of a contact with stylus 1013. Other inputs described herein are possible. In response to detecting the input, the electronic device 500 updates the numerical value in accordance with the input, as shown in FIG. 10KK.

FIG. 10KK illustrates the electronic device 500 displaying the text 1066 with an updated numerical value for the numerator. As described above, if the electronic device 500 had been displaying a graph of the equation of text 1066, the electronic device 500 would update the graph in accordance with the updated numerical value as described above. Also shown in FIG. 10KK, the electronic device 500 detects an input requesting to display a graph menu of respective options that, when selected, causes the electronic device 500 to perform respective actions with respect to one or more graphs (e.g., graphical representation 1010d) on axes 1008d. For example, the electronic device 500 detects a tap directed to option 1050a with stylus 1013. Other inputs described herein are possible. In response to detecting the input, the electronic device 500 displays a graph menu of respective options that, when selected, causes the electronic device 500 to perform respective axes with respect to the one or more graphs on axes 1008d, as shown in FIG. 10LL.

FIG. 10LL illustrates the electronic device 500 displaying a graph menu 1085 including options 1086d, 1086c, and 1088a; toggles 1087a through 1087c; and indications 1086a through 1086c of mathematical equations in the user interface 1000 available for graphing. In some embodiments, the electronic device 500 displays the graph menu 1085 in response to detecting the input described above with reference to FIG. 10KK. Option 1088a, when selected, initiates a process to change a color of graphical representation 1010c. Toggles 1087a through 1087c, when selected, cause the electronic device 500 to toggle including or not including a graph of the respective mathematical equation indicated by indications 1086a through 1086c on axes 1008d. Option 1086d, when selected, cuts the one or more graphs (e.g., graphical representation 1010d) on axes 1008d to the system clipboard and ceases displaying the one or more graphs on axes 1008d in the user interface 1000. Option 1086e, when selected, copies the one or more graphs (e.g., graphical representation 1010d) on axes 1008d to the system clipboard and maintains display of the one or more graphs on axes 1008d in the user interface 1000.

Menu 1085 further includes indications 1086a through 1086c of mathematical equations in the user interface 1000 available for graphing. In some embodiments, the mathematical equations corresponding to text 1032, 1064, and 1066 that satisfies the one or more graphing criteria described herein. In some embodiments, the electronic device 500 displays font-based text indications 1086a through 1086c for handwritten text 1032 and 1066 and typed text 1066. In some embodiments, menu 1085 includes indications and corresponding graphing toggles of equations included on other graphs in the user interface 1000 when the user interface includes other graphs. In some embodiments, menu 1085 does not include indications and corresponding graphing toggles of equations included on other graphs in the user interface 1000 when the user interface includes other graphs. As shown in FIG. 10LL, the menu 1085 includes an indication 1086a of text 1032 that is represented by graphical representation 1010d with toggle 1087a displayed to indicate that the axes 1008d include a graphical representation 1010d corresponding to indication 1086a. The menu 1085 includes indications 1086b and 1086c of text 1064 and 1066 not graphed on axes 1008d with toggles 1087b and 1087c displayed to indicate that the axes 1008d do not include graphs corresponding to indications 1086b and 1086c.

In some embodiments, the electronic device 500 detects an input in a sequence of inputs for changing the color of graphical representation 1010d. For example, as shown in FIG. 10LL, the electronic device 500 detects an input selecting option 1088a with stylus 1013. Other selection inputs directed to option 1088a and/or other inputs not directed to option 1088a are possible as described herein. In response to detecting an input directed to option 1088a, the electronic device 500 displays a color selection menu for changing the color of graphical representation 1010d, as shown in FIG. 10MM.

FIG. 10MM illustrates the electronic device 500 displaying a color selection menu 1090 for changing the color of graphical representation 1010d. In some embodiments, the electronic device 500 displays color selection menu in response to detecting an input selecting option 1088a, as described above with reference to FIG. 10LL. Color selection menu 1090 includes a plurality of selectable options 1091a through 1091d that, when selected, causes the electronic device 500 to change the color of graphical representation 1010d to the respective color corresponding to the selected option. In some embodiments, the electronic device 500 detects an input selecting on of the options 1091a through 1091d, such as a tap with stylus 1013, as shown in FIG. 10MM. Other selection inputs are possible. In response to detecting selection of one of the options 1091a through 1091d, the electronic device 500 changes the color of graphical representation 1010d and text 1032 corresponding to graphical representation 1010d to the color corresponding to the selected option, as shown in FIG. 10NN. In some embodiments, other sequences of inputs for changing the color of graphical representation 1010d and text 1032 are possible.

FIG. 10NN illustrates the user interface 1000 updated in response to detecting one or more inputs requesting to change the color of graphical representation 1010d and text 1032, such as the sequence of inputs described above with reference to FIGS. 10LL-10MM. FIG. 10NN illustrates the electronic device 500 displaying graphical representation 1010d with a dashed line to represent displaying graphical representation 1010d in a different color and displaying text 1032 with a different color. In some embodiments, the electronic device 500 displays graphical representation 1010d with the same line style as in FIG. 10MM but different color. In some embodiments, the updated colors of graphical representation 1010d and text 1032 are the same color. Additionally, the electronic device 500 updates option 1088a to be in a color corresponding to the new color of graphical representation 1010d (e.g., the same color).

In FIG. 10NN, the electronic device 500 detects an input selecting toggle 1087b with a tap with stylus 1013. In some embodiments, the electronic device 500 detects a different input requesting display of a graph of the equation of indication 1086b (e.g., text 1064). In response to detecting the input, the electronic device 500 updates axes 1008d to include a graph of the equation corresponding to indication 1086b, as shown in FIG. 10OO.

FIG. 10OO illustrates the user interface 1000 updated to include a graphical representation 1010e corresponding to text 1064 and indication 1086b. In some embodiments, the electronic device 500 updates the user interface 1000 in response to detecting the input described with reference to FIG. 10NN previously. As shown in FIG. 10OO, while displaying the graphical representation 1010e of text 1064, the electronic device 500 displays toggle 1087b with an appearance that indicates that the axes 1008d include a graphical representation 1010c corresponding to text 1064 and indication 1086b. As shown in FIG. 10OO, the electronic device 500 detects an input selecting toggle 1087a corresponding to the graphical representation 1010d of text 1032 indicated by indication 1086a. In some embodiments, the electronic device 500 detects a different input described herein requesting to remove graphical representation 1010d from axes 1008d. In response to detecting the input, the electronic device 500 updates axes 1008d to no longer include graphical representation 1010d, as shown in FIG. 10PP.

FIG. 10PP illustrates the electronic device 500 displaying the user interface 1000 with axes 1008d including graphical representation 1010e and not including graphical representation 1010d. In some embodiments, the electronic device 500 ceases displaying graphical representation 1010e in response to detecting the input described above with reference to FIG. 10OO. While not displaying graphical representation 1010d on axes 1008d, the electronic device 500 displays toggle 1087a indicating that the graphical representation 1010d corresponding to indication 1086a of text 1032 is not included in axes 1008d. As shown in FIG. 10PP, the electronic device 500 maintains display of graphical representation 1010c.

FIG. 10QQ illustrates the electronic device 500 displaying graphical representation 1010e in the user interface 1000. In some embodiments, the electronic device 500 detects an input directed to graphical representation 1010e, such as a tap with stylus 1013. In some embodiments, other inputs described herein are possible. In response to detecting the input, the electronic device 500 displays an indication of graphical representation 1010e as shown in FIG. 10RR.

FIG. 10RR illustrates the electronic device 500 displaying indication 1092 of graphical representation 1010e. In some embodiments, the electronic device 500 displays the indication 1092 in response to detecting the input described with reference to FIG. 10QQ. Indication 1092 includes a representation of text 1064 of the equation of graphical representation 1010e and an option 1093 to change the color of graphical representation 1010c. In some embodiments, even if the text corresponding to graphical representation 1010e were handwritten, the indication 1092 would include a font-based representation of the text. As shown in FIG. 10RR, the electronic device 500 detects an input directed to option 1093, such as a tap with stylus 1013. In some embodiments, other inputs described herein are possible. In some embodiments, in response to detecting the input directed to option 1093, the electronic device 500 displays a color selection menu shown in FIG. 10SS for changing the color of graphical representation 1010c.

FIG. 10SS illustrates the electronic device 500 displaying color selection menu 1094 for changing the color of graphical representation 1010e. In some embodiments, the electronic device 500 displays color selection menu 1094 in response to detecting the input described above with reference to FIG. 10RR. Color selection menu 1094 in FIG. 10SS is similar to the color selection menu 1090 in FIG. 10MM except color selection menu 1094 changes the color of graphical representation 1010e instead of changing the color of graphical representation 1010d. As shown in FIG. 10SS, the electronic device 500 detects an input selecting one of the options 1095b, such as a tap with stylus 1013. In some embodiments, other inputs are possible, including other sequences of inputs for changing the color of graphical representation 1010e. In response to detecting the one or more inputs, the electronic device 500 displays graphical representation 1010e with a different color, as shown in FIG. 10TT.

FIG. 10TT illustrates the electronic device 500 displaying graphical representation 1010e updated to be displayed in a different color than the color of graphical representation 1010e in FIG. 10SS. In some embodiments, the electronic device 500 also updates the color of text 1064 to correspond to the color of graphical representation 1010e as described above and in more detail below with reference to method(s) 1100 and/or 1200.

The examples described above with reference to FIGS. 10AA-10TT feature graphs with two variables (e.g., x and y). These examples apply to graphs with additional variables. For example, FIGS. 10UU-10VV illustrate examples of graphs in three dimensions (e.g., y, r, and t). Additionally or alternatively, it is possible to represent a variable, such as t, via animated graphs.

FIG. 10UU illustrates a graph 1046 corresponding to text 1042 on three-dimensional axes 1044. Text 1042 includes an equation that satisfies the one or more graphing criteria. In some embodiments, the electronic device 500 displays the graph 1046 according to the examples above and method 1100 below. in some embodiments, the electronic device 500 modifies the graph 1046 according to the examples above and method(s) 1100 and/or 1200 below. As shown in FIG. 10UU, the graph 1046 includes menu option 1050a that, when selected, causes the electronic device 500 to display a menu of options for editing graph 1046 as described above with respect to other graph menus. In some embodiments, the electronic device 500 rotates three-dimensional graphs in the user interface 1000 in response to detecting an input. For example, in FIG. 10UU, the electronic device 500 detects an input including movement of contact 1003 directed to graph 1046. Other inputs are possible. In response to detecting the input, the electronic device 500 rotates the graph 1046 as shown in FIG. 10VV.

FIG. 10VV illustrates the electronic device 500 displaying graph 1046 rotated in response to detecting the user input described above with reference to FIG. 10VV. In some embodiments, other interactions with graph 1046 described above with reference to other graphs, such as initiating display, panning, zooming, changing colors, adding/removing equations, and/or updating in accordance with updated numerical values in equations are possible in response to detecting similar inputs as those described above.

FIG. 10WW illustrates user interface 1000. In FIG. 10WW, the electronic device 500 detects a handwritten input via stylus 1003 to add text to user interface 1000. In response to detecting the input in FIG. 10WW, the electronic device 500 displays text 1009 (e.g., a handwritten equation), shown in FIG. 10XX. FIG. 10XX includes text 1009, which includes an equation using variables “a” and “b.” Because the equation does not include predefined variables (e.g., “x” and “y” or other combinations of variables), the electronic device 500 does not present a graphing option unless and until the electronic device 500 receives an input directed to text 1009.

In FIG. 10XX, the electronic device 500 detects an input via stylus 1003 directed towards text 1009. For example, the input in FIG. 10XX is a tap input with stylus 1003. In some embodiments, other inputs selecting text 1009 are possible (e.g., a mouse click while a cursor is at a location of text 1009 or an air pinch gesture or air tap gesture while attention or gaze is directed to a location of text 1009). In response to receiving the input, the electronic device 500 displays option 1006, described above, that when selected, causes the electronic device 500 to display a graph of the mathematical equation represented by text 1009 in accordance with one or more of the techniques described herein. In some embodiments, the graph of the text 1009 will have axes labeled with the variables “a” and “b.”

FIG. 11 illustrates a flow diagram illustrating a method in which an electronic device displays presents graphs of mathematical equations in accordance with some embodiments of the disclosure. The method 1100 is optionally performed at first electronic device and/or electronic devices such as device 100, device 300, or device 500 as described above with reference to FIGS. 1A-1B, 2-3, 4A-4B and 5A-5H. Some operations in method 1100 are, optionally combined and/or order of some operations is, optionally, changed.

In some embodiments, method 1100 is performed an electronic device in communication with a one or more display generation components and one or more input devices. In some embodiments, the electronic device, one or more display generation components, and/or one or more input devices are the same or similar to those described above with reference to methods 700 and/or 900, such as electronic device 500, display generation component 604, and/or stylus 203 in FIGS. 6A and/or 8A.

In some embodiments, the electronic device displays (1102), via the one or more display generation components, a user interface for entering content (and/or including a content entry region as described above with reference to method 700, such as content entry region 602 in FIG. 6A), such as user interface 1000 in FIG. 10A. In some embodiments, the user interface for entering content is the same as or similar to one or more of the user interfaces for entering text described above with reference to method 700, such as content entry region 602 in FIG. 6A. In some embodiments, the user interface for entering content is a user interface for entering and/or displaying text, images, and/or drawings, such as a user interface of a notes application or a user interface of a calculator application. For example, the calculator application includes a user interface in which the electronic device displays indications of text entered by the user of the electronic device and, in response to detecting an input entering text that includes a mathematical equation, the electronic device displays the answer to the mathematical equation, as described above with reference to method 700, such as solution 608 in FIG. 6B. Text entry inputs optionally include font-based text inputs and handwritten text inputs as described above with reference to method 700, such as handwritten input with stylus 203 in FIG. 6A that causes the electronic device 500 to display text 604 and/or the input that causes the electronic device 500 to display text 654 in FIG. 6J. Additionally or alternatively, in some embodiments, the user interface accepts inputs other than text entry inputs, such as drawing inputs (e.g., with a stylus, finger, other body part of the user, or other object) In some embodiments, this user interface of the calculator application also includes graphs of mathematical equations provided by the user, as described herein with reference to method 1100, such as the graph including graphical representation 1010a on axes 1008a in FIG. 10D.

In some embodiments, while displaying the user interface for entering content (1104), the electronic device detects (1106), via the one or more input devices, an input to enter text in the user interface, such as with stylus 1013 as in FIG. 10A. In some embodiments, the input is an input to enter font-based text or an input to handwrite text as described above with reference to method 700, such as handwritten input with stylus 203 in FIG. 6A that causes the electronic device 500 to display text 604 and/or the input that causes the electronic device 500 to display text 654 in FIG. 6J. In some embodiments, the input includes a voice input and/or an input detected using a hardware input device (e.g., a hardware keyboard). In some embodiments, the text includes mathematical equations and/or expressions, such as numbers, variables, and/or operations.

In some embodiments, while displaying the user interface for entering content (1104), after (e.g., in response to) detecting the input (1108), the electronic device displays (1110), via the one or more display generation components, first text corresponding to the input, such as text 1004 in FIG. 10B. In some embodiments, if the input includes handwriting, the first text includes the markings made by the user's handwriting. In some embodiments, if the input includes an input to enter typed text, the first text is typed text indicated by the input.

In some embodiments, while displaying the user interface for entering content (1104), after (e.g., in response to) detecting the input (1108), in accordance with a determination that the first text satisfies one or more criteria, the electronic device initiates (1112) a process for displaying a first graphical representation of the first text on a corresponding graph in the user interface (e.g., a graph that includes a graphical representation of the first text such as a line or other geometric shape and one or more axes) for entering content (and/or in the content entry region) while concurrently displaying the first text corresponding to the input, such as displaying option 1006 in FIG. 10B. In some embodiments, the one or more criteria include a criterion that is satisfied when the first text includes a mathematical equation with one or more variables. In some embodiments, the one or more criteria include a criterion that is satisfied when the first text includes a mathematical equation with two or more predetermined variables, such as x and y. In some embodiments, in response to detecting selection of the selectable option, the electronic device displays a graph that represents the mathematical equation included in the first text. In some embodiments, the electronic device forgoes displaying the graph unless and until the electronic device detects selection of the selectable option. In some embodiments, the electronic device displays the selectable option in response to detecting the input to enter the text (e.g., without detecting an additional input requesting display of the option). In some embodiments, the electronic device displays the selectable option once the first text satisfies the one or more criteria, even if that is before entry of the first text is complete, such as the user entering part of an equation that satisfies the one or more criteria. In some embodiments, when the input includes handwritten text, the electronic device performs character recognition on the handwritten text to recognize the underlying text as part of determining whether the one or more criteria are satisfied. In some embodiments, the electronic device performs one or more steps of method 700 while displaying the selectable option that, when selected, causes the electronic device to display the graph. As used herein, one or more “graphs” optionally include one or more “graphical representation(s) of respective equation(s)” (e.g., a line or other curve corresponding to values of the equation for sets of variables represented by the axes) and/or a set of axes representing two or more variables of the respective equation(s).

In some embodiments, while displaying the user interface for entering content (1104), after (e.g., in response to) detecting the input (1108), in accordance with a determination that the first text does not satisfy the one or more criteria, the electronic device forgoes (1114) initiating the process for displaying the first graphical representation of the first text on a corresponding graph in the user interface for entering content (e.g., forgoing displaying the selectable option that, when selected, causes the electronic device to display the graphical representation of the first text in the user interface for entering content), such as forgoing displaying an option similar to option 1006 in FIG. 10B in response to detecting the input to enter text 1002. The electronic device optionally maintains display of the first text in accordance with the determination that the first text does not satisfy the one or more criteria. In some embodiments, the electronic device performs one or more steps of method 700 without displaying the selectable option that, when selected, causes the electronic device to display the graph in accordance with a determination that the first text satisfies the respective criteria described above with reference to method 700, such as the criteria to display solution 608 in FIG. 6B.

Displaying the option to display a graphical representation of the first text in accordance with a determination that the first text displayed in response to detecting an input satisfies one or more criteria enhances user interactions with the computer system by reducing user error when graphing mathematical equations, and reduces the number of inputs needed to initiate such graphing.

In some embodiments, initiating the process for displaying the graphical representation of the first text includes displaying in the user interface for entering content, via the one or more display generation components, a selectable option that, when selected, causes the electronic device to display the graphical representation of the first text in the user interface for entering content, such as option 1006 in FIG. 10B. In some embodiments, the electronic device displays the selectable option proximate to the first text. In some embodiments, the electronic device displays the selectable option in response to detecting the one or more inputs providing the first text without detecting further input selecting the first text. In some embodiments, the electronic device displays the selectable option in response to detecting an input selecting the first text. Displaying the selectable option that, when selected, causes the electronic device to display the graphical representation of the first text enhances user interactions with the electronic device by reducing user errors when entering text that satisfies the one or more criteria for initiating a process to display a graph of the text.

In some embodiments, while displaying the selectable option, the electronic device detects, via the one or more input devices, an input selecting the selectable option, such as input with stylus 1013 in FIG. 10C. In some embodiments, the input is a touch input that includes detecting an object touching a location of a touch screen at which the selectable option is displayed. In some embodiments, the input is a voice input or an input detected using a hardware input device. In some embodiments, the input is an air gesture input that includes detecting the attention of the user directed to the selectable option. In some embodiments, the input is a voice input requesting display of the graphical representation of the first text that is not directed to the selectable option.

In some embodiments, in response to detecting the input selecting the selectable option, the electronic device displays, via the one or more display generation components, the graphical representation of the first text in the user interface for entering content optionally as described in more detail below, such as graphical representation 1010a in FIG. 10D. In some embodiments, while displaying the graph, the electronic device maintains display of the first text. In some embodiments, displaying the graph includes displaying an axis and a graphical representation of the first text. Displaying the graphical representation of the first text in response to detecting selection of the selectable option that, when selected, causes the electronic device to display the graphical representation of the first text enhances user interactions with the electronic device by reducing user errors when entering text that satisfies the one or more criteria for initiating a process to display a graph of the text.

In some embodiments, the one or more criteria include a criterion that is satisfied when the first text includes a mathematical equation with one or more predetermined variables, such as text 1004 or 1012 in FIG. 10D. In some embodiments, mathematical equations include numbers and one or more predefined characters corresponding to mathematical operations. In some embodiments, the mathematical equations further include one or more letter variables corresponding to fixed numerical values. In some embodiments, the user interface for entering content further includes text that sets the one or more letter variables to their fixed numerical values. For example, “m=3.” In some embodiments, the mathematical equations further include one or more predefined variables that correspond to axis of the graph and/or time. Example sets of predefined variables include one or more of x, y, z, r, θ, and/or t. In some embodiments, if text does not include an equals sign, or includes characters that do not correspond to assigned fixed numerical values, mathematical operations, and/or predefined variables, then the text does not satisfy the one or more criteria. In some embodiments, the one or more criteria include a criterion that is satisfied when the equation is in a predefined format. For example, the predefined format includes a first variable, followed by an equals sign, followed by a mathematical expression using a second variable different from the first variable, such as “y,” followed by equals “=,” followed by an expression using the variable “x”. Initiating a process to graph text that corresponds to mathematical equations with one or more predefined variables enhance user interactions with the electronic device by selectively performing relevant operations, thereby reducing inputs and/or user errors.

In some embodiments, displaying the user interface for entering content includes displaying a first graph including a graphical representation of second text (e.g., a mathematical equation) on a first set of axes, such as graphical representation 1010a in FIG. 10D.

In some embodiments, the process for displaying the first graphical representation of the first text on a corresponding graph in response to detecting the input and in accordance with the determination that the first text satisfies the one or more criteria includes, in accordance with a determination that the input satisfies one or more criteria with respect to the first graph, displaying a graphical representation of the first text on the first set of axes of the first graph, such as displaying graphical representations 1010a and 1010b on axes 1008a. In some embodiments, the one or more criteria with respect to the first graph relate to the proximity of the first text to the first graph. For example, the one or more criteria require that the first text is within a threshold distance of the first graph in the user interface, optionally irrespective of whether or not the first text and the first graph are concurrently displayed. Example threshold distances include 1, 2, 3, 5, 10, 20, or 50 centimeters. As another example, as described in more detail below, the one or more criteria require that the first text is displayed concurrently with the first graph. In some embodiments, the first graph includes a graphical representation of second text in the user interface that satisfies the one or more criteria. In some embodiments, the first graph includes a set of axes with multiple graphical representations of multiple mathematical equations included in the user interface for entering content, as described herein.

In some embodiments, the process for displaying the first graphical representation of the first text on a corresponding graph in response to detecting the input and in accordance with the determination that the first text satisfies the one or more criteria includes, in accordance with a determination that the input does not satisfy the one or more criteria with respect to the first graph, displaying a second graph different from the first graph that includes displaying a graphical representation of the first text on a second set of axes of a second graph, different from the first set of axes of the first graph, such as displaying graphical representation 1010c on axes 1008b. In some embodiments, the user interface for entering content includes the first graph the graph including the graphical representation of the first text. Selectively displaying the graphical representation of the first text on an existing graph including a graphical representation of other text or in a new graph enhances user interactions with the electronic device by providing an efficient way of comparing mathematical equations on a graph.

In some embodiments, the one or more criteria with respect to the first graph include a criterion that is satisfied when the input is detected while displaying more than a threshold amount of the first graph (e.g., displaying all of the first graph or displaying at least 50% of the first graph), such as display of graphical representation 1010a on axes 1008a in FIG. 10D. In some embodiments, if the user interface for entering content is scrolled to a position such that the first text is visible and the threshold amount of the first graph is not visible, then the first text does not satisfy the one or more criteria with respect to the first graph and the electronic device displays the graphical representation of the first text on a new graph separate from the first graph. In some embodiments, the one or more criteria are not satisfied when the threshold amount of the first graph is not visible, even if the respective graph is within the threshold distance described above. Selectively adding the graphical representation of the first text to the first graph or to a new graph based on whether or not the first text and the threshold amount of the first graph are concurrently displayed enhances user interactions with the electronic device by providing an efficient way of comparing mathematical equations on a graph or selectively creating separate graphs of equations.

In some embodiments, initiating the process for displaying the graphical representation of the first text on a corresponding graph includes, in accordance with a determination that the user interface includes a graph including a graphical representation of second text, different from the first text, displaying, via the one or more display generation components, a selectable option that, when selected, causes the electronic device to add the graphical representation of the first text to the graph including the graphical representation of the second text, such as option 1014 in FIG. 10E. In some embodiments, the electronic device displays the selectable option irrespective of whether or not the first text satisfies one or more criteria with respect to the graph including the graphical representation of the second text. In some embodiments, the electronic device detects an input selecting the selectable option. In some embodiments, in response to detecting the input selecting the option, the electronic device updates the graph including the graphical representation of the second text to further include the graphical representation of the first text in addition to the graphical of the second text in the manner of graphing two equations on one graph described above.

In some embodiments, initiating the process for displaying the graphical representation of the first text on a corresponding graph includes, in accordance with a determination that the user interface does not include another graph, forgoing displaying, via the one or more display generation components, a selectable option that, when selected, causes the electronic device to add the graphical representation of the first text to another graph, such as displaying option 1006 in FIG. 10C. In some embodiments, the electronic device displays an option to display the first graphical representation of the first text, as described herein. Displaying an option to display the graphical representation of the first text with the respective graph enhances user interactions with the computer system by reducing inputs and providing an efficient way of comparing mathematical equations on a graph.

In some embodiments, initiating the process for displaying the graphical representation of the first text on a corresponding graph includes displaying a selectable option that, when selected, causes the electronic device to display the graphical representation of the first text as a new graph in the user interface, such as option 1015 in FIG. 10E. In some embodiments, the selectable option that, when selected, causes the electronic device causes the electronic device to display the graphical representation of the first text as a new graph has one or more characteristics of the selectable option that, when selected, causes the electronic device to display the graphical representation of the first text in the user interface described above.

In some embodiments, displaying the selectable option that, when selected, causes the electronic device to display the graphical representation of the first text as the new graph in the user interface includes, in accordance with the determination that the user interface includes the graph including the graphical representation of the second text, displaying, via the one or more display generation components, the selectable option that, when selected, causes the electronic device to display the graphical representation of the first text as the new graph in the user interface concurrently with the selectable option that, when selected, causes the electronic device to add the graphical representation of the first text to the graph including the graphical representation of the second text, such as concurrently displaying options 1014 and 1015 in FIG. 10E. In some embodiments, the electronic device displays the option to create a graphical representation of the first text on a new graph and the option to add the graphical representation of the first text to the graph that includes the graphical representation of the second text in response to the first text satisfying the one or more criteria in accordance with the determination that the user interface includes the graph including the graphical representation of the second text. In some embodiments, in response to detecting selection of the option to create a new graph, the electronic device displays a graphical representation of the first text on a new graph in the manner of displaying a new graph described above. In some embodiments, in response to detecting selection of the option to add the first text to an existing graph, the electronic device updates an existing graph in the user interface to include the graphical representation of the first text.

In some embodiments, displaying the selectable option that, when selected, causes the electronic device to display the graphical representation of the first text as the new graph in the user interface includes, in accordance with the determination that the user interface does not include the graph including the graphical representation of the second text, displaying, via the one or more display generation components, the selectable option that, when selected, causes the electronic device to display the graphical representation of the first text as the new graph in the user interface without displaying the selectable option that, when selected, causes the electronic device to add the graphical representation of the first text to the graph including the graphical representation of the second text, such as option 1006 in FIG. 10C. In some embodiments, the selectable option that, when selected, causes the electronic device to display the graphical representation of the first text as a new graph has one or more characteristics of the selectable option that, when selected, causes the electronic device to display the graphical representation of the first text in the user interface described above. In some embodiments, after displaying the option to create a graphical representation of the first text on a new graph without displaying the option to display the graphical representation of the first text combined with the graph including the graphical representation of the second text, the electronic device receives one or more inputs corresponding to a request to display the graph including the graphical representation of the second text. In response to detecting these one or more inputs, the electronic device displays the graph including the graphical representation of the second text. In some embodiments, once the electronic device displays the graph including the graphical representation of the second text, the electronic device displays the option to display the graphical representation of the first text combined with the graph including the graphical representation of the second text in response to detecting an input requesting to display options for displaying the graphical representation of the first text, such as selection of the first text. In some embodiments, the electronic device combines graphs as described below with reference to method 1200, such as displaying graphical representations 1010a and 1010b on axes 1008a in FIG. 10G. Displaying an option to create a new graph including the graphical representation of the first text and an option to update the graph including the graphical representation of the second text to further include the graphical representation of the first text enhances user interactions with the computer system by providing an efficient way of comparing mathematical equations on a graph or selectively creating separate graphs of equations.

In some embodiments, the electronic device concurrently displays in the user interface, via the one or more display generation components, the graph including the graphical representation of the second text, a graph including a graphical representation of third text, the first text, and the selectable option that, when selected, causes the electronic device to add the graphical representation of the first text to a respective graph, such as displaying text 1060, axes 1008a and 1008c in FIG. 10U. In some embodiments, the second text and third text satisfy the one or more criteria. In some embodiments, the electronic device displays the second text and the third text in the user interface for entering content. In some embodiments, the electronic device displays the selectable option in response to detecting the first text satisfies the one or more criteria, as described above. As described in more detail below, in some embodiments the selectable option to add the graphical representation of the first text to the respective graph is an option to add the graphical representation of the first text to the graph including the graphical representation of the first text or the graph including the graphical representation of the second text depending on which graph is closer to the first text in the user interface.

In some embodiments, while displaying, in the user interface, the second graphical representation of the second text, the third graphical representation of the third text, the first text, and the selectable option that, when selected, causes the electronic device to add the graphical representation of the first text to the respective graph, the electronic device detects, via the one or more input devices, a second input directed to the selectable option that, when selected, causes the electronic device to add the graphical representation of the first text to the respective graph, such as displaying option 1057 in FIG. 10V in addition to the elements of FIG. 10U described above. In some embodiments, the second input has one or more characteristics of other selection inputs described herein. In some embodiments, the second input is a voice input not directed to the selectable option in particular that specifies a requests to add the graphical representation of the first text to the respective graph (e.g., to an existing graph).

In some embodiments, in response to detecting the second input, in accordance with a determination that the first text is closer to the graph including the graphical representation of the second text than the first text is to the graph including the graphical representation of the third text, the electronic device, via the one or more display generation components, display of the graph including the graphical representation of the second text to include the graphical representation of the first text optionally without updating the graph including the graphical representation of the third text to include the graphical representation of the first text, such as adding graphical representation 1010d to axes 1008c in FIG. 10W because axes 1008c are closer to text 1060 than axes 1008a are to text 1060. In some embodiments, the second input does not specify that the graphical representation of the first text should be added to the graph including the graphical representation of the second text and the electronic device automatically selects the graph including the graphical representation of the second text as the graph to which to add the graphical representation of the first text. In some embodiments, the graph including the graphical representation of the second text is visible in the user interface for entering content while the first text is visible in the user interface. In some embodiments, the graph including the graphical representation of the second text is not visible in the user interface, but its location in the user interface is closer to the first text than the location of the graph including the graphical representation of the third text.

In some embodiments, in response to detecting the second input, in accordance with a determination that the first text is closer to the graph including the graphical representation of the third text than the first text is to the graph including the graphical representation of the second text, the electronic device updates, via the one or more display generation components, display of the graph including the graphical representation of the third text to include the graphical representation of the first text optionally without updating the graph including the graphical representation of the second text to include the graphical representation of the first text, such as adding graphical representation 1010d to axes 1008a instead of axes 1008c if axes 1008c had been closer to text 1060 than axes 1008c are to text 1060 in FIG. 10W. In some embodiments, the second input does not specify that the graphical representation of the first text should be added to the graph including the graphical representation of the third text and the electronic device automatically selects the graph including the graphical representation of the third text as the graph to which to add the graphical representation of the first text. In some embodiments, the graph including the graphical representation of the third text is visible in the user interface for entering content while the first text is visible in the user interface. In some embodiments, the graph including the graphical representation of the third text is not visible in the user interface, but its location in the user interface is closer to the first text than the location of the graph including the graphical representation of the second text. Adding the graphical representation of the first text to the graph including the graphical representation of the second text or the graph including the graphical representation of the third text depending on which of those two graphs is closer to the first text in the user interface for entering content enhances user interactions with the electronic device by reducing the inputs needed to display the graphical representation of the first text and providing an efficient manner of comparing mathematical equations on a graph.

In some embodiments, the electronic device concurrently displays in the user interface, via the one or more display generation components, the graph including the graphical representation of the second text, the first text, and the selectable option that, when selected, causes the electronic device to add the graphical representation of the first text to the graph including the graphical representation of the second text, such as displaying graphical representation 1010a, text 1012, and option 1014 in FIG. 10E and optionally as described above; In some embodiments, the graph including the graphical representation of the second text is a graph of second text in the user interface for entering content that satisfies the one or more criteria, such as text of a mathematical equation similar to the second text or third text described above.

In some embodiments, while displaying, in the user interface, the graph including the graphical representation of the second text, the first text, and the selectable option that, when selected, causes the electronic device to add the graphical representation of the first text to the graph including the graphical representation of the second text, the electronic device detects, via the one or more input devices, a second input directed to the selectable option that, when selected, causes the electronic device to add the graphical representation of the first text to the respective graph, such as input with stylus 1013 in FIG. 10E and optionally as described above.

In some embodiments, in response to detecting the second input, the electronic device displays, via the one or more display generation components, an animation corresponding to adding the graphical representation of the first text to the graph including the graphical representation of the second text that moves from the first text to graph including the graphical representation of the second text, such as animation of graphical representation 1010b in FIG. 10F. In some embodiments, the animation includes movement of the first text towards the graph including the graphical representation of the second text. In some embodiments, the animation includes a fade out effect of the first text. In some embodiments, the animation includes an animation of the size of the first text changing (e.g., reducing or increasing).

In some embodiments, in response to detecting the second input, after displaying the animation, updating, via the one or more display generation components, display of the graph including the graphical representation of the second text to include the graphical representation of the first text, such as displaying graphical representation 1010b on axes 1008a in FIG. 10G and optionally as described above. Displaying the animation corresponding to adding the graphical representation of the first text to the graph including the graphical representation of the second text enhances user interactions with the computer system by confirming the user's input to display the graphical representation of the first text added to the graph including the graphical representation of the second text, which reduces user errors.

In some embodiments, initiating the process for displaying the graphical representation of the first text on a corresponding graph in the user interface for entering content includes, in accordance with a determination that the user interface includes content at a first location in the user interface and does not include content at a second location in the user interface, displaying, via the one or more display generation components, the graphical representation of the first text at the second location in the user interface, such as displaying graphical representation 1010a in user interface 1000 as shown in FIG. 10D. In some embodiments, the content includes text, numbers, equations, image(s), and/or graph(s). In some embodiments, the second location in the user interface is closer to the location of the first text in the user interface than a third location in the user interface that does not include content.

In some embodiments, initiating the process for displaying the graphical representation of the first text on a corresponding graph in the user interface for entering content includes in accordance with a determination that the user interface includes content at the second location in the user interface and does not include content at the first location in the user interface, displaying, via the one or more display generation components, the graphical representation of the first text at the first location in the user interface, such as displaying graphical representation 1010a in FIG. 10D in a different location in user interface 1000 if the arrangement of content in user interface 1000 were different and optionally similar to the manner of displaying the graphical representation of the first text at the second location in the user interface as described above. In some embodiments, displaying the graphical representation of the first text in the user interface includes displaying the graphical representation of the first text at a location in the user interface that is proximate to the first text that does not include other content and has enough space for the graphical representation of the first text. In some embodiments, the first location and the second location are within a predetermined threshold distance of the first text. In some embodiments, the electronic device does not display the graph at a location more than the threshold distance from the first text. In some embodiments, the predefined threshold distance is 5, 10, 30, or 50 centimeters. Selecting a location in the user interface for the graphical representation of the first text that does not include other content enhances user interactions with the electronic device by reducing the number of inputs needed to view the graphical representation of the first text concurrently with other content in the user interface.

In some embodiments, the electronic device displays, in the user interface for entering content, a first graph including a graphical representation of a first mathematical equation and a second graph including a graphical representation of a second mathematical equation, such as graphical representations 1010a and 1010b on axes 1008a and graphical representation 1010c on axes 1008b in FIG. 10M. In some embodiments, the user interface for entering content includes the first equation and the second equation. In some embodiments, the first equation and second equation are typed, handwritten, or a combination thereof. In some embodiments, the first graph and the second graph are separate graphs.

In some embodiments, while displaying the first graph and the second graph, the electronic device detects, via the one or more input devices, an input directed to the first graph including movement that corresponds to a request to combine the first graph and the second graph, such as input with contact 1003 in FIGS. 10M-10N. In some embodiments, the input is a voice input. In some embodiments, the input includes a selection input directed to the graphical representation of the first mathematical equation on the first graph that satisfies one or more criteria, such as a secondary selection made with a particular hardware button or selection that includes sustained contact, a sustained click, or a sustained hand shape for a predefined threshold time. The predefined threshold time is optionally 0.05, 0.1, 0.2, 0.3, 0.5, 1, or 2 seconds. In some embodiments, the input includes a movement portion after the secondary selection, such as dragging, movement of a hand of the user, and/or an input detected at an arrow key or other directional key. The movement is optionally towards the second graph. In some embodiments, the movement has a magnitude that exceeds a threshold, such as corresponding to moving the graphical representation of the first mathematical equation a threshold distance from the first graph, such as 1, 2, 3, 4, 5, 10, 20, 30, 50, 100, 200, or 500 centimeters in the user interface. In some embodiments, if the movement of the input ends at a location that does not correspond to the second graph (or another graph), the electronic device updates the first graph in accordance with the input without combining the first graph and the second graph.

In some embodiments, in response to detecting the input directed to the first graph, the electronic device ceases to display the first graph and displays, via the display generation component, a third graph that includes the graphical representation of the first mathematical equation and the graphical representation of the second mathematical equation, such as the display of graphical representation 1010c on axes 1008a in FIG. 10O. In some embodiments, the electronic device displays the third graph at the location in the user interface at which the electronic device displayed the second graph. In some embodiments, the third graph is a combination of the first graph and the second graph. Combining the graphs of the first mathematical equation and the second mathematical equation enhances user interactions with the electronic device by providing an efficient way of comparing mathematical equations using a graph.

In some embodiments, the first graph includes the graphical representation of the first mathematical equation on a first set of axes having a first scale, the second graph includes the graphical representation of the second mathematical equation on a second set of axes having a second scale different from the first scale, and the third graph includes the graphical representation of the first mathematical equation and the graphical representation of the second mathematical equation on a same third scale, such as the scale of axes 1008a in FIG. 10O. In some embodiments, the third scale is the same as the first scale or the second scale. In some embodiments, the third scale is the same as the first scale in a first dimension and the third scale is the same as the second scale in a second dimension different from the first dimension. In some embodiments, the third scale is the greater of the first scale and the second scale. In some embodiments, the third scale is different from the first scale and different from the second scale. For example, the third scale is between the first scale and the second scale. In some embodiments, the third scale is the same as the second scale in response to detecting an input corresponding to a request to move the graph of the first equation to the second set of axes. In some embodiments, the third scale is the same as the first scale in response to detecting an input corresponding to a request to move the graphical representation of the second equation to the first graph. Adjusting the scale of the third set of axes that includes the graphical representations of the first and second equations enhances user interactions with the electronic device by providing an efficient way of comparing equations using a graph.

In some embodiments, the electronic device displays, in the user interface for entering content, a respective graph that includes a graphical representation of a first mathematical equation and a graphical representation of a second mathematical equation on a respective set of axes optionally in the manner of displaying graphical representations of multiple equations on a common set of axes described above, such as graphical representations 1010a and 1010b in FIG. 10G.

In some embodiments, displaying the respective graph includes, in accordance with a determination that the first mathematical equation and the second mathematical equation intersect in the respective graph at a point, displaying, via the one or more display generation components, a visual indication indicating one or more values of the point, such as indication 1016 in FIG. 10G. In some embodiments, the visual indication includes numbers corresponding to the location on the axes at which the first mathematical equation and the second mathematical equation intersect. In some embodiments, the electronic device displays the visual indication at a location proximate to the intersection of the graphical representation of the first equation and the graphical representation of the second equation. In some embodiments, the electronic device further displays a first visual indication of the first mathematical equation and/or a second visual indication of the second mathematical equation as described below while displaying the visual indication indicating values of the point. In some embodiments, the electronic device forgoes displaying the first visual indication and/or the second visual indication while displaying the visual indication indicating values of the point. In some embodiments, if the graphical representation of the first equation and the graphical representation of the second equation intersect at a first point and a second point, the electronic device displays labels of the first point and the second point. In some embodiments, if the set of axes further includes a graphical representation of a third equation, the electronic device displays visual indication(s) of intersections of the graphical representation of the third equation with the graphical representation of the first equation and/or with the graphical representation of the second equation. In some embodiments, the electronic device displays the visual indication automatically (e.g., without detecting an input once the electronic device displays the graphical representation of the first equation and the graphical representation of the second equation on the respective set of axes).

In some embodiments, displaying the respective graph includes in accordance with a determination that the first mathematical equation and the second mathematical equation do not intersect in the respective graph at the point, displaying, via the one or more display generation components, the graphical representation of the first mathematical equation and the graphical representation of the second mathematical equation without displaying the visual indication indicating one or more values of the point, such as forgoing displaying indication 1016 in FIG. 10G if the graphical representations 1010a and 1010b did not intersect. In some embodiments, the electronic device displays the typed representations of the first equation and the second equation, respectively, irrespective of whether the first equation and second equation are typed, handwritten, or a combination thereof in the user interface. In some embodiments, the electronic device displays the representation of the first equation proximate to the graphical representation of the first equation and the representation of the second equation proximate to the graph of the second equation. In some embodiments, the electronic device displays the representations of the first equation and the second equation automatically (e.g., without detecting an input once the electronic device displays the graphical representation of the first equation and the graphical representation of the second equation on the respective set of axes). In some embodiments, the first visual indication of the first mathematical equation and the second visual indication of the second mathematical equation are different from the graphical representations of the first mathematical equation and the second mathematical equation Displaying visual indications of intersection(s) of graphical representations of equations and/or visual indications of the equation(s) represented by the graph(s) enhances user interactions with the electronic device by reducing the input(s) needed to view information about the mathematical equations and/or to understand the combined graph of multiple equations.

In some embodiments, the electronic device displays, in the user interface for entering content, via the one or more display generation components, a first equation and a graphical representation of the first equation, wherein the first equation includes a first numerical value, such as text 1032 and graphical representation 1010d in FIG. 10AA. In some embodiments, the first equation satisfies the one or more criteria described above with respect to the first text. In some embodiments, the numerical value is one or more digits representing a number, such as an integer, fraction, and/or decimal. In some embodiments, the first equation includes more than one numerical value.

In some embodiments, while displaying the first equation and the graphical representation of the first equation, the electronic device detects, via the one or more input devices, one or more second inputs directed to the first numerical value, such as input with stylus 1013 in FIG. 10AA. In some embodiments, the one or more second inputs include one or more voice inputs as described herein. In some embodiments, the one or more second inputs include one or more selection and/or secondary selection inputs as described herein. In some embodiments, in response to detecting a portion of the one or more second inputs, the electronic device displays a user interface element for adjusting the numerical value, as described in more detail below. In some embodiments, the one or more second inputs include one or more inputs interacting with the user interface element.

In some embodiments, in response to detecting the one or more second inputs, the electronic device adjusts the first numerical value in accordance with the one or more second inputs, such as updating text 1032 in FIG. 10CC. In some embodiments, the one or more second inputs include input(s) with a magnitude and/or direction. In accordance with a determination that the direction is a first direction, the electronic device reduces the positive value of the first numerical quantity (e.g., reducing the absolute value of a positive number or increasing the absolute value of a negative number). In accordance with a determination that the direction is a second direction different from the first direction, the electronic device increases the positive value of the first numerical quantity (e.g., increasing the absolute value of a positive number or decreasing the absolute value of a negative number). In some embodiments, the electronic device adjusts the numerical value by an amount corresponding to the magnitude. In some embodiments, in response to detecting a relatively large magnitude, the electronic device changes the first numerical value by a relatively large amount. In some embodiments, in response to detecting a relatively small magnitude, the electronic device changes the first numerical value by a relatively small amount. In some embodiments, the electronic device changes the first numerical value by an amount based in part on the magnitude and/or number of significant digits of the first numerical value, as described in more detail above with reference to method 700, such as changing the numerical values of text 672c and/or 672d in response to detecting the inputs with stylus 203 shown in FIG. 6T.

In some embodiments, in response to detecting the one or more second inputs, the electronic device updates, via the one or more display generation components, the graphical representation of the first equation in accordance with adjusting the first numerical value, such as updating graphical representation 1010d in FIG. 10CC. In some embodiments, the electronic device updates the graphical representation of the first equation automatically in response to detecting the one or more second inputs for adjusting the first numerical value in the first equation and does not require additional inputs to also update the graphical representation of the first equation. In some embodiments, updating the graphical representation of the first equation includes displaying a graphical representation of the first equation of the equation updated with the updated value of the first numerical value. In some embodiments, in response to detecting one or more inputs modifying the text of the first numerical value (e.g., insertion and/or deletion of one or more digits), the electronic device modifies the text of the first numerical value and updates the graphical representation of the first equation in accordance with adjusting the first numerical value in this manner. In some embodiments, the one or more inputs modifying the text of the first numerical value include inputs interacting with a soft keyboard, a hardware keyboard, handwriting, and/or voice input(s). In some embodiments, updating the graphical representation of the first equation in accordance with adjusting the first numerical value includes adjusting the scale of one or more axes of the graph including the graphical representation of the first equation. In some embodiments, the electronic device updates display of the first mathematical equation with the adjusted first numerical value. Automatically updating the graphical representation of the first equation in accordance with updating the first numerical value of the first mathematical equation enhances user interactions with the electronic device by reducing the inputs needed to visualize the updated equation on a graph.

In some embodiments, the electronic device displays in the user interface for entering content, via the one or more display generation components, second text including a second numerical value, the second text not satisfying the one or more criteria, such as text 1062 and 1032 in FIG. 10CC. In some embodiments, the second text is not an equation. In some embodiments, the second text is an equation that includes ambiguities and/or unsupported operations as described above with reference to method 700, such as the equations represented by text 620 through 626 in FIG. 6G. In some embodiments, the second text includes one or more numbers used to denote numerical quantities.

In some embodiments, while displaying the first equation, the graphical representation of the first equation, and the second text, the electronic device detects, via the one or more input devices, a portion of the one or more second inputs, such as input with stylus 1013 in FIG. 10CC. In some embodiments, the portion of the one or more second inputs includes a selection input as described herein directed to the first text or the second text.

In some embodiments, while displaying the first equation, the graphical representation of the first equation, and the second text, in response to detecting the portion of the one or more second inputs, in accordance with a determination that the portion of the one or more second inputs is directed to the first numerical value in the first equation, the electronic device displays, via the one or more display generation components, a first user interface element for adjusting the first numerical value of the first equation, such as menu 1070 with option 1080 in FIG. 10DD. In some embodiments, the menu further includes additional selectable options, such as selectable options that, when respectively selected, cause the electronic device to cut or copy a portion of the first equation or to paste content from the clipboard into the first equation. In some embodiments, in response to detecting selection of the selectable option that, when selected, causes the electronic device adjust the first numerical value of the first equation, the electronic device displays an interactive element for adjusting the first numerical value, as described in more detail below. In some embodiments, the electronic device displays the user interface element for adjusting the first numerical value in response to detecting a single input directed to the first numerical value. In some embodiments, in response to detecting one or more inputs interacting with the user interface element for adjusting the first numerical value of the first equation, the electronic device updates the first equation and/or the graphical representation of the first equation as described above. In some embodiments, the menu includes an option that, when selected, causes the electronic device to display the user interface element for adjusting the first numerical value and, in response to detecting an input directed to the option, the electronic device displays the user interface element for adjusting the first numerical value.

In some embodiments, while displaying the first equation, the graphical representation of the first equation, and the second text, in response to detecting the portion of the one or more second inputs, in accordance with a determination that the portion of the one or more second inputs is directed to the second text, displaying, via the one or more display generation components, a menu that does not include a user interface element for adjusting the second numerical value, such as menu 1082 in FIG. 10FF. In some embodiments, the menu includes additional selectable options, such as selectable options that, when respectively selected, cause the electronic device to cut or copy a portion of the first equation or to paste content from the clipboard into the first equation. In some embodiments, the electronic device does not adjust numerical values included in text that are not equations in the manner in which the electronic device adjusts numerical values included in text that are equations. In some embodiments, in response to detecting one or more inputs modifying the text of the second numerical value (e.g., insertion and/or deletion of one or more digits), the electronic device modifies the text of the second numerical value. In some embodiments, the one or more inputs modifying the text of the second numerical value include inputs interacting with a soft keyboard, a hardware keyboard, handwriting, and/or voice input(s). Displaying a selectable option that, when selected, causes the electronic device to initiate the process to adjust the first numerical value of the first equation in a text editing menu enhances user interactions with the electronic device by using familiar input patterns to perform new operations, thereby reducing user errors and improving discoverability of new features.

In some embodiments, adjusting the first numerical value in accordance with the one or more second inputs includes detecting, via the one or more input devices, a hover input directed towards the first numerical value included in the one or more second inputs, such as the input with stylus 1013 in FIG. 10AA. The hover input optionally has one or more of the characteristics of the hover input described above with reference to method 700, such as hover input with stylus 203, as shown in legend 664 in FIG. 6L. In some embodiments, the hover input does not include contact of an object (e.g., stylus or finger) at a touch-sensitive surface (e.g., touch screen or track pad). In some embodiments, the hover input includes detecting the attention (e.g., including gaze) of the user directed towards the first numerical value and/or detecting a hover air gesture.

In some embodiments, adjusting the first numerical value in accordance with the one or more second inputs includes in response to detecting the hover input, displaying, via the one or more display generation components, an interactive element associated with the first numerical value, such as element 1068 in FIG. 10BB. In some embodiments, the interactive element associated with the first numerical value has one or more characteristics of the scrubber element described above with reference to method 700, such as scrubber element 678a in FIG. 6R.

In some embodiments, adjusting the first numerical value in accordance with the one or more second inputs includes while displaying the interactive element, detecting, via the one or more input devices, a respective input of the one or more second inputs directed to the interactive element, such as the input with stylus 1013 in FIG. 10BB. In some embodiments, the respective input is an input adjusting a position of a portion of the interactive element corresponding to the first numerical value before detecting the one or more inputs, described in more detail below. In some embodiments, the respective input includes movement with a magnitude and direction. For example, the respective input includes a tap (e.g., of a finger or stylus on a touch screen or trackpad) directed to the interactive element, followed by movement of the contact of the tap. As another example, the respective input includes movement of a hand of the user in a predefined hand shape. In some embodiments, the respective input includes contact of an object at a touch-sensitive surface. In some embodiments, the interactive element is a slider element with an indication that moves in accordance with an input directed to the slider input as described above and with reference to method 700, such as slider element 666 in FIG. 6M.

In some embodiments, in response to detecting the respective input, the electronic device adjusts the first numerical value in accordance with the respective input, such as updating text 1032 as shown in FIG. 10CC. In some embodiments, the electronic device adjusts the first numerical value in a direction corresponding to the direction of the movement. In some embodiments, in accordance with a determination that the movement is in a first direction, the electronic device increases the first numerical value. In some embodiments, in accordance with a determination that the movement is in a second direction different from the first direction, the electronic device decreases the first numerical value. In some embodiments, the electronic device adjusts the first numerical value by an amount corresponding to the magnitude of the movement. In some embodiments, in accordance with a determination that the magnitude is a first magnitude, the electronic device adjusts the first numerical value by an amount corresponding to the first magnitude. In some embodiments, in accordance with a determination that the magnitude is a second magnitude different from the first magnitude, the electronic device adjusts the first numerical value by an amount corresponding to the second magnitude different from the amount corresponding to the first magnitude. Displaying the interactive element for adjusting the first numerical value in response to detecting a hover input directed to the first numerical value enhances user interactions with the electronic device by providing visual feedback while adjusting the first numerical value, thereby reducing user errors.

In some embodiments, adjusting the first numerical value in accordance with the one or more second inputs includes detecting, via the one or more input devices, a first input directed towards the first numerical value included in the one or more second inputs, such as the input with stylus 1013 in FIG. 10CC. In some embodiments, the first input is a selection input, such as a selection input described herein. In some embodiments, the input is a voice input. In some embodiments, the respective input includes contact of an object at a touch-sensitive surface.

In some embodiments, adjusting the first numerical value in accordance with the one or more second inputs includes in response to detecting the first input, displaying, via the one or more display generation components, a selectable option, such as option 1080 in FIG. 10DD. In some embodiments, the selectable option has one or more of the characteristics of the selectable option that, when selected, initiates a process to adjust the first numerical value, as described above.

In some embodiments, adjusting the first numerical value in accordance with the one or more second inputs includes while displaying the selectable option, detecting, via the one or more input devices, an input directed to the selectable option, such as input with stylus 1013 in FIG. 10DD. In some embodiments, the input directed to the selectable option is a selection input as described herein. In some embodiments, the input is a voice input not necessarily directed to the selectable option.

In some embodiments, adjusting the first numerical value in accordance with the one or more second inputs includes in response to detecting the input directed to the selectable option, displaying, via the one or more display generation components, an interactive element associated with the first numerical value, such as displaying element 1068 in FIG. 10BB. In some embodiments, the interactive element includes an indication corresponding to a value of the first numerical value before detecting the one or more second inputs. In some embodiments, in response to detecting an input adjusting the position of the indication within the interactive element along a respective dimension, for example, the electronic device adjusts the first numerical value, as described in more detail below. In some embodiments, the interactive element is a slider, scale, scrubber, or dial. In some embodiments, the interactive element is a slider element with an indication that moves in accordance with an input directed to the slider input as described above and with reference to method 700, such as slider element 666 in FIGS. 6M-6N and/or scrubber element 678 in FIG. 6R.

In some embodiments, adjusting the first numerical value in accordance with the one or more second inputs includes while displaying the interactive element, detecting, via the one or more input devices, a respective input of the one or more second inputs directed to the interactive element, such as the input with stylus 1013 shown in FIG. 10BB.

In some embodiments, adjusting the first numerical value in accordance with the one or more second inputs includes in response to detecting the respective input, adjusting the first numerical value in accordance with the respective input, such as the display of text 1032 in FIG. 10CC. In some embodiments, adjusting the first numerical value in accordance with the respective input includes adjusting the first numerical value according to a magnitude and/or direction of the first respective input, as described above with reference to adjusting the first numerical value in accordance with the magnitude and/or direction of a respective input. As described in more detail below, the electronic device adjusts the first numerical value in response to the respective input in accordance with a determination that the first input is directed towards the first numerical value. In some embodiments, if the first numerical value had been directed to a different numerical value in an equation, the electronic device would adjust that numerical value in response to detecting a respective input directed to the interactive element. Displaying the interactive element for adjusting the first numerical value in response to detecting an input directed to the first numerical value followed by an input directed to a selectable option enhances user interactions with the electronic device by providing visual feedback while adjusting the first numerical value, thereby reducing user errors.

In some embodiments, adjusting the first numerical value in accordance with the one or more second inputs includes detecting, via the one or more input devices, a portion of the one or more second inputs, such as inputs with stylus 1013 in FIG. 10AA. In some embodiments, the portion of the one or more second inputs include a hover input directed to a numerical value of an equation in the user interface as described above. In some embodiments, the portion of the one or more second inputs include an input directed to a selectable option as described above. In some embodiments, the portion of the one or more inputs includes a voice input.

In some embodiments, adjusting the first numerical value in accordance with the one or more second inputs includes in response to detecting the portion of the one or more second inputs, displaying, via the one or more display generation components, an interactive element associated with the first numerical value at a location in the user interface proximate to the first numerical value, such as interactive element 1068 in FIG. 10BB. In some embodiments, the interactive element has one or more of the characteristics described above. In some embodiments, the electronic device displays the interactive element above the first numerical value in the user interface.

In some embodiments, adjusting the first numerical value in accordance with the one or more second inputs includes while displaying the interactive element, detecting, via the one or more input devices, a respective input of the one or more second inputs directed to the interactive element, such as the input with stylus 1013 in FIG. 10BB. In some embodiments, the respective input directed to the interactive element has one or more characteristics of a respective input directed to the interactive element described above.

In some embodiments, adjusting the first numerical value in accordance with the one or more second inputs includes in response to detecting the respective input updating, via the one or more display generation components, an appearance of the interactive element in accordance with the respective input, such as adjusting interactive element 1068 in FIG. 10BB, optionally including adjusting an indicator of the interactive element in accordance with magnitude and/or direction of the respective input, as described above.

In some embodiments, adjusting the first numerical value in accordance with the one or more second inputs includes in response to detecting the respective input adjusting the first numerical value in accordance with the respective input, such as the display of text 1032 in FIG. 10CC, and optionally as described above, including adjusting the first numerical value by an amount and/or in a direction corresponding to a magnitude and/or direction of the respective input. Updating the appearance of the interactive element in accordance with the respective input and adjusting the first numerical value in accordance with the interactive input enhances user interactions with the computer system by providing visual feedback and reducing user errors.

In some embodiments, displaying the interactive element includes displaying a first portion of the interactive element corresponding to the first numerical value prior to detecting the one or more second inputs, such as interactive element 1068 in FIG. 10BB. In some embodiments, the first portion of the interactive element includes a visual indication distinct from other portions of the interactive element. In some embodiments, the first portion of the interactive element includes an image not included in other portions of the interactive element, such as a dot, circle, or other shape or image.

In some embodiments, displaying the interactive element includes displaying a second portion of the interactive element corresponding to values other than the first numerical value prior to detecting the one or more second inputs, and wherein updating the appearance of the interactive element in accordance with the respective input includes updating a position of the first portion of the interactive element relative to the interactive element in accordance with the respective input, such as interactive element 1068 in FIG. 10BB. In some embodiments, the second portion of the interactive element includes visual content different from visual content of the first portion of the scrubber. In some embodiments, the second portion of the interactive element includes a repeating pattern, such as a series of lines and/or dashes. In some embodiments, the electronic device updates the position of the first portion of the interactive user interface element in accordance with a magnitude and/or direction of movement of a respective input directed to the interactive element, as described in more detail above. Adjusting the position of the first portion of the interactive element relative to the interactive element in accordance with the respective input enhances user interactions with the electronic device by providing visual feedback to the user and reducing user errors.

In some embodiments, adjusting the first numerical value in accordance with the one or more second inputs includes, in accordance with a determination that, before detecting the one or more second inputs, the first numerical value has a first magnitude, the electronic device the first numerical value by a first amount in accordance with a respective magnitude of the one or more second inputs and the first magnitude, such as adjusting the numerical value “8” in FIG. 10BB. In some embodiments, adjusting the first numerical value in accordance with the magnitude of the one or more second inputs is described in more detail above. In some embodiments, the electronic device adjusts the first numerical value in accordance with a direction of the one or more inputs. In some embodiments, the electronic device adjusts the numerical value by a larger amount if the value of the numerical value prior to detecting the one or more second inputs was relatively large. In some embodiments, the electronic device adjusts the numerical value by a smaller amount if the value of the numerical value prior to detecting the one or more second inputs was relatively small. Additionally or alternatively, in some embodiments, the electronic device adjusts the numerical value by an amount in accordance with a number of significant figures of the first numerical value as described in more detail above with reference to method 700, such as the adjustment of the numerical values in text 672c and/or 672d in FIG. 6T.

In some embodiments, adjusting the first numerical value in accordance with the one or more second inputs includes in accordance with a determination that, before detecting the one or more second inputs, the first numerical value has a second magnitude different from the first magnitude, the electronic device adjusts the first numerical value by a second amount in accordance with the respective magnitude of the one or more second inputs and the second magnitude, the second amount different from the first amount, such as adjusting the numerical value “75” in FIG. 10HH. In some embodiments, the electronic device adjusts different numerical values by different amounts in response to detecting the one or more inputs with a respective magnitude depending on the magnitude (e.g., absolute value) of the numerical values prior to the electronic device detecting the one or more respective inputs. Adjusting the numerical value by an amount based on the magnitude of the numerical value prior to the electronic device detecting the one or more respective inputs in response to detecting the one or more respective inputs with a respective magnitude enhances user interactions with the electronic device by reducing the number of inputs needed to significantly change the numerical value and reducing user errors.

In some embodiments, the first equation further includes a second numerical value different from the first numerical value, such as in text 1066 in FIG. 10GG. In some embodiments, the first numerical value and second numerical value are the numerator and denominator of a fraction included in the first equation. In some embodiments, the first numerical value and the second numerical value are integers and/or decimals included in the first equation. In some embodiments, the first numerical value and the second numerical value are numerators and/or denominators of different fractions included in the first equation.

In some embodiments, while displaying the first equation and the graphical representation of the first equation in the user interface, the electronic device detects, via the one or more input devices, one or more third inputs directed to the second numerical value, such as including the input with stylus 1013 in FIG. 10GG. In some embodiments, the one or more third inputs have one or more characteristics of the one or more second inputs directed to the first numerical value, except they are directed to the first numerical value.

In some embodiments, while displaying the first equation and the graphical representation of the first equation in the user interface in response to detecting the one or more third inputs, the electronic device adjusts the second numerical value in accordance with the one or more third inputs, such as adjusting text 1066 in FIG. 10II, and optionally similar to the manner in which the electronic device adjusts the first numerical value in accordance with the one or more second inputs described above.

In some embodiments, while displaying the first equation and the graphical representation of the first equation in the user interface in response to detecting the one or more third inputs, the electronic device updates, via the one or more display generation components, the graphical representation of the first equation in accordance with adjusting the second numerical value, such as updating a graphical representation of text 1066 if there was one in FIG. 10II, and optionally similar to the manner in which the electronic device adjusts the graphical representation of the first equation in accordance with adjusting the first numerical value described above. In some embodiments, in response to detecting one or more inputs requesting to adjust a numerical value of the first equation, the electronic device adjusts the first or second numerical value depending on towards which numerical value the one or more inputs were directed. In some embodiments, the electronic device updates the second numerical value in accordance with interactions with an interactive element as described herein in accordance with a determination that the one or more third inputs include an input directed to the second numerical value. In some embodiments, the electronic device updates the first numerical value in accordance with interactions with an interactive element as described herein in accordance with a determination that the one or more third inputs include an input directed to the first numerical value. Automatically updating the graphical representation of the first mathematical equation in accordance with updating the second numerical value of the first mathematical equation enhances user interactions with the electronic device by reducing the inputs needed to visualize the updated equation on a graph.

In some embodiments, the electronic device displays in the user interface for entering content, via the one or more display generation components, a first equation that includes a variable representing a respective numerical value, such as in text 1004, 1012, and/or 1018 in FIG. 10O. In some embodiments, the variable includes one or more letters and/or symbols. In some embodiments, the user interface for entering content includes text assigning the respective numerical value to the variable. For example, if the variable is m, the user interface for entering content includes text such as “m=10” assigning the numerical value 10 to the variable m. In some embodiments, the variable representing the respective numerical value is different from one or more variables representing axes of one or more graphs in the user interface. In some embodiments, the electronic device receives one or more inputs providing the first equation before detecting an input assigning the numerical value to the variable.

In some embodiments, while displaying the first equation and the first graphical representation of the first text, the electronic device detects, via the one or more input devices, one or more second inputs, optionally including the input with stylus 1013 in FIG. 10O. In some embodiments, the one or more second inputs are inputs to modify text, as described above, directed to the text that assigns the respective numerical value to the variable. In some embodiments, the one or more second inputs include interactions with an interactive element, such as the interactive elements described above, to adjust the respective numerical value.

In some embodiments, in response to detecting the one or more second inputs, in accordance with a determination that the one or more second inputs satisfy one or more second criteria including a criterion that is satisfied when the one or more second inputs set the respective numerical value to a first numerical value, the electronic device updates the first equation in accordance with the first numerical value, such as updating the equations represented by text 1004, 1012, and/or 1018 in FIG. 10Q in accordance with updating text 1002. In some embodiments, updating the first equation includes maintaining the written content of the equation. For example, the first equation includes the variable before and after the electronic device receives the one or more second inputs. In some embodiments, the numerical quantity represented by the variable in the first equation changes in accordance with the one or more second inputs. In some embodiments, the electronic device updates a graphical representation of the first text in accordance with updating the respective numerical value. In some embodiments, the user interface for entering content includes multiple equations using the variable and updating the numerical value associated with the variable updates the multiple equations. In some embodiments, the user interface includes multiple graphical representations of multiple equations that include the variable and updating the variable causes the electronic device to update the multiple graphical representations in accordance with the updated variable. In some embodiments, the one or more second inputs are not directed to the first equation, such as an input adding text defining a numerical value for the variable to the user interface. In some embodiments, in accordance with a determination that the one or more second inputs assign a second numerical value to the variable, the electronic device assigns the second numerical value to the variable in the first equation Adjusting an equation including a variable in accordance with adjusting a numerical value assigned to the variable enhances user interactions with the electronic device by reducing the inputs needed to update equations and/or graphs and reduces user errors.

In some embodiments, the electronic device displays, in the user interface for entering content, via the one or more display generation components, a first equation that includes (i) a first variable representing a first numerical value and (ii) a second variable representing a second numerical value, such as text 1066 in FIG. 10X. In some embodiments, the first variable and the second variable have one or more characteristics of the variable associated with a numerical value described above.

In some embodiments, while displaying the first equation and the first graphical representation of the first text the electronic device detects, via the one or more input devices, one or more second inputs, optionally including input with stylus 1013 in FIG. 10GG. In some embodiments, the one or more second inputs have one or more characteristics of the one or more second inputs for adjusting numerical values described in more detail above.

In some embodiments, while displaying the first equation and the first graphical representation of the first text, in response to detecting the one or more second inputs, in accordance with a determination that the one or more second inputs are directed to the first variable, the electronic device updates the first numerical value in accordance with the one or more second inputs, such as adjusting text 1002 in FIG. 10Q, and optionally without adjusting the second numerical value associated with the second variable. In some embodiments, the one or more second inputs include an input selecting the first variable and/or a hover input directed to the first variable, as described above. In some embodiments, updating the first numerical value in accordance with the one or more inputs has one or more of the characteristics of adjusting numerical values in accordance with one or more inputs as described above.

In some embodiments, while displaying the first equation and the first graphical representation of the first text, in response to detecting the one or more second inputs in accordance with a determination that the one or more second inputs are directed to the second variable, updating the second numerical value in accordance with the one or more second inputs such as adjusting a variable represented by text other than text 1002 in FIG. 10Q in a manner similar to the manner of adjusting text 1002 and optionally without adjusting the first numerical value of the first variable. In some embodiments, the one or more second inputs include an input selecting the second variable and/or a hover input directed to the second variable, as described above. In some embodiments, updating the second numerical value in accordance with the one or more inputs has one or more of the characteristics of adjusting numerical values in accordance with one or more inputs as described above. Adjusting a numerical value of a variable in an equation in accordance with detecting one or more inputs enhances user interactions with the electronic device by reducing the number of inputs needed to adjust the equation.

In some embodiments, the electronic device displays, in the user interface for entering content, via the one or more display generation components, a graphical representation of a first equation, such as graphical representation 1046 in FIG. 10UU. In some embodiments, the user interface for entering content further includes the first equation. In some embodiments, the first equation is typed. In some embodiments, the first equation is handwritten.

In some embodiments, in accordance with a determination that the first equation includes a time variable, the electronic device the graphical representation of the first equation includes displaying an animation of the graphical representation of the first equation, such as graphical representation 1046 in FIG. 10UU. In some embodiments, the time variable is a predefined letter, such as t and/or T. In some embodiments, the first equation further includes one or more variables corresponding to axes of the graph including the graphical representation of the first equation. In some embodiments, the animation repeats automatically over a range of values for the time variable.

In some embodiments, in accordance with a determination that the first equation does not include a time variable, displaying the graphical representation of the first equation includes forgoing displaying the animation of the graphical representation of the first equation, such as graphical representation 1010e in FIG. 10TT. In some embodiments, the electronic device displays graphical representations of equations that do not include the time variable without animation. Displaying animated graphical representations of equations that include a time variable enhances user interactions with the electronic device by providing an efficient way of visualizing a equation of time.

In some embodiments, the electronic device displays in the user interface for entering content, via the one or more display generation components, a first three-dimensional graphical representation of a first equation from a first viewing angle (and/or first perspective), such as in FIG. 10UU. In some embodiments, the user interface is a two-dimensional user interface and/or the one or more display generation components are two-dimensional display generation components. The electronic device optionally displays a two-dimensional representation of a three-dimensional graphical representation of an equation with a simulated first viewing angle. In some embodiments, the user interface is a three-dimensional user interface and/or the one or more display generation components are three-dimensional display generation components. The electronic device optionally displays a three-dimensional representation of a three-dimensional graphical representation of an equation in a three-dimensional environment.

In some embodiments, while displaying the first three-dimensional graphical representation of the first equation from the first viewing angle (and/or first perspective), the electronic device detects, via the one or more input devices, a second input corresponding to a request to update the first viewing angle (and/or first perspective), such as the input with contact 1003 in FIG. 10UU. In some embodiments, the request to update the first viewing angle is a request to rotate the first three-dimensional graphical representation of the first equation in one or more axes of rotation. The axes of rotation optionally align with the graph axes. The axes of rotation optionally do not align with the axes of rotation.

In some embodiments, in response to detecting the second input, in accordance with a determination that the request to update the first viewing angle (and/or first perspective) is a request to update the first viewing angle (and/or first perspective) to a second viewing angle (and/or second perspective) different from the first viewing angle (and/or first perspective), the electronic device displays, via the one or more display generation components, the first three-dimensional graphical representation of the first equation from the second viewing angle (and/or second perspective), such as displaying representation 1046 in FIG. 10VV. In some embodiments, the electronic device adjusts the viewing angle in accordance with a direction and/or magnitude of the second input similar to manners of updating other user interface elements in accordance with direction and/or magnitude of inputs.

In some embodiments, in response to detecting the second input, in accordance with a determination that the request to update the first viewing angle (and/or first perspective) is a request to update the first viewing angle (and/or first perspective) to a third viewing angle (and/or third perspective) different from the first viewing angle (and/or first perspective) and different from the second viewing angle (and/or second perspective), displaying, via the one or more display generation components, the first three-dimensional graphical representation of the first equation from the third viewing angle (and/or third perspective), such as displaying representation 1046 at an angle other than the angles shown in FIGS. 10UU and/or 10VV and optionally similar to the manner of displaying the three-dimensional graphical representation of the first equation from the second viewing angle. Providing a way of changing the viewing angle of a three-dimensional graphical representation of the first equation enhances user interactions with the electronic device by efficiently providing more information about the appearance of the graph.

In some embodiments, initiating the process for displaying the first graphical representation of the first text on the corresponding graph in the user interface in accordance with the determination that the first text satisfies the one or more criteria includes automatically, in response to detecting the input to enter the text in the user interface, displaying, via the one or more display generation components, a selectable option that, when selected, causes the electronic device to display the first graphical representation of the first text on the corresponding graph, such as displaying option 1006 in FIG. 10B in response to detecting the input illustrated in FIG. 10A. In some embodiments, the one or more criteria include a criterion that is satisfied when the first text includes an equation using predefined variables (e.g., “x” and “y” or other predefined pairs, trios, or groupings of variables). In some embodiments, text including equations expressed with different variables from the predefined variables does not satisfy the one or more criteria, as described in more detail below. In some embodiments, in accordance with the determination that the first text satisfies the one or more criteria, the electronic device displays the selectable option in response to detecting the input to enter the text without receiving an additional input, such as an input requesting to initiate the process to present the graphical representation of the first text described in more detail below. In some embodiments, the selectable option that, when selected, causes the electronic device to display the graphical representation of the first text is described in more detail herein. In some embodiments, the electronic device detects an input selecting the selectable option, such as a tap input, a hardware device input, an air gesture, and/or a voice input optionally including an attention component (e.g., gaze of a proxy for gaze, cursor, input focus, and/or location of a direct input). In some embodiments, in response to detecting the input selecting the selectable option, the electronic device displays the graphical representation of the first text on a graph. Automatically displaying the selectable option that, when selected, causes the electronic device to display the graphical representation of the first text enhances user interactions with the electronic device by reducing the inputs needed to display graphical representations of equations and enhancing feature discoverability.

In some embodiments, while displaying the first text corresponding to the input, in accordance with the determination that the first text does not satisfy the one or more criteria, the electronic device detects, via the one or more input devices, a respective input corresponding to a request to initiate the process for displaying the first graphical representation of the first text on the corresponding graph in the user interface for entering content, such as the input shown in FIG. 10XX. In some embodiments, the respective input is a selection input, such as a tap, air gesture, hardware input device input, voice input, or direct input, optionally including an attention (e.g., gaze or gaze proxy, input focus, cursor, or direct input location) component. In some embodiments, the respective input includes selection of the first text. In some embodiments, the respective input includes selection of a respective portion of the first text, such as a selection input directed to an equals sign in the first text.

In some embodiments, while displaying the first text corresponding to the input, in accordance with the determination that the first text does not satisfy the one or more criteria, in response to detecting the respective input, in accordance with a determination that the first text satisfies one or more second criteria, the electronic device displays, via the one or more display generation components, a selectable option that, when selected, causes the electronic device to display the first graphical representation of the first text on the corresponding graph, optionally the selectable option described above and/or option 1006 shown in FIG. 10YY. In some embodiments, the one or more second criteria are satisfied when the first text includes an equation with two or more variables that are not the predefined variables described above. In some embodiments, if the first text does not satisfy the one or more criteria, the electronic device forgoes displaying the selectable option unless and until the electronic device detects the respective input.

In some embodiments, while displaying the first text corresponding to the input, in accordance with the determination that the first text does not satisfy the one or more criteria, in response to detecting the respective input in accordance with a determination that the first text does not satisfy the one or more second criteria, the electronic device forgoes displaying the selectable option, such as forgoing displaying option 1006 in FIG. 10YY in response to detecting the input in FIG. 10XX if the text 1009 did not satisfy the one or more second criteria. In some embodiments, the first text does not satisfy the one or more second criteria because the first text does not include a mathematical equation. In some embodiments, the first text does not satisfy the one or more second criteria because the first text does not include a predefined number of variables (e.g., two or three variables). Displaying the selectable option for displaying a graphical representation of the first text in response to receiving the respective input enhances user interactions with the electronic device by avoiding cluttering the user interface with the graphing option in situations in which the user is less likely to wish to view the graphical representation of the first text while providing the flexibility to display the graphical representation if the user wishes.

It should be understood that the particular order in which the operations in FIG. 11 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 900, and 1200) are also applicable in an analogous manner to method 700 described above with respect to FIG. 11. For example, the operation of graphing mathematical equations described above with reference to method 1100 optionally has one or more of the characteristics of detecting mathematical equations and displaying solutions to mathematical equations, performing unit conversion, and displaying a menu of potions to modify one or more portions of a graph described herein with reference to other methods described herein (e.g., methods 900, 1100, and 1200). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 7 are, optionally, implemented by components depicted in FIGS. 1A-1B. For example, displaying operation 1102, and detecting operation 1106 are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

FIG. 12 illustrates a flow diagram illustrating a method in which an electronic device edits graphs of mathematical functions in accordance with some embodiments of the disclosure. The method 1200 is optionally performed at first electronic device and/or electronic devices such as device 100, device 300, or device 500 as described above with reference to FIGS. 1A-1B, 2-3, 4A-4B and 5A-5H. Some operations in method 1200 are, optionally combined and/or order of some operations is, optionally, changed.

In some embodiments, method 1200 is performed at an electronic device in communication with one or more display generation components and one or more input devices. The electronic device, display generation component, and/or one or more input devices optionally have one or more characteristics as those described above with reference to method(s) 700, 900, and/or 1100.

In some embodiments, the electronic device detects (1202), via the one or more input devices, an input corresponding to a request to display a user interface element associated with a graph that includes a graphical representation of a first mathematical equation in an electronic document that includes a representation of the first mathematical equation that is separate from the graph (e.g., the first mathematical equation is written or typed or otherwise displayed outside of the graph) in an electronic document, such as the input with stylus 1013 in FIG. 10KK. In some embodiments, the input includes a touch input, a voice input, an air gesture, and/or an input detected using one or more hardware input devices. In some embodiments, prior to detecting the input (and/or while detecting the input), the electronic device displays a selectable option that, when selected, causes the electronic device to display the user interface element associated with the graph. In some embodiments, the input corresponding to the request to display the user interface element associated with the graph is directed to this selectable option, such as a touch input, an air gesture input, and/or an input detected using a hardware input device. In some embodiments, the input corresponding to the request to display the user interface element associated with the graph is not directed to this selectable option, such as a voice input and/or an input detected using a hardware input device.

In some embodiments, the electronic document is a file that includes content, such as typed, handwritten and/or image content. In some embodiments, the electronic document includes one or more graphs according to method 1100, such as graphical representation 1010a graphed on axes 1008a in FIG. 10D. In some embodiments, the electronic device displays the graph using a notetaking application and/or a calculator application as described above with reference to one or more of method(s) 700, 900, and/or 1100, such as the calculator application that includes content entry region 602 in FIG. 6A, user interface 800 in FIG. 8A, and/or user interface 1000 in FIG. 10A. In some embodiments, the electronic device displays the mathematical equation in response to detecting an input providing the equation, as described above with reference to method(s) 700, 900, and/or 1100, such as displaying text 604 in response to the input with stylus 203 in FIG. 6A, displaying solution 826b of equation 826a in FIG. 8B, and/or displaying text 1004 in FIG. 10B in response to the input with the stylus 1013 in FIG. 10A. In some embodiments, the electronic device displays the graphical representation of the mathematical equation as described above with reference to method(s) 700 and/or 1100, such as graph 651 in FIG. 6Y and/or graphical representation 1010a in FIG. 10D. In some embodiments, the mathematical equation includes a mathematical equation relating two or more variables to each other as described above with reference to method 1100, such as graphical representation 1010a on axes 1008a in FIG. 10D. For example, the mathematical equation defines the value of a first variable (e.g., y) as a equation of a second variable (e.g., x). In some embodiments, as described above with reference to method(s) 700 and/or 1100, such as text 688 in FIG. 6Y and/or text 1004 in FIG. 10B, the mathematical equation further includes numerical quantities, constants represented by one or more variables, and/or mathematical operations. In some embodiments, as described above with reference to method(s) 700 and/or 1100, the graph further includes plots of one or more mathematical equations other than the first mathematical equation, including multiple equations concurrently, such as displaying graphical representation 1010a and 1010b on axes 1008a in FIG. 10G or displaying an additional graphical representation on graph 651 in FIG. 6Y.

In some embodiments, in response to detecting the input corresponding to the request to display the user interface element associated with the graph, the electronic device displays (1204), via the one or more display generation components, a user interface element associated with the graph, such as user interface element 1085 in FIG. 10LL. In some embodiments, the user interface element is displayed concurrently with at least a portion of the graph, such as displaying user interface element 1085 with graphical representation 1010d.

In some embodiments, displaying the user interface element associated with the graph includes, in accordance with a determination that the electronic document includes a second mathematical equation different from the first mathematical equation and that is not included in the graph, displaying the user interface element associated with the graph includes displaying a visual indication of the second mathematical equation in the user interface element associated with the graph (1206), such as user interface element 1087b in FIG. 10LL. In some embodiments, the user interface element associated with the graph includes visual indication(s) of the one or more mathematical equations included in the electronic document and not included in the graph. In some embodiments, the user interface element associated with the graph further includes visual indication(s) of the one or more mathematical equations included in the graph. In some embodiments, the user interface element associated with the graph further includes selectable options that, when selected, cause the electronic device to copy the graph, cut the graph from the electronic document, or paste equations to the graph. Further details about the user interface element associated with the graph are described in detail below. In some embodiments, the visual indication of the second mathematical equation is a typed representation of the second equation. In some embodiments, as described in further detail below, in response to detecting selection of the visual indication of the second mathematical equation, the electronic device adds a graph of the second mathematical equation to the axes of the graph of the first mathematical equation.

In some embodiments, displaying the user interface element associated with the graph includes in accordance with a determination that the electronic document includes a third mathematical equation different from the first mathematical equation and different from the second mathematical equation and not included in the graph, displaying the user interface element associated with the graph includes displaying a visual indication of the third mathematical equation in the user interface element associated with the graph (1208), such as user interface element 1087c in FIG. 10LL. In some embodiments, the visual indication of the third mathematical equation is a typed representation of the third equation. In some embodiments, if the electronic document includes the second mathematical equation but not the third mathematical equation, the user interface element associated with the graph includes the visual indication of the second mathematical equation, but not the visual indication of the third mathematical equation. In some embodiments, if the electronic document includes the third mathematical equation but not the second mathematical equation, the user interface element associated with the graph includes the visual indication of the third mathematical equation, but not the visual indication of the second mathematical equation. In some embodiments, if the electronic document includes the second mathematical equation and the third mathematical equation, the user interface element associated with the graph includes the visual indication of the second mathematical equation and the visual indication of the third mathematical equation. In some embodiments, after displaying the user interface element associated with the graph, the mathematical equations included in the electronic document change, such as the electronic device adding, deleting, and/or changing one or more mathematical equations included in the electronic document as described above with reference to method(s) 700 and/or 1100, such as displaying text 653 in FIG. 6Z and/or changing the equations represented by text 1004, 1012, and/or 1018 in FIG. 10Q. In these embodiments, when displaying the user interface element associated with the graph after these changes, the electronic device displays an updated user interface element associated with the graph that includes visual indication(s) of the updated equations. In some embodiments, the electronic document includes a second graph including a graphical representation of a third mathematical equation different from the graph including the graphical representation of the first mathematical equation. In these embodiments, in response to detecting an input corresponding to a request to display a second user interface element corresponding to the second graph, the electronic device displays the user interface element corresponding to the second graph. In some embodiments, the user interface element corresponding to the second graph includes visual indications of mathematical equations included in the electronic document and not included in the second graph in a similar manner to the inclusion of the visual indication(s) of the second mathematical equation and/or the third mathematical equation in the user interface element corresponding to the graph. In some embodiments, the user interface element corresponding to the graph includes a visual indication of the respective equation included in the second graph. In some embodiments, the user interface element corresponding to the graph does not include a visual indication of the respective equation included in the second graph. In some embodiments, in response to detecting an input corresponding to a request to display a user interface element associated with a graph, the electronic device displays the user interface element that includes visual indication(s) of mathematical equations included in the electronic document but not included in the graph. In some embodiments, as described in further detail below, in response to detecting selection of the visual indication of the third mathematical equation, the electronic device adds a graphical representation of the third mathematical equation to the axes of the graph of the first mathematical equation. Displaying a user interface element associated with the graph that includes visual indication(s) of mathematical equation(s) not included in the graph enhances user interactions with the electronic device by reducing the inputs needed to concurrently view equations available to add to the graph, displaying more information concurrently, and reducing opportunity for user error.

In some embodiments, displaying the user interface element associated with the graph includes, in accordance with a determination that the electronic document does not include a mathematical equation satisfying one or more criteria different from the first mathematical equation, displaying the user interface element associated with graph includes forgoing displaying a visual indication associated with a mathematical equation different from the first mathematical equation in the user interface element associated with the graph, such as not including indications 1086b through 1086c and/or options 1087b through 1087c in FIG. 10LL if the user interface 1000 did not include text 1064 and 1066. In some embodiments, the one or more criteria are the one or more criteria for identifying a graphable mathematical equation and/or equation as described above with reference to method 1100, such as the one or more criteria for displaying the graphing option 1006 in FIG. 10B in accordance with a determination that text 1004 satisfies the one or more criteria. In some embodiments, the user interface element associated with the graph further includes selectable options that, when selected, causes the electronic device to remove the first mathematical equation from the graph and/or change the color of the first mathematical equation on the graph as described in more detail below. In some embodiments, the user interface associated with the graph further includes one or more options that, when selected, causes the electronic device to copy, cut, and/or delete the graph and/or paste a mathematical equation into the graph. In some embodiments, the electronic device automatically identifies mathematical equations satisfying the one or more criteria as described below. Displaying the user interface element associated with the graph without the visual indication associated with a mathematical equation different from the first mathematical equation enhances user interactions with the electronic device by efficiently providing options to perform actions related to the graph even when additional equations are not available to add to the graph.

In some embodiments, displaying the user interface associated with the graph includes, in accordance with a determination that the electronic document includes the second mathematical equation and the third mathematical equation, displaying the user interface element associated with the graph includes displaying the visual indication associated with the second mathematical equation and the visual indication associated with the third mathematical equation in the user interface associated with the graph, such as including options 1087b and 1087c in the user interface element 1085 in FIG. 10LL. In some embodiments, in accordance with a determination that the electronic document includes multiple mathematical equations that satisfy one or more criteria for graphing, the electronic device displays the user interface element associated with the graph with respective selectable options associated with the mathematical equations. In some embodiments, the mathematical equations are not included in other graphs in the electronic document, included in other graphs in the electronic document and/or a combination thereof. Displaying multiple options for addition equations to the graph in the user interface element associated with the graph enhances user interactions with the graph by reducing the inputs needed to compare mathematical equations on a graph.

In some embodiments, while displaying the graph including the graphical representation of the first mathematical equation in the electronic device without displaying the user interface element associated with the graph, the electronic device detects, via the one or more input devices, a second input corresponding to a request to display the user interface element associated with the graph, such as input with stylus 1013 shown in FIG. 10KK. In some embodiments, the electronic device displays the representation of the first mathematical equation outside of the graph concurrently with the graph including the graphical representation of the first mathematical equation without displaying the user interface element associated with the graph. In some embodiments, the electronic device displays a selectable option associated with the graph overlaid on or proximate to the graph. In some embodiments, the second input is a selection input as described herein directed to the selectable option. In some embodiments, the second input is a voice input corresponding to a request to display the user interface element associated with the graph optionally directed to or optionally not directed to the selectable option.

In some embodiments, in response to detecting the second input, the electronic device displays, via the one or more display generation components, the user interface element associated with the graph concurrently with at least the portion of the graph, such as user interface element 1085 in FIG. 10LL. In some embodiments, the electronic device displays the graph in response to one or more inputs as described above with reference to method 1100, such as the input with stylus 1013 in FIG. 10C. In some embodiments, while displaying the graph, the electronic device forgoes display of the user interface element associated with the graph unless and until the electronic device receives the second input. Displaying the user interface element associated with the graph in response to detecting an input enhances user interactions with the electronic device by providing an efficient way of initiating a process to modify the graph.

In some embodiments, while displaying, via the one or more display generation components, the graph that includes the graphical representation of the first mathematical equation and the user interface element associated with the graph including a visual indication of a respective mathematical equation in the electronic document different from the first mathematical equation, the electronic device detects, via the one or more input devices, an input directed to the visual indication of the respective mathematical equation, such as the input with stylus 1013 in FIG. 10NN. In some embodiments, the visual indication of the respective mathematical equation is the visual indication of the second mathematical equation or the visual indication of the third mathematical equation described in more detail above. In some embodiments, the electronic device concurrently displays, in the user interface element corresponding to the graph, the respective visual indication of the respective mathematical equation with a visual indication of another mathematical equation, as described above. In some embodiments, the input directed to the visual indication is a selection input as described herein. Alternatively, in some embodiments, the electronic device receives a voice input corresponding to a request to add the respective mathematical equation to the graph that is optionally directed to the visual indication or optionally not directed to the visual indication.

In some embodiments, while displaying, via the one or more display generation components, the graph that includes the graphical representation of the first mathematical equation and the user interface element associated with the graph including a visual indication of a respective mathematical equation in the electronic document different from the first mathematical equation in response to detecting the input directed to the visual indication of the respective mathematical equation, the electronic device updates, via the one or more display generation components, a set of axes of the graph that includes the graphical representation of the first equation to further include a graphical representation of the respective mathematical equation, such as displaying graphical representation 1010e in FIG. 10OO. In some embodiments, prior to detecting the input directed to the visual indication, the electronic device displays the graph of the first mathematical equation on the first set of axes. In some embodiments, the electronic device adjusts a scale of the set of axes when updating the graph to further include the graphical representation of the respective equation in a manner similar to the manner of adjusting the scale of graph axes described above with reference to method 1100, such as updating axes 1008a in FIG. 10G in response to adding the graphical representation 1010b to axes 1008a. In some embodiments, in response to detecting the input directed to the visual indication, the electronic device updates the user interface element associated with the graph to include a selectable option to remove the respective equation from the graph and a selectable option to change a color of the respective equation on the graph, similar to the corresponding selectable options associated with the first equation described in more detail below. Updating the graph to include the graphical representation of the respective equation in response to detecting the input directed to the user interface element associated with the graph enhances user interactions with the electronic device by providing an efficient manner of comparing mathematical equations on a set of axes.

In some embodiments, displaying the user interface element associated with the graph includes displaying, via the one or more display generation components, a color option associated with the first mathematical equation in the user interface element associated with the graph, such as option 1088a in FIG. 10LL. In some embodiments, the color option is included in a visual indication associated with the first mathematical equation in the user interface element associated with the graph. In some embodiments, the color option has a color associated with the color of the graphical representation of the first mathematical equation (e.g., the same color or a color with the same or similar hue but different darkness, saturation, and/or translucency).

In some embodiments, while displaying the user interface element associated with the graph and displaying the graphical representation of the first equation in a first color, the electronic device detects, via the one or more input devices, a sequence of one or more inputs including an input directed to the color option, such as input with stylus 1013 in FIG. 10LL. In some embodiments, the sequence of one or more inputs includes one or more voice inputs optionally directed to the color option and/or optionally not directed to the color option. In some embodiments, the input directed to the color option is a selection input as described herein. In some embodiments, in response to detecting the input directed to the color option, the electronic device displays a color selection user interface element. The color selection user interface element optionally includes a first option associated with a second color and a second option associated with a third color. In response to detecting an input directed to one of the options in the color selection user interface element, the electronic device updates the color of the graphical representation of the first mathematical equation to be the color associated with the selected option.

In some embodiments, in response to detecting the sequence of one or more inputs, the electronic device updates, via the one or more display generation components, the graphical representation of the first equation to be in a second color different from the first color, such as the display of graphical representation 1010d in FIG. 10MM. In some embodiments, the second color corresponds to the option the electronic device detected selection of while displaying the color selection user interface element described above. In some embodiments, updating the color of the graphical representation of the first equation includes updating the graphical representation of the first equation on the graph (e.g., a line or equation representing the first equation of the first equation) without updating color(s) of a set of axes or indications of scale of the graph. In some embodiments, updating the color of the graphical representation of the first equation of the graph includes updating color(s) of a set of axes or indications of scale of the graph from the first color to the second color. In some embodiments, in response to a first sequence of inputs, the electronic device displays the graphical representation of the first equation in the second color. In some embodiments, in response to detecting a second sequence of inputs, the electronic device displays the graphical representation of the first equation in a third color different from the first color and different from the second color. Providing an option to change the color of the graphical representation of the first equation on the graph enhances user interactions with the electronic device by reducing the inputs needed to efficiently visualize mathematical equations as desired by the user.

In some embodiments, while displaying the graphical representation of the first equation in the first color, the electronic device, via the one or more display generation components, the representation of the first mathematical equation in a third color that corresponds to the first color, such as the display of text 1032 in FIG. 10LL. In some embodiments, the third color is the same as the first color. In some embodiments, the third color is different from the first color but has the same hue and/or brightness and/or darkness and/or saturation and/or transparency.

In some embodiments, in response to detecting the sequence of one or more inputs, the electronic device updates, via the one or more display generation components, the graphical representation of the first mathematical equation to be displayed in a fourth color that corresponds to the second color, such as the display of text 1032 in FIG. 10MM. In some embodiments, the fourth color is the same as the second color. In some embodiments, the fourth color is different from the second color but has the same hue and/or brightness and/or darkness and/or saturation and/or transparency. In some embodiments, the fourth color is different from the third color. Updating the color of the representation of the first mathematical equation not included in the graph in accordance with updating the color of the first mathematical equation of the graph enhances user interactions with the electronic device by reducing the number of inputs needed to make the representation of the first equation consistent with the first graph and reduces user errors.

In some embodiments, the electronic device concurrently displays, via the one or more display generation components: a graphical representation of the first mathematical equation and a graphical representation of a fourth mathematical equation on a graph with a common set of axes, such as graphical representations 1010d and 1010e in FIG. 10OO, and optionally similar to examples of graphs with multiple equations described above with reference to method 1100 and method 1200, such as axes 1008a including graphical representations 1010a and 1010b in FIG. 10G. The fourth mathematical equation is optionally one of the second or third mathematical equations described above. The fourth mathematical equation is optionally different from the second and third mathematical equations described above.

In some embodiments, the electronic device concurrently displays, via the one or more display generation components, a respective user interface element associated with the graphical representation of the first mathematical equation and the graphical representation of the fourth mathematical equation, such as user interface element 1085 in FIG. 10OO.

In some embodiments, displaying the user interface element associated with the graphical representation of the first mathematical equation and the graphical representation of the fourth mathematical equation includes displaying a selectable option to delete the graphical representation of the first mathematical equation from the graph in the respective user interface element, such as option 1087a. In some embodiments, the selectable option to delete the graphical representation of the first mathematical equation from the graph includes a representation of the first equation, such as a font-based indication of the first mathematical equation. In some embodiments, the selectable option to delete the graphical representation of the first mathematical equation includes the color option described above for the first equation.

In some embodiments, displaying the user interface element associated with the graphical representation of the first mathematical equation and the graphical representation of the fourth mathematical equation includes displaying a selectable option to delete the fourth mathematical equation from the graph in the respective user interface element, such as selectable option 1087b, optionally similar to the selectable option to delete the first mathematical equation described above.

In some embodiments, while displaying, via the one or more display generation components, the respective user interface element, the electronic device detects, via the one or more input devices, a first input directed to the respective user interface element, such as the input in FIG. 1000 with stylus 1013. In some embodiments, the first input is a selection input as described herein. In some embodiments, the first input is a voice input optionally directed to the user interface element associated with the graph or optionally not directed to the user interface element associated with the graph.

In some embodiments, in response to detecting the first input, in accordance with a determination that the first input is directed to the selectable option to delete the graphical representation of the first mathematical equation from the graph (and/or in the case of a voice input, specifying the first mathematical equation), the electronic device updates, via the one or more display generation components, the graph to include the graphical representation of the fourth mathematical equation without including the graphical representation of the first mathematical equation, such as ceasing to display the graphical representation 1010e in FIG. 10PP. In some embodiments, the electronic device maintains display of the fourth mathematical equation as the electronic device displayed it prior to detecting the first input. In some embodiments, in response to detecting the first input, the electronic device updates a scale of the graph. In some embodiments, in response to detecting the first input, the electronic device forgoes updating a scale of the graph. In some embodiments, in response to detecting the first input, the electronic device updates the user interface element associated with the graph to include a selectable option that, when selected, causes the electronic device to add a graphical representation of the first mathematical equation to the graph including the graphical representation of the fourth mathematical equation.

In some embodiments, in response to detecting the first input in accordance with a determination that the first input is directed to the selectable option to delete the graphical representation of the fourth mathematical equation from the graph (and/or in the case of a voice input, specifying the fourth mathematical equation), the electronic device, via the one or more display generation components, the graph to include the graphical representation of the first mathematical equation without including the graphical representation of the fourth mathematical equation, such as if the electronic device ceased displaying graphical representation 1010d in FIG. 10PP instead of ceasing to display graphical representation 1010e. In some embodiments, the electronic device maintains display of the first mathematical equation as the electronic device displayed it prior to detecting the first input. In some embodiments, in response to detecting the first input, the electronic device updates a scale of the graph. In some embodiments, in response to detecting the first input, the electronic device forgoes updating a scale of the graph. In some embodiments, in response to detecting the first input, the electronic device updates the user interface element associated with the graph to include a selectable option that, when selected, causes the electronic device to add a graphical representation of the fourth mathematical equation to the graph including the graphical representation of the first mathematical equation. Providing options to remove graphical representations of equations from a graph in the user interface elements associated with the graph enhances user interactions with the electronic device by reducing the inputs needed to view a graph of a equation without a graph of another equation and provides a mechanism for efficiently correcting user errors.

In some embodiments, while displaying the graph of the first mathematical equation, the electronic device detects, via the one or more input devices, an input directed to the graphical representation of the first mathematical equation, such as the input with stylus 1013 in FIG. 10QQ. In some embodiments, the input is a selection input as described herein directed to the graphical representation of the first mathematical equation. In some embodiments, the input is a voice input. In some embodiments, the graph further includes a graphical representation of a fourth mathematical equation. In some embodiments, the input is directed to the graphical representation of the first equation and not directed to the graphical representation of the fourth equation.

In some embodiments, while displaying the graph of the first mathematical equation, in response to detecting the input directed to the graphical representation of the first mathematical equation, the electronic device displays, via the one or more display generation components, a visual indication of the first mathematical equation overlaid on the graph that is separate from the representation of the first mathematical equation (e.g., the text corresponding to the first mathematical equation in the user interface separate from the graph) and separate from the graphical representation of the first mathematical equation on the graph (e.g., the line or curve on the graph representing values of the first mathematical equation for the variables of the axes of the graph), such as element 1092 in FIG. 10RR. In some embodiments, the visual indication of the first mathematical equation includes a font-based indication of the first equation. In some embodiments, the visual indication is different from the user interface element associated with the graph. In some embodiments, while displaying the visual indication, the electronic device forgoes displaying the user interface element associated with the graph. In some embodiments, the electronic device concurrently displays the user interface element associated with the graph and the visual indication outside of the user interface element associated with the graph. In some embodiments, in response to detecting an input directed to the fourth equation on the graph and not to the first equation on the graph, the electronic device displays a visual indication of the fourth equation similar to the visual indication of the first equation without displaying the visual indication of the first equation. In some embodiments, the electronic device displays the visual indication of the first equation without displaying the visual indication of the fourth equation. Displaying the visual indication of the first equation in response to detecting the input directed to the graphical representation of the first mathematical equation enhances user interactions with the electronic device by providing an efficient manner of confirming the equation of the graph.

In some embodiments, while detecting the input directed to the graphical representation of the first mathematical equation, the electronic device displays the graphical representation of the first mathematical equation with a first color, wherein displaying the visual indication of the first mathematical equation overlaid on the graph includes displaying, via the one or more display generation components, a visual indication of the first color in association with the visual indication of the first mathematical equation overlaid on the graph, such as indication 1093 in FIG. 10RR. In some embodiments, displaying the graph of the first mathematical equation with the first color includes displaying a portion of the graph corresponding to the first equation (e.g., a line with a contour that follows the first equation) in the first color. Optionally, the electronic device displays other portions of the graph, such as the axes and/or numbers indicating the scale of the graph, in a different color. In some embodiments, the electronic device displays these portions of the graph in a respective color (e.g., black) irrespective of the color of the equation(s) included in the graph. In some embodiments, the electronic device displays these portions in the same color as the color of the first equation. In some embodiments, the visual indication of the first color includes the first color. In some embodiments, the visual indication of the first color is a portion of the visual indication of the first mathematical equation that includes the first color. In some embodiments, the electronic device displays the visual indication of the first color proximate to the visual indication of the first mathematical equation.

In some embodiments, the electronic device detects, via the one or more input devices, a sequence of one or more inputs including an input directed to the visual indication of the first color, such as including the input in FIG. 10RR with stylus 1013. In some embodiments, the input directed to the visual indication of the first color is a selection input as described herein. In some embodiments, the sequence of one or more inputs includes one or more voice inputs optionally directed to or optionally not directed to visual indication of the first color. In some embodiments, in response to detecting the input directed to the visual indication of the first color, the electronic device displays a color selection user interface element, and the sequence of inputs further includes one or more inputs directed to the color selection user interface element as described above.

In some embodiments, in response to detecting the sequence of one or more inputs, the electronic device updates, via the one or more display generation components, the graphical representation of the first mathematical equation to be displayed with a second color different from the first color (e.g., instead of being displayed the first color), such as the display of graphical representation 1010e in FIG. 10TT. In some embodiments, the electronic device maintains the respective color of the axes and/or indications of scale of the graph in response to detecting the sequence of one or more inputs. In some embodiments, the electronic device updates a color of the representation of the first mathematical equation in response to detecting the sequence of one or more inputs as described above. In some embodiments, the electronic device displays the graphical representation of the first mathematical equation with the second color in response to detecting a first sequence of one or more inputs. In some embodiments, the electronic device displays the graphical representation of the first mathematical equation with a third color different from the first color and different from the second color in response to detecting a second sequence of one or more inputs. Updating the color of the graphical representation of the first mathematical equation in the graph in response to the sequence of one or more inputs including an input directed to the visual indication of the first color in the visual indication of the first mathematical equation overlaid on the first graph enhances user interactions with the electronic device by reducing the user inputs needed to customize the graph.

In some embodiments, the electronic device displays, via the display generation component, the graphical representation of the first mathematical equation at a first size, such as the display of axes 1008a in FIG. 10G. In some embodiments, the graph further includes one or more graphical representations of one or more second mathematical equations.

In some embodiments, while displaying the graphical representation of the first mathematical equation at the first size, the electronic device detects, via the one or more input devices, a first input corresponding to a request to resize the graphical representation of the first mathematical equation, such as the input including movement of contacts 1003a and 1003b in FIG. 10G. In some embodiments, the input has one or more characteristics of one or more inputs described herein. In some embodiments, the input includes movements of two contacts moving away or towards each other.

In some embodiments, in response to detecting the first input, the electronic device displays the graphical representation of the first mathematical equation at a second size different from the first size in accordance with the first input, such as the display of axes 1008a in FIG. 10H. In some embodiments, the second size is different from the first size by an amount and/or in a direction corresponding to a magnitude and/or direction of the first input. In some embodiments, adjusting the size of the graphical representation of the graph includes adjusting the size and/or included portion of one or more equations included in the graph. Providing efficient ways of resizing the graphical representation of the first equation enhances user interactions with the electronic device by providing efficient ways of customizing the graph.

In some embodiments, the electronic device displays, via the one or more display generation components, the graphical representation of the first mathematical equation on a graph with a first set of axes representing first ranges of values, such as axes 1008a in FIG. 10H. In some embodiments, the first set of axes includes an axis in a first dimension having a respective range of values. In some embodiments, the first set of axes includes an axis in a second dimension having a respective range of values. In some embodiments, the first set of axes includes an axis in a third dimension having a respective range of values. In some embodiments, the electronic device displays the graph with numbers indicating the first ranges of values.

In some embodiments, while displaying the graph with the first set of axes representing the first ranges of values, the electronic device detects, via the one or more input devices, a first input corresponding to a request to pan the graph, such as the input with contact 1003 in FIG. 10H. In some embodiments, panning the graph includes changing a portion of the axes shown on the graph. In some embodiments, panning the graph includes maintaining the scale of the axes of the graph. In some embodiments, panning the graph includes changing the scale of the axes of the graph. In some embodiments, the input corresponding to a request to pan the graph has one or more of the characteristics of inputs described herein. In some embodiments, the first input includes movement, such as movement of a contact.

In some embodiments, in response to detecting the first input, the electronic device displays the graph on a different portion of the first set of axes representing a second range of values different from the first range of values in accordance with the second input, such as the display of axes 1008a in FIG. 10I. In some embodiments, displaying the graph on the first set of axes representing second ranges of values includes changing the range of values for an axis in one dimension and maintaining the range of values for an axis in another dimension, such as panning horizontally or vertically but not both. In some embodiments, displaying the graph on the first set of axes representing second ranges of values includes updating the ranges of values of axes in multiple dimensions, such as panning horizontally and vertically. In some embodiments, displaying the graph on the first set of axes representing the second ranges of values includes maintaining a size and/or position in the user interface of the graph. In some embodiments, panning the graph includes panning one or more equations included in the graph. Updating the ranges of values of the first set of axes enhances user interactions with the electronic device by providing additional information about the equation and communicating the information visually with a graph efficiently.

In some embodiments, the electronic device displays, via the one or more display generation components, a first graph that includes a graphical representation of the first mathematical equation and a graphical representation of a fourth mathematical equation on a first set of axes (optionally in a manner similar to the manners of displaying multiple equations in a graph described above), such as axes 1008a in FIG. 10Q.

In some embodiments, while displaying the first graph: the electronic device detects, via the one or more input devices, an input directed to the graphical representation of the fourth mathematical equation on the first graph that includes movement, such as movement of contact 1003 in FIG. 10Q. In some embodiments, the input includes selection of the graphical representation of the fourth mathematical equation on the graph in response to detecting a selection input as described herein. In some embodiments, the input further includes a movement portion with a magnitude and direction. For example, the input includes a contact at a location on a touch screen corresponding to the fourth equation on the graph, followed by movement of the contact away from the axes of the graph. In some embodiments, the fourth input corresponds to a request to display the graphical representation of the fourth mathematical equation on a second graph with a second set of axes different from the first graph.

In some embodiments, while displaying the first graph, in response to detecting the input directed to the graphical representation of the fourth mathematical equation on the first graph, and in accordance with a determination that the input directed to the graphical representation of the fourth mathematical equation on the first graph satisfies one or more second criteria, the electronic device updates, via the one or more display generation components, the first graph to include the graphical representation of the first mathematical equation without including the graphical representation of the fourth mathematical equation on the first set of axes, such as the display of axes 1008a in FIG. 10T. In some embodiments, if the graph further included a graphical representation of a fifth mathematical equation prior to detecting the input, the graph continues to include the graphical representation of the fifth mathematical equation in addition to the graphical representation of the first mathematical equation in response to detecting the input. In some embodiments, in response to detecting the input, the electronic device updates a scale of the graph.

In some embodiments, while displaying the first graph, in response to detecting the input directed to the graphical representation of the fourth mathematical equation on the first graph, and in accordance with a determination that the input directed to the graphical representation of the fourth mathematical equation on the first graph satisfies one or more second criteria, the electronic device displays, via the one or more display generation components, a second graph including the graphical representation of the fourth mathematical equation (e.g., that has a graphical representation of the fourth mathematical equation) on a second set of axes concurrently with updated first graph, such as graphical representation 1010b on axes 1008c in FIG. 10T. In some embodiments, the second graph has a different scale from the scale of the graph of the first mathematical equation. In some embodiments, the electronic device displays the second graph at a location corresponding to the movement of the input, such as at a location at which the input was directed at the end of the input. For example, the electronic device displays the second graph at a location in the user interface at which the fourth equation was “dragged” to by the input. In some embodiments, the electronic device displays the second graph at a location in the user interface that does not include other content as described above with respect to initiating display of graphs in method 1100, such as displaying graphical representation 1010b at the location in FIG. 10T in response to detecting the sequence of inputs illustrated in FIGS. 10Q-10S. Displaying the second graph in response to the input directed to the fourth input enhances user interactions with the electronic device by providing an efficient and intuitive way of displaying equations on separate graphs.

In some embodiments, while displaying the first graph including the graphical representation of the first mathematical equation and the graphical representation of the fourth mathematical equation on the first set of axis without detecting the input directed to the fourth mathematical equation, the electronic device the graphical representation of the first mathematical equation and the graphical representation of the fourth mathematical equation with a first amount of visual emphasis, such as the display of graphical representations 1010a through 1010c in FIG. 10Q. In some embodiments, visual emphasis includes opacity, brightness, clarity, color darkness, color saturation, size, and/or line style. In some embodiments, the electronic device displays the graphical representation of the first equation on the graph, the graphical representation of the fourth equation on the graph, the axes, and/or indications of scale with the first amount (or a first set of amounts) of visual emphasis while not detecting the input directed to the fourth mathematical equation.

In some embodiments, while (and/or in response to) detecting the input directed to the graphical representation of the fourth mathematical equation, the electronic device displays the graphical representation of the first mathematical equation with a second amount of visual emphasis that is less than the first amount of visual emphasis, such as the display of graphical representations 1010a and 1010c in FIG. 10R. In some embodiments, the second amount of visual emphasis includes less opacity, less clarity, less brightness, lighter color, less saturated color, smaller size, and/or a different line style compared to the first amount of visual emphasis. In some embodiments, the electronic device maintains display of the graphical representation of the fourth equation with the first amount of visual emphasis. In some embodiments, the electronic device displays the graphical representation of the first equation, the axes, and/or indications of the scale of the graph with the second amount of visual emphasis. In some embodiments, in response to detecting the end of the input directed to the graphical representation of the fourth mathematical equation, the electronic device displays the graphical representation of the first mathematical equation with a third amount of visual emphasis greater than the second amount of visual emphasis, such as the first amount of visual emphasis. In some embodiments, in response to detecting a similar input directed to the graphical representation of the first mathematical equation, the electronic device displays the graphical representation of the fourth mathematical equation with the second amount of visual emphasis. Displaying the graphical representation of the first equation with the second amount of visual emphasis in response to detecting the input directed to the graphical representation of the fourth equation enhances user interactions with the electronic device by communicating to the user that the input will separate the graphical representation of the fourth equation from the graph, thereby reducing user errors.

In some embodiments, the one or more second criteria include a criterion that is satisfied when the input directed to the graphical representation of the fourth mathematical equation on the first graph includes movement exceeding a predefined threshold, such as movement of contact 1003 to the location shown in FIG. 10S. In some embodiments, the threshold includes a speed, distance, and/or duration threshold. In some embodiments, the threshold is a distance from the axes of the first graph. An example distance threshold includes 1, 2, 3, 10, 15, 20, or 30 centimeters. An example duration includes 0.5, 1, 2, 3, or 5 seconds. An example speed includes 1, 2, 3, 5, 10, 20, 30, or 50 centimeters per second.

In some embodiments, in response to detecting termination of the input directed to the graphical representation of the fourth mathematical equation on the first graph and in accordance with a determination that the input directed to the graphical representation of the fourth mathematical equation on the first graph does not satisfy the one or more second criteria, such as movement of contact 1003 to the location shown in FIG. 10R, the electronic device displays an animation of the graphical representation of the fourth mathematical equation moving from a location in accordance with the movement included in the input directed to the graphical representation of the fourth mathematical equation to a location of the first set of axis, such as to the location of graphical representation 1010b in FIG. 10Q. In some embodiments, while detecting the input directed to the graphical representation of the fourth equation, the electronic device displays movement of the graphical representation of the fourth mathematical equation in accordance with movement of the input. For example, the electronic device displays the graphical representation of the fourth mathematical equation to give the appearance that the input is “dragging” the graphical representation of the fourth equation in the user interface. In some embodiments, termination of the input includes detecting liftoff of a contact or deselection of the graphical representation of the fourth mathematical equation.

In some embodiments, in response to detecting termination of the input directed to the graphical representation of the fourth mathematical equation on the first graph and in accordance with a determination that the input directed to the graphical representation of the fourth mathematical equation on the first graph does not satisfy the one or more second criteria, such as movement of contact 1003 to the location shown in FIG. 10R, after displaying the animation, the electronic device display of the first graph including the graphical representation of the first mathematical equation and the graphical representation of the fourth mathematical equation on the first set of axis, such as to the location of graphical representation 1010b in FIG. 10Q. In some embodiments, if the amount of movement of the input is less than the threshold amount, in response to detecting the end of the input, the electronic device returns the graphical representation of the fourth equation to the first graph. In some embodiments, in response to detecting the end of the input directed to the graphical representation of the fourth equation that does not satisfy the one or more second criteria, the electronic device displays an animation of the graphical representation of the fourth equation moving from a location corresponding to the end of the input to a location on the first graph. In some embodiments, in accordance with a determination that the second input satisfies the one or more second criteria, in response to detecting the end of the input, the electronic device displays the graphical representation of the fourth equation on the second graph concurrently with the first graph including the graphical representation of the first equation and not including the graphical representation of the fourth equation as described above. Maintaining display of the first graph with the graphical representations of the first and fourth mathematical equations in response to detecting the input that does not satisfy the one or more criteria enhances user interactions with the electronic device by enabling the user to cancel displaying the fourth equation on the second graph, thereby reducing user errors.

In some embodiments, while displaying the graph of the first mathematical equation, the electronic device detects, via the one or more input devices, a first input corresponding to a request to display an indication of a point on the graph, such as the input with stylus 1013 in FIG. 10X. In some embodiments, the first input includes a selection input as described herein. In some embodiments, the first input includes a voice input. In some embodiments, the point on the graph is a point included in the first equation. In some embodiments, the first input specifies (e.g., is directed to) a particular location of the graphical representation of the first equation on the graph. In some embodiments, the first input includes a hover input that does not include contact as described above.

In some embodiments, while displaying the graph of the first mathematical equation, in response to detecting the first input, in accordance with a determination that the first input is directed to a first location of the graph, the electronic device displays, via the one or more display generation components, an indication of a first set of values included on the graph corresponding to the first location of the graph, such as indication 1033 in FIG. 10Y. In some embodiments, the correspondence between the first set of values and the location of the first input is described in more detail below. In some embodiments, the electronic device displays the indication overlaid on or proximate to the first graph. In some embodiments, the indication includes numbers indicating the values of the axes at the point.

In some embodiments, while displaying the graph of the first mathematical equation, in response to detecting the first input, in accordance with a determination that the first input is directed to a second location of the graph different from the first location of the graph, the electronic device displays, via the one or more display generation components, an indication of a second set of values included on the graph, different from the first set of values and corresponding to the second location of the first graph, such as indication 1033 in FIG. 10Z. optionally in a manner similar to the manner of displaying the indication of the first set of values described above. In some embodiments, the electronic device displays indications of different points on the graph in response to detecting inputs directed to different portions of the graph. Displaying indications of sets of values of the graph in response to detecting the first input enhances user interactions with the electronic device by providing an efficient way of displaying additional information about the first equation and/or graph.

In some embodiments, the first set of values corresponds to a location of the graphical representation of the first equation closest to the first location, and the second set of values corresponds to a location of the graphical representation of the first equation closest to the second location based on the second location in two dimensions corresponding to a set of axes of the graph, such as the location of stylus 1013 in FIG. 10Z. In some embodiments, the first set of values are a set of values on the graph closest to the first location in two (or more) dimensions and the second set of values are a set of values on the graph closest to the second location in two (or more) dimensions. Displaying a set of values on the graph at a location on the graph based on the location of the first input in two dimensions enhances user interactions with the electronic device by providing an efficient way for the user to specify the information about the first equation the user wishes to view.

In some embodiments, the first set of values corresponds to the first location based on the first location in one dimension corresponding to a first axis included in a set of axes of the graph irrespective of the first location in one dimension corresponding to a second axis included in the set of axes, and the second set of values corresponds to the second location based on the second location in one dimension corresponding to the first axis irrespective of the second location in one dimension corresponding to the second axis, such as the location of stylus 1013 in FIG. 10Y. In some embodiments, the first set of values are a set of values on the graph closest to the first location in one dimension, such as a set of values for a respective value of one axis. In some embodiments, the dimension is the dimension of the independent variable, such as the x-axis in which y is expressed as a function of x.

In some embodiments, in response to detecting movement included in the first input, the electronic device displays, via the one or more display generation components, an indication of a respective set of values included on the graph corresponding to movement of the first input, such as the display of indication 1033 in FIG. 10Z. In some embodiments, in response to detecting movement of the input along the dimension of the first axis, the electronic device updates the visual indication with values corresponding to the current location of the input. Displaying a set of values on the graph at a location on the graph based on the location of the first input in one dimension enhances user interactions with the electronic device by providing an efficient way for the user to specify the information about the first equation the user wishes to view.

In some embodiments, while displaying the graph including the graphical representation of the first mathematical equation and the representation of the first mathematical equation, the electronic device displays, via the one or more display generation components, an indication of a variable included in the first mathematical equation in association with a respective numerical value, such as text 1002. In some embodiments, the variable is different from the variables of the axes of the graph. In some embodiments, the document includes text that equates the variable to a numerical value.

In some embodiments, while displaying the graph including the graphical representation of the first mathematical equation and the representation of the first mathematical equation the electronic device detects, via the one or more input devices, one or more first inputs directed to the indication of the variable, such as including the input with stylus 1013 in FIG. 10O. In some embodiments, the one or more first inputs are similar to the one or more inputs for adjusting numerical values described above with reference to method(s) 700 and/or 1100, such as hover input(s), touch input(s) and/or pointing input(s) described herein, such as interactions with scrubber 678a in FIG. 10R and/or interactions with interactive element 1068 in FIG. 10P.

In some embodiments, while displaying the graph including the graphical representation of the first mathematical equation and the representation of the first mathematical equation in response to detecting the one or more first inputs, the electronic device adjusts the respective numerical value represented by the variable in accordance with the one or more second inputs, such as the updated display of text 1002 in FIG. 10Q and optionally as described above with reference to method(s) 700 and/or 1100, such as updated display of text 672c and/or 672d in FIG. 6U; In some embodiments, adjusting the respective numerical value is in accordance with a portion of the one or more inputs directed to a scrubber and/or an interactive element as described above with reference to method(s) 700 and/or 1100, such as interactions with scrubbers 678b and/or 678c in FIG. 6T.

In some embodiments, while displaying the graph including the graphical representation of the first mathematical equation and the representation of the first mathematical equation in response to detecting the one or more first inputs, the electronic device updates, via the one or more display generation components, the indication of the variable in accordance with adjusting the respective numerical value represented by the variable, such as the updated display of text 1002 in FIG. 10Q. In some embodiments, the electronic device updates the displayed number corresponding to the respective numerical value in accordance with updating the respective numerical value.

In some embodiments, while displaying the graph including the graphical representation of the first mathematical equation and the representation of the first mathematical equation in response to detecting the one or more first inputs the electronic device updates, via the one or more display generation components, the graphical representation of the first mathematical equation in accordance with adjusting the respective numerical value represented by the variable, such as the updated graphical representations 1010a through 1010c in FIG. 10Q and optionally in a manner similar to the manner of adjusting graphs in accordance with adjusting numerical values included in equations in method 1100 described above, such as adjusting the numerical value in text 1002 in response to interactions with interactive element 1068 in FIG. 10P. Adjusting a graphical representation of an equation in accordance with adjusting the numerical value of a variable included in the equation enhances user interactions with the electronic device by providing an efficient way of visualizing changes to an equation on a graph.

In some embodiments, while displaying the graph of the first mathematical equation and the representation of the first mathematical equation, the electronic device displays, via the one or more display generation components, a fourth mathematical equation that includes the variable representing the respective numerical value, such as one of the equations represented by text 1004, 1012, and/or 1018 in FIG. 10O. In some embodiments, the fourth mathematical equation is a handwritten or typed equation included in the electronic document. In some embodiments, the fourth mathematical equation is different from the first mathematical equation. In some embodiments, the fourth mathematical equation is one of the second or third mathematical equations described above. In some embodiments, the fourth mathematical equation is different from the second and third mathematical equations. The document optionally further includes a graphical representation of the fourth mathematical equation on a graph, as described above. The document optionally does not include a graphical representation of the mathematical equation.

In some embodiments, while displaying the graph of the first mathematical equation and the representation of the first mathematical equation, in response to detecting the one or more first inputs, the electronic device adjusts the fourth equation in accordance with adjusting the respective numerical value represented by the variable, such as one of the equations represented by text 1004, 1012, and/or 1018 in FIG. 10Q. In some embodiments, adjusting the fourth equation includes maintaining display of the fourth equation with the variable and adjusting the indication of the respective numerical value of the variable as described above. Adjusting multiple equations including a variable in response to detecting one or more inputs adjusting a respective numerical value of the variable enhances user interactions with the electronic device by reducing the time and inputs needed to adjust multiple equations.

In some embodiments, while displaying the graph of the first mathematical equation and the representation of the first mathematical equation, the electronic device displays, via the one or more display generation components, a fourth mathematical equation and a second graph including a graphical representation of the fourth mathematical equation, wherein the fourth mathematical equation includes the variable representing the respective numerical value, such as text 1012 with graphical representation 1010b in FIG. 10O. In some embodiments, the second graph is different from the first graph; the first graph includes the graphical representation of the first equation but not the graphical representation of the fourth equation on a first set of axes and the second graph includes the graphical representation of the fourth equation and not the graphical representation of the first equation on a second set of axes different from the first set of axes. In some embodiments, the second graph is the same as the first graph; this graph includes the graphical representation of the first equation and the graphical representation of the fourth equation on a shared set of axes.

In some embodiments, while displaying the graph of the first mathematical equation and the representation of the first mathematical equation, in response to detecting the one or more first inputs, the electronic device updates, via the one or more display generation components, the graphical representation of the fourth mathematical equation in accordance with adjusting the respective numerical value represented by the variable, such as text 1012 with graphical representation 1010b in FIG. 10Q and optionally in a manner similar to the manners of adjusting graphs in accordance with adjusting numerical values included in equations of graphs described above and/or with reference to method 1100, such as the adjustments of graphical representations 1010a through 1010c in FIG. 10Q. In some embodiments, the adjustment to the first graph is different from the adjustment to the second graph because the first and fourth equations are different. In some embodiments, the electronic device concurrently adjusts the first graph and the second graph. Adjusting multiple graphs in response to adjusting a numerical value of equations in the multiple graphs enhances user interactions with the electronic device by reducing the inputs needed to adjust multiple graphs and provides efficient ways of visualizing changes to equations with graphs.

In some embodiments, the determination that the electronic document includes the second mathematical equation is based on second text in the electronic document satisfying one or more criteria, such as the one or more criteria described above with reference to method 1100, without detecting an input identifying the second text as a mathematical equation, such as identifying text 1004, 1012, and/or 1018 in FIG. 10Q as including equations. In some embodiments, the electronic device evaluates text added to the electronic device against the one or more criteria automatically without detecting a user input requesting to associate text with mathematical equations.

In some embodiments, the determination that the electronic document includes the third mathematical equation is based on third text in the electronic document satisfying the one or more criteria without detecting an input identifying the third text as a mathematical equation, such as identifying text 1004, 1012, and/or 1018 in FIG. 10Q as including equations and optionally similar to the manner of determining that the second text corresponds to the second mathematical equation as described above. Automatically identifying text that corresponds to equations to be graphed enhances user interactions with the electronic device by reducing the inputs needed to visualize mathematical equations using graphs.

In some embodiments, the second text is handwritten text and/or the third text is handwritten text, such as text 1004 in FIG. 10Q and optionally as described above with reference to method 700, such as text 604 in FIG. 6A. Automatically identifying handwritten text that corresponds to equations to be graphed enhances user interactions with the electronic device by reducing the inputs needed to visualize mathematical equations using graphs.

In some embodiments, the second text is font-based text and/or the third text is font-based text, such as text 1064 and optionally as described above with reference to method 700, such as text 654 in FIG. 6J. Automatically identifying font-based text that corresponds to equations to be graphed enhances user interactions with the electronic device by reducing the inputs needed to visualize mathematical equations using graphs.

In some embodiments, prior to displaying the graph including the graphical representation of the first mathematical equation and the representation of the first mathematical equation, the electronic device detects, via the one or more input devices, a sequence of one or more inputs (e.g., handwriting, spoken, and/or typing inputs) providing the first mathematical equation to the electronic document, such as the input with stylus 1013 in FIG. 10A and optionally as described above with reference to method 1100.

In some embodiments, in response to detecting the sequence of one or more inputs, the electronic device displays, via the one or more display generation components, the representation of the first mathematical equation in the electronic document, such as text 1004 in FIG. 10B and optionally as described above with reference to method 1100.

In some embodiments, while displaying the representation of the first mathematical equation in the electronic document, in accordance with a determination that the first mathematical equation satisfies one or more first criteria, the electronic device displays, via the display generation component, a graphing option, such as option 1006 in FIG. 10B and optionally as described above with reference to method 1100.

In some embodiments, while displaying the representation of the first mathematical equation in the electronic document the electronic device detects, via the one or more input devices, an input directed to the graphing option, such as input with stylus 1013 in FIG. 10C and optionally as described above with reference to method 1100.

In some embodiments, in response to detecting the input directed to the graphing option, the electronic device displays, via the one or more display generation components, the graph including the graphical representation of the first mathematical equation, such as graphical representation 1010a in FIG. 10D and optionally as described above with reference to method 1100. Presenting an option to display a graphical representation of a mathematical equation identified based on first text satisfying one or more criteria enhances user interactions with the electronic device by reducing the number of inputs needed to visualize mathematical equations using graphs.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 900, and 1100) are also applicable in an analogous manner to method 700 described above with respect to FIG. 12. For example, the operation of displaying a menu of potions to modify one or more portions of a graph described above with reference to method 1200 optionally has one or more of the characteristics of detecting mathematical equations and displaying solutions to mathematical equations, performing unit conversion, and/or graphing mathematical equations described herein with reference to other methods described herein (e.g., methods 700, 900, and/or 1100). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 7 are, optionally, implemented by components depicted in FIGS. 1A-1B. For example, displaying operation 1206 and 1208 and detecting operation 1202 are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is tracking and displaying content. The present disclosure contemplates that in some instances, the data utilized may include personal information data that uniquely identifies or can be used to contact or locate a specific person. Such personal information data can include demographic data, content consumption activity, location-based data, telephone numbers, email addresses, twitter ID's, home addresses, data relating to a person's likeness, name, date of birth, or any other identifying or personal information.

The present disclosure recognizes that the use of such personal information data, in the present technology, can be used to the benefit of users. For example, analyzing entered text to detect mathematical equations can enable the electronic device to solve and/or graph equations. Accordingly, use of such personal information data enables users to use electronic devices to perform enhanced operations with mathematical functions and expressions. Further, other uses for personal information data that benefit the user are also contemplated by the present disclosure. For instance, analyzing a user's handwriting may enhance detection of mathematical equations.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location services, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user may be notified upon initiating content collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an electronic device generated generative visual media content without associating the content with personal user data.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at an electronic device in communication with one or more display generation components and one or more input devices:
displaying, via the one or more display generation components, a user interface that includes a content entry region;
while displaying the user interface including the content entry region, detecting, via the one or more input devices, an input directed to the content entry region; and
in response to detecting the input:
displaying, in the content entry region, a representation of the input;
in accordance with a determination that the input satisfies one or more first criteria including a criterion that is satisfied when the input includes a mathematical equation, displaying, in the content entry region, information corresponding to a solution to the mathematical equation near the representation of the mathematical equation, wherein the solution was not provided as part of the mathematical equation; and
in accordance with a determination that the input does not satisfy the one or more first criteria, forgoing displaying the information corresponding to the solution to the mathematical equation near the mathematical equation.

2. The method of claim 1, wherein the input is a font-based text input.

3. The method of claim 1, wherein the input is a handwritten input.

4. The method of claim 1, wherein the information corresponding to the solution is an indication of completion of a calculation of the mathematical equation without displaying the solution to the mathematical equation.

5. The method of claim 4, further comprising:
while displaying the indication of completion, detecting, via the one or more input devices, a second input directed towards the indication of completion; and
in response to detecting the second input, displaying the solution to the mathematical equation.

6. The method of claim 1, further comprising:
while displaying the information corresponding to the solution to the mathematical equation, detecting, via the one or more input devices, a second input; and in response to detecting the second input:
in accordance with a determination that one or more second criteria are satisfied, including a criterion that is satisfied when a third input corresponding to a request to accept the solution to the mathematical equation was received prior to detecting the second input, continuing displaying, in the content entry region, the information corresponding to the solution; and
in accordance with a determination that the one or more second criteria are not satisfied, ceasing display of the information corresponding to the solution.

7. The method of claim 1, wherein displaying the information corresponding to the solution to the mathematical equation includes displaying the solution to the mathematical equation.

8. The method of claim 7, wherein displaying the solution to the mathematical equation further comprises:
in accordance with a determination that the input is a handwritten input including a first characteristic, displaying the solution to the mathematical equation with the first characteristic.

9. The method of claim 7, further comprising:
displaying a representation of the input including the mathematical equation with a visual characteristic having a first value and the solution with the visual characteristic having a second value different from the first value.

10. The method of claim 9, further comprising:
displaying an indication of a second input including a second mathematical equation with the visual characteristic having a third value different from the first value and different from the second value; and
displaying the solution of the second mathematical equation for the second input with the visual characteristic having the second value.

11. The method of claim 7, further comprising:
while displaying the solution, detecting, via the one or more input devices, a second input directed towards the solution; and
in response to detecting the second input:
displaying an indication of the mathematical equation as recognized by the electronic device in font-based text.

12. The method of claim 11, further comprising:
while displaying the indication of the mathematical equation, detecting, via the one or more input devices, a third input directed towards the indication of the mathematical equation; and
in response to detecting the third input, displaying a second content entry region;
while displaying the second content entry region, detecting, via the one or more input devices, a fourth input directed towards the second content entry region, wherein the fourth input includes changes to the indication of the mathematical equation;
in response to detecting the fourth input, updating the indication of the input including the mathematical equation in accordance with the fourth input.

13. The method of claim 12, wherein updating the indication of the input including the mathematical equation in accordance with the fourth input includes updating a visual characteristic of the input including the mathematical equation from having a first value to having a fourth value, different than the first value.

14. The method of claim 12, wherein updating the input including the mathematical equation in accordance with the fourth input includes updating the information corresponding to the solution.

15. The method of claim 12, further comprising:
while detecting the fourth input directed towards the second content entry region including changes to the indication of the mathematical equation, ceasing display of the information corresponding to the solution of the mathematical equation.

16. The method of claim 1, wherein displaying, in the content entry region, the information corresponding to the solution to the mathematical equation near the representation of the mathematical equation includes:
in accordance with a determination that the input is detected in a first direction, displaying, via the one or more display generation components, the information corresponding to the solution to the mathematical equation near the input in a first location; and
in accordance with a determination that the input is detected in a second direction, different than the first direction, displaying, via the one or more display generation components, the information corresponding to the solution to the mathematical equation in a second location, different than the first location.

17. The method of claim 1, wherein the one or more first criteria further include a second criterion that is satisfied when the mathematical equation is able to be solved automatically, and the method further comprises in response to detecting the input:
in accordance with a determination that the input does not satisfy the one or more criteria, displaying, via the one or more display generation components, a visual indication indicating that the mathematical equation is not able to be solved automatically without displaying information corresponding to the solution to the mathematical equation; and
in accordance with a determination that the input satisfies the one or more criteria, forging displaying, via the one or more display generation components, the visual indication indicating that the mathematical equation is not able to be solved automatically.

18. The method of claim 17, wherein the visual indication indicating that the mathematical equation is not able to be solved automatically includes a highlighting at a location corresponding to characters of the mathematical equation.

19. The method of claim 18, wherein:
in accordance with a determination that the input fails to satisfy the second criterion because the mathematical equation is ambiguous, the visual indication indicating that the mathematical equation is not able to be solved automatically has a first appearance with a first value for a respective visual property; and
in accordance with a determination that the input fails to satisfy the second criterion because the mathematical equation is unsupported by the electronic device, the visual indication indicating that the mathematical equation is not able to be solved automatically has a first appearance with a second value for a respective visual property.

20. The method of claim 17, wherein the visual indication indicating that the mathematical equation is not able to be solved automatically includes a highlighting at a location corresponding to an equals sign of the mathematical equation.

21. The method of claim 18, wherein a respective portion of the input fails to satisfy the second criterion because the respective portion of the input is ambiguous.

22. The method of claim 18, further comprising:
while displaying the visual indication indicating that the mathematical equation is not able to be solved automatically:
detecting, via the one or more input devices, a second input directed to a respective portion of the representation of the input;
in response to detecting the second input:
displaying, via the one or more display generation components, an option to associate the respective portion of the input with first content that satisfies the second criterion.

23. The method of claim 21, wherein the respective portion of the representation of the input includes the respective portion of the input that is ambiguous or an equal sign of the input.

24. The method of claim 22, further comprising:
while displaying the option to associate the respective portion of the input with first content that satisfies the second criterion, detecting, via the one or more input devices, a third input; and
in response to detecting the third input:
in accordance with a determination that the third input is directed towards a first option, updating the representation of the input to include the first content; and
in accordance with a determination the third input is directed towards a second option, and the electronic device updates the representation of the input to include a second content.

25. The method of claim 18 wherein the second criterion requires that the mathematical equation includes a mathematical operation from a respective set of mathematical operations and that the mathematical equation does not include a mathematical operation not from the respective set of mathematical operations, wherein:
the determination that a first portion of the input fails to satisfy the second criterion includes a determination that the first portion of the input corresponds to an operation not from the respective set; and
the determination that a second portion of the input fails to satisfy the second criterion includes a determination that the second portion of the input corresponds to an operation not from the respective set.

26. The method of claim 1, wherein the one or more first criteria further includes a second criterion that is satisfied in accordance with a determination that the mathematical equation is complete, and the method further comprises:
in accordance with the determination that the input satisfies at least the criterion that is satisfied when the input includes the mathematical equation and the second criterion, displaying, via the one or more display generation components, the information corresponding to the solution to the mathematical equation.

27. The method of claim 26, wherein the second criterion is satisfied when the electronic device has not detected text entry input for at least a threshold amount of time.

28. The method of claim 26, wherein the second criterion is satisfied when the input includes an equals sign.

29. The method of claim 28, further comprising:
while displaying the information corresponding to the solution to the mathematical equation near the representation of the mathematical equation, detecting, via the one or more input devices, a second input corresponding to a request to remove the equal sign;
in response to detecting the second input, ceasing displaying the equals sign and the information corresponding to the solution to the mathematical equation.

30. The method of claim 1, wherein:
in accordance with a determination that the user interface including the content entry region is associated with a first application, the one or more first criteria is a first set of one or more criteria; and
in accordance with a determination that the user interface including the content entry region is associated with a second application, the one or more first criteria is a second set of one or more criteria, different from the first set of one or more criteria.

31. The method of claim 1, wherein the mathematical equation further includes a variable, and the method further comprises:
while displaying the mathematical equation and while the variable is associated with a first numerical quantity:
displaying, via the one or more display generation components, first information corresponding to the solution based on the first numerical quantity of the variable; and
detecting, via the one or more input devices, a second input corresponding to a request to change the first numerical quantity of the variable;
in response to detecting the second input, updating, via the one or more display generation components, the information corresponding to the solution from the first information to second information different from the first information and based on a second numerical quantity of the variable in accordance with the second input.

32. The method of claim 31, further comprising:
while displaying the mathematical equation including the variable and while the variable is associated with the first numerical quantity, displaying, via the one or more display generation components, a second mathematical equation including the variable and third information corresponding to a solution to the second mathematical equation; and
in response to detecting the second input, updating, via the one or more display generation components, the information corresponding to the solution to the second mathematical equation to fourth information based on the second numerical quantity of the variable.

33. The method of claim 31, wherein the second input further includes a movement of a scrubber element to update the variable from the first numerical quantity to the second numerical quantity.

34. The method of claim 33, wherein updating the variable based on the second input includes:
in accordance with a determination that the first numerical quantity is a first type of number, updating the variable based on a first rate of change per unit movement in the second input; and
in accordance with a determination that the first numerical quantity is a second type of number, updating the variable based on a second rate of change, different from the first rate of change, per unit movement in the second input.

35. The method of claim 34, wherein the first type of number has a first number of significant figures and the first rate of change is a change based on the first number of significant figures; and
the second type of number has a second number of significant figures different from the first number of significant figures and the second rate of change is a change based on the second number of significant figures.

36. The method of claim 34, wherein the first type of number has a first value of a constant and the first rate of change is a change based on the first value of the constant; and
the second type of number has a second value of a constant and the second rate of change is based on the second value of the constant.

37. The method of claim 31, further comprising:
while displaying the mathematical equation including the variable and while the variable is associated with the first numerical quantity, displaying, via the one or more display generation components, a first graph that includes a first visual representation of the mathematical equation in accordance with the first numerical quantity of the variable; and
in response to detecting the second input, updating, via the one or more display generation components, the first graph that includes a first graphical representation of the mathematical equation to a second graph that includes a second graphical representation of the mathematical equation in accordance with the second numerical quantity of the variable, wherein the second graphical representation of the mathematical equation is different from the first graphical representation of the mathematical equation.

38. The method of claim 1, further comprising:
prior to displaying the user interface including the content entry region, displaying, via the one or more display generation components, a user interface of a calculator application;
while displaying the user interface of the calculator application, detecting, via the one or more input devices, a second input corresponding to a request to use the calculator application to display solutions to mathematical equations in a content entry region; and
in response to detecting the second input corresponding to the request to use the calculator application to display solutions to mathematical equations in the content entry region, updating, via the one or more display generation components, the user interface of the calculator application to display the user interface that includes the content entry region.

39. The method of claim 1, further comprising:
prior to displaying the user interface including the content entry region, displaying, via the one or more display generation components, a user interface of a notes application;
while displaying the user interface of the notes application:
detecting, via the one or more input devices, a second input corresponding to a request to use the notes application to display solutions to mathematical equations in a content entry region;
in response to detecting the second input corresponding to the request to user the notes application to display solutions to mathematical equations in the content entry region, updating, via the one or more display generation components, the user interface of the notes application to display the user interface that includes the content entry region.

40. The method of claim 1, wherein:
displaying the content entry region of the user interface includes displaying a content entry field;
displaying the information corresponding to the solution to the mathematical equation includes displaying, via the one or more display generation components, a selectable option that, when selected, causes the electronic device to enter the information corresponding to the solution to the mathematical equation into the content entry field; and
the method further comprises:
detecting, via the one or more input devices, a second input selecting the selectable option; and
in response to detecting the second input, displaying, via the one or more display generation components, the information corresponding to the solution in the content entry field.

41. The method of claim 40, wherein displaying the information corresponding to the solution includes displaying the solution without the mathematical equation.

42. The method of claim 40, wherein displaying the information corresponding to the solution includes displaying the solution with the mathematical equation.

43. The method of claim 40, wherein displaying the information corresponding to the solution includes displaying the mathematical equation without the solution.

44. The method of claim 1, wherein:
while displaying the representation of the input that satisfies one or more first criteria in a respective user interface:
in accordance with a determination that the respective user interface is a first type of user interface, displaying the information corresponding to the solution includes displaying, via the one or more display generation components, an indication of completion of a calculation of the mathematical equation without displaying the solution; and
in accordance with a determination that the respective user interface is a second type of user interface, different from the first type of user interface, displaying the information corresponding to the solution includes displaying, via the one or more display generation components, the solution.

45. The method of claim 1, wherein the mathematical equation further includes a term and displaying the information corresponding to the solution to the mathematical equation includes:
in accordance with a determination that the term is associated with a first unit of measure, displaying a solution to the mathematical equation in the first unit of measure; and
in accordance with a determination that the term is associated with a second unit of measure different from the first unit of measure, displaying the solution in the second unit of measure.

46. The method of claim 1, wherein the mathematical equation further includes a term and displaying a solution to the mathematical equation includes:
in accordance with a determination that the term is not associated with a unit of measure, displaying the solution without a unit of measure.

47. The method of claim 1, wherein the mathematical equation further includes a first term associated with a first unit of measure and a second term associated with a second unit of measure and displaying a solution to the mathematical equation includes:
in accordance with a determination that the first unit of measure and the second unit of measure cancel out in the mathematical equation, displaying, via the one or more display generation components, the solution without displaying the first unit of measure or the second unit of measure.

48. The method of claim 1, wherein the mathematical equation further includes a first term associated with a first unit of measure and a second term associated with a second unit of measure and displaying a solution to the mathematical equation includes:
in accordance with a determination that the first unit of measure and the second unit of measure do not cancel out in the mathematical equation, displaying the solution with a third unit of measure determined based on the first unit of measure and the second unit of measure in the mathematical equation.

49. The method of claim 48, wherein:
in accordance with a determination that the first unit of measure and the second unit of measure are compatible, displaying the solution with the third unit of measure corresponding to the first unit of measure.

50. The method of claim 48, wherein:
in accordance with a determination that the solution includes a value that can be represented in the third unit of measure and a subunit of measure corresponding to the third unit of measure, displaying the solution with a portion of the value in the third unit of measure and a portion of the value in the subunit of measure corresponding to the third unit of measure.

51. The method of claim 48, wherein:
in accordance with a determination that the first unit of measure and the second unit of measure are not compatible, displaying the solution with the third unit of measure that is a combination of the first unit of measure and the second unit of measure.

52. The method of claim 45, further comprising displaying, via the one or more display generation components, text defining the term, wherein the determination that the term is associated with the first unit of measure is based on identifying one or more letters after one or more numbers included in the text defining the term.

53. The method of claim 45, wherein displaying the solution to the mathematical equation including a respective unit of measure includes:
in accordance with a determination that the input including the mathematical equation and the term including the respective unit of measure is a handwritten input including a first characteristic, displaying the solution including the respective unit of measure with the first characteristic.

54. The method of claim 1, including wherein:
the mathematical equation includes one or more letters that are recognized as a unit; and
displaying, in the content entry region, information corresponding to a solution to the mathematical equation near the representation of the mathematical equation comprises:
in accordance with a determination that the one or more letters have been defined as a constant, identifying the one or more letters as the constant and using a value of the constant in the equation to determine the solution; and
in accordance with a determination that the one or more letters have not been defined as a constant, identifying the one or more letters as a first unit of measure and using the first unit of measure in the equation to determine the solution.

55. An electronic device that is in communication with one or more display generation components and one or more input devices, the electronic device comprising:
one or more processors;
memory; and
one or more programs, wherein the one or more programs are stored in the memory and configured to be executed by the one or more processors, the one or more programs including instructions for:
displaying, via the one or more display generation components, a user interface that includes a content entry region;
while displaying the user interface including the content entry region, detecting, via the one or more input devices, an input directed to the content entry region; and
in response to detecting the input:
displaying, in the content entry region, a representation of the input;
in accordance with a determination that the input satisfies one or more first criteria including a criterion that is satisfied when the input includes a mathematical equation, displaying, in the content entry region, information corresponding to a solution to the mathematical equation near the representation of the mathematical equation, wherein the solution was not provided as part of the mathematical equation; and
in accordance with a determination that the input does not satisfy the one or more first criteria, forgoing displaying the information corresponding to the solution to the mathematical equation near the mathematical equation.

56. A non-transitory computer readable storage medium storing one or more programs, the one or more programs comprising instructions, which when executed by one or more processors of an electronic device, cause the electronic device to perform a method comprising:
displaying, via one or more display generation components, a user interface that includes a content entry region;
while displaying the user interface including the content entry region, detecting, via one or more input devices, an input directed to the content entry region; and
in response to detecting the input:
displaying, in the content entry region, a representation of the input;
in accordance with a determination that the input satisfies one or more first criteria including a criterion that is satisfied when the input includes a mathematical equation, displaying, in the content entry region, information corresponding to a solution to the mathematical equation near the representation of the mathematical equation, wherein the solution was not provided as part of the mathematical equation; and
in accordance with a determination that the input does not satisfy the one or more first criteria, forgoing displaying the information corresponding to the solution to the mathematical equation near the mathematical equation.

57.-161. (canceled)
